(19) United States
(12) Patent Application Publication
(10) Pub. No.: US 2025/0091050 A1
(43) Pub. Date: Mar. 20, 2025

(54) OPTIMIZED SEQUENCING SYSTEMS AND METHODS

(71) Applicant: ULTIMA GENOMICS, INC., Fremont, CA (US)

(72) Inventors: Nathan BECKETT, Oakland, CA (US); Nathan CASWELL, Sunnyvale, CA (US); Stephanie KUBECKA, San Jose, CA (US); Jacob A. WOLF, Oakland, CA (US); Michael DARCY, JR., San Francisco, CA (US); Patrick D. KINNEY, Hayward, CA (US); Theo NIKIFOROV, Carlsbad, CA (US); Michael John KENNEDY, Los Gatos, CA (US); Armando REIMER, Oakland, CA (US); Reshef ELISHA, Mountain View, CA (US); Arunika MAKAM, San Francisco, CA (US); Joseph RICKWALDER, San Jose, CA (US); Evan HANING, Sunnyvale, CA (US)

(21) Appl. No.: 18/898,149

(22) Filed: Sep. 26, 2024

Related U.S. Application Data
(63) Continuation of application No. PCT/US2023/016763, filed on Mar. 29, 2023.
(60) Provisional application No. 63/324,860, filed on Mar. 29, 2022.
(60) Provisional application No. 63/348,733, filed on Jun. 3, 2022.
(60) Provisional application No. 63/406,609, filed on Sep. 14, 2022.

(51) Int. Cl. B01L 7/00

(52) U.S. Cl. CPC B01L 7/52; B01L 2200/026; B01L 2300/1861; B01L 2400/049

(57) ABSTRACT

Provided herein are systems, and methods configured to optimize a system for sequencing one or more nucleic acid samples.

### CROSS-REFERENCE

This application is a continuation of International Patent Application No. PCT/US2023/016763, filed Mar. 29, 2023, which claims benefit of U.S. Provisional Patent Application No. 63/324,860, filed Mar. 29, 2022, U.S. Provisional Patent Application No. 63/348,733, filed Jun. 3, 2022, and U.S. Provisional Patent Application No. 63/406,609, filed Sep. 14, 2022, each of which applications is entirely incorporated herein by reference.

### BACKGROUND

Biological sample processing has various applications in the fields of molecular biology and medicine (e.g., diagnosis). For example, nucleic acid sequencing may provide information that may be used to diagnose a certain condition in a subject and in some cases tailor a treatment plan. Sequencing is widely used for molecular biology applications, including vector designs, gene therapy, vaccine design, industrial strain design and verification. Biological sample processing may involve a fluidics system and/or a detection system.

Despite the advance of sequencing technology, analyzing samples with high throughput and efficiency still requires laborious efforts.

### SUMMARY

Provided herein are methods and systems to optimize sequencing systems and methods of sequencing. The optimization provided herein may relate to reducing the waste of reagents and/or samples by printing and/or dispensing precise volumes of droplets onto a substrate with a high degree of spatial control. By controlling the volume and spatial aspect of the droplets, waste of unnecessary continual flow of sample and/or reagent may be avoided. The methods and systems provided herein may further improve high throughput sequencing systems by separating sample loading processes from sample & reagent dispensing processes in discrete system stations. The methods and system provided herein may comprise methods configured to optimize sequencing reaction chemistry through the mixing of labeled and unlabeled nucleotides to prevent phasing, scarring, and/or weak signal associated with sequencing reagents comprising a fixed percentage of labeled and/or unlabeled nucleotides used through a sequencing run. The systems and methods described herein may provide processes for minimizing sequencing down-time by preventing growth of contaminants in the system and optimizing the replacement of sequencing reagents during sequencing.

In an aspect, provided is a method for non-contact heating, comprising: (a) providing a substrate surface and a non-contact heater, wherein the non-contact heater comprises a surface comprising a plurality of light-emitting diodes (LEDs) mounted thereto; (b) positioning the non-contact heater above the substrate surface such that the plurality of LEDs are configured to direct light to the substrate surface; and (c) activating at least a subset of the plurality of LEDs to direct light to the substrate surface.

In some embodiments, the positioning in (b) comprises lowering the non-contact heater from a non-heating position to a heating position.

In some embodiments, the substrate surface comprises a plurality of analytes immobilized thereto. In some embodiments, the plurality of analytes comprises single-stranded nucleic acid molecules. In some embodiments, the plurality of analytes comprises double-stranded nucleic acid molecules. In some embodiments, during or subsequent to the activating in (c), the double-stranded nucleic acid molecules are denatured to generate single-stranded nucleic acid molecules. In some embodiments, during or subsequent to the activating in (c), the single-stranded nucleic acid molecules are hybridized to sequencing primers. In some embodiments, the single-stranded nucleic acid molecules are hybridized to sequencing primers, and wherein the at least the subset of the plurality of LEDs are activated in the presence of sequencing reagents. In some embodiments, the sequencing reagents comprises a plurality of labeled nucleotides.

In some embodiments, the plurality of analytes are coupled to a plurality of beads, which beads are immobilized to the substrate surface.

In some embodiments, the substrate surface is stationary while the at least the subset of the plurality of LEDs are activated in (c). In some embodiments, the substrate surface is rotating with respect to the non-contact heater while the at least the subset of the plurality of LEDs are activated in (c).

In another aspect, provided is a system for non-contact heating, comprising: a substrate comprising a substrate surface; a non-contact heater, wherein the non-contact heater comprises a surface comprising a plurality of light-emitting diodes (LEDs) mounted thereto; and one or more controllers, individually or in combination, configured to activate at least a subset of the plurality of LEDs to direct light towards the substrate surface.

In some embodiments, the system further comprises one or more actuators configured to move the non-contact heater from a non-heating position to a heating position, or vice versa.

In some embodiments, the plurality of LEDs are mounted on the surface of a printed circuit board (PCB).

In some embodiments, the substrate surface comprises a plurality of analytes.

In another aspect, provided is a method for handling a substrate, comprising: providing a chuck configured to contact the substrate, wherein the chuck comprising a plurality of supports and a plurality of suction cups, wherein the plurality of supports are coupled to the plurality of suction cups, wherein at least a subset of the plurality of supports comprises a fluidic pathway, and wherein the chuck comprises one or more channels that fluidically connects the fluidic pathway of the at least the subset of the plurality of supports to at least a subset of the plurality of suction cups that are coupled to the at least the subset of the plurality of supports.

In some embodiments, the method further comprises contacting the substrate to the plurality of suction cups of the chuck. In some embodiments, the method further comprises subjecting the fluidic pathway to a vacuum or negative pressure.

In another aspect, provided is a system for handling a substrate, comprising:
a chuck configured to contact the substrate, wherein the chuck comprising a plurality of supports and a plurality of suction cups, wherein the plurality of supports are coupled to the plurality of suction cups, wherein at least a subset of the plurality of supports comprises a fluidic pathway, and wherein the chuck comprises one or more channels that fluidically connects the fluidic pathway of the at least the subset of the plurality of supports to at least a subset of the plurality of suction cups that are coupled to the at least the subset of the plurality of supports.

In some embodiments, the system further comprises the substrate. In some embodiments, the substrate is contacting the plurality of suction cups of the chuck.

In some embodiments, the system further comprises a device configured to apply a vacuum or subject the fluidic pathway to negative pressure.

In another aspect, provided is a method for heating a substrate during sequencing, comprising: (a) providing a substrate comprising a substrate surface, wherein the substrate surface comprises a plurality of nucleic acid molecules immobilized thereto; (b) contacting a plurality of labeled nucleotides to the plurality of nucleic acid molecules; and (c) prior to, during, or subsequent to (b), heating the substrate surface by one or more of (i) directing light from a non-contact heater comprising a plurality of light-emitting diodes (LEDs), wherein the non-contact heater is not in contact with the substrate surface; (ii) using a fan to heat a processing chamber comprising the substrate, wherein the fan is not in contact with the substrate surface; (iii) heating a solution comprising the plurality of labeled nucleotides to a temperature higher than a temperature of the substrate surface, and dispensing the solution in (b); (iv) heating a washing solution, and dispensing the washing solution prior to (b); and (v) heating a chuck, a sub-chuck, or a theta stage, wherein the substrate is coupled to the chuck, wherein the chuck is coupled to the theta stage via the sub-chuck, wherein the theta stage is configured to rotate the substrate.

In some embodiments, in (v), rotating of the theta stage heats the theta stage.

In some embodiments, in (b), the plurality of nucleic acid molecules are contacted with a mixture comprising the plurality of labeled nucleotides and a plurality of unlabeled nucleotides.

In some embodiments, the substrate surface is rotating during the contacting in (b). In some embodiments, the substrate surface is rotating during the heating in (c).

In some embodiments, the plurality of nucleic acid molecules are hybridized to a plurality of sequencing primers, and prior to (b), a plurality of nucleotides are provided to the plurality of nucleic acid molecules to extend the plurality of sequencing primers through a known adapter sequence of the plurality of nucleic acid molecules, wherein a concentration of the plurality of nucleotides provided are adjusted based on the known adapter sequence.

In another aspect, provided is a method for cooling a substrate during sequencing, comprising: (a) providing a substrate comprising a substrate surface, wherein the substrate surface comprises a plurality of nucleic acid molecules immobilized thereto; (b) detecting one or more signals from the plurality of nucleic acid molecules, indicative of incorporation of a nucleotide, using a detector comprising an objective; and (c) prior to or during (b), cooling the substrate surface by one or more of (i) using a fan to cool a processing chamber comprising the substrate, wherein the fan is not in contact with the substrate surface; (ii) dispensing a scan buffer to at least a region of the substrate surface in optical communication with the objective, wherein the scan buffer dispensed is at a lower temperature than a temperature of the substrate surface; (iii) cooling a chuck, a sub-chuck, or a theta stage, wherein the substrate is coupled to the chuck, wherein the chuck is coupled to the theta stage via the sub-chuck, wherein the theta stage is configured to rotate the substrate; and (iv) dispensing a washing solution prior to (b), wherein the washing solution is at a temperature lower than the substrate surface at time of dispensing.

In some embodiments, the objective is an immersion objective, wherein the immersion objective is in contact with an immersion fluid, which immersion fluid is in contact with the region of the substrate surface in optical communication with the objective.

In another aspect, provided is a data communication method, comprising: (i) at a first node: dispatching first instructions to a second node; and dispatching second instructions to a third node; and (ii) at the second node: dispatching third instructions to the third node and a fourth node; wherein: the first instructions comprise a first communication mode, and the second and third instructions comprise a second communication mode; and the first instructions are transmitted via a first connector configured for the first communication mode, and the second and third instructions are transmitted via a second connector configured for the second communication mode, wherein the first and second connectors comprise a cable.

In some embodiments, the first connector and the second connector, respectively, comprises one or more twisted pairs of conductors.

In some embodiments, the first node, the second node, the third node, and the fourth node are connected via the first connector and the second connector.

In some embodiments, the first communication mode comprises Ethernet.

In some embodiments, the second communication mode comprises CAN.

In some embodiments, the first instructions have a first priority and the second instructions comprise a second priority, wherein the second priority is lower than the first priority.

In some embodiments, the first node is a controller and the second, third, and fourth nodes comprise subassemblies.

In some embodiments, the controller is a master device and the subassemblies are slave nodes.

In another aspect, provided is a data communication system, comprising: a cable comprising a plurality of twisted pairs of conductors, wherein a first subset of one or more twisted pairs of conductors is assigned to and configured for EtherCAT (Ethernet for Control Automation) communication, and wherein a second subset of one or more twisted pairs of conductors, different from the first subset of one or more twisted pairs of conductors, is assigned to and configured for CAN (Controller Area Network) communication.

In some embodiments, respective twisted pairs in the first and second subsets are mutually exclusive.

In some embodiments, the first subset comprises two twisted pairs.

In some embodiments, the second subset comprises one twisted pair.

In some embodiments, the cable comprises a Category (CAT) cable.

In some embodiments, the controller is a master device.

In some embodiments, the first subassembly and/or the second subassembly are slave nodes.

In another aspect, provided is a data communication method, comprising: connecting a cable between a first subassembly and (i) a controller or (ii) a second subassembly, wherein the cable comprises a plurality of twisted pairs of conductors, wherein a first subset of one or more twisted pairs of conductors is assigned to and configured for EtherCAT (Ethernet for Control Automation) communication, and wherein a second subset of one or more twisted pairs of conductors, different from the first subset of one or more twisted pairs of conductors, is assigned to and configured for CAN (Controller Area Network) communication.

In some embodiments, the cable is connected between the first subassembly and the controller, communicating data between the first subassembly and the controller via the first subset of one or more twisted pairs.

In some embodiments, the cable is connected between the first subassembly and the second subassembly, communicating data between the first subassembly and the second subassembly via the second subset of one or more twisted pairs.

In another aspect, provided is a method of spin coating a substrate, comprising: (a) providing the substrate on a substrate chuck, wherein the substrate comprises immobilized thereto one or more beads, wherein the one or more beads comprise one or more nucleic acid molecules coupled thereto, and wherein the substrate chuck comprises a sensor configured in an active state or an inactive state; (b) at an inactive state of the sensor, rotating the substrate; (c) dispensing a reagent onto a surface of the substrate; and (d) stopping rotation of the substrate and/or stopping reagent dispense upon activation of the sensor.

In another aspect, provided is a method of spin coating a substrate, comprising: (a) providing a substrate on a substrate chuck in a modular sample environment, wherein the substrate comprises immobilized thereto one or more beads, wherein the one or more beads comprise one or more nucleic acid molecules coupled thereto, and wherein the substrate chuck comprises a sensor configured in an active state or an inactive state; (b) at an inactive state of the sensor, rotating the substrate; (c) dispensing a reagent onto a surface of the substrate; and (d) upon activation of the sensor, initiating draining the modular sample environment.

In some embodiments, the sensor comprises a light source, a prism, and a photodetector.

In some embodiments, the substrate chuck is in a modular sample environment.

In some embodiments, the sensor is activated when a volume of the reagent comprises at least 75% of a total volume of the modular sample environment.

In some embodiments, the sensor is activated when a level of the reagent in the modular sample environment is at least 75% of the height of the modular sample environment.

In another aspect, provided is a method, comprising: (a) dispensing a first droplet onto a surface of a substrate using a printer head, wherein the droplet comprises an analyte coupled to a bead; and (b) subjecting the substrate comprising the droplet thereon to rotation,
wherein (b) is performed during or subsequent to (a).

In another aspect, provided is a method, comprising: (a) dispensing (i) a first set of droplets onto a surface of a substrate in a first dispensing pattern using a printer head, wherein a first droplet of the first set of droplets comprises a first analyte coupled to a first bead, and (ii) a second set of droplets onto the surface of the substrate in a second dispensing pattern using the printer head that is different than the first dispensing pattern, wherein a second droplet of the second set of droplets comprises a second analyte coupled to a second bead; and (b) subjecting the substrate comprising the first droplet and the second droplet thereon to rotation, wherein (b) is performed during or subsequent to (a).

In some embodiments, the printer head comprises one or more print head nozzles. In some embodiments, the one or more print head nozzles are configured to dispense the first droplet, the second droplet, or both. In some embodiments, the one or more print head nozzles comprise an ink-jet print head nozzle.

In some embodiments, the printer head moves radially toward or away from a rotational axis of the surface during the dispensing.

In some embodiments, the printer head comprises one or more cartridges, wherein the one or more cartridges comprise one or more of a first droplet solution, a second droplet solution, a first reagent, and a second reagent. In some embodiments, the one or more cartridges maintain a first temperature of the first droplet solution. In some embodiments, the one or more print head nozzles are configured to increase the first temperature of the first droplet solution to a second temperature prior to dispensing the first droplet. In some embodiments, an environment surrounding the one or more print head nozzles, or the substrate increases the first temperature of the first droplet when the first droplet is dispensed.

In another aspect, provided is a system for sequencing a plurality of nucleic acid samples, comprising: a sample loading station configured to dispense a nucleic acid sample of the plurality of nucleic acid samples onto a surface of a substrate; a processing station configured to bring a nucleic acid molecule of the nucleic acid sample immobilized on the surface of the substrate into contact with a reagent to sequence the nucleic acid molecule; a sample station configured to supply the nucleic acid sample to the sample loading station; a substrate station configured to supply the substrate to the sample loading station; a reagent station configured to supply the reagent to the processing station, wherein the reagent is supplied from a first reservoir or a second reservoir; and one or more processors, individually or collectively, programmed to execute (i) at least a portion of a first queuing instruction to introduce the nucleic acid sample of the plurality of nucleic acid samples from the sample station to the sample loading station according to a first order of introduction defined by the first queuing instruction, (ii) a substrate loading instruction to introduce the substrate from the substrate station to the sample loading station and dispense the nucleic acid sample onto the substrate, and (iii) a sequencing instruction to draw the reagent from the first reservoir, from the second reservoir, or alternately from the first reservoir and the second reservoir, and deliver the reagent to the processing station, wherein the processing station is capable of operating during performance of one or more actions selected from the group consisting of: (1) introducing an additional nucleic acid sample of the plurality of nucleic acid samples to the sample loading station, (2) inputting a second queuing instruction and executing at least a portion of the second queuing instruction, wherein the second queuing instruction defines a second order of introduction that is different than the first order of introduction, (3) introducing an additional substrate to the substrate station, and (4) introducing an additional volume of the reagent to the reagent station by one or more of (i) replacing the first reservoir or the second reservoir with a third reservoir containing the reagent and (ii) replenishing the first reservoir or the second reservoir with the reagent.

In some embodiments, the substrate is configured to immobilize adjacent thereto the nucleic acid sample.

In some embodiments, the sample loading station comprises one or more dispensing nozzles configured to dispense the nucleic acid sample to the substrate.

In some embodiments, the sample loading station comprises a lid, wherein the lid comprises a seal that is configured to seal a chamber enclosing the substrate and the one or more dispensing nozzles.

In some embodiments, the sample loading station comprises a washing station configured to wash the one or more dispensing nozzles.

In some embodiments, the lid comprises a sealable slot configured to provide access of the one or more dispensing nozzles into the chamber to dispense the nucleic acid sample onto the substrate.

In some embodiments, the reagent station comprises temperature-controlled tubing in fluid communication between the first or second reservoir and the processing station.

In some embodiments, a temperature of the temperature-controlled tubing is controlled on demand. In some embodiments, the temperature of the temperature controlled tubing is controlled within about 0.1 degrees Kelvin (K), 0.2 degrees K, or 0.5 degrees K of a target temperature.

In some embodiments, the processing station is capable of operating for at least 24 hours without human intervention.

In some embodiments, the processing station is capable of operating during performance of two or more actions selected from the group consisting of (1), (2), (3), and (4).

In some embodiments, the substrate is configured to rotate about an axis in the processing station.

In some embodiments, the processing station comprises a thin film interferometer that is configured to measure a thickness of the reagent dispensed onto the surface of the substrate.

In some embodiments, the system comprises a dilution station configured to dilute the reagent from the reagent station prior to delivery of the reagent to the processing station.

In some embodiments, the substrate station comprises a vacuum desiccator.

In some embodiments, the one or more processors are configured to, individually or collectively, within at most 40 hours of running time of the processing station, output one or more selected from the group consisting of (i) at least 1.5 giga reads per substrate, (ii) at least 140 base pairs (bp) read length, and (iii) at least 0.2 terabase reads per run.

In another aspect, provided is a method of preparing a sample for processing, comprising: (a) providing a substrate in a sample loading station; (b) loading a nucleic acid sample onto a surface of the substrate in the sample loading station, wherein the nucleic acid sample comprises one or more nucleic acid molecules coupled to one or more beads; (c) coating the surface of the substrate with a coating solution, to provide a coated surface; and (d) transporting the substrate comprising the coated surface to a processing station.

In some embodiments, the coating solution is configured to prevent drying of the nucleic acid sample loaded onto the surface of the substrate.

In some embodiments, the substrate is transported from the sample loading station to the processing station via a mechanical interface.

In some embodiments, the coating solution comprises a thickness of between about 90 micrometers (μm) and about 200 μm.

In some embodiments, the substrate comprising the coated surface further comprises a dry surface wherein the dry surface does not comprise the nucleic acid sample or the coating solution.

In some embodiments, the processing station comprises a chemical station, a detection station, or any combination thereof.

In another aspect, provided is a method for spin coating a substrate, comprising: (a) providing a substrate on a substrate chuck, wherein the substrate comprises immobilized thereto one or more beads, wherein the one or more beads comprises one or more nucleic acid molecules coupled thereto, and wherein the substrate chuck comprises a deflector configured in an open state or a closed state; (b) at an open state of the deflector, rotating the substrate; (c) dispensing a reagent onto a surface of the substrate; and (d) actuating the deflector to the closed state.

In some embodiments, the deflector is configured to prevent splash from the dispensing.

In another aspect, provided is a method of replenishing a reagent of a chemical processing station in operation, comprising: (a) providing a first substrate to a first chemical processing station and a second substrate to a second chemical processing station; (b) initiating a plurality of first sequencing runs on the first chemical processing station and a plurality of second sequencing runs on the second chemical processing station, wherein at least a portion of the plurality of first sequencing runs and at least a portion of the plurality of second sequencing runs overlap in time, wherein the first chemical processing station is configured to dispense reagents from either a first reagent cartridge or a second reagent cartridge during a single run of the plurality of first sequencing runs, and wherein the second chemical processing station is configured to dispense reagents from either the first reagent cartridge or the second reagent cartridge during a single run of the plurality of second sequencing runs; and (c) replenishing the first reagent cartridge when both the first chemical processing station and the second chemical processing station are processing first respective sequencing runs that dispenses reagents from the second reagent cartridge, and replenishing the second reagent cartridge when both the first chemical processing station and the second chemical processing station are processing second respective sequencing runs that dispenses reagents from the first reagent cartridge.

In another aspect, provided is a method for mixing reagents, comprising: (a) providing a first reservoir comprising a first sequencing reagent of labeled nucleotides and a second reservoir comprising a second sequencing reagent of unlabeled nucleotides, wherein the first reservoir is in fluidic communication with a first dispensing nozzle and the second reservoir is in fluidic communication with a second dispensing nozzle; and (b) dispensing the first sequencing reagent and the second sequencing reagent using the first dispensing nozzle and the second dispensing nozzle, respectively, onto a surface of a substrate, wherein the first sequencing reagent is dispensed at a first flow rate and the second sequencing reagent is dispensed at a second flow rate, thereby mixing the first sequencing reagent and the second sequencing reagent.

In some embodiments, the first and second dispensing nozzles are disposed parallel to each other.

In some embodiments, the first dispensing nozzle and the second dispensing nozzle are at an angle with respect to each other.

In another aspect, provided is a method for mixing reagents, comprising: (a) providing a first reservoir comprising a first sequencing reagent of labeled nucleotides and a second reservoir comprising a second sequencing reagent of unlabeled nucleotides, wherein the first reservoir and the second reservoir are in fluidic communication with a fluid line; and (b) directing the first sequencing reagent and the second sequencing reagent from the first reservoir and the second reservoir, respectively, into the fluid line, wherein the first sequencing reagent is directed to flow at a first rate and the second sequencing reagent is directed to flow at a second rate, thereby mixing the first and second sequencing reagents in the fluid line.

In another aspect, provided is a method for mixing reagents, comprising: (a) providing a first reservoir comprising a first sequencing reagent of labeled nucleotides and a second reservoir comprising a second sequencing reagent of unlabeled nucleotides, wherein the first reservoir and the second reservoir are in fluidic communication with a valve; and (b) directing the first sequencing reagent and the second sequencing reagent from the first reservoir and the second reservoir, respectively, into the valve, wherein the first sequencing reagent and the second sequencing reagent are mixed in the valve.

In another aspect, provided is a method for mixing sequencing reagents, comprising: (a) providing a first reservoir comprising a first sequencing reagent of labeled nucleotides fluidically coupled to a first syringe pump and a second reservoir comprising a second sequencing reagent of unlabeled nucleotides fluidically coupled to a second syringe pump; and (b) aspirating the first sequencing reagent from the first reservoir with the first syringe pump and the second sequencing reagent from the second reservoir with the second syringe pump into a third syringe pump, thereby mixing the first sequencing reagent and the second sequencing reagent in the third syringe pump.

In another aspect, provided is a method for sequencing, comprising: (a) receiving, at a reagent station of a sequencer, a reagent cartridge comprising a reagent; (b) transferring the reagent from the reagent cartridge to a reagent reservoir at the reagent station; and (c) directing, via a manifold in the sequencer, the reagent from the reagent reservoir to a dispensing nozzle disposed at a processing station of the sequencer, wherein the manifold comprises a fluid inlet in fluid communication with the reagent reservoir and a fluid outlet in fluid communication with the dispensing nozzle.

In some embodiments, the method further comprises prior to dispensing the reagent from the dispensing nozzle at the processing station, diluting the reagent with a diluent.

In some embodiments, the manifold is mounted in the sequencer.

In some embodiments, the manifold comprises a plurality of fluid actuating devices configured to provide positive pressure or negative positive pressure or both to direct a fluid from a given fluid inlet of the manifold to a given fluid outlet of the manifold.

Another aspect of the present disclosure provides a method, comprising: (a) dispensing a droplet onto a surface of a substrate using a printer head, wherein said droplet comprises an analyte coupled to a bead; and (b) subjecting said substrate comprising said droplet thereon to rotation, wherein (b) is performed during or subsequent to (a).

Another aspect of the present disclosure provides a method, comprising: (a) dispensing (i) a first set of droplets onto a surface of a substrate in a first dispensing pattern using a printer head, wherein a first droplet of said first set of droplets comprises a first analyte coupled to a first bead, and (ii) a second set of droplets onto said surface of said substrate in a second dispensing pattern using said printer head that is different than said first dispensing pattern, wherein a second droplet of said second set of droplets comprises a second analyte coupled to a second bead; and (b) subjecting said substrate comprising said first droplet and said second droplet thereon to rotation, wherein (b) is performed during or subsequent to (a).

In some embodiments, the print head comprises one or more print head nozzles. In some embodiments, the one or more print head nozzles are configured to dispense said first droplet, said second droplet, or both. In some embodiments, the one or more print head nozzles comprise an ink-jet print head nozzle. In some embodiments, the print head moves radially toward or away from a rotational axis of said surface during said dispensing. In some embodiments, the first dispensing pattern is substantially the same as the second dispensing pattern. In some embodiments, the first dispensing pattern is a spiral, said second dispensing pattern is a spiral, or both. In some embodiments, the first dispensing pattern does not spatially overlap with said second dispensing pattern. In some embodiments, the first dispensing pattern is a sector of a circle, said second dispensing pattern is a sector of a circle, or both. In some embodiments, the first dispensing pattern and said second dispensing pattern comprise concentric rings. In some embodiments, the one or more print head nozzles are configured to translate linearly or non-linearly in a plane parallel to said substrate when dispensing said first droplet. In some embodiments, the substrate is configured to translate linearly or non-linearly in a plane orthogonal to said one or more print head nozzles of said printer head when dispensing said first droplet. In some embodiments, the printer head comprises one or more cartridges, wherein said one or more cartridges comprise one or more of a first droplet solution, a second droplet solution, a first reagent, and a second reagent.

In some embodiments, the one or more cartridges maintain a first temperature of said first droplet solution. In some embodiments, the one or more print head nozzles are configured to increase said first temperature of said first droplet solution to a second temperature prior to dispensing said first droplet. In some embodiments, an environment surrounding said one or more print head nozzles or said substrate increases said first temperature of said first droplet when said first droplet is dispensed. In some embodiments, the one or more cartridges are replaceable, disposable, refillable, or any combination thereof. In some embodiments, the method further comprising (c) rotating said substrate along a rotational axis of said substrate for a first duration of time and (d) stopping said rotating for a second duration of time. In some embodiments, (c) and (d) are repeated at least two times, at least three times, or at least four times. In some embodiments, the method further comprises translating said substrate in a plane parallel to said substrate for a first duration of time and (d) stopping said translating for a second duration of time. In some embodiments, the method further comprises (c) vibrating said substrate for a first duration of time. In some embodiments, the method further comprises (c) translating said substrate such that said translating comprises a non-zero derivative of an acceleration of said substrate. In some embodiments, the method further comprises (c) exposing said first droplet and said second droplet dispensed onto said surface of said substrate to an environment for a period of time thereby reducing a thickness of a film formed by said dispensed first and second droplet.

In some embodiments, the method further comprises (c) covering said surface of said substrate with a cover. In some embodiments, the cover is disposable, cleanable, reusable, or any combination thereof. In some embodiments, the method further comprises (d) rotating said substrate while holding said cover stationary.

In some embodiments, the one or more cartridges comprise a cleaning solution configured to clean said one or more print head nozzles. In some embodiments, the cleaning solution comprises bleach. In some embodiments, the one or more cartridges further comprise an antimicrobial agent. In some embodiments, the antimicrobial agent comprises metal salts of hydrazoic acid sodium azide, metal salts of hydrofluoric acid, sodium fluoride, benzalkonium chloride, or any combination thereof.

Another aspect of the present disclosure provides a system for sequencing A system for sequencing a plurality of nucleic acid samples, comprising: a sample loading station configured to dispense a nucleic acid sample of said plurality of nucleic acid samples onto a surface of a substrate; a processing station configured to bring a nucleic acid molecule of said nucleic acid sample immobilized on said surface of said substrate into contact with a reagent to sequence said nucleic acid molecule; a sample station configured to supply said nucleic acid sample to said sample loading station; a substrate station configured to supply said substrate to said sample loading station; a reagent station configured to supply said reagent to said processing station, wherein said reagent is supplied from a first reservoir or a second reservoir; and one or more processors, individually or collectively, programmed to execute (i) at least a portion of a first queuing instruction to introduce said nucleic acid sample of the plurality of nucleic acid samples from said sample station to said sample loading station according to a first order of introduction defined by said first queuing instruction, (ii) a substrate loading instruction to introduce said substrate from said substrate station to said sample loading station and dispense said nucleic acid sample onto said substrate, and (iii) a sequencing instruction to draw said reagent from said first reservoir, from said second reservoir, or alternately from said first reservoir and said second reservoir, and deliver said reagent to said processing station, wherein said processing station is capable of operating during performance of one or more actions selected from the group consisting of: introducing an additional nucleic acid sample of said plurality of nucleic acid samples to said sample loading station, inputting a second queuing instruction and executing at least a portion of said second queuing instruction, wherein said second queuing instruction defines a second order of introduction that is different than said first order of introduction, introducing an additional substrate to said substrate station, and introducing an additional volume of said reagent to said reagent station by one or more of (i) replacing said first reservoir or said second reservoir with a third reservoir containing said reagent and (ii) replenishing said first reservoir or said second reservoir with said reagent.

In some embodiments, the sample loading station is configured to dispense a sample solution as one or more droplets onto said surface of said substrate. In some embodiments, the one or more droplets comprise a plurality of nucleic acid samples coupled to one or more beads. In some embodiments, the substrate is configured to immobilize adjacent thereto said nucleic acid sample. In some embodiments, the sample loading station comprises one or more dispensing nozzles configured to dispense said nucleic acid sample to said substrate. In some embodiments, the sample loading station comprises a lid, wherein said lid comprises a seal that is configured to seal a chamber enclosing said substrate and said one or more dispensing nozzles. In some embodiments, the seal comprises a hermetic seal. In some embodiments, the chamber comprises humidity and/or temperature control. In some embodiments, the sample loading station comprises a washing station configured to wash said one or more dispensing nozzles. In some embodiments, the lid comprises a sealable slot configured to provide access of said one or more dispensing nozzles into said chamber to dispense said nucleic acid sample onto said substrate.

In some embodiments, the reagent station comprises temperature-controlled tubing in fluid communication between said first or second reservoir and said processing station. In some embodiments, a temperature of said temperature-controlled tubing is controlled on demand. In some embodiments, the temperature of said temperature-controlled tubing is controlled within about 0.1 degrees Kelvin (K), 0.2 degrees K, or 0.5 degrees K of a target temperature.

In some embodiments, the processing station comprises a detecting station, wherein said detecting station comprises an objective lens in optical communication with said surface of said substrate. In some embodiments, the system further comprises deionized water, wherein said objective lens is configured for cleaning by submerging said objective lens in said deionized water prior to or after imaging said surface of said substrate. In some embodiments, the sample loading station comprises a print head configured to dispense said nucleic acid sample as one or more droplets onto said surface of said substrate. In some embodiments, the print head comprises one or more print head nozzles. In some embodiments, the one or more print head nozzles comprise an ink-jet printer nozzle. In some embodiments, the processing station is capable of operating for at least 24 hours without human intervention.

In some embodiments, the system is capable of continuous operation for more than 10 days with human intervention at intervals of not less than 18 hours. In some embodiments, the processing station is capable of operating during performance of two or more actions selected from the group consisting of (1), (2), (3), and (4). In some embodiments, the processing station is capable of operating during performance of three or more actions selected from the group consisting of (1), (2), (3), and (4). In some embodiments, the processing station is capable of operating during performance of each of (1), (2), (3), and (4). In some embodiments, the sequencing instruction comprises instructions to draw said reagent from said first reservoir until said first reservoir is depleted below a predetermined threshold, then to draw said reagent from said second reservoir. In some embodiments, (4) comprises replacing or replenishing a reservoir from said first reservoir and said second reservoir that is depleted below a predetermined threshold.

In some embodiments, the said reagent comprises one or more members selected from the group consisting of a nucleotide solution, a cleavage solution, and a washing solution. In some embodiments, the nucleotide solution comprises one or more members selected from the group consisting of adenine-containing nucleotides, cytosine-containing nucleotides, guanine-containing nucleotides, thymine-containing nucleotides, and uracil-containing nucleotides. In some embodiments, the nucleotide solution comprises labeled nucleotides.

In some embodiments, the substrate is a wafer. In some embodiments, the substrate comprises a substantially planar array. In some embodiments, the substrate comprises a plurality of independently addressable locations. In some embodiments, the substrate is configured to rotate about an axis in said processing station. In some embodiments, the substrate is configured to linearly translate in said processing station.

In some embodiments, the plurality of nucleic acid samples is compatible with a common sequencing protocol. In some embodiments, the processing station is disposed in a first environment different from a second environment in which said sample station, substrate station, and/or reagent station is disposed. In some embodiments, the processing station comprises a thin film interferometer that is configured to measure a thickness of said reagent dispensed onto said surface of said substrate. In some embodiments, the one or more processors are in operable communication with said thin film interferometer, and individually or collectively programmed to use said thickness to calculate a humidity of said first environment. In some embodiments, the humidity of said first environment is utilized by said one or more processors to adjust a dispense rate and/or temperature of said nucleic acid sample, said substrate, said reagent, or any combination thereof. In some embodiments, the thickness of said reagent is used to determine a uniformity of a film of said reagent dispensed across said surface of said substrate. In some embodiments, the first environment has a higher relative humidity than said second environment. In some embodiments, the first environment comprises one or more regions of controlled average temperature different from a second average temperature of said second environment. In some embodiments, the processing station is disposed in an environment different from an ambient environment. In some embodiments, the environment comprises a higher relative humidity than said ambient environment. In some embodiments, the environment comprises one or more regions of controlled average temperature different from an ambient temperature.

In some embodiments, the system comprises a dilution station configured to dilute said reagent from said reagent station prior to delivery of said reagent to said processing station. In some embodiments, the reagent is diluted with deionized water. In some embodiments, the substrate station comprises a sealed environment. In some embodiments, the substrate station comprises a hermetically sealed environment. In some embodiments, the substrate station comprises a vacuum desiccator.

In some embodiments, the one or more processors are configured to, individually or collectively, within at most 40 hours of running time of said processing station, output one or more selected from the group consisting of: at least 1.5 giga reads per substrate, at least 140 base pairs (bp) read length, and at least 0.2 terabase reads per run. In some embodiments, the one or more processors are configured to, within at most 40 hours of running time of said processing station, output at least 40.0 Giga reads per substrate. In some embodiments, the one or more processors are configured to, within at most 40 hours of running time of said processing station, output at least 500 bp read length. In some embodiments, the one or more processors are configured to, within at most 40 hours of running time of said processing station, output at least 6.5 terabase reads per run. In some embodiments, the one or more processors are configured to, within at most 25 hours of running time of said processing station, output one or more selected from the group consisting of: (i) at least 1.5 giga reads per substrate, (ii) at least 140 base pairs (bp) read length, and (iii) at least 0.2 terabase reads per run. In some embodiments, the one or more processors are configured to, within at most 15 hours of running time of said processing station, output one or more selected from the group consisting of: (i) at least 1.5 giga reads per substrate, (ii) at least 140 base pairs (bp) read length, and (iii) at least 0.2 terabase reads per run.

In some embodiments, the system is further configured to (A) receive (1) said plurality of nucleic acid samples, including said nucleic acid sample, in said sample station and (2) a plurality of substrates, including said substrate, in said substrate station; and (B) receive, by said one or more processors, user instructions to start two or more sequencing cycles. In some embodiments, the system is further configured to (C) in a first sequencing cycle, process a first nucleic acid sample from said plurality of nucleic acid samples on a first substrate of said plurality of substrates; and (D) during or subsequent to said first sequencing cycle, in a second sequencing cycle, process a second nucleic acid sample from said plurality of nucleic acid samples on a second substrate of said plurality of substrates, wherein said second sequencing cycle is configured to be performed in absence of additional user intervention In some embodiments, the two or more sequencing cycles are at least 5 sequencing cycles. In some embodiments, the two or more sequencing cycles are at least 10 sequencing cycles. In some embodiments, the two or more sequencing cycles are at least 20 sequencing cycles. In some embodiments, the system is further configured to purify a reagent mixture comprising said reagent prior to delivery of said reagent to said processing station, wherein said reagent mixture comprises a plurality of nucleotides or nucleotide analogs.

Another aspect of the present disclosure provides a method of preparing a sample for processing, comprising: providing a substrate in a sample loading station; loading a nucleic acid sample onto a surface of said substrate in said sample loading station, wherein said nucleic acid sample comprises one or more nucleic acid molecules coupled to one or more beads; coating said surface of said substrate with a coating solution, to provide a coated surface; and transporting said substrate comprising said coated surface to a processing station.

In some embodiments, the coating solution is configured to prevent drying of said nucleic acid sample loaded onto said surface of said substrate. In some embodiments, the substrate is a wafer. In some embodiments, the substrate is provided to said sample loading station via a mechanical interface. In some embodiments, the substrate is transported from said sample loading station to said processing station via a mechanical interface. In some embodiments, the coating solution comprises a thickness of between about 90 micrometers (μm) and about 200 μm. In some embodiments, the substrate comprising said coated surface further comprises a dry surface wherein said dry surface does not comprise said nucleic acid sample or said coating solution. In some embodiments, the mechanical interface comprises a mechanical arm. In some embodiments, the mechanical interface is configured to mechanically contact said dry surface. In some embodiments, the method comprises (e) sanitizing said mechanical interface. In some embodiments, the method comprises (f) washing a tubing of said sample loading station in fluidic communication with said nucleic acid sample by introducing a cleaning solution through said tubing. In some embodiments, the processing station comprises a chemical station, a detection station, or any combination thereof.

Another aspect of the present disclosure provides a method for spin coating a substrate, comprising: providing a substrate on a substrate chuck, wherein said substrate comprises immobilized thereto one or more beads, wherein said one or more beads comprises one or more nucleic acid molecules coupled thereto, and wherein said substrate chuck comprises a deflector configured in an open state or a closed state; at an open state of said deflector, rotating said substrate; dispensing a reagent onto a surface of said substrate; and actuating said deflector to said closed state.

In some embodiments, the deflector is configured to prevent splash from said dispensing.

Another aspect of the present disclosure provides a method of replenishing a reagent of a chemical processing station in operation, comprising: providing a first substrate to a first chemical processing station and a second substrate to a second chemical processing station; initiating a plurality of first sequencing runs on said first chemical processing station and a plurality of second sequencing runs on said second chemical processing station, wherein at least a portion of said plurality of first sequencing runs and at least a portion of said plurality of second sequencing runs overlap in time, wherein said first chemical processing station is configured to dispense reagents from either a first reagent cartridge or a second reagent cartridge during a single run of said plurality of first sequencing runs, and wherein said second chemical processing station is configured to dispense reagents from either said first reagent cartridge or said second reagent cartridge during a single run of said plurality of second sequencing runs; and replenishing said first reagent cartridge when both said first chemical processing station and said second processing station are processing first respective sequencing runs that dispenses reagents from said second reagent cartridge, and replenishing said second reagent cartridge when both said first chemical processing station and said second processing station are processing second respective sequencing runs that dispenses reagents from said first reagent cartridge.

Another aspect of the present disclosure provides a method for mixing reagents, comprising: providing a first reservoir comprising a first sequencing reagent of labeled nucleotides and a second reservoir comprising a second sequencing reagent of unlabeled nucleotides, wherein said first reservoir is in fluidic communication with a first dispensing nozzle and said second reservoir is in fluidic communication with a second dispensing nozzle; and dispensing said first sequencing reagent and said second sequencing reagent using said first dispensing nozzle and said second dispensing nozzle, respectively, onto a surface of a substrate, wherein said first sequencing reagent is dispensed at a first flow rate and said second sequencing reagent is dispensed at a second flow rate, thereby mixing said first sequencing reagent and said second sequencing reagent.

In some embodiments, the first dispensing nozzle dispenses said first sequencing reagent at a time prior to or after said second dispensing nozzle dispenses said second sequencing reagent. In some embodiments, the first and second dispensing nozzles are disposed parallel to each other. In some embodiments, the first dispensing nozzle and said second dispensing nozzle are at an angle with respect to each other.

Another aspect of the present disclosure provides a method for mixing reagents, comprising: providing a first reservoir comprising a first sequencing reagent of labeled nucleotides and a second reservoir comprising a second sequencing reagent of unlabeled nucleotides, wherein said first reservoir and said second reservoir are in fluidic communication with a fluid line; and directing said first sequencing reagent and said second sequencing reagent from said first reservoir and said second reservoir, respectively, into said fluid line, wherein said first sequencing reagent is directed to flow at a first rate and said second sequencing reagent is directed to flow at a second rate, thereby mixing said first and second sequencing reagents in said fluid line.

Another aspect of the present disclosure provides a method for mixing reagents, comprising: providing a first reservoir comprising a first sequencing reagent of labeled nucleotides and a second reservoir comprising a second sequencing reagent of unlabeled nucleotides, wherein said first reservoir and said second reservoir are in fluidic communication with a valve; and directing said first sequencing reagent and said second sequencing reagent from said first reservoir and said second reservoir, respectively, into said valve, wherein said first sequencing reagent and said second sequencing reagent are mixed in said valve.

Another aspect of the present disclosure provides a method for mixing sequencing reagents, comprising: providing a first reservoir comprising a first sequencing reagent of labeled nucleotides fluidically coupled to a first syringe pump and a second reservoir comprising a second sequencing reagent of unlabeled nucleotides fluidically coupled to a second syringe pump; and aspirating said first sequencing reagent from said first reservoir with said first syringe pump and said second sequencing reagent from said second reservoir with said second syringe pump into a third syringe pump, thereby mixing said first sequencing reagent and said second sequencing reagent in said third syringe pump.

In some embodiments, the first syringe pump aspirates said first sequencing reagent at a first rate and said second syringe pump aspirates said second sequencing reagent at a second rate. In some embodiments, the first rate and said second rate are different.

Another aspect of the present disclosure provides a kit, comprising: a cartridge configured to be inserted into a print head; and a sample pack configured to be inserted into said cartridge, wherein said sample pack comprises a nucleic acid sample coupled to one or more beads.

Another aspect of the present disclosure provides a kit, comprising: a cartridge configured to be inserted into a print head; and a reagent pack configured to be inserted into a cartridge, wherein said reagent pack comprises a sequencing reagent of labeled or unlabeled nucleotides.

In another aspect, provided is a method for sequencing, comprising: (a) receiving, at a reagent station of a sequencer, a reagent cartridge comprising a reagent; (b) transferring the reagent from the reagent cartridge to a reagent reservoir at the reagent station; and (c) directing, via a manifold in the sequencer, the reagent from the reagent reservoir to a dispensing nozzle disposed at a processing station of the sequencer, wherein the manifold comprises a fluid inlet in fluid communication with the reagent reservoir and a fluid outlet in fluid communication with the dispensing nozzle.

In some embodiments, the method further comprises, prior to dispensing the reagent from the dispensing nozzle at the processing station, diluting the reagent with a diluent. In some embodiments, the reagent is diluted in the reagent reservoir. In some embodiments, the reagent is diluted subsequent to exiting the reagent reservoir. In some embodiments, the reagent is mixed with a diluent via the manifold, wherein the manifold comprises a second fluid inlet in fluid communication with a diluent reservoir comprising the diluent.

In some embodiments, the method further comprises removing the reagent cartridge from the reagent station or replacing the reagent cartridge with a second reagent cartridge while the processing station is in operation. In some embodiments, the processing station is dispensing the reagent via the dispensing nozzle during operation.

In some embodiments, the manifold is mounted in the sequencer.

In some embodiments, the manifold comprises a plurality of fluid actuating devices configured to provide positive pressure or negative positive pressure or both to direct a fluid from a given fluid inlet of the manifold to a given fluid outlet of the manifold.

Another aspect of the present disclosure provides a system comprising one or more computer processors and computer memory coupled thereto. The computer memory comprises machine executable code that, upon execution by the one or more computer processors, implements any of the methods above or elsewhere herein. Another aspect of the present disclosure provides a non-transitory computer readable medium comprising machine executable code that, upon execution by one or more computer processors, implements any of the methods above or elsewhere herein.

Additional aspects and advantages of the present disclosure will become readily apparent to those skilled in this art from the following detailed description, wherein only illustrative instances of the present disclosure are shown and described. As will be realized, the present disclosure is capable of other and different instances, and its several details are capable of modifications in various obvious respects, all without departing from the disclosure. Accordingly, the drawings and description are to be regarded as illustrative in nature, and not as restrictive.

### INCORPORATION BY REFERENCE

All publications, patents, and patent applications mentioned in this specification are herein incorporated by reference to the same extent as if each individual publication, patent, or patent application was specifically and individually indicated to be incorporated by reference. To the extent publications and patents or patent applications incorporated by reference contradict the disclosure contained in the specification, the specification is intended to supersede and/or take precedence over any such contradictory material.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings (also “Figure” and “FIG.” herein) of which:

FIG. 1 illustrates an example workflow for processing a sample for sequencing.

FIG. 2 illustrates examples of individually addressable locations distributed on substrates, as described herein.

FIGS. 3A-3G illustrate different examples of cross-sectional surface profiles of a substrate, as described herein.

FIG. 4 shows an example coating of a substrate with a hexagonal lattice of beads, as described herein.

FIGS. 5A-5B illustrate example systems and methods for loading a sample or a reagent onto a substrate, as described herein.

FIG. 6 illustrates a computerized system for sequencing a nucleic acid molecule.

FIGS. 7A-7C illustrate multiplexed stations in a sequencing system.

FIGS. 8A-8B show reagent and sample dispensing on a rotating substrate with continual flow and droplet printing systems, as described elsewhere herein.

FIGS. 9A-9B show a print head sample loading station and print head cartridge assembly, as described elsewhere herein.

FIGS. 10A-10D show various configurations and interfaces for the print head cartridge assemblies, as described in some embodiments herein.

FIGS. 11A-11D show dispensed sample and/or reagent patterns printed onto a substrate, as described elsewhere herein.

FIG. 12 illustrates a computer system that is programmed or otherwise configured to implement methods provided herein, as described elsewhere herein.

FIGS. 13A-13B show configurations of the reagent dispensing nozzles for on substrate mixing of one or more sequencing reagent, as described elsewhere herein.

FIGS. 14A-14B show flow diagrams for warm and hot swapping workflows for replacing a reagent of the chemical processing station, as described elsewhere herein.

FIG. 15 shows a sequencing system and various sub-systems, as described in some embodiments herein.

FIG. 16 shows a bowl sample environment, as described in some embodiments herein.

FIG. 17A shows a cross-section of the bowl sample environment illustrating the modular liquid-catching structure, as described in some embodiments herein.

FIGS. 17B-17C show a cross-section and top view, respectively, of the bowl sample environment illustrating the liquid level sensor, as described in some embodiments.

FIGS. 18A-18C illustrate different schematics of using a physical scraper, such as a doctor blade tool, a mop tool, or a rigid object tool, to disperse reagents across different regions of a substrate.

FIG. 18D illustrate different schematics of using inkjet heads, multi-needle dispensers, single-needle dispensers, and actuated dispensers.

FIG. 18E illustrate different schematics of using slot die tools to dispense fluids to a substrate.

FIG. 19 illustrates a chuck comprising a plurality of supports and suction cups.

FIG. 20 illustrates an example non-contact heater module.

FIG. 21 illustrates a cross-sectional side view of a chuck and substrate assembly where the substrate-chuck distance is adjusted between the top and bottom schematics.

FIG. 22 illustrates block diagrams of example dual network cables.

FIGS. 23A-23B illustrate a block diagram of the physical connections in an example dual network cable and a block diagram of the logical connections of the example dual network cable, respectively.

### DETAILED DESCRIPTION

While various embodiments of the invention have been shown and described herein, it will be obvious to those skilled in the art that such embodiments are provided by way of example only. Numerous variations, changes, and substitutions may occur to those skilled in the art without departing from the invention. It should be understood that various alternatives to the embodiments of the invention described herein may be employed.

As used herein, the singular forms “a,” “an,” and “the” include the plural reference unless the context clearly dictates otherwise.

When a range of values is provided, it is to be understood that each intervening value between the upper and lower limit of that range, and any other stated or intervening value in that stated range is encompassed within the scope of the present disclosure. Where the stated range includes upper or lower limits, ranges excluding either of those included limits are also included in the present disclosure.

The term “biological sample,” as used herein, generally refers to any sample derived from a subject or specimen. The biological sample can be a fluid, tissue, collection of cells (e.g., cheek swab), hair sample, or feces sample. The fluid can be blood (e.g., whole blood), saliva, urine, or sweat. The tissue can be from an organ (e.g., liver, lung, or thyroid), or a mass of cellular material, such as, for example, a tumor. The biological sample can be a cellular sample or cell-free sample. Examples of biological samples include nucleic acid molecules, amino acids, polypeptides, proteins, carbohydrates, fats, or viruses. In an example, a biological sample is a nucleic acid sample including one or more nucleic acid molecules, such as deoxyribonucleic acid (DNA) and/or ribonucleic acid (RNA). The nucleic acid sample may comprise cell-free nucleic acid molecules, such as cell-free DNA or cell-free RNA. Further, samples may be extracted from variety of animal fluids containing cell free sequences, including but not limited to blood, serum, plasma, vitreous, sputum, urine, tears, perspiration, saliva, semen, mucosal excretions, mucus, spinal fluid, amniotic fluid, lymph fluid and the like. Cell free polynucleotides may be fetal in origin (via fluid taken from a pregnant subject) or may be derived from tissue of the subject itself. A biological sample may also refer to a sample engineered to mimic one or more properties (e.g., nucleic acid sequence properties, e.g., sequence identity, length, GC content, etc.) of a sample derived from a subject or specimen.

The term “subject,” as used herein, generally refers to an individual from whom a biological sample is obtained. The subject may be a mammal or non-mammal. The subject may be human, non-human mammal, animal, ape, monkey, chimpanzee, reptilian, amphibian, avian, or a plant. The subject may be a patient. The subject may be displaying a symptom of a disease. The subject may be asymptomatic. The subject may be undergoing treatment. The subject may not be undergoing treatment. The subject can have or be suspected of having a disease, such as cancer (e.g., breast cancer, colorectal cancer, brain cancer, leukemia, lung cancer, skin cancer, liver cancer, pancreatic cancer, lymphoma, esophageal cancer, cervical cancer, etc.) or an infectious disease. The subject can have or be suspected of having a genetic disorder such as achondroplasia, alpha-1 antitrypsin deficiency, antiphospholipid syndrome, autism, autosomal dominant polycystic kidney disease, Charcot-Marie-tooth, cri du chat, Crohn's disease, cystic fibrosis, Dercum disease, down syndrome, Duane syndrome, Duchenne muscular dystrophy, factor V Leiden thrombophilia, familial hypercholesterolemia, familial Mediterranean fever, fragile x syndrome, Gaucher disease, hemochromatosis, hemophilia, holoprosencephaly, Huntington's disease, Klinefelter syndrome, Marfan syndrome, myotonic dystrophy, neurofibromatosis, Noonan syndrome, osteogenesis imperfecta, Parkinson's disease, phenylketonuria, Poland anomaly, porphyria, progeria, retinitis pigmentosa, severe combined immunodeficiency, sickle cell disease, spinal muscular atrophy, Tay-Sachs, thalassemia, trimethylaminuria, Turner syndrome, velocardiofacial syndrome, WAGR syndrome, or Wilson disease.

The term “analyte,” as used herein, generally refers to an object that is the subject of analysis, or an object, regardless of being the subject of analysis, which is directly or indirectly analyzed during a process. An analyte may be synthetic. An analyte may be, originate from, and/or be derived from, a sample, such as a biological sample. In some examples, an analyte is or includes a molecule, macromolecule (e.g., nucleic acid, carbohydrate, protein, lipid, etc.), nucleic acid, carbohydrate, lipid, antibody, antibody fragment, antigen, peptide, polypeptide, protein, macromolecular group (e.g., glycoproteins, proteoglycans, ribozymes, liposomes, etc.), cell, tissue, biological particle, or an organism, or any engineered copy or variant thereof, or any combination thereof. The term “processing an analyte,” as used herein, generally refers to one or more stages of interaction with one more samples. Processing an analyte may comprise conducting a chemical reaction, biochemical reaction, enzymatic reaction, hybridization reaction, polymerization reaction, physical reaction, any other reaction, or a combination thereof with, in the presence of, or on, the analyte. Processing an analyte may comprise physical and/or chemical manipulation of the analyte. For example, processing an analyte may comprise detection of a chemical change or physical change, addition of or subtraction of material, atoms, or molecules, molecular confirmation, detection of the presence of a fluorescent label, detection of a Forster resonance energy transfer (FRET) interaction, or inference of absence of fluorescence.

The terms “nucleic acid,” “nucleic acid molecule,” “nucleic acid sequence,” “nucleic acid fragment,” “oligonucleotide” and “polynucleotide,” as used herein, generally refer to a polynucleotide that may have various lengths of bases, comprising, for example, deoxyribonucleotide, deoxyribonucleic acid (DNA), ribonucleotide, or ribonucleic acid (RNA), or analogs thereof. A nucleic acid may be single-stranded. A nucleic acid may be double-stranded. A nucleic acid may be partially double-stranded, such as to have at least one double-stranded region and at least one single-stranded region. A partially double-stranded nucleic acid may have one or more overhanging regions. An “overhang,” as used herein, generally refers to a single-stranded portion of a nucleic acid that extends from or is contiguous with a double-stranded portion of a same nucleic acid molecule and where the single-stranded portion is at a 3′ or 5′ end of the same nucleic acid molecule. Non-limiting examples of nucleic acids include DNA, RNA, genomic DNA or synthetic DNA/RNA or coding or non-coding regions of a gene or gene fragment, loci (locus) defined from linkage analysis, exons, introns, messenger RNA (mRNA), transfer RNA, ribosomal RNA (rRNA), short interfering RNA (siRNA), short-hairpin RNA (shRNA), micro-RNA (miRNA), ribozymes, cDNA, recombinant nucleic acids, branched nucleic acids, plasmids, vectors, isolated DNA of any sequence, and isolated RNA of any sequence. A nucleic acid can have a length of at least about 10 nucleic acid bases (“bases”), 20 bases, 30 bases, 40 bases, 50 bases, 100 bases, 200 bases, 300 bases, 400 bases, 500 bases, 1 kilobase (kb), 2 kb, 3, kb, 4 kb, 5 kb, 10 kb, 20 kb, 30 kb, 40 kb, 50 kb, 100 kb, 200 kb, 300 kb, 400 kb, 500 kb, 1 megabase (Mb), 10 Mb, 100 Mb, 1 gigabase or more. A nucleic acid can comprise a sequence of four natural nucleotide bases: adenine (A); cytosine (C); guanine (G); and thymine (T) (or uracil (U) instead of thymine (T) when the nucleic acid is RNA). A nucleic acid may include one or more nonstandard nucleotide(s), nucleotide analog(s) and/or modified nucleotide(s).

The term “nucleotide,” as used herein, generally refers to any nucleotide or nucleotide analog. The nucleotide may be naturally occurring or non-naturally occurring. The nucleotide may be a modified, synthesized, or engineered nucleotide. The nucleotide may include a canonical base or a non-canonical base. The nucleotide may comprise an alternative base. The nucleotide may include a modified polyphosphate chain (e.g., triphosphate coupled to a fluorophore). The nucleotide may comprise a label. The nucleotide may be terminated (e.g., reversibly terminated). Nonstandard nucleotides, nucleotide analogs, and/or modified analogs may include, but are not limited to, diaminopurine, 5-fluorouracil, 5-bromouracil, 5-chlorouracil, 5-iodouracil, hypoxanthine, xanthine, 4-acetylcytosine, 5-(carboxyhydroxylmethyl)uracil, 5-carboxymethylaminomethyl-2-thiouridine, 5-carboxymethylaminomethyluracil, dihydrouracil, beta-D-galactosylqueosine, inosine, N6-isopentenyladenine, 1-methylguanine, 1-methylinosine, 2,2-dimethylguanine, 2-methyladenine, 2-methylguanine, 3-methylcytosine, 5-methylcytosine, N6-adenine, 7-methylguanine, 5-methylaminomethyluracil, 5-methoxyaminomethyl-2-thiouracil, beta-D-mannosylqueosine, 5′-methoxycarboxymethyluracil, 5-methoxyuracil, 2-methylthio-D46-isopentenyladenine, uracil-5-oxy acetic acid (v), wybutoxosine, pseudouracil, queosine, 2-thiocytosine, 5-methyl-2-thiouracil, 2-thiouracil, 4-thiouracil, 5-methyluracil, uracil-5-oxyacetic acid methylester, uracil-5-oxy acetic acid (v), 5-methyl-2-thiouracil, 3-(3-amino-3-N-2-carboxypropyl) uracil, (acp3)w, 2,6-diaminopurine, ethynyl nucleotide bases, 1-propynyl nucleotide bases, azido nucleotide bases, phosphoroselenoate nucleic acids and the like. In some cases, nucleotides may include modifications in their phosphate moieties, including modifications to a triphosphate moiety. Additional, non-limiting examples of modifications include phosphate chains of greater length (e.g., a phosphate chain having, 4, 5, 6, 7, 8, 9, 10 or more phosphate moieties), modifications with thiol moieties (e.g., alpha-thio triphosphate and beta-thiotriphosphates) or modifications with selenium moieties (e.g., phosphoroselenoate nucleic acids). Nucleic acids may also be modified at the base moiety (e.g., at one or more atoms that typically are available to form a hydrogen bond with a complementary nucleotide and/or at one or more atoms that are not typically capable of forming a hydrogen bond with a complementary nucleotide), sugar moiety or phosphate backbone. Nucleic acids may also contain amine-modified groups, such as aminoallyl-dUTP (aa-dUTP) and aminohexhylacrylamide-dCTP (aha-dCTP) to allow covalent attachment of amine reactive moieties, such as N-hydroxysuccinimide esters (NHS). Alternatives to standard DNA base pairs or RNA base pairs in the oligonucleotides of the present disclosure can provide higher density in bits per cubic mm, higher safety (resistant to accidental or purposeful synthesis of natural toxins), easier discrimination in photo-programmed polymerases, or lower secondary structure. Nucleotides may be capable of reacting or bonding with detectable moieties for nucleotide detection.
term “terminator” as used herein with respect to a nucleotide may generally refer to a moiety that is capable of terminating primer extension. A terminator may be a reversible terminator. A reversible terminator may comprise a blocking or capping group that is attached to the 3′-oxygen atom of a sugar moiety (e.g., a pentose) of a nucleotide or nucleotide analog. Such moieties are referred to as 3-O-blocked reversible terminators. Examples of 3-O-blocked reversible terminators include, for example, 3′-ONH₂ reversible terminators, 3-O-allyl reversible terminators, and 3-O-aziomethyl reversible terminators. Alternatively, a reversible terminator may comprise a blocking group in a linker (e.g., a cleavable linker) and/or dye moiety of a nucleotide analog. 3-unblocked reversible terminators may be attached to both the base of the nucleotide analog as well as a fluorescing group (e.g., label, as described herein). Examples of 3-unblocked reversible terminators include, for example, the “virtual terminator” developed by Helicos BioSciences Corp. and the “lightning terminator” developed by Michael L. Metzker et al. Cleavage of a reversible terminator may be achieved by, for example, irradiating a nucleic acid molecule including the reversible terminator.

The term “sequencing,” as used herein, generally refers to a process for generating or identifying a sequence of a biological molecule, such as a nucleic acid. The sequence may be a nucleic acid sequence which comprises a sequence of nucleic acid bases. As used herein, the term “template nucleic acid” generally refers to the nucleic acid to be sequenced. The template nucleic acid may be an analyte or be associated with an analyte. For example, the analyte can be a mRNA, and the template nucleic acid is the mRNA or a cDNA derived from the mRNA, or other derivative thereof. In another example, the analyte can be a protein, and the template nucleic acid is an oligonucleotide that is conjugated to an antibody that binds to the protein, or derivative thereof. Examples of sequencing include single molecule sequencing or sequencing by synthesis, for example. Sequencing may comprise generating sequencing signals and/or sequencing reads. Sequencing may be performed on template nucleic acids immobilized on a support, such as a flow cell, substrate, and/or one or more beads. In some cases, a template nucleic acid may be amplified to produce a colony of nucleic acid molecules attached to the support to produce amplified sequencing signals. In one example, (i) a template nucleic acid is subjected to a nucleic acid reaction, e.g., amplification, to produce a clonal population of the nucleic acid attached to a bead, the bead immobilized to a substrate, (ii) amplified sequencing signals from the immobilized bead are detected from the substrate surface during or following one or more nucleotide flows, and (iii) the sequencing signals are processed to generate sequencing reads. The substrate surface may immobilize multiple beads at distinct locations, each bead containing distinct colonies of nucleic acids, and upon detecting the substrate surface, multiple sequencing signals may be simultaneously or substantially simultaneously processed from the different immobilized beads at the distinct locations to generate multiple sequencing reads. In some sequencing methods, the nucleotide flows comprise non-terminated nucleotides. In some sequencing methods, the nucleotide flows comprise terminated nucleotides.

The term “nucleotide flow” as used herein, generally refers to a temporally distinct instance of providing a nucleotide-containing reagent to a sequencing reaction space. The term “flow” as used herein, when not qualified by another reagent, generally refers to a nucleotide flow. For example, providing two flows may refer to (i) providing a nucleotide-containing reagent (e.g., an A-base-containing solution) to a sequencing reaction space at a first time point and (ii) providing a nucleotide-containing reagent (e.g., G-base-containing solution) to the sequencing reaction space at a second time point different from the first time point. A “sequencing reaction space” may be any reaction environment comprising a template nucleic acid. For example, the sequencing reaction space may be or comprise a substrate surface comprising a template nucleic acid immobilized thereto; a substrate surface comprising a bead immobilized thereto, the bead comprising a template nucleic acid immobilized thereto; or any reaction chamber or surface that comprises a template nucleic acid, which may or may not be immobilized. A nucleotide flow can have any number of base types (e.g., A, T, G, C; or U), for example 1, 2, 3, or 4 canonical base types. A “flow order,” as used herein, generally refers to the order of nucleotide flows used to sequence a template nucleic acid. A flow order may be expressed as a one-dimensional matrix or linear array of bases corresponding to the identities of, and arranged in chronological order of, the nucleotide flows provided to the sequencing reaction space:
(e.g., [A T G C A T G C A T G A T G A T G A T G C A T G C]). Such one-dimensional matrix or linear array of bases in the flow order may also be referred to herein as a “flow space.” A flow order may have any number of nucleotide flows. A “flow position,” as used herein, generally refers to the sequential position of a given nucleotide flow entry in the flow space (e.g., an element in the one-dimensional matrix or linear array). A “flow cycle,” as used herein, generally refers to the order of nucleotide flow(s) of a sub-group of contiguous nucleotide flow(s) within the flow order. A flow cycle may be expressed as a one-dimensional matrix or linear array of an order of bases corresponding to the identities of, and arranged in chronological order of, the nucleotide flows provided within the sub-group of contiguous flow(s) (e.g., [A T G C], [A A T T G G C C], [A T], [A/T A/G], [A A], [A], [A T G], etc.). A flow cycle may have any number of nucleotide flows. A given flow cycle may be repeated one or more times in the flow order, consecutively or non-consecutively. Accordingly, the term “flow cycle order,” as used herein, generally refers to an ordering of flow cycles within the flow order and can be expressed in units of flow cycles. For example, where [A T G C] is identified as a 1^{st} flow cycle, and [A T G] is identified as a 2^{nd} flow cycle, the flow order of [A T G C A T G C A T G A T G A T G A T G C A T G C] may be described as having a flow-cycle order of [1^{st} flow cycle; 1^{st} flow cycle; 2^{nd} flow cycle; 2^{nd} flow cycle; 2^{nd} flow cycle; 1^{st} flow cycle; 1^{st} flow cycle]. Alternatively or in addition, the flow cycle order may be described as [cycle 1, cycle, 2, cycle 3, cycle 4, cycle 5, cycle 6], where cycle 1 is the 1^{st} flow cycle, cycle 2 is the 1^{st} flow cycle, cycle 3 is the 2^{nd} flow cycle, etc.

The terms “amplifying,” “amplification,” and “nucleic acid amplification” are used interchangeably and generally refer to generating one or more copies of a nucleic acid or a template. For example, “amplification” of DNA generally refers to generating one or more copies of a DNA molecule. Amplification of a nucleic acid may be linear, exponential, or a combination thereof. Amplification may be emulsion based or non-emulsion based. Non-limiting examples of nucleic acid amplification methods include reverse transcription, primer extension, polymerase chain reaction (PCR), ligase chain reaction (LCR), helicase-dependent amplification, asymmetric amplification, rolling circle amplification (RCA), recombinase polymerase reaction (RPA), loop mediated isothermal amplification (LAMP), nucleic acid sequence based amplification (NASBA), self-sustained sequence replication (3SR), and multiple displacement amplification (MDA). Where PCR is used, any form of PCR may be used, with non-limiting examples that include real-time PCR, allele-specific PCR, assembly PCR, asymmetric PCR, digital PCR, emulsion PCR (ePCR or emPCR), dial-out PCR, helicase-dependent PCR, nested PCR, hot start PCR, inverse PCR, methylation-specific PCR, miniprimer PCR, multiplex PCR, nested PCR, overlap-extension PCR, thermal asymmetric interlaced PCR, and touchdown PCR. Amplification can be conducted in a reaction mixture comprising various components (e.g., a primer(s), template, nucleotides, a polymerase, buffer components, co-factors, etc.) that participate or facilitate amplification. In some cases, the reaction mixture comprises a buffer that permits context independent incorporation of nucleotides. Non-limiting examples include magnesium-ion, manganese-ion and isocitrate buffers. Additional examples of such buffers are described in Tabor, S. et al. C. C. PNAS, 1989, 86, 4076-4080 and U.S. Pat. Nos. 5,409,811 and 5,674,716, each of which is herein incorporated by reference in its entirety. Useful methods for clonal amplification from single molecules include rolling circle amplification (RCA) (Lizardi et al., Nat. Genet. 19:225-232 (1998), which is incorporated herein by reference), bridge PCR (Adams and Kron, Method for Performing Amplification of Nucleic Acid with Two Primers Bound to a Single Solid Support, Mosaic Technologies, Inc. (Winter Hill, Mass.); Whitehead Institute for Biomedical Research, Cambridge, Mass., (1997); Adessi et al., Nucl. Acids Res. 28:E87 (2000); Pemov et al., Nucl. Acids Res. 33:e11(2005); or U.S. Pat. No. 5,641,658, each of which is incorporated herein by reference), polony generation (Mitra et al., Proc. Natl. Acad. Sci. USA 100:5926-5931 (2003); Mitra et al., Anal. Biochem. 320:55-65(2003), each of which is incorporated herein by reference), and clonal amplification on beads using emulsions (Dressman et al., Proc. Natl. Acad. Sci. USA 100:8817-8822 (2003), which is incorporated herein by reference) or ligation to bead-based adapter libraries (Brenner et al., Nat. Biotechnol. 18:630-634 (2000); Brenner et al., Proc. Natl. Acad. Sci. USA 97:1665-1670 (2000)); Reinartz, et al., Brief Funct. Genomic Proteomic 1:95-104 (2002), each of which is incorporated herein by reference). Amplification products from a nucleic acid may be identical or substantially identical. A nucleic acid colony resulting from amplification may have identical or substantially identical sequences.

As used herein, the terms “identical” or “percent identity,” when used with respect to two or more nucleic acid or polypeptide sequences, refer to two or more sequences that are the same or, alternatively, have a specified percentage of amino acid residues or nucleotides that are the same, when compared and aligned for maximum correspondence, as measured using any one or more of the following sequence comparison algorithms: Needleman-Wunsch (see, e.g., Needleman, Saul B.; and Wunsch, Christian D. (1970). “A general method applicable to the search for similarities in the amino acid sequence of two proteins” Journal of Molecular Biology 48 (3):443-53); Smith-Waterman (see, e.g., Smith, Temple F.; and Waterman, Michael S., “Identification of Common Molecular Subsequences” (1981) Journal of Molecular Biology 147:195-197); or BLAST (Basic Local Alignment Search Tool; see, e.g., Altschul S F, Gish W, Miller W, Myers E W, Lipman D J, “Basic local alignment search tool” (1990) J Mol Biol 215 (3):403-410). As used herein, the terms “substantially identical” or “substantial identity” when used with respect to two or more nucleic acid or polypeptide sequences, refer to two or more sequences or subsequences (such as biologically active fragments) that have at least 60%, at least 70%, at least 75%, at least 80%, at least 85%, at least 90%, at least 95%, at least 96%, at least 97%, at least 98%, or at least 99% nucleotide or amino acid residue identity, when compared and aligned for maximum correspondence, as measured using a sequence comparison algorithm or by visual inspection. Substantially identical sequences are typically considered to be homologous without reference to actual ancestry. In some embodiments, “substantial identity” exists over a region of the sequences being compared. In some embodiments, substantial identity exists over a region of at least 25 residues in length, at least 50 residues in length, at least 100 residues in length, at least 150 residues in length, at least 200 residues in length, or greater than 200 residues in length. In some embodiments, the sequences being compared are substantially identical over the full length of the sequences being compared. Typically, substantially identical nucleic acid or protein sequences include less than 100% nucleotide or amino acid residue identity, and as such sequences would generally be considered “identical.”

The term “detector,” as used herein, generally refers to a device that is capable of detecting a signal, including a signal indicative of the presence or absence of one or more incorporated nucleotides or fluorescent labels. The detector may simultaneously or substantially simultaneously detect multiple signals. The detector may detect the signal in real-time during, substantially during a biological reaction, such as a sequencing reaction (e.g., sequencing during a primer extension reaction), or subsequent to a biological reaction. In some cases, a detector can include optical and/or electronic components that can detect signals. Non-limiting examples of detection methods, for which a detector is used, include optical detection, spectroscopic detection, electrostatic detection, electrochemical detection, acoustic detection, magnetic detection, and the like. Optical detection methods include, but are not limited to, light absorption, ultraviolet-visible (UV-vis) light absorption, infrared light absorption, light scattering, Rayleigh scattering, Raman scattering, surface-enhanced Raman scattering, Mie scattering, fluorescence, luminescence, and phosphorescence. Spectroscopic detection methods include, but are not limited to, mass spectrometry, nuclear magnetic resonance (NMR) spectroscopy, and infrared spectroscopy. Electrostatic detection methods include, but are not limited to, gel-based techniques, such as, for example, gel electrophoresis. Electrochemical detection methods include, but are not limited to, electrochemical detection of amplified product after high-performance liquid chromatography separation of the amplified products. A detector may be a continuous area scanning detector. For example, the detector may comprise an imaging array sensor capable of continuous integration over a scanning area where the scanning is electronically synchronized to the image of an object in relative motion. A continuous area scanning detector may comprise a time delay and integration (TDI) charge coupled device (CCD), Hybrid TDI, complementary metal oxide semiconductor (CMOS) pseudo TDI device, or TDI line-scan camera.

### Sample Processing Methods

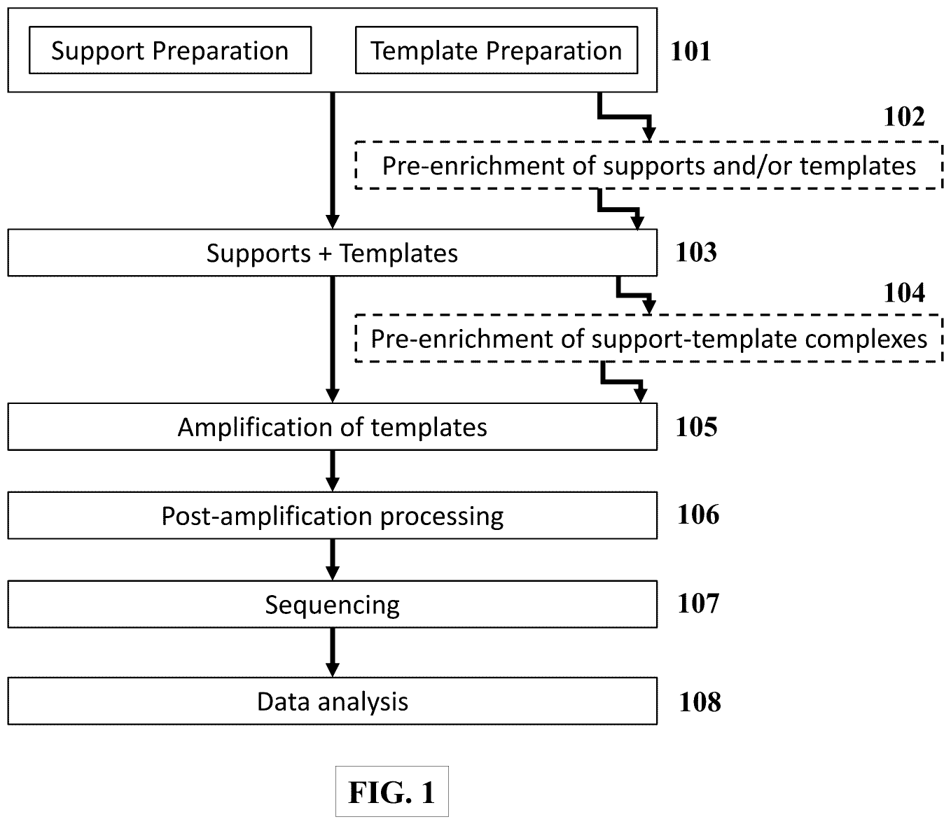

Described herein are devices, systems, methods, compositions, and kits for processing samples, such as to prepare a sample for sequencing, to sequence a sample, and/or to analyze sequencing data. FIG. 1 illustrates an example sequencing workflow 100, according to the devices, systems, methods, compositions, and kits of the present disclosure.

Supports and/or template nucleic acids may be prepared and/or provided (101) to be compatible with downstream sequencing operations (e.g., 107). A support (e.g., bead) may be used to help facilitate sequencing of a template nucleic acid on a substrate. The support may help immobilize a template nucleic acid to a substrate, such as when the template nucleic acid is coupled to the support, and the support is in turn immobilized to the substrate. The support may further function as a binding entity to retain molecules of a colony of the template nucleic acid (e.g., copies comprising identical or substantially identical sequences as the template nucleic acid) together for any downstream processing, such as for sequencing operations. This may be particularly useful in distinguishing a colony from other colonies (e.g., on other supports) and generating amplified sequencing signals for a template nucleic acid sequence.

A support that is prepared and/or provided may comprise an oligonucleotide comprising one or more functional nucleic acid sequences. For example, the support may comprise a capture sequence configured to capture or be coupled to a template nucleic acid (or processed template nucleic acid). For example, the support may comprise the capture sequence, a primer sequence, a barcode sequence, a sample index sequence, a unique molecular identifier (UMI), a flow cell adapter sequence, an adapter sequence, a binding sequence for any molecule (e.g., splint, primer, template nucleic acid, capture sequence, etc.), or any other functional sequence useful for a downstream operation, or any combination thereof. The oligonucleotide may be single-stranded, double-stranded, or partially double-stranded.

A support may comprise one or more capture entities, where a capture entity is configured for capture by a capturing entity. A capture entity may be coupled to an oligonucleotide coupled to the support. A capture entity may be coupled to the support. For example, the capturing entity may comprise streptavidin (SA) when the capture moiety comprises biotin. In another example, the capturing entity may comprise a complementary capture sequence when the capture entity comprises a capture sequence (e.g., a capture oligonucleotide that is complementary to the complementary capture sequence). In another example, the capturing entity may comprise an apparatus, system, or device configured to apply a magnetic field when the capture entity comprises a magnetic particle. In another example, the capturing entity may comprise an apparatus, system, or device configured to apply an electrical field when the capture entity comprises a charged particle. In some instances, the capturing entity may comprise one or more other mechanisms configured to capture the capture entity. A capture entity and capturing entity may bind, couple, hybridize, or otherwise associate with each other. The association may comprise formation of a covalent bond, non-covalent bond, and/or releasable bond (e.g., cleavable bond that is cleavable upon application of a stimulus). In some cases, the association may not form any bond. For example, the association may increase a physical proximity (or decrease a physical distance) between the capturing entity and capture entity. In some instances, a single capture entity may be capable of associating with a single capturing entity. Alternatively, a single capture entity may be capable of associating with multiple capturing entities. Alternatively or in addition, a single capturing entity may be capable of associating with multiple capture entities. The capture entity may be capable of linking to a nucleotide. Chemically modified bases comprising biotin, an azide, cyclooctyne, tetrazole, and a thiol, and many others are suitable as capture entities. The capture entity/capturing entity pair may be any combination. The pair may include, but is not limited to, biotin/streptavidin, azide/cyclooctyne, and thiol/maleimide. It will be appreciated that either of the pair may be used as either the capture entity or the capturing entity. In some instances, the capturing entity may comprise a secondary capture entity, for example, for subsequent capture by a secondary capturing entity. The secondary capture entity and secondary capturing entity may comprise any one or more of the capturing mechanisms described elsewhere herein (e.g., biotin and streptavidin, complementary capture sequences, etc.). In some instances, the secondary capture entity can comprise a magnetic particle (e.g., magnetic bead) and the secondary capturing entity can comprise a magnetic system (e.g., magnet, apparatus, system, or device configured to apply a magnetic field, etc.). In some instances, the secondary capture entity can comprise a charged particle (e.g., charged bead carrying an electrical charge) and the secondary capturing entity can comprise an electrical system (e.g., magnet, apparatus, system, or device configured to apply an electric field, etc.).

A support may comprise one or more cleaving moieties. The cleavable moiety may be part of or attached to an oligonucleotide coupled to the support. The cleavable moiety may be coupled to the support. A cleavable moiety may comprise any useful cleavable or excisable moiety that can be used to cleave an oligonucleotide (or portion thereof) from the support. For example, the cleavable moiety may comprise a uracil, a ribonucleotide, or other modified nucleotide that is excisable or cleavable using an enzyme (e.g., UDG, RNAse, endonuclease, exonuclease, etc.). The cleavable moiety may comprise an abasic site or an analog of an abasic site (e.g., dSpacer), a dideoxyribose. The cleavable moiety may comprise a spacer, e.g., C3 spacer, hexanediol, triethylene glycol spacer (e.g., Spacer 9), hexa-ethylene glycol spacer (e.g., Spacer 18), or combinations or analogs thereof. The cleavable moiety may comprise a photocleavable moiety. The cleavable moiety may comprise a modified nucleotide, e.g., a methylated nucleotide. The modified nucleotide may be recognized specifically by an enzyme (e.g., a methylated nucleotide may be recognized by MspJI). The cleavable moiety may be cleaved enzymatically (e.g., using an enzyme such as UDG, RNAse, APE1, MspJI, etc.). Alternatively, or in addition to, the cleavable moiety may be cleavable using one or more stimuli, e.g., photo-stimulus, chemical stimulus, thermal stimulus, etc.

In some examples, a single support comprises copies of a single species of oligonucleotide, which are identical or substantially identical to each other. In some examples, a single support comprises copies of at least two species of oligonucleotides (e.g., comprising different sequences). For example, a single support may comprise a first subset of oligonucleotides configured to capture a first adapter sequence of a template nucleic acid and a second subset of oligonucleotides configured to capture a second adapter sequence of a template nucleic acid.

In some examples, a population of a single species of supports may be prepared and/or provided, where all supports within a species of supports is identical (e.g., has identical oligonucleotide composition (e.g., sequence), etc.). In some examples, a population of multiple species of supports may be prepared and/or provided. For example, a population of supports may be prepared to comprise a plurality of unique support species, where each unique support species comprises a primer sequence unique to said support species. When attaching template nucleic acids to supports, only a template nucleic acid comprising a given adapter sequence compatible with (e.g., at least partially complementary to) a given primer sequence may be capable of attaching to a given support of a support species comprising the given primer sequence. In another example, a population of supports may be prepared, such that each unique support species comprises a plurality of primer sequences (e.g., a pair of primer sequences) unique to said support species. In some embodiments, the systems and methods disclosed herein can include a population of supports that comprise two, three, four, five, six, seven, eight, nine, ten or more unique support species. Each unique support species can comprise a unique primer sequence that allows selective interactions between the respective support species with an intended binding partner (e.g., a complementary nucleic acid sequence within an adapter region of a template nucleic acid or an intermediary primer sequence which can subsequently bind to a complementary nucleic acid sequence within an adapter region of a sample nucleic acid). A population of multiple species of supports may be prepared by first preparing distinct populations of a single species of supports, all different, and mixing such distinct populations of single species of supports to result in the final population of multiple species of supports. A concentration of the different support species within the final mixture may be adjusted accordingly. Devices, systems, methods, compositions, and kits for preparing and using support species are described in further detail in WO 2020/167656 and WO2022/040557, each of which is entirely incorporated herein by reference for all purposes.

A template nucleic acid may include an insert sequence sourced from a biological sample. In some cases, the insert sequence may be derived from a larger nucleic acid in the biological sample (e.g., an endogenous nucleic acid), or reverse complement thereof, for example by fragmenting, transposing, and/or replicating from the larger nucleic acid. The template nucleic acid may be derived from any nucleic acid of the biological sample and result from any number of nucleic acid processing operations, such as but not limited to fragmentation, degradation or digestion, transposition, ligation, reverse transcription, extension, etc. A template nucleic acid that is prepared and/or provided may comprise one or more functional nucleic acid sequences. In some cases, the one or more functional nucleic acid sequences may be disposed at one end of the insert sequence. In some cases, the one or more functional nucleic acid sequences may be separated and disposed at both ends of an insert sequence, such as to sandwich the insert sequence. In some cases, a nucleic acid molecule comprising the insert sequence, or complement thereof, may be ligated to one or more adapter oligonucleotides that comprise such functional nucleic acid sequence(s). In some cases, a nucleic acid molecule comprising the insert sequence, or complement thereof, may be hybridized to a primer comprising such functional nucleic acid sequence(s) and extended to generate a template nucleic acid comprising such functional nucleic acid sequence(s). In some cases, a nucleic acid molecule comprising the insert sequence, or complement thereof, may be hybridized to a primer comprising one or more functional nucleic acid sequence(s) and extended to generate an intermediary molecule, and the intermediary molecule hybridized to a primer comprising additional functional nucleic acid sequence(s) and extended, and so on for any number of extension reactions, to generate a template nucleic acid comprising one or more functional nucleic acid sequence(s). For example, the template nucleic acid may comprise an adapter sequence configured to be captured by a capture sequence on an oligonucleotide coupled to a support. For example, the template nucleic acid may comprise a capture sequence, a primer sequence, a barcode sequence, a sample index sequence, a unique molecular identifier (UMI), a flow cell adapter sequence, the adapter sequence, a binding sequence for any molecule (e.g., splint, primer, template nucleic acid, capture sequence, etc.), or any other functional sequence useful for a downstream operation, or any combination thereof. The template nucleic acid may be single-stranded, double-stranded, or partially double-stranded.

A template nucleic acid may comprise one or more capture entities that are described elsewhere herein. In some cases, in the workflow, only the supports comprise capture entities and the template nucleic acids do not comprise capture entities. In other cases, in the workflow, only the template nucleic acids comprise capture entities and the supports do not comprise capture entities. In other cases, both the template nucleic acids and the supports comprise capture entities. In other cases, neither the supports nor the template nucleic acids comprise capture entities.

A template nucleic acid may comprise one or more cleaving moieties that are described elsewhere herein. In some cases, in the workflow, only the supports comprise cleavable moieties and the template nucleic acids do not comprise cleavable moieties. In other cases, in the workflow, only the template nucleic acids comprise cleavable moieties and the supports do not comprise cleavable moieties. In other cases, both the template nucleic acids and the supports comprise cleavable moieties. In other cases, neither the supports nor the template nucleic acids comprise cleavable moieties. A cleavable moiety may be strategically placed based on a desired downstream amplification workflow, for example.

In some examples, a library of insert sequences are processed to provide a population of template sequences with identical configurations, such as with identical sequences and/or locations of one or more functional sequences. For example, a population of template sequences may comprise a plurality of nucleic acid molecules each comprising an identical first adapter sequence ligated to a same end. In some examples, a library of insert sequences are processed to provide a population of template sequences with varying configurations, such as with varying sequences and/or locations of one or more functional sequences. For example, a population of template sequences may comprise a first subset of nucleic acid molecules each comprising an identical first adapter sequence at a first end, and a second subset of nucleic acid molecules each comprising an identical second adapter sequence at the second end, where the second adapter sequence is different form the first adapter sequence. In some instances, a population of template sequences with varying configurations (e.g., varying adapter sequences) may be used in conjunction with a population of multiple species of supports, such as to reduce polyclonality problems during downstream amplification. A population of multiple configurations of template nucleic acids may be prepared by first preparing distinct populations of a single configuration of template nucleic acids, all different, and mixing such distinct populations of single configurations of template nucleic acids to result in the final population of multiple configurations of template nucleic acids. A concentration of the different configurations of template nucleic acids within the final mixture may be adjusted accordingly.

Optionally, the supports and/or template nucleic acids may be pre-enriched (102). For example, a support comprising a distinct oligonucleotide sequence is isolated from a mixture comprising support(s) that do not have the distinct oligonucleotide sequence. Alternatively, a support population may be provided to comprise substantially uniform supports, where each support comprises an identical surface primer molecule immobilized thereto. For example, template nucleic acids comprising a distinct configuration (e.g., comprising a particular adapter sequence) is isolated from a mixture comprising template nucleic acids that do not have the distinct configuration. Alternatively, a template nucleic acid population may be provided to comprise substantially uniform configurations. In some cases, the capture entit(ies) on the supports and/or template nucleic acids are used for pre-enrichment.

Subsequent to preparation of the supports and template nucleic acids, the two may be attached (103). A template nucleic acid may be coupled to a support via any method(s) that results in a stable association between the template nucleic acid and the support. For example, the template nucleic acid may hybridize to an oligonucleotide on the support. In another example, the template nucleic acid may hybridize to one or more intermediary molecules, such as a splint, bridge, and/or primer molecule, which hybridizes to an oligonucleotide on the support. Alternatively or in addition, a template nucleic acid may be ligated to one or more nucleic acids on or coupled to the support. Alternatively or in addition, a template nucleic acid may be hybridized to an oligonucleotide on a support, which oligonucleotide comprises a primer sequence, and subsequent extension form the primer sequence is performed. Once attached, a plurality of support-template complexes may be generated.

Optionally, support-template complexes may be pre-enriched (104), wherein a support-template complex is isolated from a mixture comprising support(s) and/or template nucleic acid(s) that are not attached to each other. In some cases, the capture entit(ies) on the supports and/or template nucleic acids are used for pre-enrichment.

Subsequent to attachment of the template nucleic acid molecule to the support, the template nucleic acids may be subjected to amplification reactions (105) to generate a plurality of amplification products immobilized to the support. For example, such amplification reactions may comprise performing polymerase chain reaction (PCR) or any other amplification methods described herein, including but not limited to emulsion PCR (ePCR or emPCR), isothermal amplification (e.g., recombinase polymerase amplification (RPA)), bridge amplification, template walking, etc. In some cases, amplification reactions can occur while the support is immobilized to a substrate. In other cases, amplification reactions can occur off the substrate, such as in solution, or on a different surface or platform. In some cases, amplification reactions can occur in isolated reaction volumes, such as within multiple droplets in an emulsion during emulsion PCR (ePCR or emPCR), or in wells. Emulsion PCR methods are described in further detail in WO2020/167656 and WO2022/040557, each of which is entirely incorporated by reference herein.

Subsequent to amplification, the supports (e.g., comprising the template nucleic acids) may be subjected to post-amplification processing (106). Often, subsequent to amplification, a resulting mixture may comprise a mix of positive supports (e.g., those comprising a template nucleic acid molecule) and negative supports (e.g., those not attached to template nucleic acid molecules). Enrichment procedure(s) may isolate positive supports from the mixtures. Example methods of enrichment of amplified supports are described in U.S. Pat. No. 10,900,078 and WO2020/186243 and WO2022/040557, each of which is entirely incorporated by reference herein. For example, an on-substrate enrichment procedure may immobilize only the positive supports onto the substrate surface to isolate the positive supports. In some instances, the positive supports may be immobilized to desired locations on the substrate surface (e.g., individually addressable locations), as distinguished from undesired locations (e.g., spacers between the individually addressable locations). In some instances, positive supports and/or negative supports may be processed to selectively remove unamplified surface primers (on the support(s)), such that a resulting positive support retains the template nucleic acid molecule, and a resulting negative support is stripped of the unamplified surface primers. Subsequently, the template nucleic acid(s) on the positive supports may be used to enrich for the positive supports, e.g., by capturing the template nucleic acids.

Subsequent to post-amplification processing, the template nucleic acids may be subject to sequencing (107). The template nucleic acid(s) may be sequenced while attached to the support. Alternatively, the template nucleic acid molecules may be free of the support when sequenced and/or analyzed. In some instances, the template nucleic acids may be sequenced while attached to the support which is immobilized to a substrate. Examples of substrate-based sample processing systems are described elsewhere herein. Any sequencing method described elsewhere herein may be used. In some cases, sequencing by synthesis (SBS) is performed.

In one example (Example A), an SBS method comprises flowing nucleotide reagents according to a flow order comprising a repeat of one 4-base flow (e.g., [A/T/G/C]), where each nucleotide is reversibly terminated (e.g., dideoxynucleotide), and where each base is labeled with a different dye (yielding different optical signals). With each flow, other sequencing reagents, e.g., sequencing primer, polymerase, buffer, etc. are present to provide sufficient conditions for incorporation of the reversibly terminated, labeled nucleotide into a growing strand hybridized to a template nucleic acid. After each flow, an incorporation event or lack thereof of each base can be detected by interrogating the different dyes in 4 channels. After the incorporation events of a flow, in which at most one nucleotide is incorporated into each growing strand due to the terminated state, the termination can be reversed (e.g., cleaving a terminating moiety) to allow for subsequent stepwise incorporation events in subsequent flows. After each or one or more detection events, the labels may be removed (e.g., cleaved) to reduce signal noise for the next detection. In another example (Example B), an SBS method comprises flowing nucleotide reagents according to a flow order comprising a repeat of a flow cycle of 4 single base flows (e.g., [A T G C]), where each nucleotide is reversibly terminated, and where each base is labeled with a same dye (yielding same frequency optical signals). With each flow, other sequencing reagents, e.g., sequencing primer, polymerase, buffer, etc. are present to provide sufficient conditions for incorporation of the reversibly terminated, labeled nucleotide into a growing strand hybridized to a template nucleic acid. After each flow, an incorporation event or lack thereof of the particular base in that flow can be detected by interrogating the wavelength of the dye. After the incorporation events of a flow, in which at most one nucleotide is incorporated into each growing strand due to the terminated state, the termination can be reversed (e.g., cleaving a terminating moiety) to allow for subsequent stepwise incorporation events in subsequent flows. After each or one or more detection events, the labels may be removed (e.g., cleaved) to reduce signal noise for the next detection. In another example (Example C), an SBS method comprises flowing nucleotide reagents according to a flow order comprising a repeat of a flow cycle of 4 single base flows (e.g., [A T G C]), where each nucleotide is not terminated, and where each base is labeled with a same dye (yielding same frequency optical signals). With each flow, other sequencing reagents, e.g., sequencing primer, polymerase, buffer, etc. are present to provide sufficient conditions for incorporation of the labeled nucleotide into a growing strand hybridized to a template nucleic acid. After each flow, an incorporation event or lack thereof of the particular base in that flow can be detected by interrogating the wavelength of the dye. Because the nucleotides are not terminated, if the growing strand is extending through a homopolymer region (e.g., polyT region, etc.) of the template nucleic acid, multiple nucleotides may be incorporated during one flow. After each or one or more detection events, the labels may be removed (e.g., dyes are cleaved) to reduce signal noise for the next detection. In another example (Example D), an SBS method comprises flowing nucleotide reagents according to a flow order comprising a repeat of a flow cycle of 4 single base flows (e.g., [A T G C]), where each nucleotide is not terminated, and where only a fraction of the bases in each flow (e.g., less than 90%, 80%, 70%, 60%, 50%, 40%, 30%, 20%, 10%, 9%, 8%, 7%, 6%, 5%, 4%, 3%, 2%, 1%, etc.) is labeled with a same dye (yielding same frequency optical signals). With each flow, other sequencing reagents, e.g., sequencing primer, polymerase, buffer, etc. are present to provide sufficient conditions for incorporation of the nucleotide into a growing strand hybridized to a template nucleic acid. After each flow, an incorporation event or lack thereof of the particular base in that flow can be detected by interrogating the wavelength of the dye. Because the nucleotides are not terminated, if the growing strand is extending through a homopolymer region (e.g., polyT region, etc.) of the template nucleic acid, multiple nucleotides may be incorporated during one flow. After each or one or more detection events, the labels may be removed (e.g., dyes are cleaved) to reduce signal noise for the next detection. In another example (Example E), an SBS method comprises flowing nucleotide reagents according to a flow order comprising a repeat of a flow cycle of 8 single base flows, with each of the 4 canonical base types flowed twice consecutively within the flow cycle, (e.g., [A A T T G G C C]), where each nucleotide is not terminated, and where only a fraction of the bases in every other flow in the flow cycle (e.g., less than 90%, 80%, 70%, 60%, 50%, 40%, 30%, 20%, 10%, 9%, 8%, 7%, 6%, 5%, 4%, 3%, 2%, 1%, etc.) is labeled with a same dye (yielding same frequency optical signals) and the nucleotides in the alternating other flow is unlabeled. With each flow, other sequencing reagents, e.g., sequencing primer, polymerase, buffer, etc. are present to provide sufficient conditions for incorporation of the nucleotide into a growing strand hybridized to a template nucleic acid. After one or both of the flows for each canonical base type, an incorporation event or lack thereof of the particular base in that flow can be detected by interrogating the wavelength of the dye. Because the nucleotides are not terminated, if the growing strand is extending through a homopolymer region (e.g., polyT region) of the template nucleic acid, multiple nucleotides may be incorporated during one flow. A first flow of a canonical base type (e.g., A) followed by a second flow of the same canonical base type (e.g., A) may help facilitate completion of incorporation reactions across each growing strand such as to reduce phasing problems. After each or one or more detection events, the labels may be removed (e.g., dyes are cleaved) to reduce signal noise for the next detection.

Labeled nucleotides may comprise a dye, fluorophore, or quantum dot. Non-limiting examples of dyes include SYBR green, SYBR blue, DAPI, propidium iodine, Hoechst, SYBR gold, ethidium bromide, acridine, proflavine, acridine orange, acriflavine, fluorocoumarin, ellipticine, daunomycin, chloroquine, distamycin D, chromomycin, homidium, mithramycin, ruthenium polypyridyls, anthramycin, phenanthridines and acridines, ethidium bromide, propidium iodide, hexidium iodide, dihydroethidium, ethidium homodimer-1 and -2, ethidium monoazide, and ACMA, Hoechst 33258, Hoechst 33342, Hoechst 34580, DAPI, acridine orange, 7-AAD, actinomycin D, LDS751, hydroxystilbamidine, SYTOX Blue, SYTOX Green, SYTOX Orange, POPO-1, POPO-3, YOYO-1, YOYO-3, TOTO-1, TOTO-3, JOJO-1, LOLO-1, BOBO-1, BOBO-3, PO-PRO-1, PO-PRO-3, BO-PRO-1, BO-PRO-3, TO-PRO-1, TO-PRO-3, TO-PRO-5, JO-PRO-1, LO-PRO-1, YO-PRO-1, YO-PRO-3, PicoGreen, OliGreen, RiboGreen, SYBR Gold, SYBR Green I, SYBR Green II, SYBR DX, SYTO-40, -41, -42, -43, -44, -45 (blue), SYTO-13, -16, -24, -21, -23, -12, -11, -20, -22, -15, -14, -25 (green), SYTO-81, -80, -82, -83, -84, -85 (orange), SYTO-64, -17, -59, -61, -62, -60, -63 (red), fluorescein, fluorescein isothiocyanate (FITC), tetramethyl rhodamine isothiocyanate (TRITC), rhodamine, tetramethyl rhodamine, R-phycoerythrin, Cy-2, Cy-3, Cy-3.5, Cy-5, Cy5.5, Cy-7, Texas Red, Phar-Red, allophycocyanin (APC), Sybr Green I, Sybr Green II, Sybr Gold, CellTracker Green, 7-AAD, ethidium homodimer I, ethidium homodimer II, ethidium homodimer III, ethidium bromide, umbelliferone, eosin, green fluorescent protein, erythrosin, coumarin, methyl coumarin, pyrene, malachite green, stilbene, lucifer yellow, cascade blue, dichlorotriazinylamine fluorescein, dansyl chloride, fluorescent lanthanide complexes such as those including europium and terbium, carboxy tetrachloro fluorescein, 5 and/or 6-carboxy fluorescein (FAM), VIC, 5- (or 6-) iodoacetamidofluorescein, 5-{[2(and 3)-5-(Acetylmercapto)-succinyl]amino}fluorescein (SAMSA-fluorescein), lissamine rhodamine B sulfonyl chloride, 5 and/or 6 carboxy rhodamine (ROX), 7-amino-methyl-coumarin, 7-Amino-4-methylcoumarin-3-acetic acid (AMCA), BODIPY fluorophores, 8-methoxypyrene-1,3,6-trisulfonic acid trisodium salt, 3,6-Disulfonate-4-amino-naphthalimide, phycobiliproteins, Atto 390, 425, 465, 488, 495, 532, 565, 594, 633, 647, 647N, 665, 680 and 700 dyes, AlexaFluor 350, 405, 430, 488, 532, 546, 555, 568, 594, 610, 633, 635, 647, 660, 680, 700, 750, and 790 dyes, DyLight 350, 405, 488, 550, 594, 633, 650, 680, 755, and 800 dyes, or other fluorophores, Black Hole Quencher Dyes (Biosearch Technologies) such as BH1-0, BHQ-1, BHQ-3, BHQ-10); QSY Dye fluorescent quenchers (from Molecular Probes/Invitrogen) such QSY7, QSY9, QSY21, QSY35, and other quenchers such as Dabcyl and Dabsyl; Cy5Q and Cy7Q and Dark Cyanine dyes (GE Healthcare); Dy-Quenchers (Dyomics), such as DYQ-660 and DYQ-661; and ATTO fluorescent quenchers (ATTO-TEC GmbH), such as ATTO 540Q, 580Q, 612Q. In some cases, the label may be one with linkers. For instance, a label may have a disulfide linker attached to the label. Non-limiting examples of such labels include Cy5-azide, Cy-2-azide, Cy-3-azide, Cy-3.5-azide, Cy5.5-azide and Cy-7-azide. In some cases, a linker may be a cleavable linker. In some cases, the label may be a type that does not self-quench or exhibit proximity quenching. Non-limiting examples of a label type that does not self-quench or exhibit proximity quenching include Bimane derivatives such as Monobromobimane. Alternatively, the label may be a type that self-quenches or exhibits proximity quenching. Non-limiting examples of such labels include Cy5-azide, Cy-2-azide, Cy-3-azide, Cy-3.5-azide, Cy5.5-azide and Cy-7-azide. In some instances, a blocking group of a reversible terminator may comprise the dye.

It will be appreciated that the combinations of termination states on the nucleotides, label types (e.g., types of dye or other detectable moiety), fraction of labeled nucleotides within a flow, type of nucleotide bases in each flow, type of nucleotide bases in each flow cycle, and/or the order of flows in a flow cycle and/or flow order, other than enumerated in Examples A-E, can be varied for different SBS methods.

Subsequent to sequencing, the sequencing signals collected and/or generated may be subjected to data analysis (108). The sequencing signals may be processed to generate base calls and/or sequencing reads. In some cases, the sequencing reads may be processed to generate diagnostics data to the biological sample, or the subject from which the biological sample was derived from.

While the sequencing workflow 100 with respect to FIG. 1 has been described with respect to the use of supports to bind template molecules, it will be appreciated that the different supports may be effectively replaced by using spatially distinct locations on one or more surfaces, which do not necessarily have to be the surfaces of individual supports (e.g., beads). For example, a first spatially distinct location on a surface may be capable of directly immobilizing a first colony of a first template nucleic acid and a second spatially distinct location on the same surface (or a different surface) may be capable of directly immobilizing a second colony of a second template nucleic acid to distinguish from the first colony. In some cases, the surface comprising the spatially distinct locations may be a surface of the substrate on which the sample is sequenced, thus streamlining the amplification-sequencing workflow.

It will be appreciated that in some instances, the different operations described in the sequencing workflow 100 may be performed in a different order. It will be appreciated that in some instances, one or more operations described in the sequencing workflow 100 may be omitted or replaced with other comparable operation(s). It will be appreciated that in some instances, one or more additional operations described in the sequencing workflow 100 may be performed.

The different operations described with respect to sequencing workflow 100 may be performed with the help of open substrate systems described herein.

### Open Substrate Systems

Described herein are devices, systems, and methods that use open substrates or open flow cell geometries to process a sample. The term “open substrate,” as used herein, generally refers to a substrate in which any point on an active surface of the substrate is physically accessible from a direction normal to the substrate. The devices, systems and methods may be used to facilitate any application or process involving a reaction or interaction between two objects, such as between an analyte and a reagent or between two reagents. For example, the reaction or interaction may be chemical (e.g., polymerase reaction) or physical (e.g., displacement). The devices, systems, and methods described herein may benefit from higher efficiency, such as from faster reagent delivery and lower volumes of reagents required per surface area. The devices, systems, and methods described herein may avoid contamination problems common to microfluidic channel flow cells that are fed from multiport valves which can be a source of carryover from one reagent to the next. The devices, systems, and methods may benefit from shorter completion time, use of fewer resources (e.g., various reagents), and/or reduced system costs. The open substrates or flow cell geometries may be used to process any analyte from any sample, such as but not limited to, nucleic acid molecules, protein molecules, antibodies, antigens, cells, and/or organisms, as described herein. The open substrates or flow cell geometries may be used for any application or process, such as, but not limited to, sequencing by synthesis, sequencing by ligation, amplification, proteomics, single cell processing, barcoding, and sample preparation, as described herein.

A sample processing system may comprise a substrate, and devices and systems that perform one or more operations with or on the substrate. The sample processing system may permit highly efficient dispensing of reagents onto the substrate. The sample processing may permit highly efficient imaging of one or more analytes, or signals corresponding thereto, on the substrate. The sample processing system may comprise an imaging system comprising a detector. Substrates and detectors that can be used in the sample processing system are described in further detail in WO2019/099886, WO2020/167656, and WO2020/186243, each of which is entirely incorporated herein by reference for all purposes.

### Substrates

The substrate may be a solid substrate. The substrate may entirely or partially comprise one or more of rubber, glass, silicon, a metal such as aluminum, copper, titanium, chromium, or steel, a ceramic such as titanium oxide or silicon nitride, a plastic such as polyethylene (PE), low-density polyethylene (LDPE), high-density polyethylene (HDPE), polypropylene (PP), polystyrene (PS), high impact polystyrene (HIPS), polyvinyl chloride (PVC), polyvinylidene chloride (PVDC), acrylonitrile butadiene styrene (ABS), polyacetylene, polyamides, polycarbonates, polyesters, polyurethanes, polyepoxide, polymethyl methacrylate (PMMA), polytetrafluoroethylene (PTFE), phenol formaldehyde (PF), melamine formaldehyde (MF), urea-formaldehyde (UF), polyetheretherketone (PEEK), polyetherimide (PEI), polyimides, polylactic acid (PLA), furans, silicones, polysulfones, any mixture of any of the preceding materials, or any other appropriate material. The substrate may be entirely or partially coated with one or more layers of a metal such as aluminum, copper, silver, or gold, an oxide such as a silicon oxide (SiₓO_{y}, where x, y may take on any possible values), a photoresist such as SU8, a surface coating such as an aminosilane or hydrogel, polyacrylic acid, polyacrylamide dextran, polyethylene glycol (PEG), or any combination of any of the preceding materials, or any other appropriate coating. The substrate may comprise multiple layers of the same or different type of material. The substrate may be fully or partially opaque to visible light. The substrate may be fully or partially transparent to visible light. A surface of the substrate may be modified to comprise active chemical groups, such as amines, esters, hydroxyls, epoxides, and the like, or a combination thereof. A surface of the substrate may be modified to comprise any of the binders or linkers described herein. In some instances, such binders, linkers, active chemical groups, and the like may be added as an additional layer or coating to the substrate.

The substrate may have the general form of a cylinder, a cylindrical shell or disk, a rectangular prism, or any other geometric form. The substrate may have a thickness (e.g., a minimum dimension) of at least 100 micrometers (μm), at least 200 μm, at least 500 μm, at least 1 mm, at least 2 millimeters (mm), at least 5 mm, at least 10 mm, or more. The substrate may have a first lateral dimension (such as a width for a substrate having the general form of a rectangular prism or a radius or diameter for a substrate having the general form of a cylinder) and/or a second lateral dimension (such as a length for a substrate having the general form of a rectangular prism) of at least 1 mm, at least 2 mm, at least 5 mm, at least 10 mm, at least 20 mm, at least 50 mm, at least 100 mm, at least 200 mm, at least 500 mm, at least 1,000 mm, or more.

One or more surfaces of the substrate may be exposed to a surrounding open environment, and accessible from such surrounding open environment. For example, the array may be exposed and accessible from such surrounding open environment. In some cases, as described elsewhere herein, the surrounding open environment may be controlled and/or confined in a larger controlled environment.

The substrate may comprise a plurality of individually addressable locations. The individually addressable locations may comprise locations that are physically accessible for manipulation. The manipulation may comprise, for example, placement, extraction, reagent dispensing, seeding, heating, cooling, or agitation. In some cases, the substrate may be placed onto a heating stage, where the heating stage may spatially control the surface temperatures of the substrate. In some cases, the spatial control of the substrate temperature may improve the reaction rates of sequencing chemical reactions as sample reagents are dispensed onto the substrate surface. In some cases, the substrate may comprise a thickness designed to prevent splashing of reagents dispensed onto the substrate which splashing may re-adhere the dispensed reagents to the processing station dispensing surface and cause future contamination. The manipulation may be accomplished through, for example, localized microfluidic, pipet, optical, laser, acoustic, magnetic, and/or electromagnetic interactions with the analyte or its surroundings. The individually addressable locations may comprise locations that are digitally accessible. For example, each individually addressable location may be located, identified, and/or accessed electronically or digitally for indexing, mapping, sensing, associating with a device (e.g., detector, processor, dispenser, etc.), or otherwise processing.

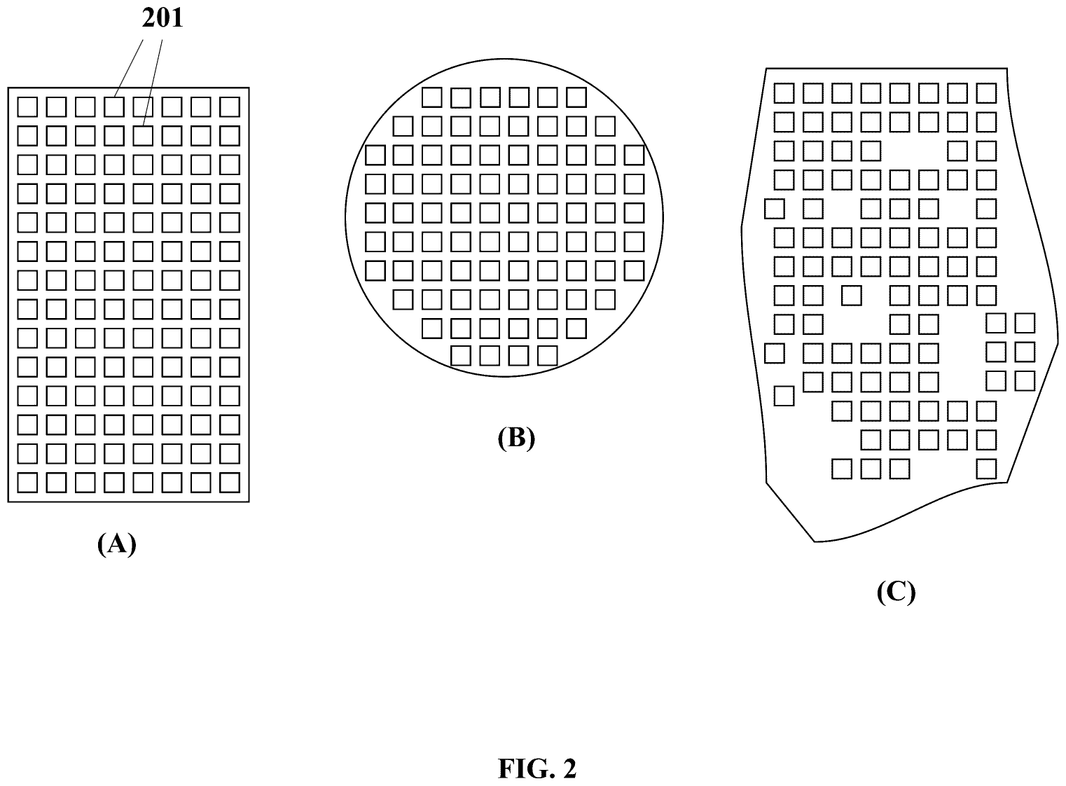

The plurality of individually addressable locations may be arranged as an array, randomly, or according to any pattern, on the substrate. FIG. 2 illustrates different substrates (from a top view) comprising different arrangements of individually addressable locations 201, with panel A showing a substantially rectangular substrate with regular linear arrays, panel B showing a substantially circular substrate with regular linear arrays, and panel C showing an arbitrarily shaped substrate with irregular arrays. The substrate may have any number of individually addressable locations, for example, at least 1, at least 2, at least 5, at least 10, at least 20, at least 50, at least 100, at least 200, at least 500, at least 1,000, at least 2,000, at least 5,000, at least 10,000, at least 20,000, at least 50,000, at least 100,000, at least 200,000, at least 500,000, at least 1,000,000, at least 2,000,000, at least 5,000,000, at least 10,000,000, at least 20,000,000, at least 50,000,000, at least 100,000,000, at least 200,000,000, at least 500,000,000, at least 1,000,000,000, at least 2,000,000,000, at least 5,000,000,000, at least 10,000,000,000, at least 20,000,000,000, at least 50,000,000,000, at least 100,000,000,000 or more individually addressable locations. The substrate may have a number of individually addressable locations that is within a range defined by any two of the preceding values.

Each individually addressable location may have the general shape or form of a circle, pit, bump, rectangle, or any other shape or form (e.g., polygonal, non-polygonal). A plurality of individually addressable locations can have uniform shape or form, or different shapes or forms. An individually addressable location may have any size. In some cases, an individually addressable location may have an area of about 0.1 square micron (μm²), about 0.2 μm², about 0.25 μm², about 0.3 μm², about 0.4 μm², about 0.5 μm², about 0.6 μm², about 0.7 μm², about 0.8 μm², about 0.9 m², about 1 μm², about 1.1 μm², about 1.2 μm², about 1.25 μm², about 1.3 μm², about 1.4 μm², about 1.5 μm², about 1.6 μm², about 1.7 μm², about 1.75 μm², about 1.8 μm², about 1.9 μm², about 2 μm², about 2.25 μm², about 2.5 μm², about 2.75 μm², about 3 μm², about 3.25 μm², about 3.5 μm², about 3.75 μm², about 4 μm², about 4.25 μm², about 4.5 μm², about 4.75 μm², about 5 μm², about 5.5 μm², about 6 μm², or more. An individually addressable location may have an area that is within a range defined by any two of the preceding values. An individually addressable location may have an area that is less than about 0.1 μm² or greater than about 6 μm².

The individually addressable locations may be distributed on a substrate with a pitch determined by the distance between the center of a first location and the center of the closest or neighboring individually addressable location. Locations may be spaced with a pitch of about 0.1 micron (μm), about 0.2 μm, about 0.25 μm, about 0.3 μm, about 0.4 μm, about 0.5 μm, about 0.6 μm, about 0.7 μm, about 0.8 μm, about 0.9 μm, about 1 μm, about 1.1 μm, about 1.2 μm, about 1.25 μm, about 1.3 μm, about 1.4 μm, about 1.5 μm, about 1.6 μm, about 1.7 μm, about 1.75 μm, about 1.8 μm, about 1.9 μm, about 2 μm, about 2.25 μm, about 2.5 μm, about 2.75 μm, about 3 μm, about 3.25 μm, about 3.5 μm, about 3.75 μm, about 4 μm, about 4.25 μm, about 4.5 μm, about 4.75 μm, about 5 μm, about 5.5 μm, about 6 μm, about 6.5 μm, about 7 μm, about 7.5 μm, about 8 μm, about 8.5 μm, about 9 μm, about 9.5 μm, or about 10 μm. In some cases, the locations may be positioned with a pitch that is within a range defined by any two of the preceding values. The locations may be positioned with a pitch of less than about 0.1 μm or greater than about 10 μm. In some cases, the pitch between two individually addressable locations may be determined as a function of a size of a loading object (e.g., bead). For example, where the loading object is a bead having a maximum diameter, the pitch may be at least about the maximum diameter of the loading object.

Each of the plurality of individually addressable locations, or each of a subset of such locations, may be capable of immobilizing thereto an analyte (e.g., a nucleic acid molecule, a protein molecule, a carbohydrate molecule, etc.) or a reagent (e.g., a nucleic acid molecule, a probe molecule, a barcode molecule, an antibody molecule, a primer molecule, a bead, etc.). In some cases, an analyte or reagent may be immobilized to an individually addressable location via a support, such as a bead. In an example, a bead is immobilized to the individually addressable location, and the analyte or reagent is immobilized to the bead. In some cases, an individually addressable location may immobilize thereto a plurality of analytes or a plurality of reagents, such as via the support. The substrate may immobilize a plurality of analytes or reagents across multiple individually addressable locations. The plurality of analytes or reagents may be of the same type of analyte or reagent (e.g., a nucleic acid molecule) or may be a combination of different types of analytes or reagents (e.g., nucleic acid molecules, protein molecules, etc.). In an example, a first bead comprising a first colony of nucleic acid molecules each comprising a first template sequence is immobilized to a first individually addressable location, and a second bead comprising a second colony of nucleic acid molecules each comprising a second template sequence is immobilized to a second individually addressable location.

A substrate may comprise more than one type of individually addressable location arranged as an array, randomly, or according to any pattern, on the substrate. In some cases, different types of individually addressable locations may have different chemical, physical, and/or biological properties (e.g., hydrophobicity, charge, color, topography, size, dimensions, geometry, etc.). For example, a first type of individually addressable location may bind a first type of biological analyte but not a second type of biological analyte, and a second type of individually addressable location may bind the second type of biological analyte but not the first type of biological analyte.

In some cases, an individually addressable location may comprise a distinct surface chemistry. The distinct surface chemistry may distinguish between different addressable locations. The distinct surface chemistry may distinguish an individually addressable location from a surrounding location on the substrate. For example, a first location type may comprise a first surface chemistry, and a second location type may lack the first surface chemistry. In another example, the first location type may comprise the first surface chemistry and the second location type may comprise a second, different surface chemistry. A first location type may have a first affinity towards an object (e.g., a bead comprising nucleic acid molecules, e.g., amplicons, immobilized thereto) and a second location type may have a second, different affinity towards the same object due to different surface chemistries. In other examples, a first location type comprising a first surface chemistry may have an affinity towards a first sample type (e.g., a bead comprising nucleic acid molecules, e.g., amplicons, immobilized thereto) and exclude a second sample type (e.g., a bead lacking nucleic acid molecules, e.g., amplicons, immobilized thereto). The first location type and the second location type may or may not be disposed on the surface in alternating fashion. For example, a first location type or region type may comprise a positively charged surface chemistry and a second location type or region type may comprise a negatively charged surface chemistry. In another example, a first location type or region type may comprise a hydrophobic surface chemistry and a second location type or region type may comprise a hydrophilic surface chemistry. In another example, a first location type comprises a binder, as described elsewhere herein, and a second location type does not comprise the binder or comprises a different binder. In some cases, a surface chemistry may comprise an amine. In some cases, a surface chemistry may comprise a silane (e.g., tetramethylsilane). In some cases, the surface chemistry may comprise hexamethyldisilazane (HMDS). In some cases, the surface chemistry may comprise (3-aminopropyl)triethoxysilane (APTMS). In some cases, the surface chemistry may comprise a surface primer molecule or any oligonucleotide molecule that has any degree of affinity towards another molecule. In one example, the substrate comprises a plurality of individually addressable locations, each defined by APTMS, which are positively charged and has affinity towards an amplified bead (e.g., a bead comprising nucleic acid molecules, e.g., amplicons, immobilized thereto) which exhibits a negative charge. The locations surrounding the plurality of individually addressable locations may comprise HMDS which repels amplified beads.

In some cases, the individually addressable locations may be indexed, e.g., spatially. Data corresponding to an indexed location, collected over multiple periods of time, may be linked to the same indexed location. In some cases, sequencing signal data collected from an indexed location, during iterations of sequencing-by-synthesis flows, are linked to the indexed location to generate a sequencing read for an analyte immobilized at the indexed location. In some embodiments, the individually addressable locations are indexed by demarcating part of the surface, such as by etching or notching the surface, using a dye or ink, depositing a topographical mark, depositing a sample (e.g., a control nucleic acid sample), depositing a reference object (e.g., e.g., a reference bead that always emits a detectable signal during detection), and the like, and the individually addressable locations may be indexed with reference to such demarcations. As will be appreciated, a combination of positive demarcations and negative demarcations (lack thereof) may be used to index the individually addressable locations. In some embodiments, each of the individually addressable locations is indexed. In some embodiments, a subset of the individually addressable locations is indexed. In some embodiments, the individually addressable locations are not indexed, and a different region of the substrate is indexed.

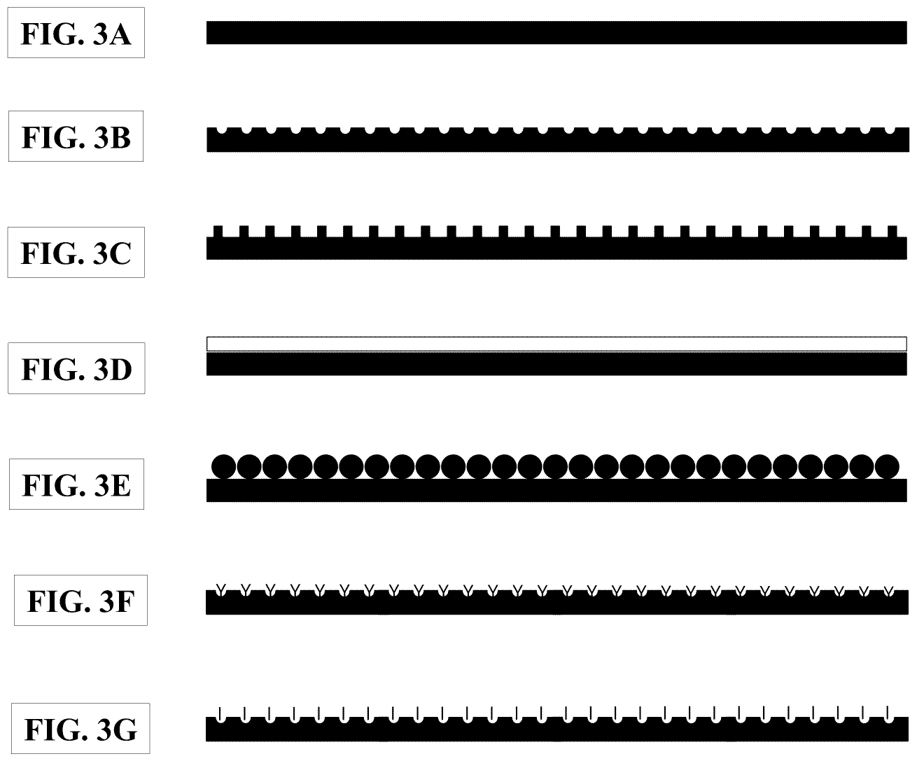

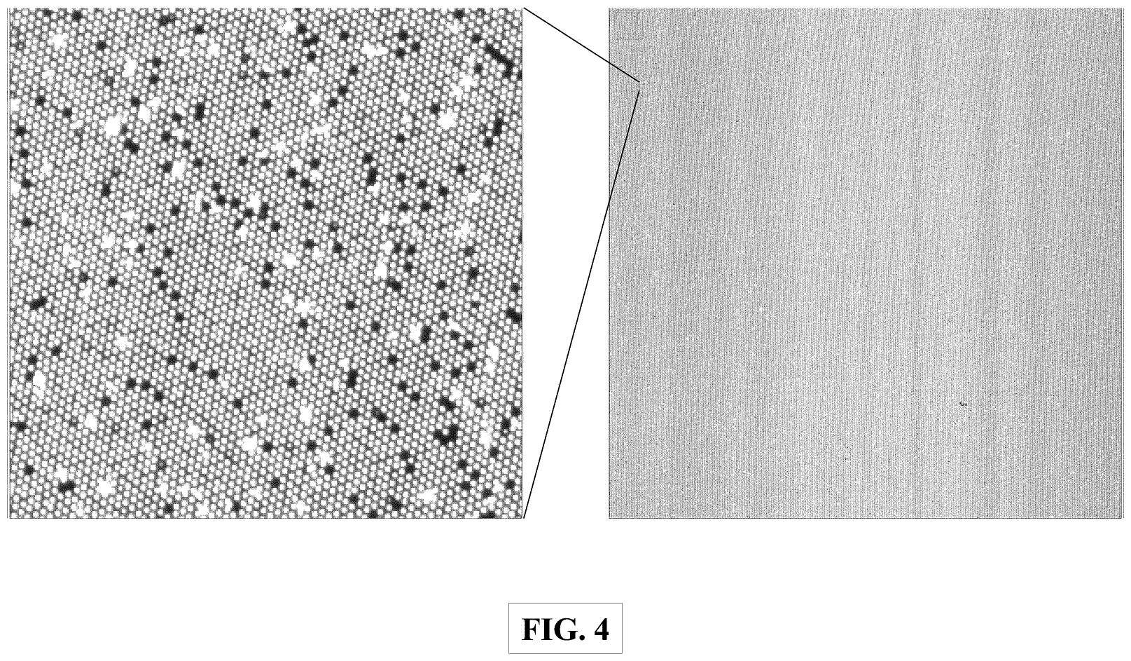

The substrate may comprise a planar or substantially planar surface. Substantially planar may refer to planarity at a micrometer level (e.g., a range of unevenness on the planar surface does not exceed the micrometer scale) or nanometer level (e.g., a range of unevenness on the planar surface does not exceed the nanometer scale). Alternatively, substantially planar may refer to planarity at less than a nanometer level or greater than a micrometer level (e.g., millimeter level). Alternatively or in addition, a surface of the substrate may be textured or patterned. For example, the substrate may comprise grooves, troughs, hills, and/or pillars. The substrate may define one or more cavities (e.g., micro-scale cavities or nano-scale cavities). The substrate may define one or more channels. The substrate may have regular textures and/or patterns across the surface of the substrate. For example, the substrate may have regular geometric structures (e.g., wedges, cuboids, cylinders, spheroids, hemispheres, etc.) above or below a reference level of the surface. Alternatively, the substrate may have irregular textures and/or patterns across the surface of the substrate. In some instances, a texture of the substrate may comprise structures having a maximum dimension of at most about 100%, 90%, 80%, 70%, 60%, 50%, 40%, 30%, 20%, 10%, 9%, 8%, 7%, 6%, 5%, 4%, 3%, 2%, 1%, 0.1%, 0.01%, 0.001%, 0.0001%, 0.00001% of the total thickness of the substrate or a layer of the substrate. In some instances, the textures and/or patterns of the substrate may define at least part of an individually addressable location on the substrate. A textured and/or patterned substrate may be substantially planar. FIGS. 3A-3G illustrate different examples of cross-sectional surface profiles of a substrate. FIG. 3A illustrates a cross-sectional surface profile of a substrate having a completely planar surface. FIG. 3B illustrates a cross-sectional surface profile of a substrate having semi-spherical troughs or grooves. FIG. 3C illustrates a cross-sectional surface profile of a substrate having pillars, or alternatively or in conjunction, wells. FIG. 3D illustrates a cross-sectional surface profile of a substrate having a coating. FIG. 3E illustrates a cross-sectional surface profile of a substrate having spherical particles. FIG. 3F illustrates a cross-sectional surface profile of FIG. 3B, with a first type of binders seeded or associated with the respective grooves. FIG. 3G illustrates a cross-sectional surface profile of FIG. 3B, with a second type of binders seeded or associated with the respective grooves.

A binder may be configured to immobilize an analyte or reagent to an individually addressable location. In some cases, a surface chemistry of an individually addressable location may comprise one or more binders. In some cases, a plurality of individually addressable locations may be coated with binders. In some cases, at least 10%, at least 20%, at least 30%, at least 40%, at least 50%, at least 60%, at least 70%, at least 80%, at least 90%, at least 91%, at least 92%, at least 93%, at least 94%, at least 95%, at least 96%, at least 97%, at least 98%, or at least 99% of the total number of individually addressable locations, or of the surface area of the substrate, are coated with binders. The binders may be integral to the array. The binders may be added to the array. For instance, the binders may be added to the array as one or more coating layers on the array. The substrate may comprise an order of magnitude of at least about 10, 100, 10³, 10⁴, 10⁵, 10⁶, 10⁷, 10⁸, 10⁹, 10¹⁰, 10¹¹, or more binders. Alternatively or in addition, the substrate may comprise an order of magnitude of at most about 10¹¹, 10¹⁰, 10⁹, 10⁸, 10⁷, 10⁶, 10⁵, 10⁴, 10³, 100, 10 or fewer binders.

The binders may immobilize analytes or reagents through non-specific interactions, such as one or more of hydrophilic interactions, hydrophobic interactions, electrostatic interactions, physical interactions (for instance, adhesion to pillars or settling within wells), and the like. Alternatively or in addition, the binders may immobilize analytes or reagents through specific interactions. For instance, where the analyte or reagent is a nucleic acid molecule, the binders may comprise oligonucleotide adaptors configured to bind to the nucleic acid molecule. In other examples, the binders may comprise one or more of antibodies, oligonucleotides, nucleic acid molecules, aptamers, affinity binding proteins, lipids, carbohydrates, and the like. The binders may immobilize analytes or reagents through any possible combination of interactions. For instance, the binders may immobilize nucleic acid molecules through a combination of physical and chemical interactions, through a combination of protein and nucleic acid interactions, etc. In some instances, a single binder may bind a single analyte (e.g., nucleic acid molecule) or single reagent. In some instances, a single binder may bind a plurality of analytes (e.g., plurality of nucleic acid molecules) or a plurality of reagents. In some instances, a plurality of binders may bind a single analyte or a single reagent. Though examples herein describe interactions of binders with nucleic acid molecules, the binders may immobilize other molecules (such as proteins), other particles, cells, viruses, other organisms, or the like. Though examples herein describe interactions of binders with samples or analytes, the binders may similarly immobilize reagents. In some instances, the substrate may comprise a plurality of types of binders, for example to bind different types of analytes or reagents. For example, a first type of binders (e.g., oligonucleotides) are configured to bind a first type of analyte (e.g., nucleic acid molecules) or reagent, and a second type of binders (e.g., antibodies) are configured to bind a second type of analyte (e.g., proteins) or reagent. In another example, a first type of binders (e.g., first type of oligonucleotide molecules) are configured to bind a first type of nucleic acid molecules and a second type of binders (e.g., second type of oligonucleotide molecules) are configured to bind a second type of nucleic acid molecules. For example, the substrate may be configured to bind different types of analytes or reagents in certain fractions or specific locations on the substrate by having the different types of binders in the certain fractions or specific locations on the substrate.

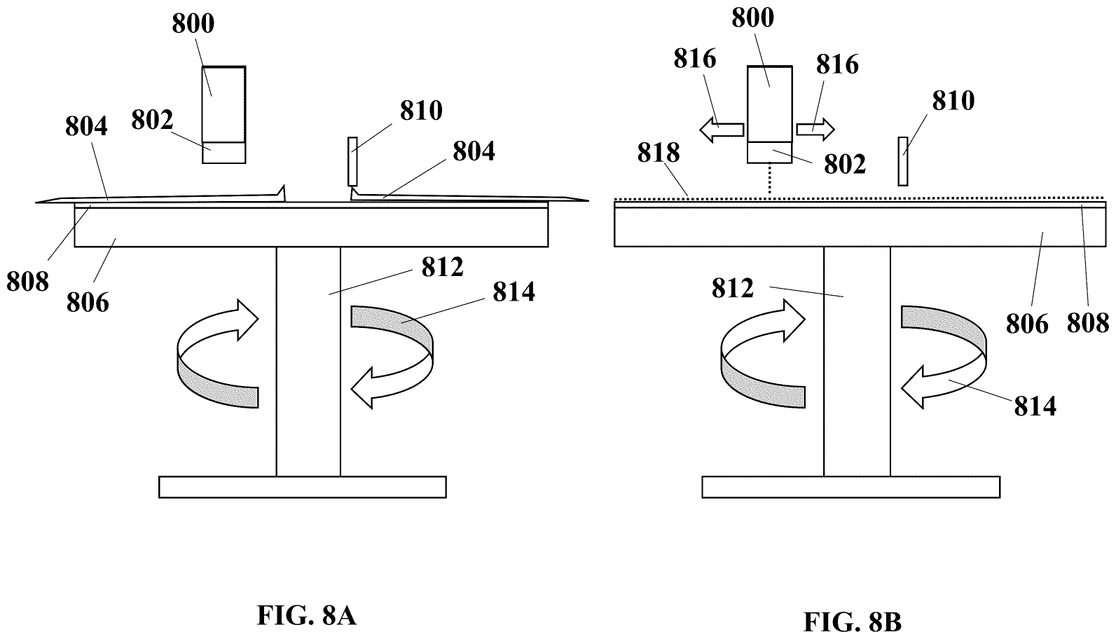

The substrate may be rotatable about an axis. The axis of rotation may or may not be an axis through the center of the substrate. In some instances, the systems, devices, and apparatus described herein may further comprise an automated or manual rotational unit configured to rotate the substrate. The rotational unit may comprise a motor and/or a rotor 812 to rotate the substrate 808, as seen in FIGS. 8A-8B. For instance, the substrate may be affixed to a chuck 806 (such as a vacuum chuck). The substrate may be rotated 814 at a rotational speed of at least 1 revolution per minute (rpm), at least 2 rpm, at least 5 rpm, at least 10 rpm, at least 20 rpm, at least 50 rpm, at least 100 rpm, at least 200 rpm, at least 500 rpm, at least 1,000 rpm, at least 2,000 rpm, at least 5,000 rpm, at least 10,000 rpm, or greater. Alternatively or in addition, the substrate may be rotated at a rotational speed of at most about 10,000 rpm, 5,000 rpm, 2,000 rpm, 1,000 rpm, 500 rpm, 200 rpm, 100 rpm, 50 rpm, 20 rpm, 10 rpm, 5 rpm, 2 rpm, 1 rpm, or less. The substrate may be configured to rotate with a rotational velocity that is within a range defined by any two of the preceding values. The substrate may be configured to rotate with different rotational velocities during different operations described herein. The substrate may be configured to rotate with a rotational velocity that varies according to a time-dependent function, such as a ramp, sinusoid, pulse, or other function or combination of functions. The time-varying function may be periodic or aperiodic.

Analytes or reagents may be immobilized to the substrate during rotation. Analytes or reagents may be dispensed onto the substrate prior to or during rotation of the substrate. When the substrate is rotated at a relatively high rotational velocity, high speed coating across the substrate may be achieved via tangential inertia directing unconstrained spinning reagents in a partially radial direction (that is, away from the axis of rotation) during rotation, a phenomenon commonly referred to as centrifugal force. In some cases, the substrate may be rotated at relatively low velocities such that reagents dispensed to a certain location do not move to another location, or moves minimally, because of the rotation, to permit controlled dispensing of reagents to desired locations. For controlled dispensing, the substrate may be rotating with a rotational frequency of no more than 60 rpm, no more than 50 rpm, no more than 40 rpm, no more than 30 rpm, no more than 25 rpm, no more than 20 rpm, no more than 15 rpm, no more than 14 rpm, no more than 13 rpm, no more than 12 rpm, no more than 11 rpm, no more than 10 rpm, no more than 9 rpm, no more than 8 rpm, no more than 7 rpm, no more than 6 rpm, no more than 5 rpm, no more than 4 rpm, no more than 3 rpm, no more than 2 rpm, or no more than 1 rpm. In some cases the rotational frequency may be within a range defined by any two of the preceding values. In some cases the substrate may be rotating with a rotational frequency of about 5 rpm during controlled dispensing. A speed of substrate rotation may be adjusted according to the appropriate operation (e.g., high speed for spin-coating, high speed for washing the substrate, low speed for sample loading, low speed for detection, etc.).

In some cases, the substrate may be movable in any vector or direction. For example, such motion may be non-linear (e.g., in rotation about an axis), linear, or a hybrid of linear and non-linear motion. In some instances, the systems, devices, and apparatus described herein may further comprise a motion unit configured to move the substrate. The motion unit may comprise any mechanical component, such as a motor, rotor, actuator, linear stage, drum, roller, pulleys, etc., to move the substrate. Analytes or reagents may be immobilized to the substrate during any such motion. Analytes or reagents may be dispensed onto the substrate prior to, during, or subsequent to motion of the substrate.

Loading Reagents and Samples onto an Open Substrate

The surface of the substrate 808 may be in fluid communication with at least one fluid nozzle (of a fluid dispenser 810), as seen in FIGS. 8A-8B. The surface may be in fluid communication with the fluid nozzle via a non-solid gap, e.g., an air gap. In some cases, the surface may additionally be in fluid communication with at least one fluid outlet. The surface may be in fluid communication with the fluid outlet via an air gap. The nozzle may be configured to direct a solution to the array. The outlet may be configured to receive a solution from the substrate surface. The solution may be directed to the surface using one or more dispensing nozzles. For example, the solution may be directed to the array using at least 1, 2, 3, 4, 5, 6, 7, 8, 9, 10, 11, 12, 13, 14, 15, 16, 17, 18, 19, 20 or more dispensing nozzles. The solution may be directed to the array using a number of nozzles that is within a range defined by any two of the preceding values. In some cases, different reagents (e.g., nucleotide solutions of different types, different probes, washing solutions, etc.) may be dispensed via different nozzles, such as to prevent contamination. Each nozzle may be connected to a dedicated fluidic line or fluidic valve, which may further prevent contamination. A type of reagent may be dispensed via one or more nozzles. The one or more nozzles may be directed at or in proximity to a center of the substrate. Alternatively, the one or more nozzles may be directed at or in proximity to a location on the substrate other than the center of the substrate. Alternatively or in combination, one or more nozzles may be directed closer to the center of the substrate than one or more of the other nozzles. For instance, one or more nozzles used for dispensing washing reagents may be directed closer to the center of the substrate than one or more nozzles used for dispensing active reagents. The one or more nozzles may be arranged at different radii from the center of the substrate. Two or more nozzles may be operated in combination to deliver fluids to the substrate more efficiently. One or more nozzles may be configured to deliver fluids to the substrate as a jet, spray (or other dispersed fluid), and/or droplets. One or more nozzles may be operated to nebulize fluids prior to delivery to the substrate. For example, the fluids may be delivered as aerosol particles. In some cases, the droplets may comprise beads, as described elsewhere herein.

In some cases, the solution may be dispensed on the substrate while the substrate is stationary; the substrate may then be subjected to rotation (or other motion) following the dispensing of the solution. Alternatively, the substrate may be subjected to rotation (or other motion) prior to the dispensing of the solution; the solution may then be dispensed on the substrate while the substrate is rotating (or otherwise moving). In some cases, rotation of the substrate may yield a centrifugal force (or inertial force directed away from the axis) on the solution, causing the solution to flow radially outward over the array. In this manner, rotation of the substrate may direct the solution across the array. Continued rotation of the substrate over a period of time may dispense a fluid film of a nearly constant thickness across the array.

One or more conditions such as the rotational velocity of the substrate, the acceleration of the substrate (e.g., the rate of change of velocity), viscosity of the solution, angle of dispensing (e.g., contact angle of a stream of reagents) of the solution, radial coordinates of dispensing of the solution (e.g., on center, off center, etc.), temperature of the substrate, temperature of the solution, and other factors may be adjusted and/or otherwise optimized to attain a desired wetting on the substrate and/or a film thickness on the substrate, such as to facilitate uniform coating of the substrate. For instance, one or more conditions may be applied to attain a film thickness of at least 10 nanometers (nm), 20 nm, 50 nm, 100 nm, 200 nm, 500 nm, 1 micrometer (μm), 2 μm, 5 μm, 10 μm, 20 μm, 50 μm, 100 μm, 200 μm, 500 μm, 1 millimeter (mm), or more. Alternatively or in addition, one or more conditions may be applied to attain a film thickness of at most 10 nanometers (nm), 20 nm, 50 nm, 100 nm, 200 nm, 500 nm, 1 micrometer (μm), 2 μm, 5 μm, 10 μm, 20 μm, 50 μm, 100 μm, 200 μm, 500 μm, 1 millimeter (mm) or less. One or more conditions may be applied to attain a film thickness that is within a range defined by any two of the preceding values. The thickness of the film may be measured or monitored by a variety of techniques, such as thin film spectroscopy with a thin film spectrometer, such as a fiber spectrometer. In some cases, a surfactant may be added to the solution, or a surfactant may be added to the surface to facilitate uniform coating or to facilitate sample loading efficiency. Alternatively or in conjunction, the thickness of the solution may be adjusted using mechanical, electric, physical, or other mechanisms. For example, the solution may be dispensed onto a substrate and subsequently leveled using, e.g., a physical scraper such as a squeegee, to obtain a desired thickness of uniformity across the substrate.

Reagents may be dispensed to the substrate to multiple locations, and/or multiple reagents may be dispensed to the substrate to a single location, via different mechanisms. Reagent dispensing mechanisms disclosed herein may be applicable to sample dispensing. For example, a reagent may comprise the sample. The term “loading onto a substrate,” as used in reference to a reagent or a sample herein, may refer to dispensing of the reagent or the sample to a surface of the substrate in accordance with any reagent dispensing mechanism described herein.

In some cases, dispensing may be achieved via relative motion of the substrate and the dispenser (e.g., nozzle). For example, a reagent may be dispensed to the substrate at a first location, and thereafter travel to a second location different from the first location due to forces (e.g., centrifugal forces, centripetal forces, inertial forces, etc.) caused by motion of the substrate (e.g., rotational motion of the substrate, linear motion of the substrate, combination thereof, etc.). In another example, a reagent may be dispensed to a reference location, and the substrate may be moved relative to the reference location such that the reagent is dispensed to multiple locations of the substrate. In another example, a dispenser may be moved relative to the substrate to dispense the reagent at different locations, for example moved prior to, during, or subsequent to dispensing. In an example, a reagent is ‘painted’ onto the substrate by moving the dispenser and/or the substrate relative to each other, along a desired path on the substrate. The open substrate geometry may allow for flexible and controlled dispensing of a reagent to a desired location on the substrate. In some cases, dispensing may be achieved without relative motion between the substrate and the dispenser. For example, multiple dispensers may be used to dispense reagents to different locations, and/or multiple reagents to a single location, or a combination thereof (e.g., multiple reagents to multiple locations).

In another example, an external force (e.g., involving a pressure differential, involving physical force, involving a magnetic force, involving an electrical force, etc.), such as wind, a field-generating device, or a physical device, may be applied to one or more surfaces of the substrate to direct reagents to different locations across the substrate. In another example, the method for dispensing reagents may comprise vibration. In such an example, reagents may be distributed or dispensed onto a single region or multiple regions of the substrate (or a surface of the substrate). The substrate (or a surface thereof) may then be subjected to vibration, which may spread the reagent to different locations across the substrate (or the surface). A method for dispensing reagents may comprise agitation, or with a cycle of interrupted movements. For example, during or subsequent to dispensing reagents onto the substrate, the substrate may be subjected to movement, stopped, with such movement and stopping repeating any number of times. The movement may be a rotation. The movement may be at high velocities for any duration of time (e.g., seconds, minutes, etc.). In some cases, the substrate movement or velocity may change directions between repeats. Alternatively or in conjunction, the method may comprise using mechanical, electric, physical, or other mechanisms to dispense reagents to the substrate. For example, the solution may be dispensed onto a substrate and a physical scraper (e.g., a squeegee) may be used to spread the dispensed material or spread the reagents to different locations and/or to obtain a desired thickness or uniformity across the substrate. Beneficially, such flexible dispensing may be achieved without contamination of the reagents.

In some cases, reagent loading may be accelerated via evaporation. For example, reagents may be initially loaded as a relatively thick film, and the thickness may be evaporated via evaporation to generate a relatively thinner film. This method may be employed additionally or alternatively to rotational motion, at any rotational speeds (high or low). Such loading with evaporation may be useful for loading both reagents and samples.

In some instances, where a volume of reagent is dispensed to the substrate at a first location, and thereafter travels to a second location different from the first location, the volume of reagent may travel in a path or paths, such that the travel path or paths are coated with the reagent. In some cases, such travel path or paths may encompass a desired surface area (e.g., entire surface area, partial surface area(s), etc.) of the substrate.

### Mixing of Reagents on a Substrate

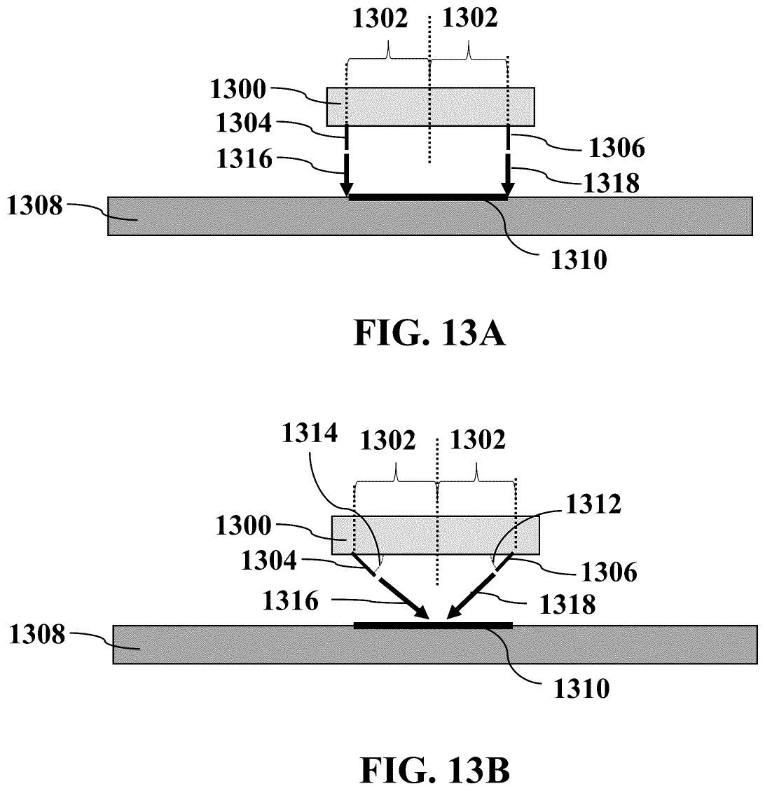

Two or more reagents may be mixed within the sequencing system. The two or more reagents may comprise reagents of a same type or reagents of different types. In some cases, the two or more reagents may comprise a reagent and a diluent or buffer. In some instances, two or more reagents may be mixed on the surface of the substrate. For example, two or more reagents (1316, 1318) may be dispensed by one or more dispensing nozzles (1304, 1306) of a fluid dispenser 1300, described elsewhere herein, and mixed 1310 on the surface of the substrate 1308, as seen in FIGS. 13A-13B. In some cases, the two or more reagents may be dispensed while the substrate 1308 rotates at a first rate (i.e., rotation per minute of the substrate (RPM)) for a first period of time and a second rate for a second period of time once the two or more reagents have been dispensed. In some instances, the first rate may be less than the second rate of rotation. In some cases, the second rate may be up to about 500 RPM.

The one or more dispensing nozzles (1304, 1306) may comprise an orientation perpendicular to the substrate surface, as seen in FIG. 13A. In some instances, the one or more dispensing nozzles (1304, 1306) may be disposed parallel to each other. In some cases, the one or more dispensing nozzles (1304, 1306) may comprise an angled orientation with respect to each of the one or more dispensing nozzles, the fluid dispenser 1300, and/or the substrate 1308, as seen in FIG. 13B. In some instances, the one or more dispensing nozzles (1304, 1306) may be actuated to a particular angled orientation individually or a group of one or more dispensing nozzles.

In some instances, the angle (1312, 1314) between the one or more dispensing nozzles and the fluid dispenser may comprise an angle of about 2 degrees to about 80 degrees. In some instances, the angle (1312, 1314) between the one or more dispensing nozzles and the fluid dispenser may comprise an angle of about 2 degrees to about 4 degrees, about 2 degrees to about 6 degrees, about 2 degrees to about 8 degrees, about 2 degrees to about 10 degrees, about 2 degrees to about 20 degrees, about 2 degrees to about 30 degrees, about 2 degrees to about 40 degrees, about 2 degrees to about 50 degrees, about 2 degrees to about 60 degrees, about 2 degrees to about 80 degrees, about 4 degrees to about 6 degrees, about 4 degrees to about 8 degrees, about 4 degrees to about 10 degrees, about 4 degrees to about 20 degrees, about 4 degrees to about 30 degrees, about 4 degrees to about 40 degrees, about 4 degrees to about 50 degrees, about 4 degrees to about 60 degrees, about 4 degrees to about 80 degrees, about 6 degrees to about 8 degrees, about 6 degrees to about 10 degrees, about 6 degrees to about 20 degrees, about 6 degrees to about 30 degrees, about 6 degrees to about 40 degrees, about 6 degrees to about 50 degrees, about 6 degrees to about 60 degrees, about 6 degrees to about 80 degrees, about 8 degrees to about 10 degrees, about 8 degrees to about 20 degrees, about 8 degrees to about 30 degrees, about 8 degrees to about 40 degrees, about 8 degrees to about 50 degrees, about 8 degrees to about 60 degrees, about 8 degrees to about 80 degrees, about 10 degrees to about 20 degrees, about 10 degrees to about 30 degrees, about 10 degrees to about 40 degrees, about 10 degrees to about 50 degrees, about 10 degrees to about 60 degrees, about 10 degrees to about 80 degrees, about 20 degrees to about 30 degrees, about 20 degrees to about 40 degrees, about 20 degrees to about 50 degrees, about 20 degrees to about 60 degrees, about 20 degrees to about 80 degrees, about 30 degrees to about 40 degrees, about 30 degrees to about 50 degrees, about 30 degrees to about 60 degrees, about 30 degrees to about 80 degrees, about 40 degrees to about 50 degrees, about 40 degrees to about 60 degrees, about 40 degrees to about 80 degrees, about 50 degrees to about 60 degrees, about 50 degrees to about 80 degrees, or about 60 degrees to about 80 degrees. In some instances, the angle (1312, 1314) between the one or more dispensing nozzles and the fluid dispenser may comprise an angle of about 2 degrees, about 4 degrees, about 6 degrees, about 8 degrees, about 10 degrees, about 20 degrees, about 30 degrees, about 40 degrees, about 50 degrees, about 60 degrees, or about 80 degrees. In some instances, the angle (1312, 1314) between the one or more dispensing nozzles and the fluid dispenser may comprise an angle of at least about 2 degrees, about 4 degrees, about 6 degrees, about 8 degrees, about 10 degrees, about 20 degrees, about 30 degrees, about 40 degrees, about 50 degrees, or about 60 degrees. In some instances, the angle (1312, 1314) between the one or more dispensing nozzles and the fluid dispenser may comprise an angle of at most about 4 degrees, about 6 degrees, about 8 degrees, about 10 degrees, about 20 degrees, about 30 degrees, about 40 degrees, about 50 degrees, about 60 degrees, or about 80 degrees.

In some cases, the two or more reagents (1316, 1318) may comprise a labeled nucleotide reagent, unlabeled nucleotide reagent, or any combination thereof. In some cases, the two or more reagents (1316, 1318) may be mixed by being dispensed at the same location and/or by directing a first reagent to travel to meet additional reagent(s). In some cases, the two or more reagents (1316, 1318) may comprise a nucleotide reagent of a first canonical base type (labeled or unlabeled), a nucleotide reagent of a second canonical base type (labeled or unlabeled), a nucleotide reagent of a third canonical base type (labeled or unlabeled), a nucleotide reagent of a fourth canonical base type (labeled or unlabeled), or any combination thereof, where the first through fourth canonical base types (e.g., A, T, G, C, U) are different. In some cases, the two or more reagents (1316, 1318) may comprise a diluent.

In some instances, dynamically altering the fraction of labeled and unlabeled nucleotide analogs in a sequencing flow mixture may provide better results through the course of several runs of sequencing. For example, when a fixed fraction of labeled and unlabeled nucleotide analogs in sequencing flow mixtures is repeatedly used through the course of multiple consecutive sequencing runs, the sequencing data quality may decrease due to an increase in background signal noise, such as from scarring (e.g., when a labeled nucleotide has its dye cleaved off, and the remaining moiety from the cleavage site interferes with subsequent nucleotide incorporations into the growing primer strand) and phasing issues. To address this problem, when sequencing a nucleic acid sample during earlier sequencing runs, a larger percentage of unlabeled nucleotides may be used to prevent scarring and/or phasing issues associated with high concentrations of labeled nucleotides, and during subsequent sequencing runs, a higher percentage of labeled nucleotides may be mixed with unlabeled nucleotides to provide brighter sequencing signals that are readily detectable against background signal noise.

In some instances, the concentration of a nucleotide reagent may be dynamically altered, such as by mixing a concentrated nucleotide reagent with a diluent pre-dispense or during dispensing, according to the methods and systems described herein, and dynamically changing the concentrations of the concentrated nucleotide reagent and/or diluent in the final mixture. For example, to increase the concentration of a nucleotide, the concentration of the concentrated nucleotide reagent may be increased and/or concentration of diluent reduced. To decrease the concentration of a nucleotide, the concentration of the concentrated nucleotide reagent may be decreased and/or concentration of diluent increased. In some cases, the concentration of a nucleotide reagent of a particular base type may be increased or decreased based on knowledge of a known, predetermined sequence during sequencing flows. For example, an adapter sequence or other functional sequence that is disposed downstream of a sequencing primer binding site may be a known sequence. Where nucleotide reagents are provided in a predetermined flow order (e.g., flow order of T-G-C-A is cyclically repeated), the concentration of a nucleotide flow may be decreased (or nucleotide flow skipped altogether) if the nucleotide base type is not complementary to the expected base in the known sequence. Similarly, alternatively or in addition, the concentration of a nucleotide flow may be increased if the nucleotide base type is complementary to the expected base in the known sequence. Such adjustments may increase efficiency of correct base incorporations and/or decrease misincorporation rates at locations of such known sequences.

In some cases, the one or more dispensing nozzles may comprise a distance 1302 from a nozzle of the one or more nozzles to a mid-point plane of the fluid dispenser and/or between one or more nozzles.

In some instances, the distance 1302 may comprise a length of about 0.1 mm to about 40 mm. In some instances, the distance 1302 may comprise a length of about 0.1 mm to about 0.5 mm, about 0.1 mm to about 1 mm, about 0.1 mm to about 1.5 mm, about 0.1 mm to about 2 mm, about 0.1 mm to about 2.5 mm, about 0.1 mm to about 5 mm, about 0.1 mm to about 10 mm, about 0.1 mm to about 15 mm, about 0.1 mm to about 25 mm, about 0.1 mm to about 30 mm, about 0.1 mm to about 40 mm, about 0.5 mm to about 1 mm, about 0.5 mm to about 1.5 mm, about 0.5 mm to about 2 mm, about 0.5 mm to about 2.5 mm, about 0.5 mm to about 5 mm, about 0.5 mm to about 10 mm, about 0.5 mm to about 15 mm, about 0.5 mm to about 25 mm, about 0.5 mm to about 30 mm, about 0.5 mm to about 40 mm, about 1 mm to about 1.5 mm, about 1 mm to about 2 mm, about 1 mm to about 2.5 mm, about 1 mm to about 5 mm, about 1 mm to about 10 mm, about 1 mm to about 15 mm, about 1 mm to about 25 mm, about 1 mm to about 30 mm, about 1 mm to about 40 mm, about 1.5 mm to about 2 mm, about 1.5 mm to about 2.5 mm, about 1.5 mm to about 5 mm, about 1.5 mm to about 10 mm, about 1.5 mm to about 15 mm, about 1.5 mm to about 25 mm, about 1.5 mm to about 30 mm, about 1.5 mm to about 40 mm, about 2 mm to about 2.5 mm, about 2 mm to about 5 mm, about 2 mm to about 10 mm, about 2 mm to about 15 mm, about 2 mm to about 25 mm, about 2 mm to about 30 mm, about 2 mm to about 40 mm, about 2.5 mm to about 5 mm, about 2.5 mm to about 10 mm, about 2.5 mm to about 15 mm, about 2.5 mm to about 25 mm, about 2.5 mm to about 30 mm, about 2.5 mm to about 40 mm, about 5 mm to about 10 mm, about 5 mm to about 15 mm, about 5 mm to about 25 mm, about 5 mm to about 30 mm, about 5 mm to about 40 mm, about 10 mm to about 15 mm, about 10 mm to about 25 mm, about 10 mm to about 30 mm, about 10 mm to about 40 mm, about 15 mm to about 25 mm, about 15 mm to about 30 mm, about 15 mm to about 40 mm, about 25 mm to about 30 mm, about 25 mm to about 40 mm, or about 30 mm to about 40 mm. In some instances, the distance 1302 may comprise a length of about 0.1 mm, about 0.5 mm, about 1 mm, about 1.5 mm, about 2 mm, about 2.5 mm, about 5 mm, about 10 mm, about 15 mm, about 25 mm, about 30 mm, or about 40 mm. In some instances, the distance 1302 may comprise a length of at least about 0.1 mm, about 0.5 mm, about 1 mm, about 1.5 mm, about 2 mm, about 2.5 mm, about 5 mm, about 10 mm, about 15 mm, about 25 mm, or about 30 mm. In some instances, the distance 1302 may comprise a length of at most about 0.5 mm, about 1 mm, about 1.5 mm, about 2 mm, about 2.5 mm, about 5 mm, about 10 mm, about 15 mm, about 25 mm, about 30 mm, or about 40 mm.

In some cases, the method of mixing reagents on a substrate may comprise: (a) providing a first reservoir, described elsewhere herein, comprising a first sequencing reagent of labeled nucleotides and a second reservoir comprising a second sequencing reagent of unlabeled nucleotide, where the first reservoir is in fluidic communication with a first dispensing nozzle and the second reservoir is in fluidic communication with a second dispensing nozzle; and (b) dispensing the first sequencing reagent and the second sequencing reagent using the first dispensing nozzle and the second dispensing nozzle, respectively, onto a surface of a substrate, where the first sequencing reagent is dispensed at a first flow rate and the second sequencing reagent is dispensed at a second flow rate, thereby mixing the first sequencing reagent and the second sequencing reagent. In some instances, the first dispensing nozzle dispenses the first sequencing reagent a time prior to and/or after the second dispensing nozzle dispenses the second sequencing reagent.

In some instances, the mixture of reagents formed on the substrate may be homogenous or substantially homogenous. The mixture of reagents may be formed at a first location on the substrate prior to dispersing the mixing of reagents to other locations on the substrate, such as at locations to meet other reagents or analytes.

### Mixing Reagents in a Dispense Line

In some cases, the two or more reagents may be mixed in a fluidic line prior to dispensing by the one or more nozzles. The two or more reagents may comprise reagents of a same type or reagents of different types. In some cases, the two or more reagents may comprise a reagent and a diluent or buffer. In some instances, the method of mixing reagents in a fluidic line may comprise: (a) providing a first reservoir comprising a first sequencing reagent of labeled nucleotides and a second reservoir comprising a second sequencing reagent of unlabeled nucleotides, where the first reservoir and the second reservoir are in fluidic communication with a fluid line; and (b) directing the first sequencing reagent and the second sequencing reagent from the first reservoir and the second reservoir, respectively, into the fluid line, where the first sequencing reagent is directed to flow at a first rate and the second sequencing reagent is directed to flow at a second rate, thereby mixing the first and the second sequencing reagents in the fluid line. In some instances, the first rate and the second rate are the same. In some instances, the first rate and the second rate are different (e.g., due to different tube diameters). In some cases, the mixing of the first sequencing reagent and the second sequencing reagent may occur by shear force between the first sequencing reagent, the second sequencing reagent, and the fluid line and/or by diffuse mixing between the first sequencing reagent and second sequencing reagent in a length of the fluid line. In some instances, the mixing may be pressure-induced. In some instances, the method of mixing reagents in a fluidic line may comprise: (a) providing a first reservoir comprising a first sequencing reagent (e.g., of labeled or unlabeled nucleotides, or a mixture thereof) and a second reservoir comprising a diluent or buffer, where the first reservoir and the second reservoir are in fluidic communication with a fluid line; and (b) directing the first sequencing reagent and the diluent or buffer from the first and second reservoir, respectively, into the fluid line, where the first sequencing reagent is directed to flow at a first rate and the diluent or buffer is directed to flow at a second rate, thereby mixing the first sequencing reagent and the diluent or buffer in the fluid line. In some cases, the mixing of the first sequencing reagent and the diluent or buffer may occur by shear force between the first sequencing reagent, the diluent or buffer, and the fluid line and/or by diffuse mixing between the first sequencing reagent and diluent or buffer in a length of the fluid line.

### Mixing Reagents in a Valve

In some instances, the two or more reagents may be mixed in a valve prior to dispensing by the one or more nozzles. The two or more reagents may comprise reagents of a same type or reagents of different types. In some cases, the two or more reagents may comprise a reagent and a diluent or buffer. In some cases, the method may comprise: (a) providing a first reservoir comprising a first sequencing reagent of labeled nucleotides and a second reservoir comprising a second sequencing reagent of unlabeled nucleotides, where the first reservoir and the second reservoir are in fluidic communication with a valve; and (b) directing the first sequencing reagent and the second sequencing reagent from the first reservoir and the second reservoir, respectively, into the valve, where the first sequencing reagent and the second sequencing reagent are mixed in the valve. In some cases, the method may comprise: (a) providing a first reservoir comprising a first sequencing reagent (e.g., of labeled or unlabeled nucleotides, or a mixture thereof) and a second reservoir comprising a diluent or buffer, where the first reservoir and the second reservoir are in fluidic communication with a valve; and (b) directing the first sequencing reagent and the diluent or buffer from the first reservoir and the second reservoir, respectively, into the valve, where the first sequencing reagent and the diluent or buffer are mixed in the valve.

### Mixing Reagents in a Syringe Pump

In some instances, the two or more reagents may be mixed in a syringe pump prior to dispensing by the one or more nozzles. The two or more reagents may comprise reagents of a same type or reagents of different types. In some cases, the two or more reagents may comprise a reagent and a diluent or buffer. In some cases, the method may comprise: (a) providing a first reservoir comprising a first sequencing reagent of labeled nucleotides fluidically coupled to a first syringe pump and a second reservoir comprising a second sequencing reagent of unlabeled nucleotides fluidically coupled to a second syringe pump; and (b) aspirating the first sequencing reagent from the first reservoir with the first syringe pump and the second sequencing reagent from the second reservoir with the second syringe pump into a third syringe pump, thereby mixing the first sequencing reagent and the second sequencing reagent in the third syringe pump. In some cases, the first syringe pump aspirates the first sequencing reagent at a first rate and the second syringe pump aspirates the second sequencing reagent a second rate. In some instances, the first rate and the second rate are different. In some instances, the method of mixing reagents in a fluidic line may comprise: (a) providing a first reservoir comprising a first sequencing reagent (e.g., of labeled or unlabeled nucleotides, or a mixture thereof) fluidically coupled to a first syringe pump and a second reservoir comprising a diluent or buffer fluidically coupled to a second syringe pump; and (b) aspirating the first sequencing reagent from the first reservoir with the first syringe pump and the diluent or buffer from the second reservoir with the second syringe pump into a third syringe pump, thereby mixing the first sequencing reagent and the diluent or buffer in the third syringe pump.

### Reagent Delivery

In some embodiments, one or more solutions may be delivered directly to the reaction site without substantial displacement of the one or more solution from the point of delivery. Methods of direct delivery of a solution to the reaction site may include aerosol delivery of the solution, applying the solution using an applicator, curtain-coating the solution, slot-die coating, dispensing the solution from a translating dispense probe, dispensing the solution from an array of dispense probes, dispensing the solution from a print head, dipping the substrate into the solution, or contacting the substrate to a sheet comprising the solution.

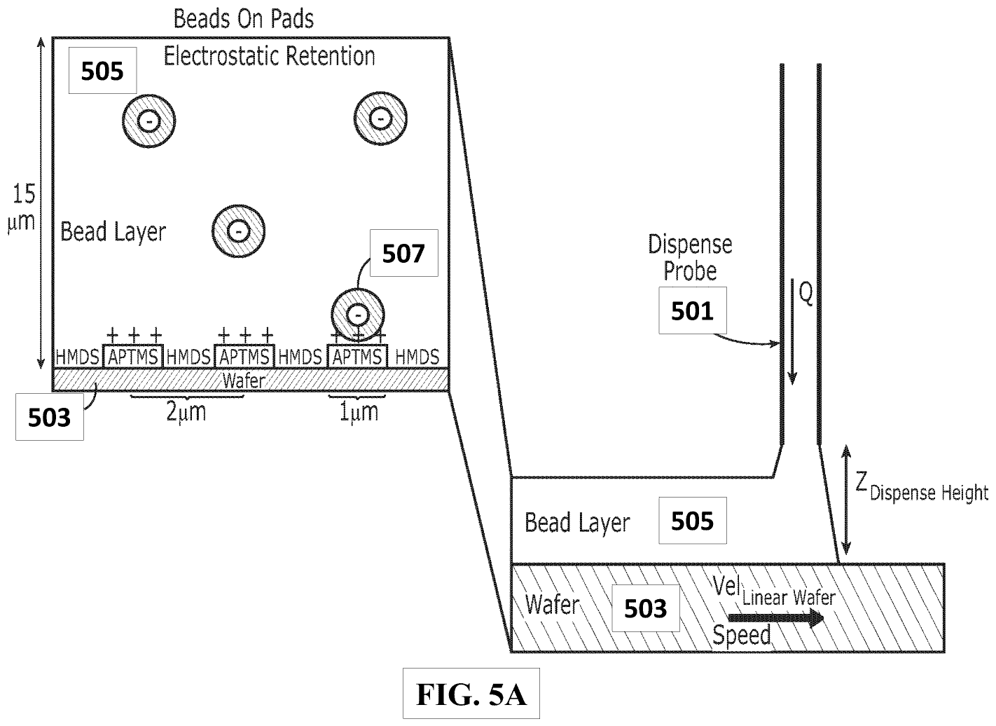

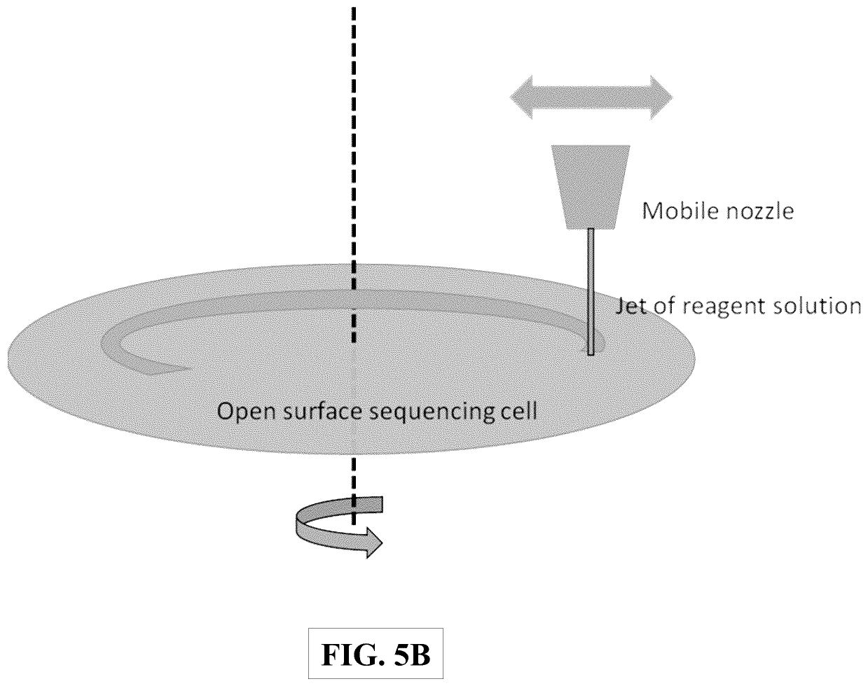

Aerosol delivery may comprise delivering a solution to the substrate in aerosol form by directing the solution to the substrate using a pressure nozzle or an ultrasonic nozzle. Applying the solution using an applicator may comprise contacting the substrate with an applicator comprising the solution and translating the applicator relative to the substrate. For example, applying the solution using an applicator may comprise painting the substrate. The solution may be applied in a pattern by translating the applicator, rotating the substrate, translating the substrate, or a combination thereof. Curtain-coating may comprise dispensing the solution from a dispense probe to the substrate in a continuous stream (e.g., a curtain or a flat sheet) and translating the dispense probe relative to the substrate. A solution may be curtain-coated in a pattern by translating the dispense probe, rotating the substrate, translating the substrate, or a combination thereof. Slot-die coating may comprise dispensing the solution from a dispense probe positioned near the substrate such that the solution forms a meniscus between the substrate and the dispense probe and translating the dispense probe relative to the substrate. A solution may be slot-die coated in a pattern by translating the dispense probe, rotating the substrate, translating the substrate, or a combination thereof. Dispensing the solution from a translating dispense probe may comprise translating the dispense probe relative to the substrate in a pattern (e.g., a spiral pattern, a circular pattern, a linear pattern, a striped pattern, a cross-hatched pattern, or a diagonal pattern). Dispensing the solution from an array of dispense probes may comprise dispensing the solution from an array of nozzles (e.g., a shower head) positioned above the substrate such that the solution is dispensed across an area of the substrate substantially simultaneously. Dipping the substrate into the solution may comprise dipping the substrate into a reservoir comprising the solution. In some embodiments, the reservoir may be a shallow reservoir to reduce the volume of the solution required to coat the substrate. Contacting the substrate to a sheet comprising the solution may comprise bringing the substrate in contact with a sheet of material (e.g., a porous sheet or a fibrous sheet) permeated with the solution. The solution may be transferred to the substrate. In some embodiments, the sheet of material may be a single-use sheet. In some embodiments, the sheet of material may be a reusable sheet. In some embodiments, a solution may be dispensed onto a substrate using the method illustrated in FIG. 5B, where a jet of a solution may be dispensed from a nozzle to a rotating substrate. The nozzle may translate radially relative to the rotating substrate, thereby dispensing the solution in a spiral pattern onto the substrate.

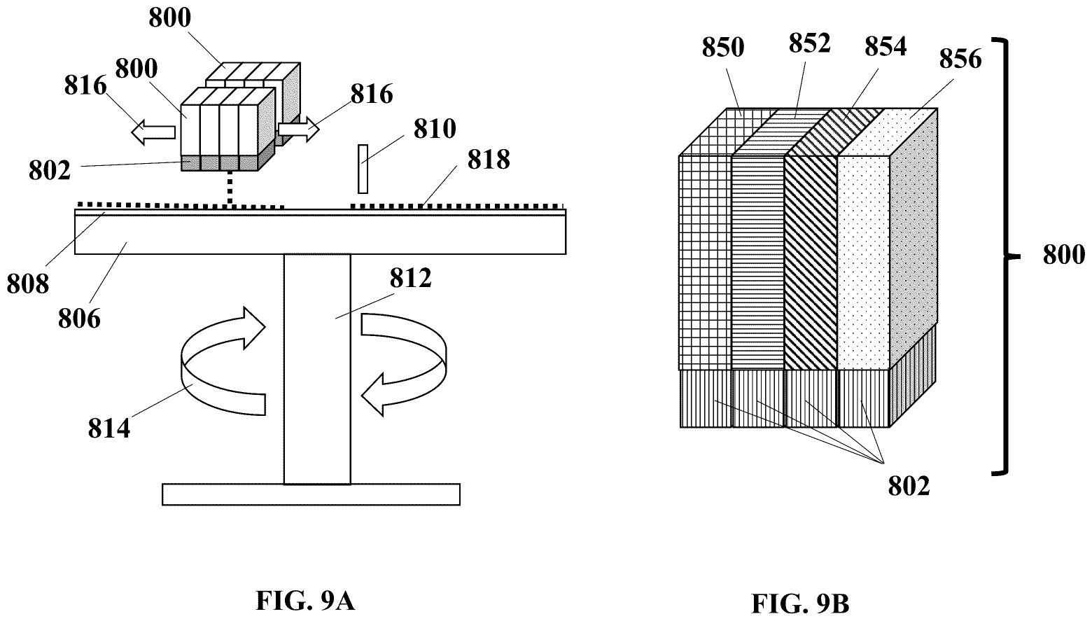

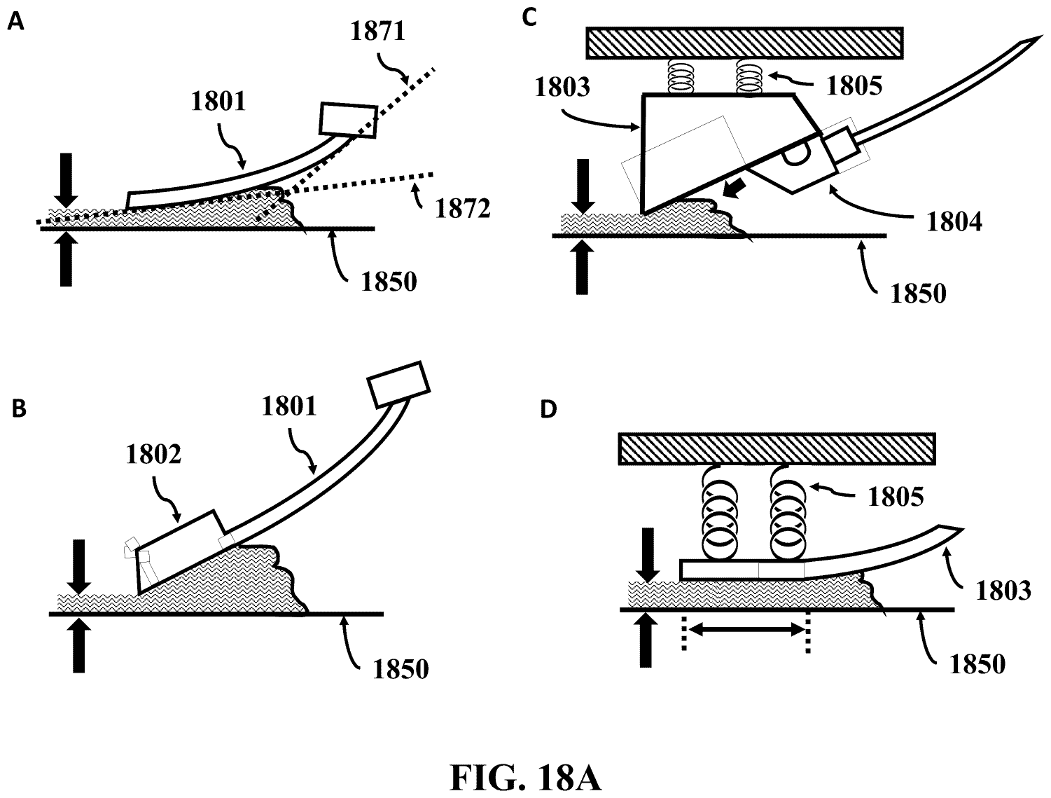

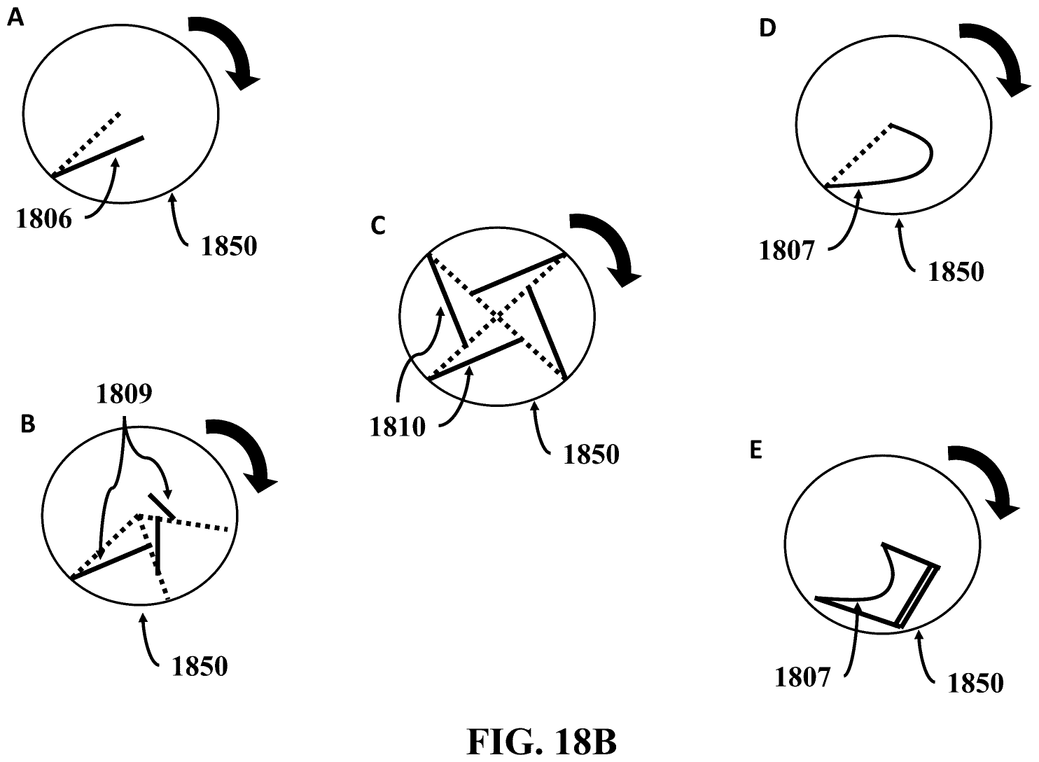

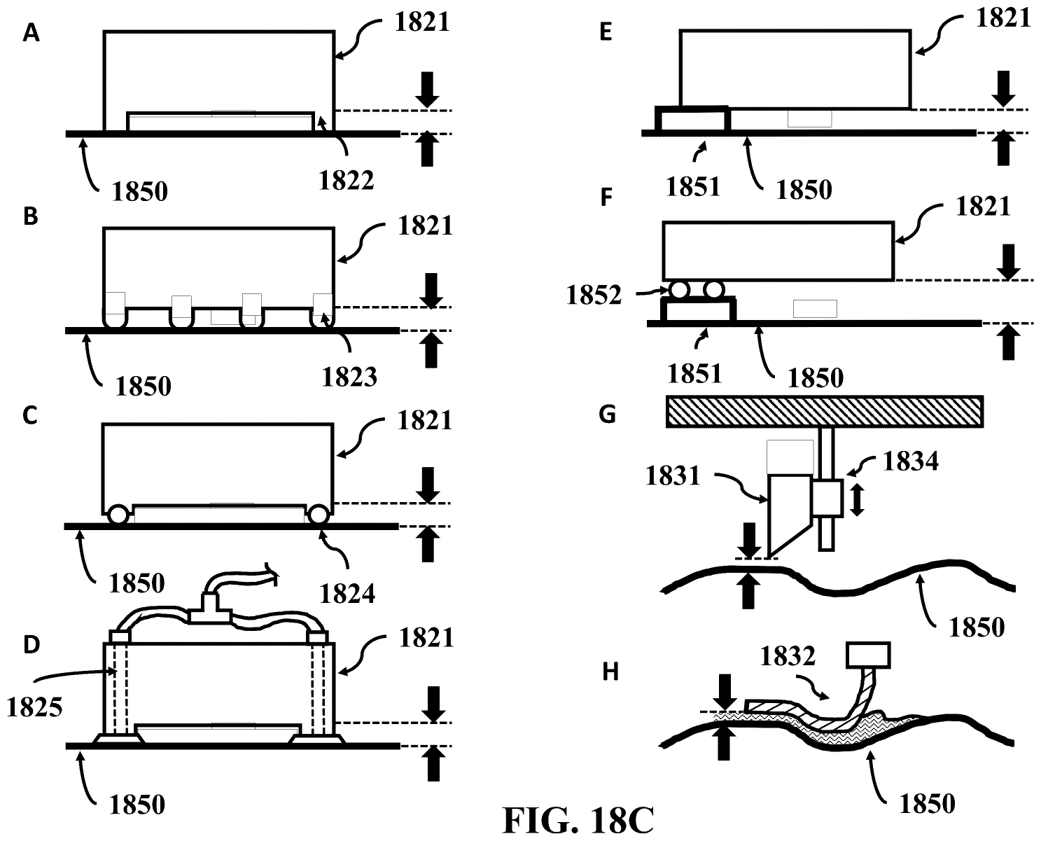

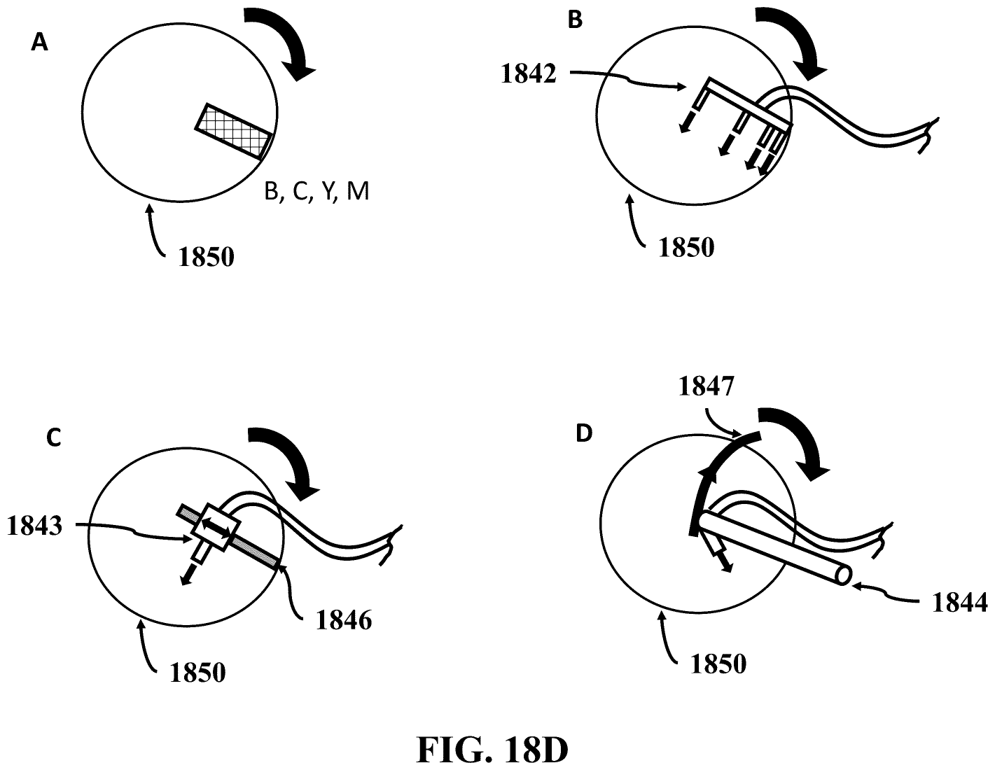

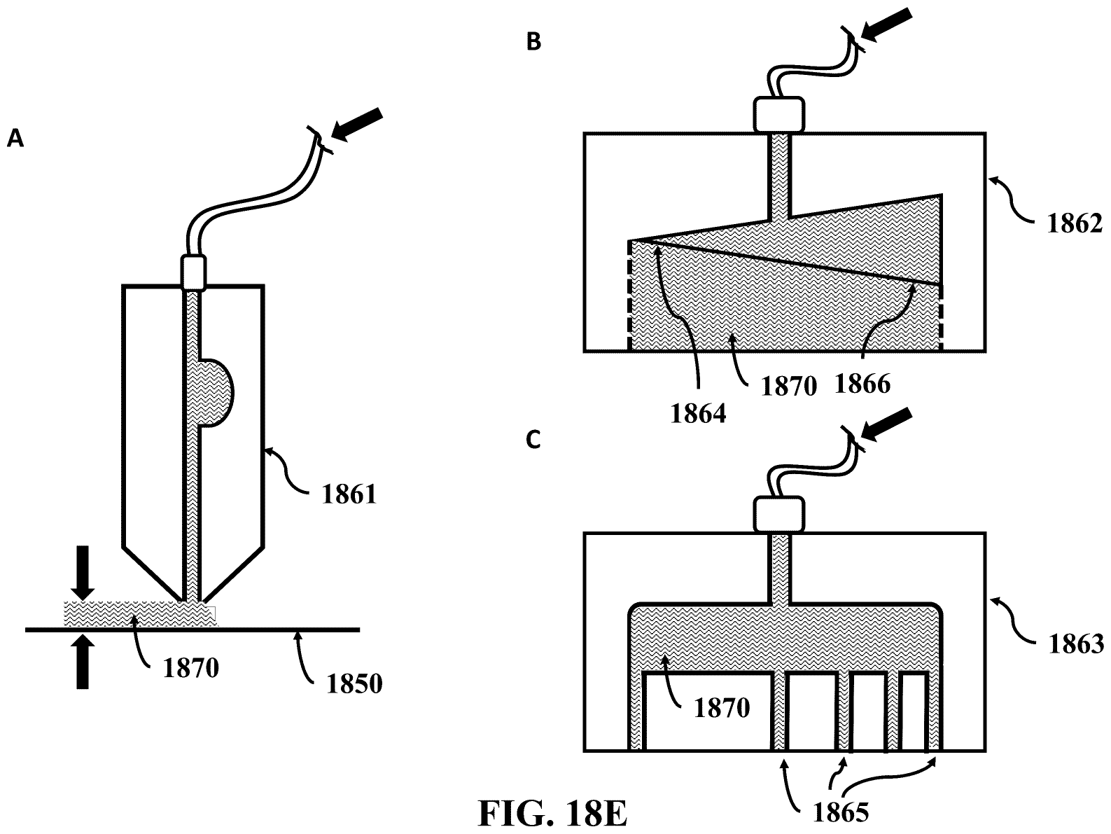

FIGS. 8A-8B, FIG. 9A, and FIGS. 18A-18E illustrate multiple dispense mechanisms that can be used with the systems described herein, such as to dispense and/or disperse reagents and/or samples to a substrate. For example, FIGS. 8A-8B and FIG. 9A illustrate use of fluid nozzles (e.g., of a fluid dispenser 810) and print heads (e.g., 800) to dispense fluids to a substrate, which are described in further detail elsewhere herein. FIGS. 18A-18C illustrate different schematics of using a physical scraper, such as a doctor blade tool, a mop tool, or a rigid object tool, to disperse reagents across different regions of a substrate. FIG. 18D illustrate different schematics of using inkjet heads, multi-needle dispensers, single-needle dispensers, and actuated dispensers. FIG. 18E illustrate different schematics of using slot die tools to dispense fluids to a substrate.

A physical scraper may be used to disperse fluids, such as reagents or samples, across different regions of a substrate via relative motion between the physical scraper and the substrate. The physical scraper may be a rigid object or a flexible, deformable object. Some non-limiting examples of physical scrapers include a squeegee tool, a doctor blade tool, a mop tool, other flexible or deformable tool, or a rigid object tool. In some cases, the physical scraper may contact the substrate surface as it relatively travels from one region to another region of the substrate. In some cases, the physical scraper may not contact the substrate surface, in one example by maintaining a minimum distance from the substrate surface, as it relatively travels from one region to another region on the substrate. Beneficially, this may prevent displacement of previously immobilized objects on the substrate surface (e.g., beads comprising nucleic acid molecules) due to the action of the physical scraper. In some cases, even when the physical scraper is not contacting the substrate surface, the physical scraper may contact the fluid on the substrate surface as it relatively travels from one region to another region of the substrate. In some cases, the physical scraper may maintain or leave behind a fluid film on the substrate surface. In some cases, the physical scraper may alternate between contacting the substrate and not contacting the substrate as it relatively moves from one region to another region on the substrate. In some cases, the physical scraper may alternate between contacting the fluid and not contacting the fluid on the substrate surface as it relatively moves from one region to another region on the substrate. It will be appreciated that the physical scraper may be stationary and the substrate may move relative to the physical scraper, the substrate may be stationary and the physical scraper may move relative to the substrate, or both the physical scraper and the substrate may be in active motion relative to the other.

In FIG. 18A, panel A illustrates a cross-sectional side view of a single, flexible blade 1801 dispersing fluid across a substrate 1850. The blade 1801 may have a deflection angle 1871 and contact angle 1872 relative to the substrate surface. Such angles may be optimized for efficient fluid dispersal. The blade 1801 may be set to not contact the substrate surface, such as to leave behind a fluid film (e.g., reagent film, sample film, etc.) on the substrate surface along its travel path. The flexibility of the blade may allow the blade to bend in either direction as it relatively travels across the substrate surface to account for non-uniformities on the substrate surface, such as height deviations. Panel B illustrates a cross-sectional side view of a single, flexible blade 1801 which contains a contact end 1802 of different design than that shown in Panel A. The blade 1801 may be set to not contact the substrate surface, such as to leave behind a fluid film (e.g., reagent film, sample film, etc.) on the substrate surface along its travel path. In some cases, not shown in panels A-B, the blade end proximal to the substrate surface may comprise one or more standoffs or spacers (described in more detailed with respect to FIG. 18C), which may or may not contact the substrate surface, to set a height of the remaining blade portion from the substrate surface. In such cases, a stiffer or more rigid blade may reduce the bow between the standoffs or spacers. Panel C illustrates a cross-sectional side view of a single blade 1803 dispersing fluid across a substrate 1850, which blade 1803 is held above the substrate surface via one or more springs 1805. The blade 1803 may be flexible or rigid. In either case, the one or more springs 1805 may provide flexibility in height movement of the blade, such as to account for non-uniformities on the substrate surface. In some cases, the blade 1803 may further comprise a slot die 1804 or other nozzle (or nozzles) configured to dispense fluid, such as wash fluid, directly onto or along the blade 1801. The slot die or other nozzle may be integrated into the blade 1801 or may be an independent system coupled to the blade 1801. Beneficially, the blade may be washed in between different flows to prevent contamination via the blade carrying over fluids (e.g., reagents, samples) from previous flows. The same wash buffer washing the blade may be used downstream to wash the substrate between the flows. Panel D illustrates a cross-sectional side view of a single blade 1803 dispersing fluid across a substrate 1850, which blade 1803 is held above the substrate surface via one or more springs 1805. The blade 1803 may be flexible or rigid. In either case, the one or more springs 1805 may provide flexibility in height movement of the blade, such as to account for non-uniformities on the substrate surface. In some cases, the blade may have a relatively long horizontal contact portion with the fluid on the substrate surface, such that the contact angle of the blade is closer to 0. The larger horizontal contact area may facilitate better tracking of the blade along the surface profile, similar to slide film damping.

In FIG. 18B, panel A illustrates a top view of a single blade 1806 dispersing fluid across a rotating substrate 1850. The blade 1806 may be oriented at a predetermined chord angle to facilitate faster, radially outward movement of the fluid across the substrate. Panels B and C each illustrate atop view of multiple blades 1809 and multiple blades 1810, respectively, dispersing fluid across a rotating substrate 1850. The blades 1809 and 1810 may each be oriented at a predetermined chord angle to facilitate faster, radially outward movement of the fluid across the substrate. The multiple blades may improve coverage and spreading of the fluid. Panel B shows multiple blades having different blade lengths, and panel C shows multiple blades having uniform blade lengths. Any number of blades may be used to optimize coverage and fluid dispersal efficiency. Any arrangement of the blade(s) may be used to optimize coverage and fluid dispersal efficiency. Panel D illustrates a top view of a single, curved blade 1807 dispersing fluid across a rotating substrate 1850. The curved blade 1807 may expand across the full radius to cover the full area of the substrate during rotational movement, but also enable the angles to facilitate faster, radially outward movement of the fluid across the substrate. In some cases, the curvature of the blade 1807 may be maintained via rigidity of the blade, where flexibility across blade height movement from the surface may be provided by springs (e.g., 1805) or other mechanisms (e.g., see FIG. 18C, panel G). Panel E illustrates a projection of the curved blade 1807 of Panel D.

In FIG. 18C, Panel A illustrates a cross-sectional side view of a blade 1821 with two spacers 1822 disposed at a first end of the blade 1821, the first end being proximal to the substrate 1850 surface. A spacer surface or edge facing the substrate surface may be closer to the substrate surface (sometimes contacting the substrate surface) than a non-spacer blade surface or edge facing the substrate surface (which is not contacting the substrate surface). The spacers may help set the blade height from the surface. In some cases, the spacers may be integrated with the blade material. In some cases, the spacers may be composed of alternate material from the blade material, for example coupled to the blade. The spacer material may be selected to help reduce friction and/or improve wear. The blade may comprise any number of spacers, such as 1, 2, 3, 4, 5, 6, 7, 8, 9, 10 or more spacers, arranged in any design (e.g., in a regular or irregular array, or ordered or random pattern, etc.) at the first end of the blade. As an example, Panel A illustrates the two spacers 1822 as being disposed at opposing ends of the first end of the blade. Panel B illustrates a cross-sectional side view of a blade 1821 with four spacers 1823 disposed at a first end of the blade 1821, the first end being proximal to the substrate 1850 surface, and the four spacers 1823 being substantially evenly spaced apart across the first end of the blade.

Panel C illustrates a cross-sectional side view of two rollers, spherical bearings, or ball bearings 1824 disposed at a first end of the blade 1821, the first end being proximal to the substrate 1850 surface. A roller, spherical bearing, or ball bearing may contact and roll and/or slide across the substrate surface while maintaining a non-roller blade surface or edge at a distance from the substrate surface. The roller, spherical bearing, or ball bearing may help set the blade height from the surface. The roller material may be selected to help reduce friction and/or improve wear. The blade may comprise any number of rollers, spherical bearings, or ball bearings such as 1, 2, 3, 4, 5, 6, 7, 8, 9, 10 or more, arranged in any design (e.g., in a regular or irregular array, or ordered or random pattern, etc.) at the first end of the blade. As an example, Panel C illustrates the two rollers, spherical bearings, or ball bearings 1824 as being disposed at opposing ends of the first end of the blade. Panel D illustrates a cross-sectional side view of a blade 1821 comprising two fluid bearings 1825 in which a fluid (e.g., liquid or gas), such as water, oil, or air, can be pressurized between a blade 1821 surface and a substrate 1850 surface. Panel E illustrates a cross-sectional side view of a substrate 1850 comprising a sticker or other bearing surface 1851, which is elevated from non-bearing surfaces of the substrate, the sticker or other bearing surface 1851 interfacing a blade 1821. The sticker or other bearing surface 1851 may be closer to the blade surface or edge facing the substrate surface than the non-bearing surfaces of the substrate. The sticker or other bearing surface may help set the blade height from the substrate surface. In some cases, the sticker or other bearing surface may be integrated with the substrate material. In some cases, the sticker or other bearing surface may be composed of alternate material from the substrate material, for example coupled to the substrate. The sticker or other bearing surface material may be selected to help reduce friction and/or improve wear. The sticker or other bearing surface material may experience different levels of wear across radial distances from the rotational axis of the substrate as the substrate rotates and interfaces the blade, where the bearing portions closer to the rotational axis experiences less wear due to lower tangential velocity compared to the bearing portions farther from the rotational axis—in some cases, the bearing material may be designed to equalize wear across different radial positions of the bearing material. The substrate may comprise any number of stickers or other bearing surfaces, such as 1, 2, 3, 4, 5, 6, 7, 8, 9, 10 or more, arranged in any design (e.g., in a regular or irregular array, or ordered or random pattern, etc.) and configured to interact with the blade 1821. Panel F illustrates a cross-sectional side view of the design of Panel E with additional rollers, spherical bearings, or ball bearings 1852 disposed above the sticker or other bearing surface 1851 of the substrate 1850. The roller, spherical bearing, or ball bearing 1852 on the sticker or other bearing surface 1851 may contact and roll and/or slide across the blade surface or edge while maintaining the blade surface or edge at a distance from the substrate surface. The roller material may be selected to help reduce friction and/or improve wear. The sticker or other bearing surface may comprise any number of rollers, spherical bearings, or ball bearings such as 1, 2, 3, 4, 5, 6, 7, 8, 9, 10 or more, arranged in any design (e.g., in a regular or irregular array, or ordered or random pattern, etc.) above the sticker or other bearing surface. In some cases, the number and location of rollers, spherical bearings, or ball bearings may be selected to better control or optimize the angle of the blade relative to the substrate surface.

Panel G illustrates a cross-sectional side view of an active blade height control system 1834 comprising a blade 1831 which is configured to move along a z axis (substantially perpendicular to a plane of the substrate surface 1850 or substantially parallel to a direction of gravitational force) relative to the substrate surface 1850. The blade height control system 1834, in a non-limiting example, may be informed of substrate surface profile data by one or more sensors, for example an autofocus system, and configured to move the blade 1831 in the z axis based on the data as the blade and substrate surface relatively transitions (e.g., linear movement, rotational movement, both linear and rotational movement, etc.). In some cases, a map of the substrate surface profile may be generated or learned, and the same map may be used to inform one or more actuators that are configured to move the blade height through each cycle and/or repeated cycles. In some cases, a map of the substrate surface profile may be generated, learned, and/or estimated in real-time or substantially real-time by one or more sensors while the blade and substrate are in relative motion. In some cases, the blade height control system 1834 may be configured to adjust a height of the blade within at most about 100 μm, 90 μm, 80 μm, 70 μm, 60 μm, 50 μm, 40 μm, 30 μm, 20 μm, 19 μm, 18 μm, 17 μm, 16 μm, 15 μm, 14 μm, 13 μm, 12 μm, 11 μm, 10 μm, 9 μm, 8 μm, 7 μm, 6 μm, 5 μm or less from the surface profile.

An autofocus system may comprise an autofocus illumination source. An autofocus system may map part or all of a surface profile of the substrate to generate an autofocus map of the surface. The autofocus map of the surface may comprise surface textures, irregularities, or tilts. In one application, during detection, the autofocus map may be used to anticipate a focal position of the surface and adjust the position of the surface relative to an objective to correct for the surface textures, irregularities, or tilts. The autofocus system may be configured to send a signal to a focusing system to adjust a position of the surface relative to the objective, thereby returning the surface to a focused position relative to the detector. In another application, during reagent and/or sample dispensing or dispersing, the autofocus map may be used to anticipate surface irregularities and send a signal to one or more actuators to adjust a position (e.g., height relative to surface) of one or more dispense or dispersal tools described herein (e.g., blade, mop, slot-die, print head, etc.) to track the surface profile of the substrate. In some cases the autofocus system may map part or all of a surface prior to scanning the surface to generate an autofocus map of the surface. In some cases, the autofocus system may map a first part of the surface (e.g., a first ring) before scanning the first part of the surface. The map of the first part of the surface may be used to anticipate and adjust the focus of the surface while scanning the first part of the surface. The map of the first part of the surface may be used to predict the focus of the surface while scanning a second part of the surface (e.g., a second ring). The second portion of the surface may be close to the first part of the surface so that the map of the first part of the surface may approximate a map of the second part of the surface. The autofocus system may map the second portion of the surface while scanning the second portion of the surface. The map of the second part of the surface may be used to anticipate and adjust the focus of the surface while scanning the third part of the surface (e.g., a third ring). In some cases, a map generated while scanning a third, fourth, fifth, sixth, seventh, eighth, ninth, tenth, eleventh, twelfth, or more portion of a surface may be used to anticipate and adjust the focus of the surface while scanning a fourth, fifth, sixth, seventh, eighth, ninth, tenth, eleventh, twelfth, thirtieth, or more part of the surface, respectively. Sequential surface portions may be positioned close together such that the map of a preceding part of the surface may approximate a map of the following part of the surface. In some cases, the autofocus system may map the entire surface before scanning. In some cases, the autofocus system may adjust the focus while scanning without generating a map.

Panel H illustrates a cross-sectional side view of a mop 1832 comprising a flexible material that is configured to track the substrate surface profile while maintaining a distance from the surface. The mop may be configured to actuate along a z axis (substantially perpendicular to a plane of the substrate surface 1850 or substantially parallel to a direction of gravitational force) relative to the substrate surface 1850 as the mop 1832 and substrate surface relatively transitions (e.g., linear movement, rotational movement, both linear and rotational movement, etc.). For example, such actuation may be via spring-loaded fixations and/or one or more actuators. The flexibility of the mop 1832 may account for irregularities in the substrate surface profile (e.g., height deviations). In some cases, the hydrodynamic pressure of the fluid film on the substrate surface may keep the mop from contacting the substrate surface.

FIG. 18D illustrates in panel A atop view of an inkjet, pico-jet, or other print head (e.g., 800) that may dispense different-colored jet streams or droplets for different nucleotide types (or otherwise different reagents) onto the substrate 1850. Panel B illustrates a top view of a multi-needle dispenser 1842 that may simultaneously or successively dispense reagents and/or samples from multiple dispense nozzles onto the substrate 1850. The multiple dispense nozzles may be arranged and/or optimized in any matter. For example, the multiple dispense nozzles may be spaced such that each nozzle covers an equal area of the substrate surface with fluid. In another example, the multiple dispense nozzles may be spaced evenly, and each nozzle may have varying orifice size to vary flow rate from each nozzle such as to cover an equal area of the substrate surface with fluid. Panel C illustrates atop view of a single-needle dispenser 1843 that may be actuated along a linear track 1846 above the substrate 1850 (e.g., via a linear actuator) and dispense reagents and/or samples from a single dispense nozzle onto the substrate 1850. Panel D illustrates a top view of a single-needle dispenser 1844 that may be actuated along a curved track 1847 (e.g., via a rotary actuator) and dispense reagents and/or samples from a single dispense nozzle onto the substrate 1850. Different features from the various panels may be combined, for example to combine a multi-needle dispenser with one or more actuators along one or more linear and/or non-linear tracks, or to combine an inkjet head with one or more actuators along one or more linear and/or non-linear tracks.

While Panels B-D illustrate the needle or nozzle at a certain angle, it will be appreciated that the angle of any needle or nozzle, described herein, relative to the substrate surface may be varied and/or optimized for efficient fluid delivery across the substrate surface. In some cases, an angled dispenser may have a proximal end (closer to the substrate surface) point radially outwards relative to the substrate surface. Such angling may reduce the relative horizontal velocity between the substrate and the dispensed stream. Beneficially, the reagents and/or samples may be dispensed at relatively larger radii on a rotating substrate, with minimized splashing or bouncing or the dispensed stream, leading to reduction in fluid loss and higher efficiency fluid delivery. In some cases, the flow velocity of the dispensed fluid may be selected to match the tangential velocity of the substrate where the fluid contacts the substrate.

FIG. 18E illustrates different slot-die tools that can be used to dispense reagents and/or samples onto a substrate 1850. Panel A illustrates a cross-sectional side view of a slot-die head 1861 dispensing fluid 1870 onto the substrate 1850 surface. The slot-die head may comprise a cavity having any profile, such as a hemi-spherical side profile as illustrated in panel A. The cavity may have a linear side profile. The cavity may have a non-linear side profile. The cavity may comprise side profiles having a combination of linear and non-linear edges. The cavity may be designed to optimize pressure drop along one or more directions, for example. Panel B illustrates a cross-sectional side view of a slot-die head 1862 dispensing fluid 1870. The slot-die head may comprise a cavity having a substantially triangular or horn-shaped side profile which tapers to the left 1864 (as seen in the cross-section in panel B), a design in which the pressure drop is relatively higher along the left 1864 resulting in less flow of the fluid leaving from the left 1864 side than on the right 1866 side of the slot. Beneficially, the slot-die may be designed to vary the dispense flow rate with the radius of dispense location (on the substrate). Panel C illustrates a cross-sectional side view of a slot-die head 1863 dispensing fluid 1870. The slot-die head may comprise a cavity that branches out to multiple different output slot channels 1865, which multiple channels can be designed to vary the dispense flow rate with the radius of dispense location on the substrate.

It will be appreciated that the dispense mechanisms and dispense tools for dispensing reagents and/or samples, as described herein, are not limited to those described in FIGS. 18A-18E.

One or more solutions or reagents may be delivered to a substrate by any of the delivery methods disclosed herein. In some embodiments, two or more solutions or reagents are delivered to the substrate using the same or different delivery methods. In some embodiments, two or more solutions are delivered to the substrate such that the time between contacting a solution or reagent and a subsequent solution or reagent is substantially similar for each region of the substrate contacted to the one or more solutions or reagents. In some embodiments, a solution or reagent may be delivered as a single mixture. In some embodiments, the solution or reagent may be dispensed in two or more component solutions. For example, each component of the two or more component solutions may be dispensed from a distinct nozzle. The distinct nozzles may dispense the two or more component solutions substantially simultaneously to substantially the same region of the substrate such that a homogenous solution forms on the substrate. In some embodiments, dispensing of each component of the two or more components may be temporally separated. Dispensing of each component may be performed using the same or different delivery methods. In some embodiments, direct delivery of a solution or reagent may be combined with spin-coating.

A solution may be incubated on the substrate for any desired duration (e.g., minutes, hours, etc.). In some embodiments, the solution may be incubated on the substrate under conditions that maintain a layer of fluid on the surface. One or more of the temperature of the chamber, the humidity of the chamber, the rotation of the substrate, or the composition of the fluid may be adjusted such that the layer of fluid is maintained during incubation. In some instances, during incubation, the substrate may be rotated at a rotational frequency of no more than 60 rpm, 50 rpm, 40 rpm, 30 rpm, 25 rpm, 20 rpm, 15 rpm, 14 rpm, 13 rpm, 12 rpm, 11 rpm, 10 rpm, 9 rpm, 8 rpm, 7 rpm, 6 rpm, 5 rpm, 4 rpm, 3 rpm, 2 rpm, 1 rpm or less. In some cases, the substrate may be rotating with a rotational frequency of about 5 rpm during incubation.

The substrate or a surface thereof may comprise other features that aid in solution or reagent retention on the substrate or thickness uniformity of the solution or reagent on the substrate. In some cases, the surface may comprise a raised edge (e.g., a rim) which may be used to retain solution on the surface. The surface may comprise a rim near the outer edge of the surface, thereby reducing the amount of the solution that flows over the outer edge.

The dispensed solution may comprise any sample or any analyte disclosed herein. The dispensed solution may comprise any reagent disclosed herein. In some cases, the solution may be a reaction mixture comprising a variety of components. In some cases, the solution may be a component of a final mixture (e.g., to be mixed after dispensing). In non-limiting examples, the solution can comprise samples, analytes, supports, beads, probes, nucleotides, oligonucleotides, labels (e.g., dyes), terminators (e.g., blocking groups), other components to aid, accelerate, or decelerate a reaction (e.g., enzymes, catalysts, buffers, saline solutions, chelating agents, reducing agents, other agents, etc.), washing solution, cleavage agents, combinations thereof, deionized water, and other reagents and buffers.

In some cases, a sample may be diluted such that the approximate occupancy of the individually addressable locations is controlled. In some cases, a sample may comprise beads, as described elsewhere herein, for example beads comprising nucleic acid colonies bound thereto. In some cases, an order of magnitude of at least about 10, 100, 1000, 10,000, 100,000, 1,000,000, 10,000,000, 100,000,000, 1,000,000,000, 10,000,000,000, 100,000,000,000 or more beads may be loaded on the substrate, such as to immobilize to as many individually addressable locations. Alternatively or in addition, an order of magnitude of at most about 100,000,000,000, 10,000,000,000, 1,000,000,000, 100,000,000, 10,000,000, 1,000,000, 100,000, 10,000, 1000, 100, or 10 beads may be loaded on the substrate, such as to immobilize to as many individually addressable locations. In some cases, the beads may be distinguishable from one another using a property of the beads, such as color, reflectance, anisotropy, brightness, fluorescence, etc. In some cases, as described elsewhere herein, different beads may comprise different tags (e.g., nucleic acid sequences) coupled thereto. For example, a bead may comprise an oligonucleotide molecule comprising a tag that identifies a bead amongst a plurality of beads. FIG. 4 illustrates images of a portion of a substrate surface after loading a sample containing beads onto a substrate patterned with a substantially hexagonal lattice of individually addressable locations, where the right panel illustrates a zoomed-out image of a portion of a surface, and the left panel illustrates a zoomed-in image of a section of the portion of the surface. In some cases, after sample loading, a “bead occupancy” may generally refer to the number of individually addressable locations of a type comprising at least one bead out of the total number of individually addressable locations of the same type. A bead “landing efficiency” may generally refer to the number of beads that bind to the surface out of the total number of beads dispensed on the surface.

In some cases, beads may be dispensed to the substrate according to one or more systems and methods shown in FIGS. 5A-5B. As shown in FIG. 5A, a solution comprising beads may be dispensed from a dispense probe 501 (e.g., a nozzle) to a substrate 503 (e.g., a wafer) to form a layer 505. The dispense probe may be positioned at a height (“Z”) above the substrate. In the illustrated example, the beads are retained in the layer 505 by electrostatic retention and may immobilize to the substrate at respective individually addressable locations. A set of beads in the solution may each comprise a population of amplified products (e.g., nucleic acid molecules) immobilized thereto, which amplified products accumulate to a negative charge on the bead with affinity to a positive charge. Otherwise, the beads may comprise reagents that have a negative charge. The substrate comprises alternating surface chemistry between distinguishable locations, in which a first location type comprises APTMS carrying a positive charge with affinity towards the negative charge of the amplified bead (e.g., a bead comprising amplified products immobilized thereto, and as distinguished from a negative bead which does not the comprise the same) or other bead comprising the negative charge, and a second location type comprises HMDS which has lower affinity and/or is repellant of the amplified bead or other bead comprising the negative charge. Within the layer 505 a bead may successfully land on a first location of the first location type (as in 507). In the illustrated example, the location size is 1 micron, the pitch between the different locations of the same location type (e.g., first location type) is 2 microns, and the layer has a depth of 15 micron. FIG. 5B illustrates a reagent (e.g., beads) being dispensed along a path on an open surface of the substrate. As shown in FIG. 5B, a reagent solution may be dispensed from a dispense probe (e.g., a nozzle). The reagent may be dispensed on the surface in any desired pattern or path. This may be achieved by moving one or both of the substrate and the dispense nozzle. The substrate and the dispense probe may move in any configuration with respect to each other to achieve any pattern (e.g., linear pattern, substantially spiral pattern, etc.).

In some instances, a subset or an entirety of the solution(s) may be recycled after the solution(s) have contacted the substrate. Recycling may comprise collecting, filtering, and reusing the subset or entirety of the solution. The filtering may be molecule filtering.

### Chuck

A substrate may be affixed to a chuck (e.g., chuck 806) during one or more operations at various stations (e.g., chemistry station, detection station, sample loading station, etc.). The substrate may be affixed to a chuck for rotation. The chuck may comprise a planar or substantially planar surface which contacts the substrate. The chuck may be a vacuum chuck. A chuck may comprise any material, such as metal, plastic, ceramic, glass, silicon carbide (SiC), aluminum, macor, zirconia, stainless steel, or any material of the substrate, etc.

In some cases, the chuck may comprise one or more supports that contact the substrate, such as pins, columns, pillars, a lip, or any other structure. A support may contact the substrate at an elevated point relative to other surfaces (non-support surfaces) of the chuck. A support may comprise any material, such as metal, plastic, ceramic, glass, or any material of the substrate, etc. A support may be coupled to the chuck, embedded in the chuck, and/or integrated to the chuck. The chuck may comprise any number of discrete supports (not in direct contact with each other), such as at least and/or at most about 1, 2, 3, 4, 5, 6, 7, 8, 9, 10, 11, 12, 13, 14, 15, 16, 17, 18, 19, 20, 30, 40, 50, 60, 70, 80, 90, 100, 150, 200, 300, 400, 500 or more discrete supports.

The chuck may comprise one or more mechanisms for coupling or affixing to the substrate, such as vacuum or suction. In some cases, the chuck may comprise one or more suction cups that contact the substrate. A suction cup may be coupled to the chuck, embedded in the chuck, and/or integrated to the chuck. The chuck may comprise any number of discrete suction cups (not in direct contact with each other), such as at least and/or at most about 1, 2, 3, 4, 5, 6, 7, 8, 9, 10, 11, 12, 13, 14, 15, 16, 17, 18, 19, 20, 30, 40, 50, 60, 70, 80, 90, 100, 150, 200, 300, 400, 500 or more discrete suction cups.

There may be the same number or different numbers of supports and suction cups. A suction cup may or may not surround, contact, or be coupled to a support. In some cases, each support may be surrounded by, contacted by, or be coupled to a suction cup. In some cases, a subset of supports may be surrounded by, contacted by, or be coupled to a suction cup. In some cases, a subset of suction cups may surround, contact, or be coupled to a support. Where suction cups are provided around supports, such as pins, beneficially, the suction cups may pull the substrate onto each respective support without needing vacuum on the chuck surface between the different supports. Further, the suction cups around the supports may allow the substrate to be supported with fewer supports without warping the substrate. Reducing the chuck-to-substrate contact area (e.g., to the respective substrate-contacting surface areas of the support and/or suction cups, as opposed to the whole surface area of the chuck) can significantly decrease the thermal coupling between the chuck and the substrate, and/or increase thermal resistance between the substrate and the chuck. This permits thermal cycling of the substrate without thermal cycling of the chuck, thus lowering the input energy requirement for the heating mechanism. In some cases, a chuck may comprise one or more channels within the chuck to distribute vacuum to different suction cups. In some cases, a support may be hollow and/or have one or more channels or pathways (e.g., axial holes) to allow vacuum through such axial holes.

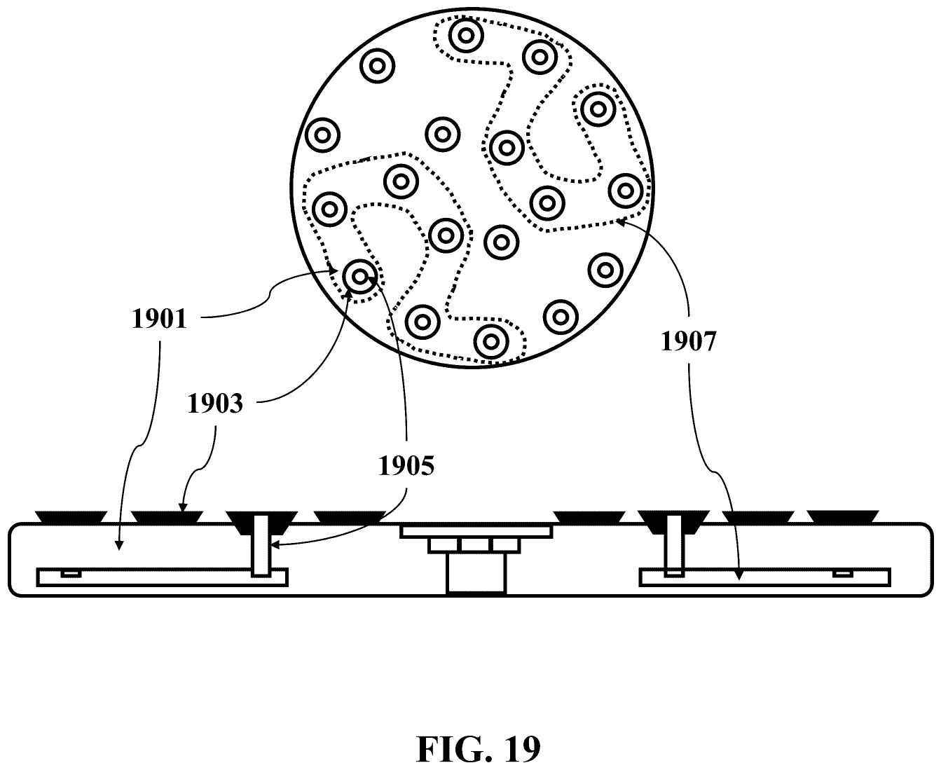

FIG. 19 illustrates a chuck 1901 comprising a plurality of supports 1905 and a plurality of suction cups 1903 disposed around the plurality of supports 1905. The top and bottom schematics represent a top view and cross-sectional side view, respectively. As seen from the cross-sectional side view, the plurality of supports 1905 (e.g., pins) may be embedded in and coupled to the remainder of the chuck. The chuck 1901 may comprise one or more channels 1907 within the chuck which can distribute vacuum flow to all the suction cups (and respective supports) that are fluidically coupled to the one or more channels. The plurality of supports 1905 may be hollow and/or have one or more pathways (e.g., axial holes, other channels,) that allow vacuum through the pathways. The arrangement of supports, suction cups, and/or vacuum channels may be in a regular array (e.g., radially symmetrical), arbitrary, or in any other pattern.

In some cases, at least and/or at most about 1%, 2%, 3%, 4%, 5%, 6%, 7%, 8%, 9%, 10%, 15%, 20%, 25%, 30%, 35%, 40%, 45%, 50%, 55%, 60%, 65%, 70%, 75%, 80%, 85%, 90%, 95%, or higher % of the substrate surface may be in contact with a support and/or suction cup to attach to the chuck.

Accordingly, provided are methods for handling a substrate, comprising: providing a chuck comprising a plurality of supports and a plurality of suction cups, wherein the plurality of supports are coupled to the plurality of suction cups, wherein at least a subset of the plurality of supports comprises a fluidic pathway, and wherein the chuck comprises one or more channels that fluidically connects the fluidic pathway of the at least the subset of the plurality of supports to at least a subset of the plurality of suction cups that are coupled to the at least the subset of the plurality of supports. The method may further comprise contacting the substrate to the plurality of suction cups of the chuck. The method may further comprise subjecting the fluidic pathway to a vacuum or negative pressure. A system may comprise a chuck comprising a plurality of supports and a plurality of suction cups, wherein the plurality of supports are coupled to the plurality of suction cups, wherein at least a subset of the plurality of supports comprises a fluidic pathway, and wherein the chuck comprises one or more channels that fluidically connects the fluidic pathway of the at least the subset of the plurality of supports to at least a subset of the plurality of suction cups that are coupled to the at least the subset of the plurality of supports. The system may further comprise a substrate. The substrate may be contacted to the plurality of suction cups of the chuck. The system may further comprise a device configured to apply a vacuum or subject the fluidic pathway to negative pressure.

### Detection

An optical system comprising a detector may be configured to detect one or more signals from a detection area on the substrate prior to, during, or subsequent to, the dispensing of reagents to generate an output. Signals from multiple individually addressable locations may be detected during a single detection event. Signals from the same individually addressable location may be detected in multiple instances.

A detectable signal, such as an optical signal (e.g., fluorescent signal), may be generated upon a reaction between a probe in the solution and the analyte. For example, the signal may originate from the probe and/or the analyte. The detectable signal may be indicative of a reaction or interaction between the probe and the analyte. The detectable signal may be a non-optical signal. For example, the detectable signal may be an electronic signal. The detectable signal may be detected by a detector (e.g., one or more sensors). For example, an optical signal may be detected via one or more optical detectors in an optical detection scheme described elsewhere herein. The signal may be detected during rotation of the substrate. The signal may be detected following termination of the rotation. The signal may be detected while the analyte is in fluid contact with a solution. The signal may be detected following washing of the solution. In some instances, after the detection, the signal may be muted, such as by cleaving a label from the probe and/or the analyte, and/or modifying the probe and/or the analyte. Such cleaving and/or modification may be affected by one or more stimuli, such as exposure to a chemical, an enzyme, light (e.g., ultraviolet light), or temperature change (e.g., heat). In some instances, the signal may otherwise become undetectable by deactivating or changing the mode (e.g., detection wavelength) of the one or more sensors, or terminating or reversing an excitation of the signal. In some instances, detection of a signal may comprise capturing an image or generating a digital output (e.g., between different images).

The operations of (i) directing a solution to the substrate and (ii) detection of one or more signals indicative of a reaction between a probe in the solution and an analyte immobilized to the substrate, may be repeated any number of times. Such operations may be repeated in an iterative manner. For example, the same analyte immobilized to a given location in the array may interact with multiple solutions in the multiple repetition cycles. For each iteration, the additional signals detected may provide incremental, or final, data about the analyte during the processing. For example, where the analyte is a nucleic acid molecule and the processing is sequencing, additional signals detected for each iteration may be indicative of a base in the nucleic acid sequence of the nucleic acid molecule. In some cases, multiple solutions can be provided to the substrate without intervening detection events. In some cases, multiple detection events can be performed after a single flow of solution. In some instances, a washing solution, cleaving solution (e.g., comprising cleavage agent), and/or other solutions may be directed to the substrate between each operation, between each cycle, or a certain number of times for each cycle.

The optical system may be configured for continuous area scanning of a substrate during rotational motion of the substrate. The term “continuous area scanning (CAS),” as used herein, generally refers to a method in which an object in relative motion is imaged by repeatedly, electronically or computationally, advancing (clocking or triggering) an array sensor at a velocity that compensates for object motion in the detection plane (focal plane). CAS can produce images having a scan dimension larger than the field of the optical system. TDI scanning may be an example of CAS in which the clocking entails shifting photoelectric charge on an area sensor during signal integration. For a TDI sensor, at each clocking step, charge may be shifted by one row, with the last row being read out and digitized. Other modalities may accomplish similar function by high-speed area imaging and co-addition of digital data to synthesize a continuous or stepwise continuous scan.

The optical system may comprise one or more sensors. The sensors may detect an image optically projected from the sample. The optical system may comprise one or more optical elements. An optical element may be, for example, a lens, prism, mirror, wave plate, filter, attenuator, grating, diaphragm, beam splitter, diffuser, polarizer, depolarizer, retroreflector, spatial light modulator, or any other optical element. The system may comprise any number of sensors. In some cases, a sensor is any detector as described herein. In some examples, the sensor may comprise image sensors, CCD cameras, CMOS cameras, TDI cameras (e.g., TDI line-scan cameras), pseudo-TDI rapid frame rate sensors, or CMOS TDI or hybrid cameras. The optical system may further comprise any optical source. In some cases, where there are multiple sensors, the different sensors may image the same or different regions of the rotating substrate, in some cases simultaneously. Each sensor of the plurality of sensors may be clocked at a rate appropriate for the region of the rotating substrate imaged by the sensor, which may be based on the distance of the region from the center of the rotating substrate or the tangential velocity of the region. In some cases, multiple scan heads can be operated in parallel along different imaging paths (e.g., interleaved spiral scans, nested spiral scans, interleaved ring scans, nested ring scans). A scan head may comprise one or more of a detector element such as a camera (e.g., a TDI line-scan camera), an illumination source (e.g., as described herein), and one or more optical elements (e.g., as described herein).

The system may further comprise a controller. The controller may be operatively coupled to the one or more sensors. The controller may be programmed to process optical signals from each region of the rotating substrate. For instance, the controller may be programmed to process optical signals from each region with independent clocking during the rotational motion. The independent clocking may be based at least in part on a distance of each region from a projection of the axis and/or a tangential velocity of the rotational motion. The independent clocking may be based at least in part on the angular velocity of the rotational motion. While a single controller has been described, a plurality of controllers may be configured to, individually or collectively, perform the operations described herein.

In some cases, the optical system may comprise an immersion objective lens. The immersion objective lens may be in contact with an immersion fluid that is in contact with the open substrate. In some cases, the objective lens may be in optical communication with the surface of the substrate. In some instances, the objective lens may be configured for cleaning by submerging the objective lens in deionized water or other fluid (e.g., immersion fluid) prior to or after imaging a surface of a substrate. The objective lens may be submerged and un-submerged in the deionized water or other fluid in repeated motion. Beneficially, the objective lens may be cleaned to remove salt accumulation. The immersion fluid may comprise any suitable immersion medium for imaging (e.g., water, aqueous, organic solution). In some cases, an enclosure may partially or completely surround a sample-facing end of the optical imaging objective. The enclosure may be configured to contain the fluid. The enclosure may not be in contact with the substrate; for example, a gap between the enclosure and the substrate may be filled by the fluid contained by the enclosure (e.g., the enclosure can retain the fluid via surface tension). In some cases, an electric field may be used to regulate a hydrophobicity of one or more surfaces of the container to retain at least a portion of the fluid contacting the immersion objective lens and the open substrate.

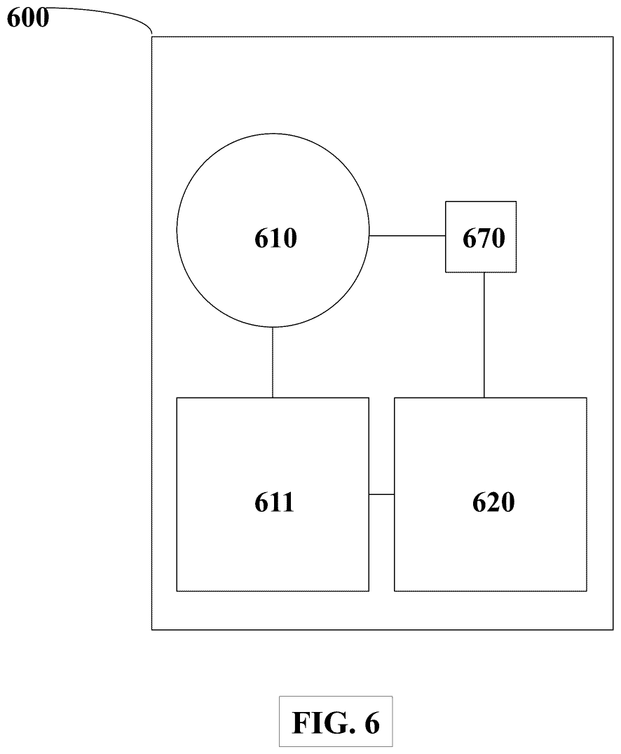

FIG. 6 shows a computerized system 600 for sequencing a nucleic acid molecule. The system may comprise a substrate 610, such as any substrate described herein. The system may further comprise a fluid flow unit 611. The fluid flow unit may comprise any element associated with fluid flow described herein. The fluid flow unit may be configured to direct a solution comprising a plurality of nucleotides described herein to an array of the substrate prior to or during rotation of the substrate. The fluid flow unit may be configured to direct a washing solution described herein to an array of the substrate prior to or during rotation of the substrate. In some instances, the fluid flow unit may comprise pumps, compressors, and/or actuators to direct fluid flow from a first location to a second location. The fluid flow unit may be configured to direct any solution to the substrate 610. The fluid flow system may be configured to collect any solution from the substrate 610. The system may further comprise a detector 670, such as any detector described herein. The detector may be in sensing communication with the substrate surface.

The system may further comprise one or more processors 620. The one or more processors may be individually or collectively programmed to implement any of the methods described herein. For instance, the one or more processors may be individually or collectively programmed to implement any or all operations of the methods of the present disclosure. In particular, the one or more processors may be individually or collectively programmed to: (i) direct the fluid flow unit to direct the solution comprising the plurality of nucleotides across the array during or prior to rotation of the substrate; (ii) subject the nucleic acid molecule to a primer extension reaction under conditions sufficient to incorporate at least one nucleotide from the plurality of nucleotides into a growing strand that is complementary to the nucleic acid molecule; and (iii) use the detector to detect a signal indicative of incorporation of the at least one nucleotide, thereby sequencing the nucleic acid molecule.

### High Throughput

An open substrate system of the present disclosure may comprise a barrier system configured to maintain a fluid barrier between a sample processing environment and an exterior environment. The barrier system is described in further detail in WO2020/167656, which is entirely incorporated herein by reference. A sample environment system may comprise a sample processing environment defined by a chamber and a lid plate, where the lid plate is not in contact with the chamber. The gap between the lid plate and the chamber may comprise the fluid barrier. The fluid barrier may comprise fluid (e.g., air) from the sample processing environment and/or the exterior environment and may have lower pressure than the sample environment, the external environment, or both. The fluid in the fluid barrier may be in coherent motion or bulk motion.

The sample processing environment may comprise therein a substrate, such as any substrate described elsewhere herein. Any operation performed on or with the substrate, as described elsewhere herein, may be performed within the sample processing environment while the fluid barrier is maintained. For example, the substrate may be rotated within the sample processing environment during various operations. In another example, fluid may be directed to the substrate while the substrate is in the sample processing environment, via a fluid handler (e.g., nozzle) that penetrates the lid plate into the sample processing environment. In another example, a detector can image the substrate while the substrate is in the sample processing environment, via a detector that penetrates the lid plate into the sample processing environment. Beneficially, the fluid barrier may help maintain temperature(s) and/or relative humidit(ies), or ranges thereof, within the sample processing environment during various processing operations.

The systems described herein, or any element thereof, may be environmentally controlled. For instance, the systems may be maintained at a specified temperature or humidity. For an operation, the systems (or any element thereof) may be maintained at a temperature of at least 20 degrees Celsius (° C.), 25° C., 30° C., 35° C., 40° C., 45° C., 50° C., 55° C., 60° C., 65° C., 70° C., 75° C., 80° C., 85° C., 90° C., 95° C., 100° C., or more. Alternatively or in addition, for an operation, the systems (or any element thereof) may be maintained at a temperature of at most 100° C., 95° C., 90° C., 85° C., 80° C., 75° C., 70° C., 65° C., 60° C., 55° C., 50° C., 45° C., 40° C., 35° C., 30° C., 25° C., 20° C., or less. Different elements of the system may be maintained at different temperatures or within different temperature ranges, such as the temperatures or temperature ranges described herein. Elements of the system may be set at temperatures above the dew point to prevent condensation. Elements of the system may be set at temperatures below the dew point to collect condensation. In one example, a sample processing environment comprising a substrate as described elsewhere herein may be environmentally controlled from an exterior environment. The sample processing environment may be further divided into separate regions which are maintained at different local temperatures and/or relative humidities, such as a first region contacting or in proximity to a surface of the substrate, and a second region contacting or in proximity to a top portion of the sample processing environment (e.g., a lid). For example, the local environment of the first region may be maintained at a first set of temperatures and first set of humidities configured to prevent or minimize evaporation of one or more reagents on the surface of the substrate, and the local environment of the second region may be maintained at a second set of temperatures and second set of humidities configured to enhance or restrict condensation. The first set of temperatures may be the lowest temperatures within the sample processing environment and the second set temperatures may be the highest temperatures within the sample processing environment.

In some instances, the environmental conditions of the different regions may be achieved by controlling the temperature of the enclosure. In some instances, the environmental conditions of the different regions may be achieved by controlling the temperature of selected parts or whole of the container. In some instances, the environmental conditions of the different regions may be achieved by controlling the temperature of selected parts or whole of the substrate. In some instances, the environmental conditions of the different regions may be achieved by controlling the temperature of reagents dispensed to the substrate. Any combination thereof may be used to control the environmental conditions of the different regions. Heat transfer may be achieved by any method, including for example, conductive, convective, and radiative methods.

While examples described herein provide relative rotational motion of the substrates and/or detector systems, the substrates and/or detector systems may alternatively or additionally undergo relative non-rotational motion, such as relative linear motion, relative non-linear motion (e.g., curved, arcuate, angled, etc.), and any other types of relative motion.

In some instances, an open substrate is retained in the same or approximately the same physical location during processing of an analyte and subsequent detection of a signal associated with a processed analyte.

In some instances, different operations on or with the open substrate are performed in different stations. Different stations may be disposed in different physical locations. For example, a first station may be disposed above, below, adjacent to, or across from a second station. In some cases, the different stations can be housed within an integrated housing. Alternatively, the different stations can be housed separately. In some cases, different stations may be separated by a barrier, such as a retractable barrier (e.g., sliding door). One or more different stations of a system, or portions thereof, may be subjected to different physical conditions, such as different temperatures, pressures, or atmospheric compositions. In an example, a processing station may comprise a first atmosphere comprising a first set of conditions and a second atmosphere comprising a second set of conditions. The barrier systems may be used to maintain different physical conditions of one or more different stations of the system, or portions thereof, as described elsewhere herein.

The open substrate may transition between different stations by transporting a sample processing environment containing the open substrate (such as the one described with respect to the barrier system) between the different stations. One or more mechanical components or mechanisms, such as a robotic arm, elevator mechanism, actuators, rails, and the like, or other mechanisms may be used to transport the sample processing environment.

An environmental unit (e.g., humidifiers, heaters, heat exchangers, compressors, etc.) may be configured to regulate one or more operating conditions in each station. In some instances, each station may be regulated by independent environmental units. In some instances, a single environmental unit may regulate a plurality of stations. In some instances, a plurality of environmental units may, individually or collectively, regulate the different stations. An environmental unit may use active methods or passive methods to regulate the operating conditions. For example, the temperature may be controlled using heating or cooling elements. The humidity may be controlled using humidifiers or dehumidifiers. In some instances, a part of a particular station, such as within a sample processing environment, may be further controlled from other parts of the particular station. Different parts may have different local temperatures, pressures, and/or humidity.

In one example, the delivery and/or dispersal of reagents may be performed in a first station having a first operating condition, and the detection process may be performed in a second station having a second operating condition different from the first operating condition. The first station may be at a first physical location in which the open substrate is accessible to a fluid handling unit during the delivery and/or dispersal processes, and the second station may be at a second physical location in which the open substrate is accessible to the detector system.

One or more modular sample environment systems (each having its own barrier system) can be used between the different stations. In some instances, the systems described herein may be scaled up to include two or more of a same station type. For example, a sequencing system may include multiple processing and/or detection stations.

### High-Throughput Sequencing Systems

The present disclosure provides sequencing systems, which sequencing systems may be used to process one or more nucleic acid samples. In some cases, a sequencing system provided herein may be used to process a plurality of nucleic acid samples in sequence or simultaneously. A sequencing system configured to process a plurality of nucleic acid samples may be considered a “high throughput” sequencing system.

The sequencing system of the present disclosure permits highly efficient sequencing operation. Such efficiency may be facilitated by allowing parallel real-time operations and/or instructions, such as dynamic queuing and hot-swapping of samples for processing, real-time replacement and/or replenishing of reagents, and real-time loading and/or unloading of substrates. The term “real-time,” as used herein, generally refers to simultaneous or substantially simultaneous occurrence of, or without interruption, of one event (e.g., updating sample queuing instructions) relative to occurrence of another event (e.g., processing of another sample).

In some examples, the methods and systems provided herein may facilitate high-throughput, continuous, automated, and/or un-interrupted sequencing of one or more samples. The samples that may be used along with the sequencing system of the present disclosure are described in further detail elsewhere herein. In some examples, the sample may comprise a plurality of particles (e.g., beads). A particle (e.g., bead) of the plurality of particles (e.g., beads) may comprise one or more (e.g., a plurality of) nucleic acid molecules (e.g., DNA and/or RNA molecules) coupled thereto (e.g., immobilized thereon). The nucleic acid molecules may have been immobilized on the surface of the particles prior to sample loading on the sequencing system. Nucleic acid molecules of a given sample may derive from a same source, such as a same subject. Alternatively, nucleic acid molecules of a given sample may derive from one or more different sources, such as one or more different subjects. In some examples, the methods and systems provided herein may facilitate high-throughput, continuous, automated, and/or un-interrupted sequencing of a plurality of samples deriving from a plurality of sources.

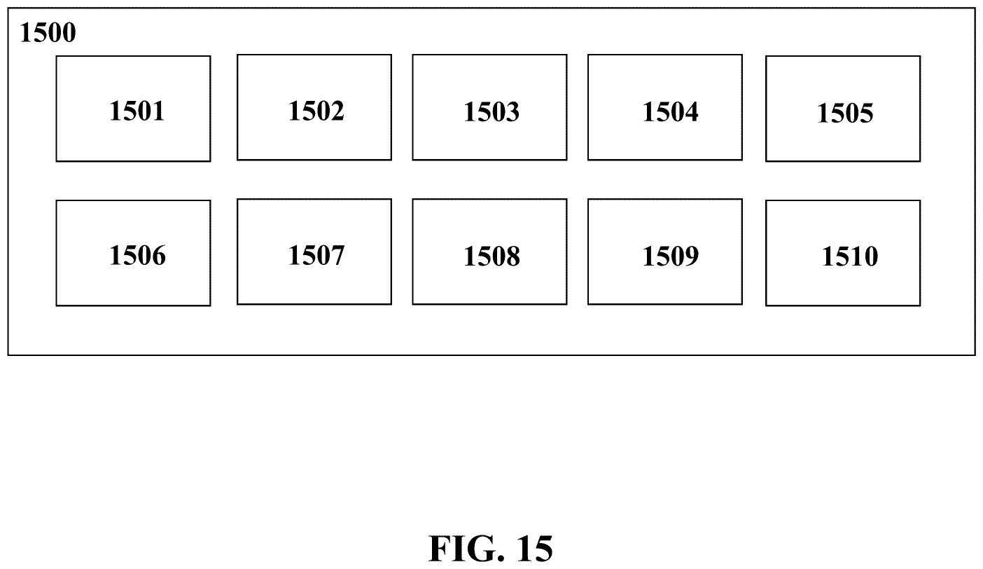

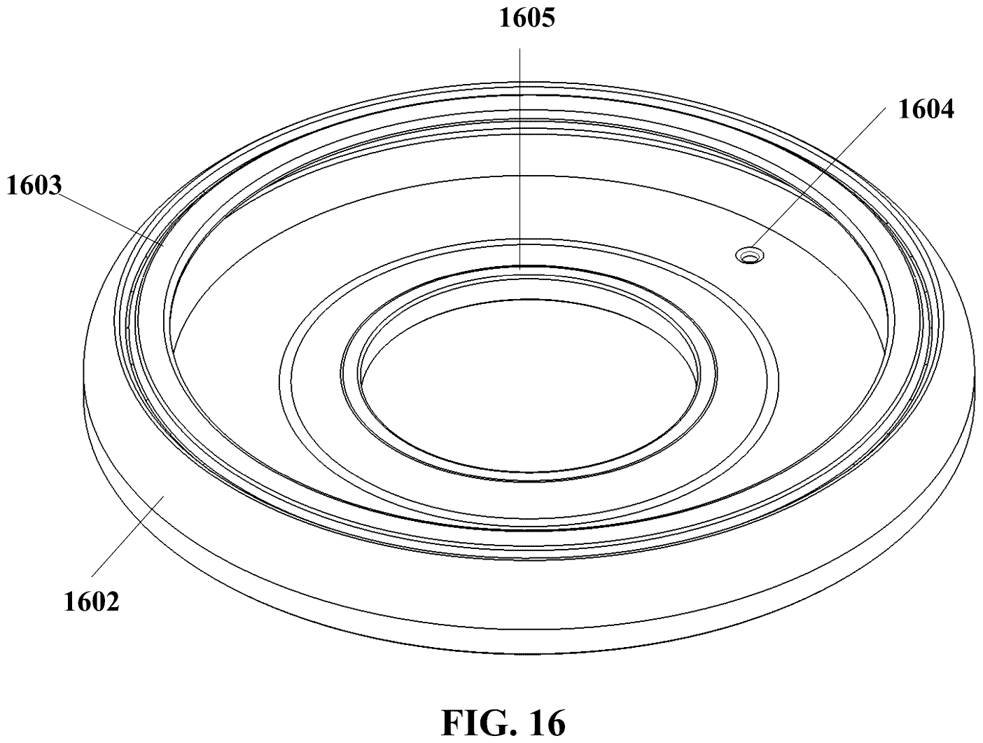

FIG. 15 illustrates a sequencing system 1500, which sequencing system may be a high throughput sequencing system. The sequencing system 1500 may comprise one or more stations 1501, 1502, 1503, 1504, 1505, 1506, 1507, 1508, 1509, 1510. While ten examples of stations are illustrated, it will be appreciated that there may be any number of stations in the system. In some instances, a station of the sequencing system, and/or operation performed therein, may be controlled independent of other operations and/or independent of other stations in the sequencing system. In some instances, two or more stations of the sequencing system may be controlled together and/or substantially simultaneously, such as with a single set of instructions.

For example, the sequencing system 1500 may comprise one or more of a sample station 1501, a sample loading station 1510, a substrate station 1502, a reagent station 1503, a processing station 1504, a detection station 1505, a diluent station 1506, a controlling station 1507, a power station 1508, and an instructions station 1509. In some cases, the system may comprise fewer stations. For example, one or more stations described above may not be included. In some cases, the system may comprise one or more additional stations.

Provided herein is a system for sequencing a plurality of nucleic acid samples. In some cases, the system may comprise: a sample loading station 1510 configured to dispense a nucleic acid sample of the plurality of nucleic acid samples onto a surface of a substrate; a processing station 1504 configured to bring a nucleic acid molecule of the nucleic acid sample immobilized on the surface of the substrate into contact with a reagent to sequence the nucleic acid molecule; a sample station 1501 configured to supply the nucleic acid sample to the sample loading station 1510; a substrate station 1502 configured to supply the substrate to the sample loading station; a reagent station 1503 configured to supply the reagent to the processing station 1504, where the reagent is supplied from a first reservoir or a second reservoir; and one or more processors, individually or collectively, programmed to execute (i) at least a portion of a first queuing instruction to introduce the nucleic acid sample of the plurality of nucleic acid samples from the sample station to the sample loading station according to a first order of introduction defined by a the first queuing instructions, (ii) a substrate loading instruction to introduce the substrate from the substrate station to the sample loading station and dispense the nucleic acid sample onto the substrate, and (iii) a sequencing instruction to draw the reagent from the first reservoir, from the second reservoir, or alternately from the first reservoir and the second reservoir, and deliver the reagent to the processing station 1504, where the processing station 1504 is capable of operating during performance of one or more actions selected from the group consisting of: (1) introducing an additional nucleic acid sample of the plurality of nucleic acid samples to the sample loading station 1510, (2) inputting a second queuing instruction and executing at least a portion of the second queuing instruction, where the second queuing instruction defines a second order of introduction that is different than the first order of introduction, (3) introducing an additional substrate to the substrate station 1502, and (4) introducing an additional volume of the reagent to the reagent station 1503 by one or more of (i) replacing the first reservoir or the second reservoir with a third reservoir containing the reagent and (ii) replenishing the first reservoir or the second reservoir with the reagent. In some instances, the processing station may be capable of operating during performance of two or more, or three or more actions selected from the group consisting of (1), (2), (3), and (4). In some cases, the processing station may be capable of operating during performance of each of (1), (2), (3), and (4). In some cases, the plurality of nucleic acid samples may be compatible with a common sequencing protocol

In some cases, the sequencing instructions may comprise instruction to draw the reagent from the first reservoir until the first reservoir is depleted below a predetermined threshold, then to draw the reagent from the second reservoir. In some instances, (4) comprises replacing or replenishing a reservoir from the first reservoir and the second reservoir that is depleted below a predetermined threshold.

In some cases, the system may be further configured to (A) receive (1) the plurality of nucleic acid samples, including the nucleic acid sample, in the sample station and (2) a plurality of substrates, including the substrate, in the substrate station; and (B) receive, by the one or more processors, user instructions to start two or more sequencing cycles. In some cases, the two more sequencing cycles may comprise at least 5, at least 10, or at least 20 sequencing cycles In some cases, the system may be further configured to (C) in a first sequencing cycle, process a first nucleic acid sample from the plurality of nucleic acid samples on a first substrate of the plurality of substrates; and (D) during or subsequent to the first sequencing cycle, in a second sequencing cycle, process a second nucleic acid sample from the plurality of nucleic acid samples on a second substrate of the plurality of substrates, where the second sequencing cycle may be configured to be performed in absence of additional user intervention.

In some cases, the system may be capable of continuous operation for more than 10 days with human intervention at intervals of not less than 18 hours. In some cases, the system may be capable of continuous operation for more than 10 days with human intervention at intervals of not less than 18 hours.

The sample station 1501 may be configured to receive and/or supply a sample to the sample loading station 1510. The sample loading station 1510 may increase throughput of the sequencing systems described elsewhere herein, by isolating the process of loading one or more samples onto a substrate and dispensing sequencing reagents onto the substrate. A sample may comprise an analyte. For example, the sample may be a nucleic acid sample comprising a nucleic acid molecule (e.g., a deoxyribonucleic acid (DNA) or ribonucleic acid (RNA) molecule or a plurality of DNA and/or RNA molecules). In some examples, a sample may comprise a plurality of supports such as beads which may have one or more nucleic acid molecules (e.g., DNA and/or RNA molecules) immobilized thereon (e.g., on their surface). The sample may be according to the descriptions provided elsewhere herein. In some examples, the sample may undergo pre-processing prior to being supplied to or loaded on the sequencing system 1500. For example, a sample may be subjected to a polymerase chain reaction (PCR) (e.g., emulsion PCR or “ePCR”) prior to being received by the sample stations or a tube thereof.

The sample station may comprise or be configured to receive a plurality of samples, such as a plurality of nucleic acid samples (e.g., as described herein). For example, a sample may be provided in a tube, well, cartridge, compartment in the sample station, or any other container that is capable of isolating a sample from other samples. In some cases, a sample may be provided on a support (e.g., as described herein).

In some instances, the sample station may comprise or be configured to receive at least about 1, 2, 3, 4, 5, 6, 7, 8, 9, 10, 20, 30, 40, 50, 60, 70, 80, 90, 100, 200, 300, 400, 500 or more samples. Alternatively or additionally, the sample station may comprise or be configured to receive at most about 500, 400, 300, 200, 100, 90, 80, 70, 60, 50, 40, 30, 20, 10, 9, 8, 7, 6, 5, 4, 3, 2, or 1 sample. In some instances, a sample may be derived or associated with a sample origin. In some instances, multiple samples may be derived or associated with the same sample origin. In some instances, a sample may be derived or associated with multiple sample origins. Multiple samples may be configured to be analyzed simultaneously (e.g., as described herein). For example, multiple samples may be configured to be included on a same support, such as a same array (e.g., substantially planar array). Such samples may be spatially separated on a support (e.g., at predefined spatial locations such as individually addressable locations, which locations may comprise wells and/or spatial patterning) and/or may be indexed using labels, barcodes, or other indices. Alternatively or additionally, samples may be configured to be analyzed separately.

Provided herein are systems and methods for loading a sample from the sample station 101. A sample may undergo one or more preparation (e.g., pre-processing) operations, such as one or more amplification reactions (e.g., one or more PCR processes, such as one or more ePCR processes), prior to input to the sample station. For example, the sample input to the sample station may be provided in a tube, as described elsewhere herein. The sample may comprise a plurality of particles (e.g., beads) in a solution, wherein a particle (e.g., bead) comprises a plurality of nucleic acid molecules coupled thereto (e.g., immobilized thereon). In some cases, each bead in the sample may comprise a distinct colony of amplification products (e.g., from PCR). In some cases, a sample may undergo one or more preparation operations such as one or more amplification reactions subsequent to input to the sample station and/or loading onto the substrate. For example, on-surface amplification may be performed on the surface of the substrate. The sample (e.g., via, or with aid of the tube) may be transferred to a substrate (e.g., a wafer), and may be dispensed over the substrate. In some cases, after dispensing, the sample may be given some time to settle on the substrate prior to performing further operations. Such time (e.g., incubation time or settlement time) may be at least about 1 minute (min), 5 min, 10 min, 15 min, 20 min, 25 min, 30 min, 40 min, 50 min, 60 min (1 hour (hr)), 70 min, 80 min, 90 min, 100 min, 120 min (2 hrs), or longer. The settlement time may allow the sample to couple with (e.g., immobilize thereon) the surface of the substrate (e.g., wafer).

A sample loading process on the sequencing system 1500 may comprise providing and/or using a variety of systems, methods, and/or techniques. A sample loading station 1510 may comprise an interface such as a transport line, such as a pipe, tube, nozzle, capillary, duct, channel, conduit, canal, line, print head, or any other piece, device, equipment, or object which may be configured to receive, move, transport, and/or deliver the sample (e.g., to a substrate).

### Sample Loading Station

In some cases, a sample loading station 1510 may be configured to dispense a sample solution onto a surface of a substrate, in some cases as bulk solution or as one or more droplets. In some instances, the sample loading station may comprise one or more dispensing nozzles configured to dispense nucleic acid samples to a substrate. In some instances, the sample loading station may comprise a print head 800 in addition to or in place of a fluid dispenser 810 (e.g., comprising one or more dispensing nozzles) to load samples onto a substrate 808, as seen in FIGS. 8A-8B and 9A. In some cases, the fluid dispenser 810 may dispense reagents 804, described elsewhere herein, as a continual stream of reagents. In some instances, the sample loading station may comprise one or more print heads 800, as seen in FIG. 9A. In some cases, the print head 800 may comprise one or more print head nozzles 802 configured to dispense the one or more sample droplets on a substrate 808. In some cases the one or more print head nozzles 802 may comprise ink-jet printing nozzles. In some instances, the one or more droplets may comprise one or more nucleic acid molecules coupled to one or more beads, described elsewhere herein.

The print head 800 may be configured to translate 816 in at least 1 dimension, at least 2 dimensions, or at least 3-dimensions. In some instances, the translation of the print head may occur in a plane parallel to the substrate 808. In some instances, the translation of the print head may comprise a linear or non-linear translation in a plane orthogonal to the one or more print head nozzles of the print head. The print head 800 may be configured to dispense one or more sample droplets 818 on a substrate 808 while translating across the substrate 808. In some cases, the substrate 808 may rotate while the print head 800 is translating and dispensing the one or more sample droplets 818 on the substrate. In some instances, the print head may move radially toward or away from a rotational axis of the surface as the print head dispenses one or more droplets.

The print head 800 may dispense one or more sample droplets 818 onto a substrate with both liquid volume control and spatial control. In comparison to the fluid dispenser 810, the print head provides an unexpected benefit of limiting sample waste. Excess dispensed fluid (e.g., reagents 804) may spill over an edge of the substrate 808 when the substrate 808 and chuck 806 are rotated 814 by a rotor 812. In contrast, the droplet volume control and spatial dispensing control provided by use of print head 800 can limit the amount of sample dispensed on the substrate and so avoid dispensing excess fluid that could spill over the edge of the substrate 808 and hence be wasted.

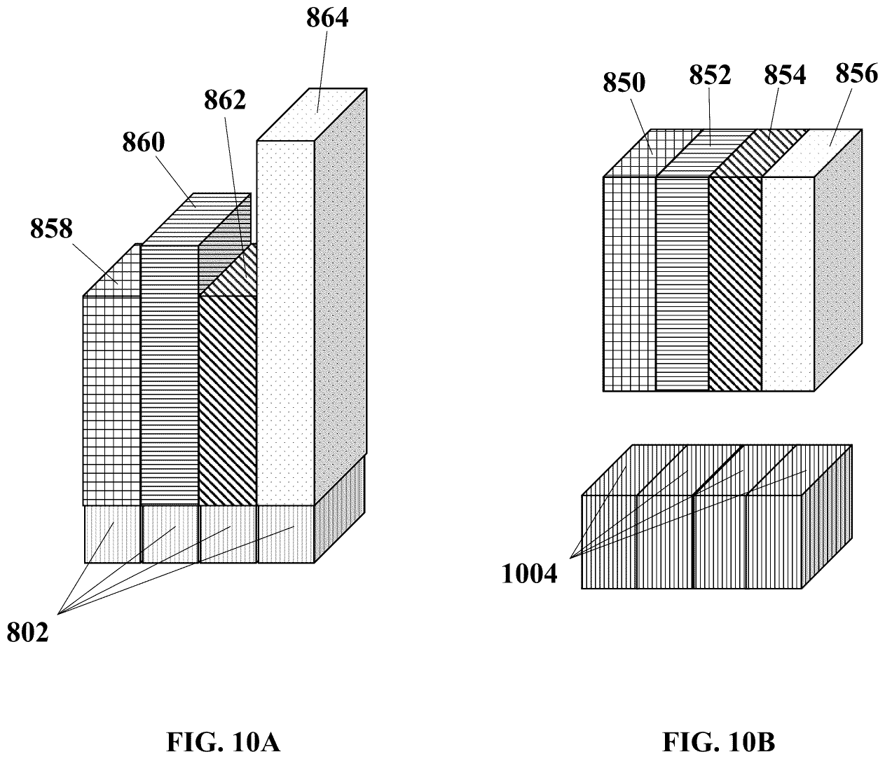

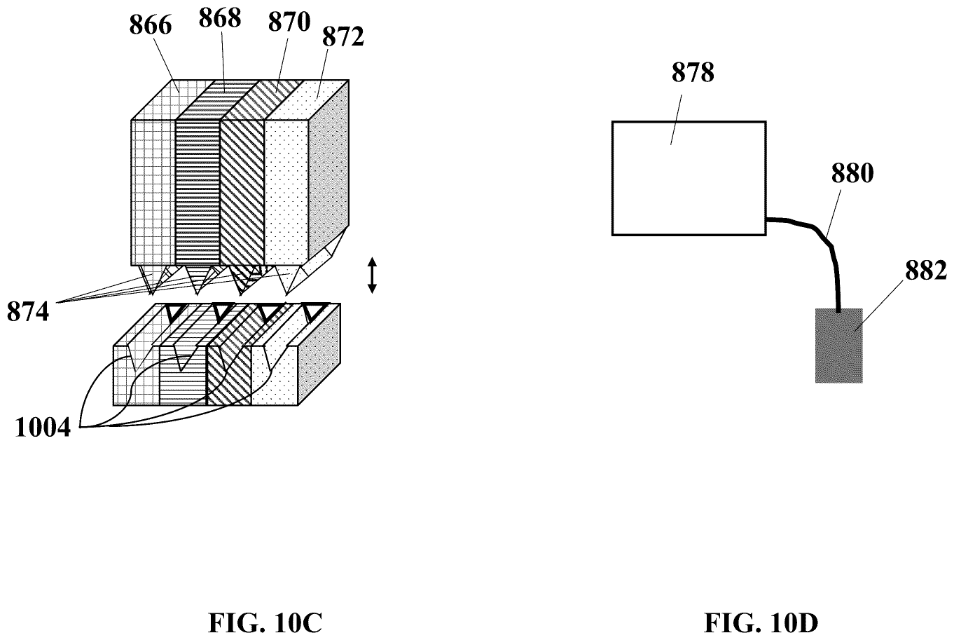

The print head 800 may comprise one or more printer cartridges (850, 852, 854, 856) as seen in FIGS. 9B and 10A-10C. The one or more printer cartridges (850, 852, 854, 856) may comprise one or more samples in solution, as described elsewhere herein. In some cases, the one or more printer cartridges (858, 860, 862, 864) may comprise printer cartridges of varying liquid volume holding capacity and size, as seen in FIG. 10A. In some instances, the one or more printer cartridges may comprise thermal heating and/or cooling mechanisms to regulate the temperature of the cartridge samples. In some cases, the printer cartridges may hold. In some cases, the one or more printer cartridges (850, 852, 854, 856) may be modular such that a printer cartridge of the plurality of printer cartridges may be removed and replaced without having to remove or replace all of the plurality of printer cartridges. In some cases, the one or more printer cartridges (850, 852, 854, 856) may be configured to interface with one or more print head nozzle receptacles 1004, as seen in FIG. 10B. In some instances, the one or more print head nozzles 802 may comprise the one or more print head nozzle receptacles 1004, as seen in FIGS. 10B and 10C. In some cases, the one or more printer cartridges (850, 852, 854, 856) may be configured to releasably couple to the one or more print head nozzle receptacles 1004. In some cases, the one or more printer cartridges (866, 868, 870, 872) may comprise a coupling feature 874 configured to releasably couple to the one or more print head nozzle receptacles 1004.

In some cases, the print head 882 may be in fluidic communication with a reagent source 878, as seen in FIG. 10D. In some instances, the fluidic interface 880 between the print head 882 and the reagent source 878 may comprise a tube, line, capillary, duct, channel, conduit, canal, or any combination thereof fluidic interface. In some cases, the reagent source 878 may be housed in the sample station, described elsewhere herein. In some instances, the reagent source 878 may comprise one or more cartridges of samples. The one or more cartridges may be replaceable, modular, and/or refillable.

The sample may be dispensed onto the substrate in the sample loading station 1510 according to any reagent dispense mechanism described elsewhere herein.

In some instances, the sample loading station 1510 may comprise a lid, where the lid comprises a seal that is configured to seal a chamber enclosing the substrate and one or more dispensing nozzles. In some cases, the lid may comprise a sealable slot configured to provide access of the one or more dispensing nozzles into the chamber to dispense the nucleic acid sample onto a substrate. The seal may comprise a hermetic seal. The lid may help prevent evaporation and even out the sample film thickness across the substrate. In some cases, the lid may be used to seal the chamber during incubation of the sample after the sample is loaded on the substrate. In some cases, the lid may be held stationary while the substrate is rotated during incubation. The chamber may comprise humidity and/or temperature control. The lid may help maintain and seal a local environment within the chamber, such as the humidity and/or temperature range.

In some cases, the sample loading station may comprise a washing station configured to wash the one or more dispensing nozzles.

The methods and systems may comprise a robotic interface and software to perform sample receipt and delivery.

In some cases, the system may be compatible for use by a human operator. In some cases, a human operator may not be needed for performing the methods. In some cases, the methods and systems may be partially or fully automated. A sequencing system may comprise a system or mechanism for cleaning, decontaminating, and/or sanitizing all or a portion of the loading system that may be used to transfer sample material to a location for subsequent processing. For example, the system may include a mechanism for cleaning, decontaminating, and/or sanitizing a channel, capillary, duct, conduit, canal, print head, nozzle, line, or other material used to transfer sample material to a location for subsequent processing.

In some examples, sample loading on the system may be performed in one step. Alternatively, sample loading may be performed in more than one step. For example, sample loading may be performed in at least 1, 2, 3, 4, 5, 6, 7, 8, 9, 10, or more steps. For example, a first sample may be transferred to a location for analysis (e.g., a location including a substrate such as a wafer) in a first step and a second sample may be transferred to a location for analysis (e.g., the same or a different location) in a second step. In another example, a first sample may be transferred to a location for analysis (e.g., a location including a substrate such as a wafer) and a second sample may be transferred to a location for analysis (e.g., the same or a different location) in a same step (e.g., simultaneously and/or in a coordinated fashion).

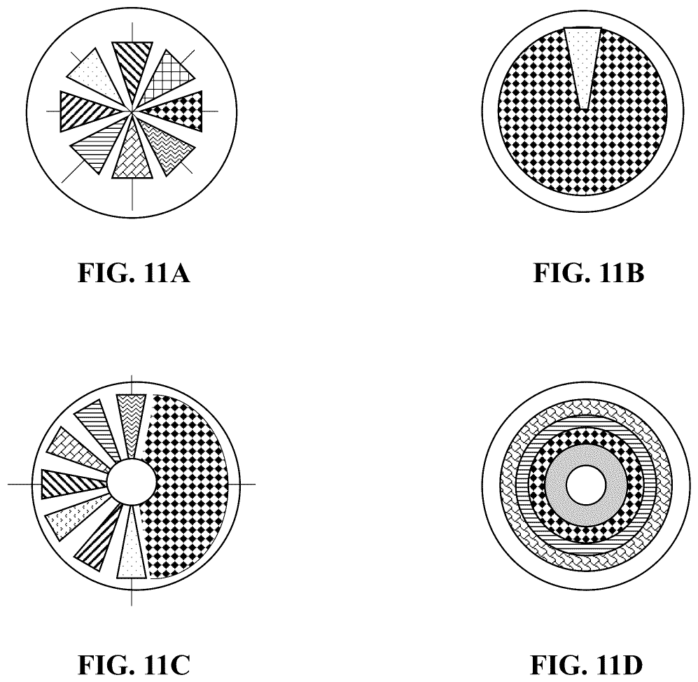

In some cases, sample loading and/or reagent dispensing may comprise one or more feedback systems, such as involving monitoring (e.g., imaging) and control feedback. In an example, a sample or a portion thereof may be loaded on the substrate. For example, a sample comprising particles (e.g., beads) with nucleic acid molecules and/or reagents may be dispensed onto a substrate (e.g., wafer) with various predetermined patterns, as seen in the examples of FIGS. 11A-11D. In some cases, the patterned surface may comprise samples and/or reagents in spatially discrete zones (FIG. 11A), a mixture of spatially discrete zones and circular sectors (FIGS. 11B-C), or one or more concentric rings (FIG. 11D). In some cases, the sample and/or reagent patterned surface (FIGS. 11A-11D) may comprise one or more different samples (e.g., beads coupled to nucleic acid molecules) and/or one or more different reagents provided in one or more spatially discrete zone. In some instances, the one or more spatially discrete zones may be configured for individual sequencing runs.

In some cases, a method of dispensing spatially discrete droplets is provided herein. In some cases the method may comprise: (a) dispensing a droplet onto a surface of a substrate using a printer head, where the droplet comprises an analyte coupled to a bead; and (b) subjecting the substrate comprising the droplet thereon to rotation, where (b) is performed during or subsequent to (a). In some instances, the method may comprise the steps of: (a) dispensing (i) a first set of droplets onto a surface of a substrate in a first dispensing pattern using a printer head, where a first droplet of the first set of droplets comprises a first analyte coupled to a first bead, and (ii) a second set of droplets onto the surface of the substrate in a second dispensing pattern using the printer head that is different than the first dispensing pattern, where a second droplet of the second set of droplets comprises a second analyte coupled to a second bead; and (b) subjecting the substrate comprising the first droplet and the second droplet thereon to rotation, where (b) is performed during or subsequent to (a). In some cases, the print head may comprise one or more print head nozzles. In some cases, the one or more print head nozzles, described elsewhere herein, may be configured to dispense the first droplet, the second droplet, or both.

In some cases, the first dispensing pattern may be substantially the same as the second dispensing pattern. In some instances, the first dispensing pattern may be a spiral, the second dispensing pattern may be a spiral, or both. In some cases, the first dispensing pattern may not spatially overlap with the second dispensing pattern. Alternatively, the patterns can spatially overlap. In some instances, the first dispensing pattern may comprise a sector of a circle, the second dispensing pattern may comprise a sector of a circle, or both. In some cases, the first dispensing pattern and the second dispensing pattern may comprise concentric rings.

In some instances, the one or more print head nozzles, described elsewhere herein, may be configured to translate linearly or non-linear in a plane parallel to the substrate when dispensing the first droplet. In some cases, the substrate may be configured to translate linearly or non-linearly in a plane orthogonal to the one or more print head nozzles of the printer head when dispensing the first droplet.

In some cases, the printer head may comprise one or more cartridges, as described elsewhere herein. The one or more cartridges may comprise one or more of a first droplet solution, a second droplet solution, a first reagent, and a second reagent. The one or more cartridges may comprise more than two solutions, and/or more than two reagents. In some instances, the one or more cartridges may maintain a first temperature of the first droplet solution. In some cases, the one or more cartridges may comprise a cleaning solution configured to clean the one or more print head nozzles. In some cases, the cleaning solution may comprise bleach. In some instances, the one or more cartridges may further comprise an antimicrobial agent. The antimicrobial agent may comprise metal salts of hydrazoic acid sodium azide, metal salts of hydrofluoric acid, sodium fluoride, benzalkonium chloride, or any combination thereof. In some cases, the one or more print head nozzle may be configured to increase the first temperature of the first droplet solution to a second temperature prior to dispensing the first droplet. In some cases, an environment surrounding the one or more print head nozzles or the substrate may increase the first temperature of the first droplet when the first droplet is dispensed. In some cases, the one or more cartridges may be replaceable, disposable, refillable, or any combination thereof.

In some cases, the method may further comprise (c) rotating the substrate along a rotational axis of the substrate for a first duration of time and (d) stopping the rotating for a second duration of time. In some instances, (c) and (d) may be repeated at least two times, at least three times, at least four times, or more. In some cases the method may further comprise translating the substrate in a plane parallel to the substrate for a first duration of time and (d) stopping the translating for a second duration of time. In some instances, the method may further comprise (c) vibrating the substrate for a first duration of time. In some cases, the method may further comprise (c) translating the substrate such that the translating comprises a non-zero derivative of an acceleration of the substrate. Such movements of the substrate (e.g., oscillation of rotation and stop cycles, vibrating, translating, etc.) may even out the solution film layer dispensed on the substrate surface.

In some cases, the method may further comprise (c) exposing the first droplet and the second droplet dispensed onto the surface of the substrate to an environment for a period of time thereby reducing a thickness of a film formed by said dispensed first and second droplet. In instances, the method may further comprise (c) covering the surface of the substrate with a cover. The cover may be disposable, cleanable, reusable, or any combination thereof. In some cases, the method may further comprise (d) rotating the substrate while holding the cover station

A data set indicative of the status of loading may be collected from such load or loading operation. The data set may comprise any format, such as a signal, an image, or any other data type which may be capable of providing information about the status of the load, for example, information with respect to whether and how efficiently the beads have been properly loaded in predefined locations or areas, or other information indicative of the efficiency or quality of the load (e.g., first load). The data or information may be programmatically or manually analyzed to make decisions about the subsequent loads or subsequent loading steps. Adjustments to the subsequent loading procedures may be made as appropriate, and a subsequent loading process may be performed. For example, an operator may observe and evaluate the data (e.g., via a user interface) and make the decision about the subsequent load. Alternatively, the system may be automated in whole or in part. For example, the system may comprise an automated monitoring and control scheme which may provide feedback to the system for the subsequent loads or steps. The open substrate described in further detail elsewhere herein may facilitate flexibility and convenience for loading according to the methods provided herein.

The sample loading station may perform one or more additional operations subsequent to loading the sample. For example, the sample loaded onto the substrate in the sample loading station may be single-stranded nucleic acid molecules (e.g., directly or via supports, such as beads). In the sample loading station, sequencing primers may be hybridized to the single-stranded nucleic acid molecules. In the sample loading station, sequencing reagents such as polymerases may be bound to the sample. In some cases, the sample loaded onto the substrate in the sample loading station may be double-stranded nucleic acid molecules (e.g., directly or via supports, such as beads). In the sample loading station, the double-stranded nucleic acid molecules may be denatured to generate single-stranded nucleic acid molecules immobilized to the substrate, such as by treating with NaOH or other denaturing agent and/or applying heat. Any one or more operations of the chemistry or processing station may be performed in the sample loading station.

In some cases, provided herein is a method of coating a substrate with a thick film of liquid after loading a substrate with a sample prior to transporting the sample-loaded substrate to the processing station. Coating the substrate with a thick film of liquid sample may prevent drying on the wafer (e.g., drying of the sample on the wafer) as well as contamination of the wafer from external elements. The method may comprise the steps of: (a) providing a substrate in a sample loading station; (b) loading a nucleic acid sample onto a surface of the substrate in the sample loading station, where the nucleic acid sample comprises one or more nucleic acid molecules coupled to one or more beads; (c) coating the surface of the substrate with a coating solution, to provide a coated surface; and (d) transporting the substrate with the coated surface to a processing station. In some instances, the substrate may comprise a wafer. In some instances, the substrate is provided to the sample loading station via a mechanical interface. In some cases the substrate is transported from the sample loading station to the processing station via a mechanical interface. In some cases, the coating solution may be a washing solution or buffer used during sequencing. The coating solution may comprise any solution or buffer that does not affect the integrity of the sample for downstream processing (e.g., sequencing). Alternatively, the sample-loaded substrate may be transported from the sample loading station to the processing station without coating the sample-loaded substrate. One or more actuators, such as a robotic arm may be configured to pick up and/or transport the substrate between different stations.

In some instances, the coating solution may comprise a thickness of about 90 micrometers (μm) to about 240 m. In some instances, the coating solution may comprise a thickness of about 90 μm to about 95 μm, about 90 μm to about 100 μm, about 90 μm to about 120 μm, about 90 μm to about 140 μm, about 90 μm to about 160 μm, about 90 μm to about 180 μm, about 90 m to about 200 μm, about 90 m to about 220 μm, about 90 m to about 240 μm, about 95 μm to about 100 μm, about 95 μm to about 120 μm, about 95 μm to about 140 μm, about 95 μm to about 160 μm, about 95 μm to about 180 μm, about 95 μm to about 200 μm, about 95 μm to about 220 μm, about 95 μm to about 240 μm, about 100 m to about 120 μm, about 100 μm to about 140 μm, about 100 m to about 160 μm, about 100 m to about 180 μm, about 100 μm to about 200 μm, about 100 μm to about 220 μm, about 100 μm to about 240 μm, about 120 m to about 140 μm, about 120 m to about 160 μm, about 120 m to about 180 μm, about 120 μm to about 200 μm, about 120 μm to about 220 μm, about 120 μm to about 240 μm, about 140 μm to about 160 μm, about 140 μm to about 180 μm, about 140 μm to about 200 μm, about 140 m to about 220 μm, about 140 m to about 240 μm, about 160 m to about 180 μm, about 160 m to about 200 μm, about 160 μm to about 220 μm, about 160 μm to about 240 μm, about 180 μm to about 200 μm, about 180 μm to about 220 μm, about 180 μm to about 240 μm, about 200 μm to about 220 μm, about 200 μm to about 240 μm, or about 220 μm to about 240 μm. In some instances, the coating solution may comprise a thickness of about 90 μm, about 95 μm, about 100 μm, about 120 μm, about 140 μm, about 160 μm, about 180 μm, about 200 μm, about 220 μm, or about 240 μm. In some instances, the coating solution may comprise a thickness of at least about 90 μm, about 95 μm, about 100 μm, about 120 μm, about 140 μm, about 160 μm, about 180 μm, about 200 μm, or about 220 μm. In some instances, the coating solution may comprise a thickness of at most about 95 μm, about 100 μm, about 120 μm, about 140 μm, about 160 μm, about 180 μm, about 200 μm, about 220 μm, or about 240 μm. The thickness may be at least or at most any of the above listed thicknesses. The thickness may be less than 90 μm or greater than 240 μm.

In some cases, the substrate comprising the coated surface may further comprise a dry surface where the dry surface does not comprise the nucleic acid sample or the coating solution. The dry surface may provide better than expected results of preventing contamination that may arise from the mechanical interface coming into contact with the wet substrate. Providing a dry region for the mechanical interface to come into contact reduces the potential for any contaminants on the mechanical interface originating from one substrate to be transferred over to another substrate. In some cases, the mechanical interface may comprise a mechanical arm. The dry surface portion can occupy any portion of the substrate, such as a center portion (e.g., proximal to a central axis) of the substrate or a peripheral portion (e.g., proximal to an outer edge) of the substrate. In some instances, the method may comprise the (e) sanitizing the mechanical interface prior to and/or after transferring the substrate between the substrate station and the sample loading station and/or between the sample loading station and the processing station. In some cases, the method may comprises (f) washing a tubing of the sample loading station in fluidic communication with the nucleic acid sample by introducing a cleaning solution through the tubing. In some instances, the cleaning solution may comprise a bleach solution. In some cases, the processing station may comprise a chemical station, a detection station, or any combination thereof.

### Non-Contact Heating of Substrates

Any substrate handling station, such as the sample loading station, processing station, detection station, or new station which receives a substrate during one or more operations, may comprise a non-contact heater. The non-contact heater may heat the substrate, a surface of the substrate, and/or local environment surrounding the substrate without contacting the substrate. The system may comprise a single non-contact heater that is located at a single station, or which is moved around multiple stations (e.g., via actuators or robot arms or manually). The system may comprise a plurality of non-contact heaters that are located at a single station or at multiple stations, which may or may not be moved between stations. The non-contact heater may be fixed at a location within a station and/or be configured to move to different locations within a station. For example, at a first point in time the non-contact heater may be at a first location in a first station that is relatively far from a near vicinity of the substrate to allow other handlers or operating units (e.g., nozzles, detectors, etc.) to interact with the substrate, and at a second point in time the non-contact heater may be moved to a second location in the first station that is relatively closer to the substrate for heating of the substrate. In some cases, the non-contact heater may be configured to move along a z-axis (up and down), such that it is lifted when it needs to be out of the way and lowered when it is heating the substrate. In some cases, a heating efficiency of the non-contact heater may increase as the distance between the non-contact heater and the substrate decreases. The non-contact heater may have a non-heating position(s) (when heating mode is off) and a heating position(s) (when heating mode is on). One or more actuators may move the non-contact heater between the different positions.

In some cases, the non-contact heater may operate simultaneously while other handlers or operating units are operating. In some cases, the non-contact heater may operate at different times than when the other handlers or operating units operate.

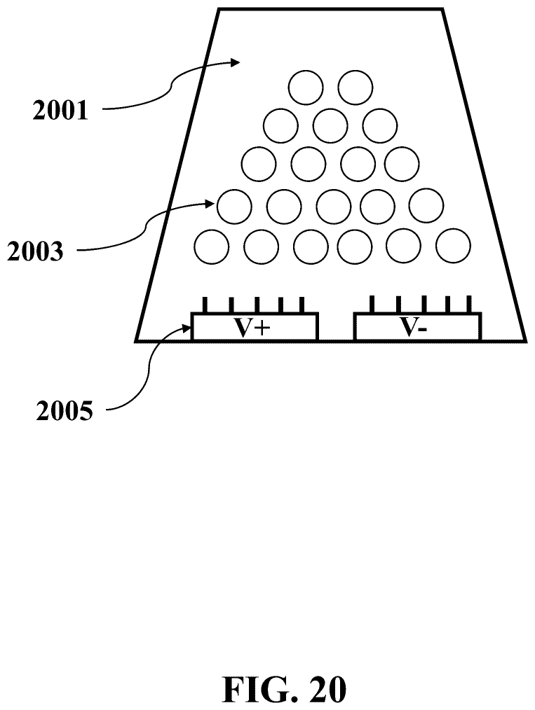

The non-contact heater may be configured for optical heating. The non-contact heater may comprise a plurality of light-emitting diodes (LEDs) configured to direct light (e.g., radiation) towards the substrate surface. The plurality of LEDs may be mounted on a printed circuit board (PCB) or other surface. The mounting surface may comprise heat sinks for thermal management. The plurality of LEDs may be arranged in a regular array, arbitrarily, or in any useful pattern to effect heating. For example, the plurality of LEDs may be arranged in a rectangular array where its length is disposed radially with respect to a rotational axis of the substrate such that when the non-contact heater is turned on as the substrate rotates, each radial portion of the substrate passes underneath the non-contact heater during rotation. In another example, the plurality of LEDs may be arranged in a wedge-like shape, as shown in FIG. 20. The plurality of LEDs may be arranged in any shape. Each LED, subsets of LEDs (e.g., a zone of LEDs), or all LEDs may be controlled by one or more controllers, such as to power on or off, or to adjust intensity, wavelength, and/or another characteristic of light emitted by the LEDs. The LEDs may generate light at any wavelength range. The LEDs may generate light in the ultraviolet, visible, or infrared light range. In some cases, the LEDs generate red light or green light. In some cases, the LEDs may generate light at a wavelength between 400˜2000 nanometers (nm). FIG. 20 illustrates a top view of a non-contact heater. An example PCB 2001 may comprise a plurality of LEDs 2003 with power connection 2005. The PCB 2001 may comprise dielectric and copper traces. The plurality of LEDs may be arranged in different zones, where each zone comprises a subset of one or more LEDs (in series), and each zone may be powered in parallel or individually. A single LED may have any radiant power, for example, at least and/or at most about 0.1, 0.2, 0.3, 0.4, 0.5, 0.6, 0.7, 0.8, 0.9, 1.0, 1.1, 1.2, 1.3, 1.4, 1.5, 1.6, 1.7, 1.8, 1.9, 2.0, 3.0, 4.0, 5.0, 6.0, 7.0, 8.0, 9.0, 10, 20, 30, 40, 50, 60, 70, 80, 90, 100, 150, 200, 250, 300, 350, 400, 450, 500 Watts (W) or more. The plurality of LEDs may have any amount of combined radiant power, for example, at least and/or at most about 0.1, 0.2, 0.3, 0.4, 0.5, 0.6, 0.7, 0.8, 0.9, 1.0, 1.1, 1.2, 1.3, 1.4, 1.5, 1.6, 1.7, 1.8, 1.9, 2.0, 3.0, 4.0, 5.0, 6.0, 7.0, 8.0, 9.0, 10, 20, 30, 40, 50, 60, 70, 80, 90, 100, 150, 200, 250, 300, 350, 400, 450, 500, 600, 700, 800, 900, 1000, 1100, 1200, 1300, 1400, 1500, 1600, 1700, 1800, 1900, 2000, 3000, 4000, 5000, 6000, 7000, 8000, 9000, 10,000 Watts (W) or more. A non-contact heater may comprise any number of LEDs, such as 1, 2, 3, 4, 5, 6, 7, 8, 9, 10, 11, 12, 13, 14, 15, 16, 17, 18, 19, 20, 30, 40, 50, 60, 70, 80, 90, 100, 110, 120, 130, 140, 150, 160, 170, 180, 190, 200, 210, 220, 230, 240, 250, 260, 270, 280, 290, 300, 400, 500, 600, 700, 800, 900, 1000 or more LEDs. A zone of LEDs on the PCB may comprise any number of LEDs. Different zones may have the same number or different numbers of LEDs. Beneficially, different zones of one or more LEDs may be controlled (e.g., turned on/off, adjusted for wavelength, intensity, etc.) to heat different sections of the substrate corresponding to the different zones.

Accordingly, a method for non-contact heating may comprise: (a) providing a substrate surface and a non-contact heater, wherein said non-contact heater comprises a surface comprising a plurality of LEDs mounted thereto; (b) positioning the non-contact heater above the substrate surface such that the plurality of LEDs are configured to direct light to the substrate surface; and (c) activating at least a subset of the plurality of LEDs to direct light to the substrate surface. The non-contact heater may be lowered into the heating position from a non-heating position. The non-contact heater may be otherwise moved into a heating position from a non-heating position. One or more controllers may individually or in combination activate at least the subset of plurality of LEDs to direct light to the substrate surface. A system for non-contact heating may comprise: (a) a substrate comprising a substrate surface; (b) a non-contact heater, wherein said non-contact heater comprises a surface comprising a plurality of LEDs mounted thereto; and (c) one or more controllers individually or in combination configured to activate at least a subset of the plurality of LEDs to direct light towards the substrate surface. The system may further comprise one or more actuators configured to move the non-contact heater from a non-heating position to a heating position, and/or vice versa.

In some cases, a chuck with low thermal conductivity may be used to focus the majority of the heat transfer to the substrate only, instead of sharing the heat with the chuck. The low thermal conductivity chuck may significantly reduce power requirements of the non-contact heater (or other heating mechanism where heat is directed first to the substrate). In some cases, the thermal conductivity of a chuck may be at most about 200, 190, 180, 170, 160, 150, 140, 130, 120, 110, 100, 90, 80, 70, 60, 50, 40, 30, 20, 10, 9, 7, 6, 5, 4, 3, 2, 1, 0.9, 0.8, 0.7, 0.6, 0.5, 0.4, 0.3, 0.2, 0.1 Watts per meter-Kelvin (W/mK) or less. As an example, a zirconia-material chuck has a lower thermal conductivity of about 3 W/mK compared to that of a SiC-material chuck which has a higher thermal conductivity of about 180 W/mK. In some cases, a substrate with high absorptivity and/or low reflectivity for the radiation from the non-contact heater may be selected. In some cases, the substrate may comprise a fluid film thereon, which fluid film may be selected or adjusted to have high absorptivity and/or low reflectivity for the radiation from the non-contact heater. For example, a radiation-absorbing dye (e.g., near infrared (NIR) dyes, NIR869A from QCR Solutions Corp, Crysta-Lyn water soluble dyes, sigmaaldrich IR-806, etc.) may be added to a water film to increase the absorptivity. In some cases, the substrate may comprise an additive or coating thereon, which additive or coating may be selected or adjusted to have high absorptivity and/or low reflectivity for the radiation from the non-contact heater. In some cases, the chuck and the substrate materials may be selected so that the respective temperatures of the chuck and the substrate equalize in at least about 0.5, 1, 2, 3, 4, 5, 6, 7, 8, 9, 10, 20, 30, 40, 50, 60, 70, 80, 90, 100, 110, 120, 130, 140, 150, 160, 170, 180, 190, 200, 210, 220, 230, 240, 250, 300, 350, 400, 450, 500, 1000 seconds or greater. A substrate may be configured to absorb at least about 5, 10, 15, 20, 25, 30, 35, 40, 45, 50, 55, 60, 65, 70, 75, 80, 85, 90, 95 percent (%) or greater of the energy output of the non-contact heater.

The non-contact heater may be activated (e.g., at least a subset of LEDs powered on) for any duration of time with any power output. The non-contact heater may be activated without interruption for any duration of time. The non-contact heater may be activated in pulses for any duration of time for individual pulses and for any total duration of time. The non-contact heater may be activated at a constant power output during a single activation. The non-contact heater may be activated at variable power output (e.g., increase from low to high, or high to low, or oscillate between high and low power outputs) during a single activation. For example, the non-contact heater may be activated for at least and/or at most about 1, 2, 3, 4, 5, 6, 7, 8, 9, 10, 11, 12, 13, 14, 15, 16, 17, 18, 19, 20, 30, 40, 50, 60, 70, 80, 90, 100, 110, 120, 130, 140, 150, 160, 170, 180, 190, 200, 210, 220, 230, 240, 250, 300, 350, 400, 450, 500, 1000, 2000, 3000 seconds or greater during a single pulse and/or during a single activation.

It will be appreciated that the non-contact heater may comprise, alternatively or in addition, a light source other than an LED, such as a laser, phosphor, etc.

The non-contact heater may be used during various operations or phases of sequencing using the open substrate systems described herein. For example, a method may comprise: heating a substrate comprising a plurality of double-stranded nucleic acid molecules immobilized thereto, using a non-contact heater, to denature the double-stranded nucleic acid molecules. A method may comprise: heating a substrate comprising a plurality of double-stranded nucleic acid molecules immobilized thereto in the presence of a plurality of sequencing primers, using a non-contact heater, to denature the double-stranded nucleic acid molecules to generate a plurality of single-stranded molecules immobilized to the substrate and hybridize sequencing primers of the plurality of sequencing primers to single-stranded molecules of the plurality of single-stranded molecules. In some cases, the methods may further comprise, loading the plurality of double-stranded nucleic acid molecules onto the substrate to immobilize the plurality of double-stranded nucleic acid molecules. In some cases, one or more double-stranded nucleic acid molecules may be immobilized to a support, such as a bead, which support is immobilized to the substrate. In some cases, a support comprises a plurality of double-stranded nucleic acid molecules which are derived from a same template molecule and/or are identical or substantially identical copies in a colony.

### Temperature Cycling Methods

Improving control of the substrate temperature during one or more operations can improve sequencing accuracy. For example, a lower substrate temperature during detection operations of a sequencing cycle results in higher brightness (e.g., higher signal intensity) measured from the probes (e.g., 5%-20% reduction in brightness as temperature increases from 30° C. to 50° C. depending on different system and chemistry parameters). In another example a higher substrate temperature during labeled nucleotide incorporation chemistry operations of a sequencing cycle results in faster incorporation. Thus, it may be beneficial to temperature cycle the substrate such that the substrate is at an optimal temperature or temperature range for different operations. In some cases, the substrate may be adjusted to a first temperature or temperature range during sequencing chemistry operations (e.g., nucleotide incorporation, label cleavage, etc.) and adjusted to a second temperature or temperature range during detection operations, where the first temperature or temperature range is higher than the second temperature or temperature range. In some cases, the substrate may be adjusted to a third temperature or temperature range during any operations that do not involve labeled nucleotide incorporation, where first temperature or temperature range is higher than the third temperature or temperature range, and the third temperature or temperature range is the same as or different than the second temperature or temperature range. The substrate may be heated and/or cooled during the temperature cycling.

The substrate may be actively or passively heated or cooled using one or more heating or cooling mechanisms, such as but not limited to using a non-contact heater as described elsewhere herein; dispensing reagents via a temperature-controlled fluidic pathway component (e.g., tubing, dispense nozzle, valve, other component) as described elsewhere herein; dispensing scan buffers in connection with a detector during detection; heating or cooling one or more of the chuck, sub-chuck, or theta stage that is directly or indirectly coupled to the substrate; flowing a temperature-controlled fluid between the substrate and the chuck; condensation or convection for heating; and evaporation or convection for cooling. The substrate temperature may be adjusted or maintained using a non-contact heater, from a distance, as described elsewhere herein. The substrate temperature may be adjusted or maintained using a nominal heat load, such as one or more fans, from a distance. The substrate temperature may be adjusted or maintained by dispensing a reagent at a controlled temperature, for example by dispensing a cold reagent to cool the substrate or dispensing a hot reagent to heat the substrate. In some cases, a wash buffer or solution may be dispensed at a controlled temperature or temperature range (hot or cold) to control the substrate temperature. Different parameters of the system may be adjusted to optimize control of the substrate temperature, such as wash solution temperature at point of dispense, volume of wash solution dispensed, RPM of the substrate at dispense, flow rate of the wash solution dispense, location(s) of the wash solution dispense, etc. In some cases, the temperature of a scan buffer which is used during detection with an objective, such as with an immersion objective, may be controlled to adjust or maintain the substrate temperature. In some cases, the temperature of one or more of the chuck, sub-chuck, and theta stage that is directly or indirectly coupled to the substrate may be controlled via heating, cooling, or rotating, to control the substrate temperature. The chuck may be coupled to the theta stage via a sub-chuck, which theta stage is configured to rotate the substrate on the chuck. In some cases, the theta stage may generate heat due to rotational motion. In some cases, the theta stage may be heated to level the temperature curve boundary condition and counteract large temperature fluctuations caused by rotation-generated heat. In some cases, the chuck may be heated on backboards. In some cases, the temperature of the sample processing environment, and/or that of the bowl and/or ceiling that define the sample processing environment, may be controlled to control the substrate temperature. In some cases, a temperature-controlled fluid such as water (e.g., tap water, DI water, etc.) may be flowed between the substrate and the chuck to control the substrate temperature. In some cases, a high temperature evaporation source, such as a heated floor, of the sample processing environment may raise or maintain a dew point and activate condensation when the substrate is colder than the dew point to heat the substrate. In some cases, a low temperature source (e.g., a pump generating pumped dry cool air) of the sample processing environment may lower or maintain a dew point and activate evaporation when the substrate is hotter than the dew point to cool the substrate.

A temperature-controlled reagent or wash solution, when dispensed, may have a temperature of at least and/or at most about 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 75, 80, 85, 90, 95, 99° C. or higher. For example, a reagent or wash solution of temperature of 25° C. or lower may be dispensed to cool the substrate. For example, a reagent or wash solution of temperature of 25° C. or higher may be dispensed to heat the substrate.

In some cases, a substrate may be heated only during labeled nucleotide incorporation operations and cooled for the remaining operations of the sequencing cycle, such as during unlabeled nucleotide incorporation (during a dark flow or chase flow), detection of signals, label cleaving, washing, and the like. In some cases, a substrate may be heated during nucleotide incorporation operations and cooled during imaging. Minimizing heating of the substrate to only certain operations may minimize the total time that the substrate is at high temperatures (e.g., about 50° C.) and further allow the temperature of the sample processing environment to stay cool relative to the high substrate temperature, which allows for more efficient downstream cooling of the substrate after the high temperature operations are completed. In some cases, only a subsection of the substrate surface, as opposed to the entire surface of the substrate, may be heated or cooled during a particular operation. For example, during imaging, only a small surface area immediately surrounding an objective may be cooled, such as by dispensing a low temperature scan buffer upstream of the objective. Adjusting the local temperature of only a subsection of the substrate surface may save energy requirements compared to adjusting the temperature of the entire substrate.

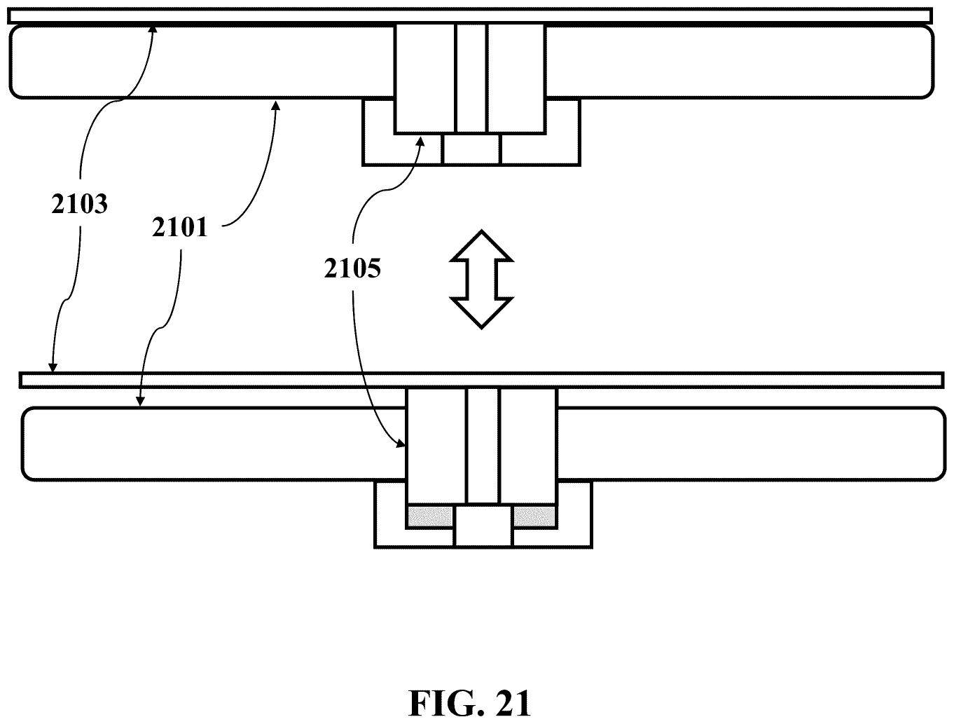

In some cases, a distance between the substrate and the chuck may be adjusted to control the substrate temperature. For example, raising the substrate farther from the chuck may increase thermal resistance between the substrate and chuck and effectively decouple the substrate temperature from the chuck temperature. Such decoupling allows for faster temperature cycling with less energy or power input. FIG. 21 illustrates a cross-sectional side view of a chuck and substrate assembly where the substrate-chuck distance is adjusted between the top and bottom schematics. In the top schematic, a substrate 2103 is affixed to a chuck 2101 under full vacuum pressure or flow. In the bottom schematic, a pad 2105 supporting the substrate 2103 is raised under partial vacuum pressure or flow to lift the substrate 2103 from the chuck 2101 at a certain distance. In some cases, a bottom of the pad may be coupled to a spring mechanism, where under full vacuum pressure or flow the spring potential is overcome and the substrate seals to the chuck as the pad is lowered, and where under less or partial vacuum pressure or flow the pad is raised from the chuck. A lifter may comprise a pad or other support and a spring mechanism that interact with the vacuum line of a vacuum chuck. It will be appreciated that the lifter may comprise another mechanism, e.g., actuator, configured to move the substrate relative to the chuck. In some cases, the lifter may be of a material with low thermal conductivity, such as a low thermal conductivity polymer or elastomer. The lifter may minimally change flatness or tilt of the substrate, which is not critical during non-detection operations.

### Substrate Station

The substrate station 1502 may be configured to supply a substrate to the processing station. In some cases, the substrate station may comprise a sealed environment. In some instances, the substrate station may comprise a hermetically sealed environment. In some cases, the substrate station may comprise a vacuum desiccator. The substrate station may comprise a plurality of substrates (e.g., wafers, as described herein). For example, a substrate may be provided in a rack (e.g., horizontal or vertical) in the sample station, or in any other structure that is capable of isolating a substrate from other substrates. A substrate may be provided on or configured to be provided on (e.g., in direct physical contact with) a stage, which stage may be translated, rotated, or otherwise moved automatically or upon user input (e.g., as described herein). A substrate may be configured to be levitated (e.g., magnetically levitated). A substrate may be configured to be contacted at a fixed number of points, such as at a center of the substrate (e.g., a center of a disc-shaped substrate) to facilitate rotation of the substrate. A substrate may comprise an opening (e.g., a hole), depression, or other physical feature to facilitate transfer and/or movement of the substrate within the system. For example, the substrate may comprise an opening or depression at a center of the substrate (e.g., a center of a disc-shaped substrate) configured to facilitate interaction between the substrate and a component of the system configured to stabilize and, in some cases, rotate or otherwise move the substrate, such as a rotatable element. A system may comprise a mechanism for moving a substrate from a storage location such as a rack to the processing station, which mechanism may comprise, for example, a robotic arm.

In some instances, the substrate station may comprise at least about 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 40, 50, or more substrates. Alternatively or additionally, the substrate station may comprise at most about 50, 40, 30, 29, 28, 27, 26, 25, 24, 23, 22, 21, 20, 19, 18, 17, 16, 15, 14, 13, 12, 11, 10, 9, 8, 7, 6, 5, 4, 3, 2, or 1 substrate. In some instances, the substrate station may comprise a uniform type of substrates. In some instances, the substrate station may comprise different types of substrates, such as differently patterned substrates, substrates comprising different materials, substrates of different sizes, etc.

### Reagent Station

In some cases, the reagent station 1503 may be configured to supply one or more reagents to the processing station 1504, where the reagent is supplied from a first reservoir or a second reservoir. In some instances, the one or more reagents may comprise a nucleotide solution, an enzyme solution, a cleavage solution, a washing solution, a buffer solution, a solution comprising any other one or more reagents configured to perform the methods described herein (e.g., amplification reagents, sequencing reagents, etc.), any non-solution forms thereof, and/or any combination thereof. The nucleotide solution may comprise adenine-containing nucleotides, cytosine-containing nucleotides, guanine-containing nucleotides, thymine-containing nucleotides, and uracil-containing nucleotides. In some cases, the nucleotide solution may comprise labeled, unlabeled, or any combination thereof.

In some instances, the reagent station and/or other station may comprise temperature controlled tubing in fluid communication with the first reservoir or the second reservoir. In some cases, one or more of a dispense nozzle, reagent cartridge, reagent reservoir, valve, or other component of a fluidic pathway from a reagent cartridge to the dispensing nozzle may be temperature controlled, such that a reagent passing through such component undergoes heat transfer (in or out). In some cases, one or more fluidic components, such as the tubing, may comprise insulation or the tubing may be insulated tubing to minimize heat loss as the reagent is directed through the tubing. In some cases, the temperature of said temperature-controlled tubing, dispense nozzle, or other component may be controlled on demand. By controlling a temperature of the reagents prior to and/or during delivery provides better than expected result of sequencing by maintaining appropriate temperatures of the substrate optimal for sequencing reactions. Additionally, such temperature control methods may provide advantages when conducting isothermal chemistry applications and/or other chemical reactions that require varying temperatures at varying times during the reaction.

In some instances, the temperature of the temperature-controlled component or reagent passing through such component is controlled within about 0.1 degrees Kelvin (K). In some cases, the temperature of the temperature-controlled component or reagent passing through such component is controlled within about 0.1 K to about 1.5 K. In some cases, the temperature of the temperature controlled component or reagent passing through such component is controlled within at most about 0.1 K to about 0.2 K, about 0.1 K to about 0.3 K, about 0.1 K to about 0.4 K, about 0.1 K to about 0.5 K, about 0.1 K to about 0.6 K, about 0.1 K to about 0.7 K, about 0.1 K to about 0.8 K, about 0.1 K to about 0.9 K, about 0.1 K to about 1 K, about 0.1 K to about 1.5 K, about 0.2 K to about 0.3 K, about 0.2 K to about 0.4 K, about 0.2 K to about 0.5 K, about 0.2 K to about 0.6 K, about 0.2 K to about 0.7 K, about 0.2 K to about 0.8 K, about 0.2 K to about 0.9 K, about 0.2 K to about 1 K, about 0.2 K to about 1.5 K, about 0.3 K to about 0.4 K, about 0.3 K to about 0.5 K, about 0.3 K to about 0.6 K, about 0.3 K to about 0.7 K, about 0.3 K to about 0.8 K, about 0.3 K to about 0.9 K, about 0.3 K to about 1 K, about 0.3 K to about 1.5 K, about 0.4 K to about 0.5 K, about 0.4 K to about 0.6 K, about 0.4 K to about 0.7 K, about 0.4 K to about 0.8 K, about 0.4 K to about 0.9 K, about 0.4 K to about 1 K, about 0.4 K to about 1.5 K, about 0.5 K to about 0.6 K, about 0.5 K to about 0.7 K, about 0.5 K to about 0.8 K, about 0.5 K to about 0.9 K, about 0.5 K to about 1 K, about 0.5 K to about 1.5 K, about 0.6 K to about 0.7 K, about 0.6 K to about 0.8 K, about 0.6 K to about 0.9 K, about 0.6 K to about 1 K, about 0.6 K to about 1.5 K, about 0.7 K to about 0.8 K, about 0.7 K to about 0.9 K, about 0.7 K to about 1 K, about 0.7 K to about 1.5 K, about 0.8 K to about 0.9 K, about 0.8 K to about 1 K, about 0.8 K to about 1.5 K, about 0.9 K to about 1 K, about 0.9 K to about 1.5 K, or about 1 K to about 1.5 K. In some cases, the temperature of the temperature controlled component or reagent passing through such component is controlled within about 0.1 K, about 0.2 K, about 0.3 K, about 0.4 K, about 0.5 K, about 0.6 K, about 0.7 K, about 0.8 K, about 0.9 K, about 1 K, or about 1.5 K. In some cases, the temperature of the temperature controlled component or reagent passing through such component is controlled within at least about 0.1 K, about 0.2 K, about 0.3 K, about 0.4 K, about 0.5 K, about 0.6 K, about 0.7 K, about 0.8 K, about 0.9 K, or about 1 K. In some cases, the temperature of the temperature controlled component or reagent passing through such component is controlled within at most about 0.2 K, about 0.3 K, about 0.4 K, about 0.5 K, about 0.6 K, about 0.7 K, about 0.8 K, about 0.9 K, about 1 K, or about 1.5 K.

In some cases, the reagent station may comprise one or more reagent reservoirs that receives and stores reagents from a reagent cartridge. In some cases, the reagent station may comprise a separate reagent reservoir for each type of reagent. The separate reagent reservoir may be dedicated to that type of reagent. Upon insertion of a reagent cartridge into the sequencing system, the reagent(s) in the reagent cartridge may be directed into the reagent reservoir(s), from which the reagent(s) may be subsequently sourced for various operations performed by the sequencing system, such as dispensing of nucleotides to a substrate (and/or dilution of reagents). Upon at least partial depletion or complete depletion of a reagent cartridge, the reagent cartridge may be removed and/or replaced with another reagent cartridge. Such removal and/or replacement may occur during operation of the sequencing system, as described elsewhere herein with respect to the processing station. Upon insertion of a new reagent cartridge, the reagent(s) in the new reagent cartridge may be directed into the reagent reservoir(s) before use.

In some instances, a first reagent may be transferred from a first reagent cartridge to a first reagent reservoir via a diaphragm pump. In some cases, the transfer of the first reagent is performed prior to dilution of the first reagent. That is, in some cases, the first reagent is diluted upon transfer into the first reagent reservoir (e.g., the first reagent reservoir already contains diluent or buffer or there is concurrent transfer of a diluent or buffer into the first reagent reservoir). In some cases, the first reagent is diluted in the first reagent cartridge prior to transfer into the first reagent reservoir (e.g., mixing of the first reagent and a diluent or buffer occurs within the first reagent cartridge). In some cases, the first reagent is diluted subsequent to transfer into the first reagent reservoir. In some such cases, the first reagent reservoir is filled partially or completely with a gas (e.g., air) prior to transfer of the first reagent.

### Processing Station

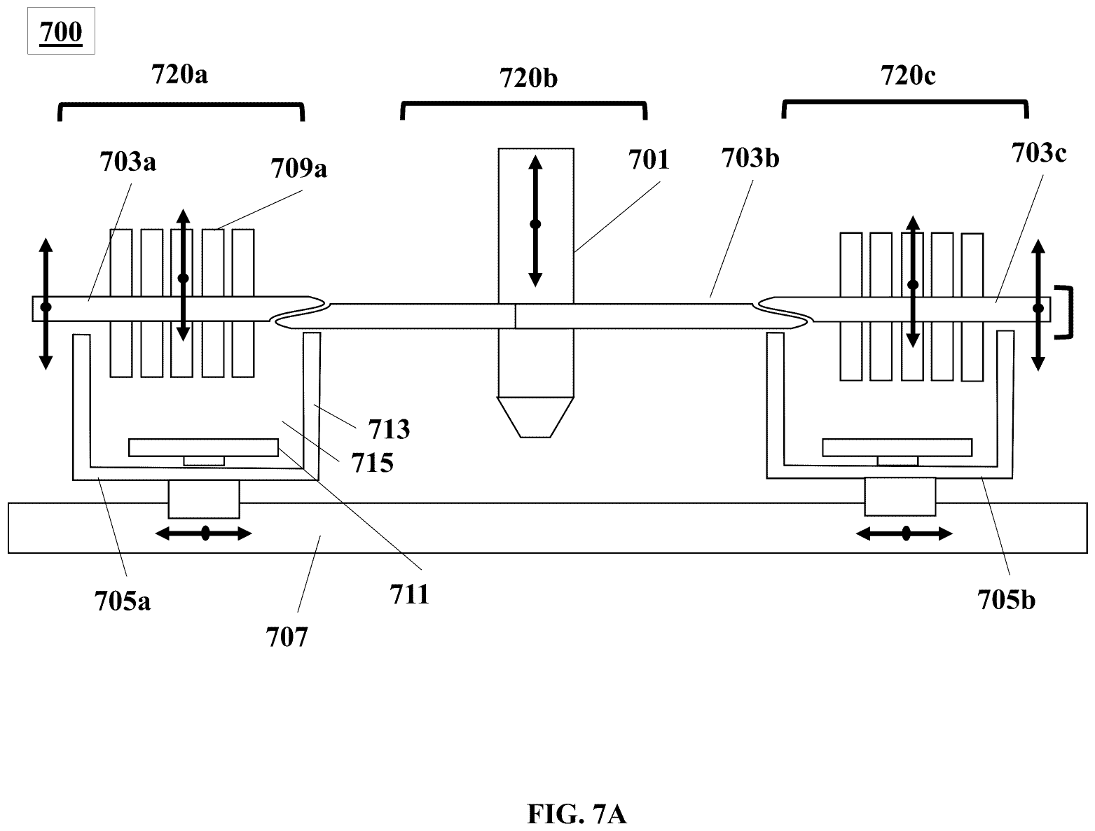

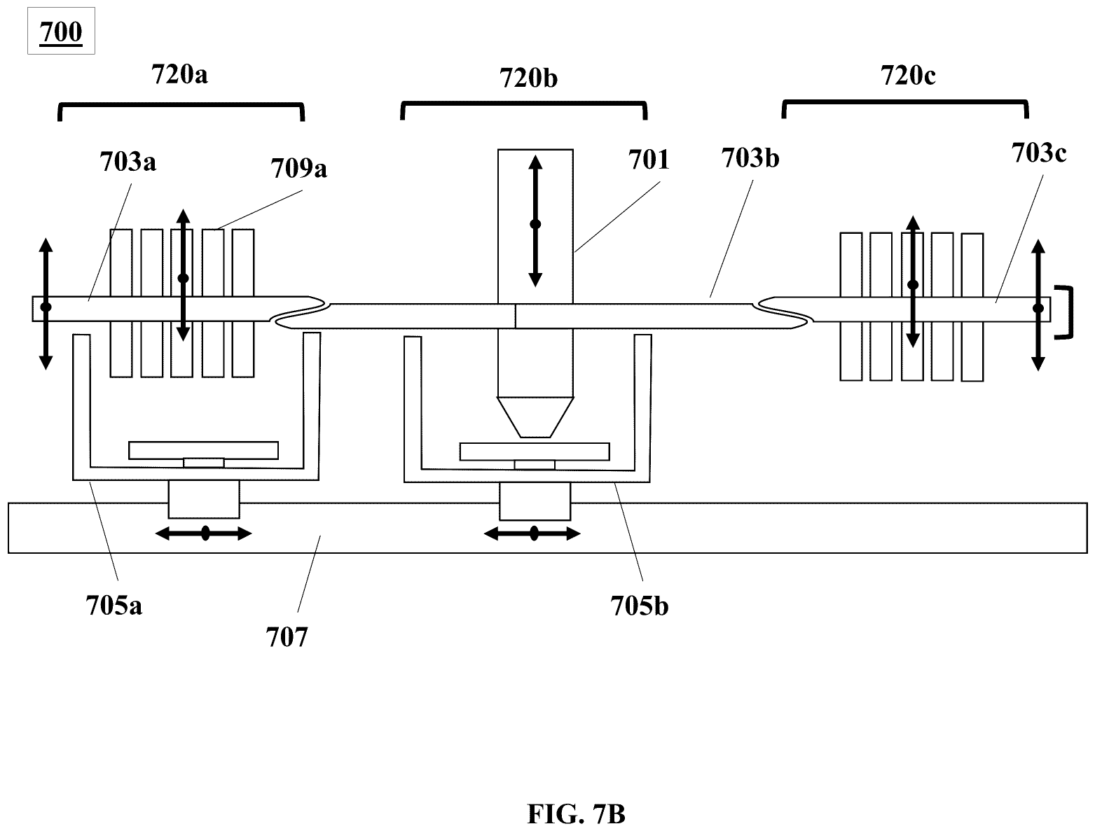

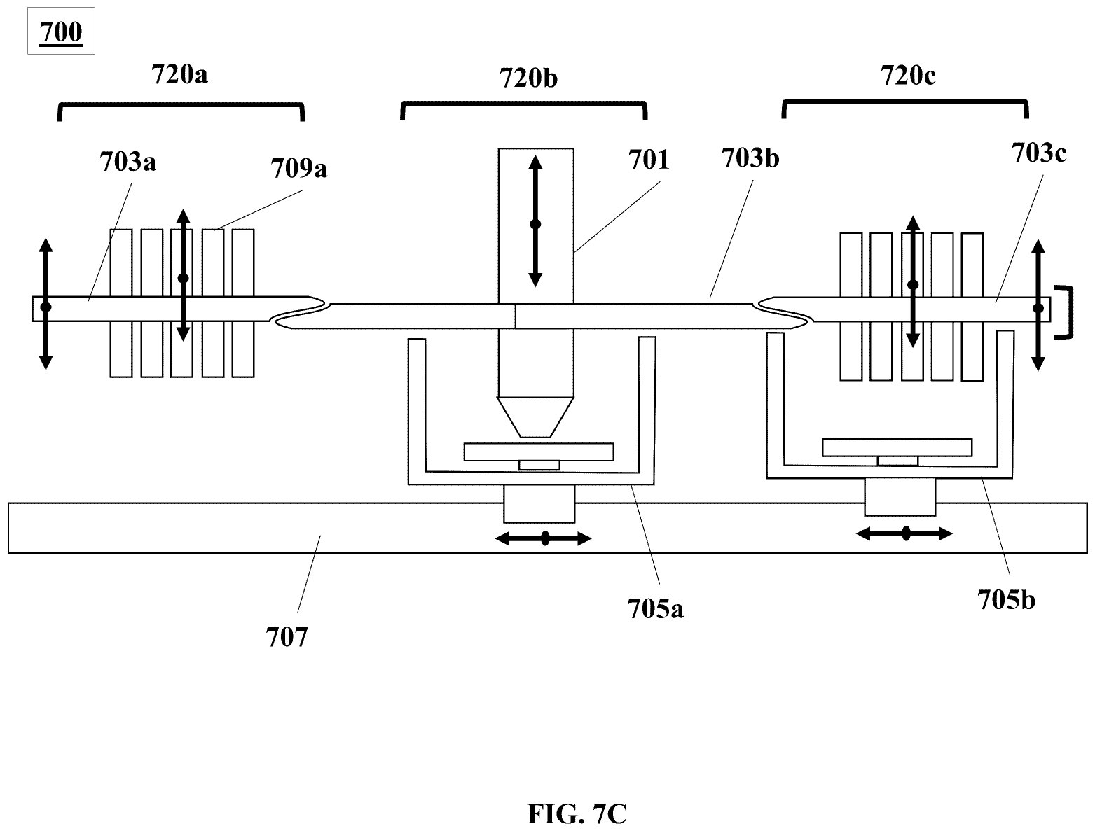

The processing station 700, as shown in FIGS. 7A-7C, (processing station 1504) may comprise different stations (e.g., 720a, 720b, 720c) capable of parallel operation. A station may be positioned relative to a section of the plate 703. In some instances, a single modular plate may comprise one or more operating units for a station. In some instances, multiple modular plates may comprise one or more operating units for a station. In some instances, a single modular plate may comprise one or more operating units for multiple stations. In some instances, multiple modular plates may comprise one or more operating units for multiple stations. A processing station may comprise a chemical station (e.g., 720a, 720c), such as for reagent dispensing, and/or washing. In some cases, the chemical station may comprise one or more nozzles, described elsewhere herein, for dispensing reagents and/or washing solutions onto a substrate. In some instances, the chemical station may comprise a print head nozzle, described elsewhere herein, configured to dispense droplets of reagent and/or washing solutions comprise a print head, described elsewhere herein, configured to dispense droplets of reagent and/or washing solution. The print head nozzle may comprise one or more ink-jet printer nozzles, described elsewhere herein.

In some cases, the processing station may be disposed in a first environment different from a second environment in which the sample station, substrate station, and/or reagent station are disposed. In some instances, the first environment has a higher relative humidity than the second environment. In some cases, the first environment may comprise one or more regions of controlled average temperature different from a second average temperature of the second environment. The processing station may be disposed in an environment different from an ambient environment. In some cases, the environment may comprise a higher relative humidity than the ambient environment. In some instances, the environment may comprise one or more regions of controlled average temperature different from an ambient temperature.

A processing station may comprise a detecting station (e.g., 720b), such as for detection of a signal or signal change. Any modular sample environment system (e.g., 705a, 705b) of the processing system may be capable of traveling between different stations. Alternatively or additionally, the plate 703 may be capable of traveling relative to any modular sample environment system to position a modular sample environment system with respect to a station (e.g., located with respect to a section of the plate). In some instances, a modular sample environment system may be provided a rail or track 707 or other motion path to allow for travel between the different stations. In some instances, different modular sample environment systems may share the same rail or track or other motion path for travel between the different operating systems (e.g., as illustrated in FIGS. 3A-3C). In such cases, the different modular sample environment systems may be configured to move independent of each other on the same rail or track or other motion path or move in unison. In some instances, different modular sample environment systems may move on a dedicated, separate rail or track or other motion path. The motion path may be linear and/or non-linear (e.g., following an arc or curved path). In some instances, the fluid barrier of a modular sample environment system may be maintained during relative motion between the plate 703 and the modular sample environment system, such as during switch of stations. In some cases, the one or more operating units may be capable of movement relative to the plate 703 (such as along an axis normal to the plate) or removal from the plate 703 to allow a modular sample environment system to be positioned with respect to a station. Alternatively, the one or more operating units may not protrude beyond a surface of the plate, or only minimally protrude from the surface of the plate, such as to allow relative movement between the modular sample environment system and different stations.

In some cases, the substrate may be configured to rotate about an axis in the processing station. In some instances, the substrate may be configured to linearly translate in the processing station.

Beneficially, different operations within the system may be multiplexed with high flexibility and control. For example, as described herein, one or more processing stations may be operated in parallel with one or more detection stations on different substrates in different modular sample environment systems to reduce or eliminate lag between different sequences of operations (e.g., chemistry first, then detection). For example, a processing station may be dispensing nucleotides and/or washing solution while a detection station may be performing a detection operation. Each station can be optimized for most efficient use. In an example time scheme, a chemistry cycle can take about 45 seconds per cycle and an imaging cycle can take about 30 seconds per cycle. Depending on the desired results, for example, the imaging cycle may comprise scanning of a complete substrate or part(s) of a substrate once, twice, three times, four times, five times, or more times. In some examples, it may take about 55 seconds to scan an entire substrate once. In another example scheme, a chemistry cycle can take about 30 seconds and an imaging cycle can take about 15 seconds per cycle. In another example, an imaging cycle can take at least about 10 seconds, 20 seconds, 30 seconds, 40 seconds, 50 seconds, 60 seconds, 120 seconds, 180 seconds, 240 seconds, 300 seconds, or more. Alternatively or in addition, an imaging cycle can take at most about 300 seconds, 240 seconds, 180 seconds, 120 seconds, 60 seconds, 50 seconds, 40 seconds, 30 seconds, 20 seconds, 10 seconds, or less. The modular sample environment systems may be translated between the different stations accordingly to optimize efficient equipment use (e.g., such that the detection station is in operation almost 100% of the time). In some cases, the processing station may be capable of operating for at least 24 hours without human intervention

In some examples, at least 1, 2, 3, 4, 5, 6, 7, 8, 9, or more modules or stations of the sequencing system may be multiplexed. For example, 2 or more of the modules may each perform their intended function simultaneously or according to the methods described elsewhere herein. An example of this may comprise two-station multiplexing of an optics station and a chemistry station as described herein. Another example may comprise multiplexing three or more stations and process phases. For example, the method may comprise using staggered chemistry phases sharing a scanning station. The scanning station may be a high-speed scanning station. The modules or stations may be multiplexed using various sequences and configurations.

FIGS. 7A-7C illustrate a system 700 that multiplexes two modular sample environment systems in a three-station system. In FIG. 7B, a first chemistry station (e.g., 720a) can operate (e.g., dispense reagents, e.g., to incorporate nucleotides to perform sequencing by synthesis) via at least a first operating unit (e.g., fluid dispenser 709a) on a first substrate (e.g., 711) in a first sample environment system (e.g., 705a) while substantially simultaneously, a detection station (e.g., 720b) can operate (e.g., scan) on a second substrate in a second sample environment system (e.g., 705b) via at least a second operating unit (e.g., detector 701), while substantially simultaneously, a second chemistry station (e.g., 720c) sits idle. An idle station may not operate on a substrate. An idle station (e.g., 720c) may be recharged, reloaded, replaced, cleaned, washed (e.g., to flush reagents), calibrated, reset, kept active (e.g., power on), and/or otherwise maintained during an idle time. After an operating cycle is complete, the sample environment systems may be re-stationed, as in FIG. 7C, where the second substrate in the second sample environment system (e.g., 705b) is re-stationed from the detection station (e.g., 720b) to the second chemistry station (e.g., 720c) for operation (e.g., dispensing of reagents, e.g., to incorporate nucleotides to perform sequencing by synthesis) by the second chemistry station, and the first substrate in the first sample environment system (e.g., 705a) is re-stationed from the first chemistry station (e.g., 720a) to the detection station (e.g., 720b) for operation (e.g., scanning) by the detection station. An operating cycle may be deemed complete when operation at each active, parallel station is complete. During re-stationing, the different sample environment systems may be physically moved (e.g., along the same track or dedicated tracks, e.g., rail(s) 707) to the different stations and/or the different stations may be physically moved to the different sample environment systems. One or more components of a station, such as modular plates 703a, 703b, 703c of plate 703 defining a particular station(s), may be physically moved to allow a sample environment system to exit the station, enter the station, or cross through the station. During processing of a substrate at station, the environment of a sample environment region (e.g., 715) of a sample environment system (e.g., 705a) may be controlled and/or regulated according to the station's requirements. The sample environment system (e.g., 705a) may comprise a bowl or container (e.g., 713) that at least partially defines the sample environment region (e.g., 715). After the next operating cycle is complete, the sample environment systems can be re-stationed again, such as back to the configuration of FIG. 7B, and this re-stationing can be repeated (e.g., between the configurations of FIGS. 7B and 7C) with each completion of an operating cycle until the required processing for a substrate is completed. In this illustrative re-stationing scheme, the detection station may be kept active (e.g., not have idle time not operating on a substrate) for all operating cycles by providing alternating different sample environment systems to the detection station for each consecutive operating cycle. Beneficially, use of the detection station is optimized. Based on different processing or equipment needs, an operator may opt to run the two chemistry stations (e.g., 720a, 720c) substantially simultaneously while the detection station (e.g., 720b) is kept idle, such as illustrated in FIG. 7A.

In some cases, the processing station may comprise a thin film interferometer that is configured to measure a thickness of a film of the reagent solution dispensed onto a surface of the substrate. In some instances, the one or more processors of the system may be in operable communication with the thin film interferometer, and individually or collectively programmed to use the thickness to calculate a humidity of the first environment where the processing station is disposed. In some cases, the humidity of the first environment may be utilized by the one or more processors to adjust a dispense rate and/or temperature of a nucleic acid sample, a substrate, a reagent, or any combination thereof. In some cases, the thickness of the reagent may be used to determine a uniformity of a film of the reagent dispensed across the surface of the substrate.

In some examples, pre-sequencing processing of samples, such as amplification of samples or portions thereof (e.g., as described herein), may be performed in the processing station 1504. Alternatively or additionally, a separate system may be used to perform pre-sequencing processing of the samples prior to their input or loading into system 1500 (e.g., to the sample station 1501). For example, samples or portions thereof, such as nucleic acid molecules of a sample, may undergo processing and/or amplification prior to their loading onto a substrate. Processing of a sample may comprise, for example, filtration, agitation, centrifugation, storage, transfer, purification, stabilization, selective precipitation, cell lysis, permeabilization, heating, coupling to supports (e.g., particles such as beads, as described herein), primer extension reactions, amplification, ligation, enrichment, pre-enrichment, and/or any other useful process. For example, a sample may be prepared by subjecting a plurality of biological and. or biochemical particles of the sample, such as nucleic acid molecules (e.g., DNA, RNA, etc.), to one or more reactions and processes. The plurality of biological and or biochemical particles (e.g., nucleic acid molecules), and optionally a plurality of supports, such as particles (e.g., beads), may be processed in a pre-processing system (e.g., other than system 1500), in a pre-processing station in system 1500, and/or in a station (e.g., processing station 1504, sample station 1501, sample loading station, etc.). During pre-processing, the biological and/or biochemical particles may be subjected to reactions including amplification reactions such as polymerase chain reactions (PCR). PCR may be performed in compartments such as droplets (e.g., droplets comprising particles such as beads), such as ePCR. The method may comprise breaking, disrupting, and coalescing the droplets, and extracting or pooling the materials therein, which materials may comprise amplicons (e.g., copies of template nucleic acid molecules, or complements thereof) free in solution and/or coupled to particles (e.g., as described herein). Amplification may be performed on-surface of the substrate, such as after loading the sample onto the substrate, via any amplification method described herein, such as RCA, RPA, MDA, LAMP, etc. Beneficially, in such cases, the sample may be amplified and sequenced on the same substrate and prevent material loss during transition of the sample between different operations.

### Diluting Station

In some instances, the sequencing system 1500 may further comprise a diluent station to provide a diluent to, e.g., the processing station 1504. In some instances, such diluent can be used to, in real-time, adjust (e.g., increase or decrease) and/or maintain a concentration of a reagent from the reagent station 1503 prior to delivery to the processing station. For example, a diluent reservoir and the reagent reservoir of the reagent station may be fluidically connected such that fluids from the reagent reservoir and the diluent reservoir may be merged (e.g., in a pre-determined proportion) prior to the fluids being dispensed or dispersed in the processing station. Merged fluids may be provided in additional reservoirs for storage in advance of use in subsequent processing. Alternatively or additionally, merged fluids may be combined in, e.g., tubes, conduits, or channels that may be configured to provide the merged fluids to the processing station. In some instances, a diluent may comprise water. Water may be, for example, treated water, such as distilled or deionized water. A diluent may comprise a buffer solution. A diluent may comprise any other diluent. The diluent station may comprise one or more diluents. For example, a diluent may be provided in a tube, a well, or compartment in the diluent station, or any other container that is capable of isolating a reagent from other diluents. In some instances, for each diluent, at least two reservoirs (e.g., containers) may be provided. The diluent station may be configured to provide a diluent to the processing station from either or all of the at least two reservoirs. Beneficially, when a diluent reservoir is depleted, the other reservoir may be used for continuous supplying to the processing station while the first reservoir is replaced or replenished, without disturbing operations in the processing station. In some instances, each diluent reservoir may be in fluid communication with the processing station. In some instances, diluent volumes from different reservoirs may be dispensed in the processing station through the same outlet. In some instances, diluent volumes from different reservoirs may be dispensed in the processing station through different outlets. In some instances, switching diluent supply from one reservoir to another may comprise manipulating a valve (automatically and/or manually) in fluid connection with each reservoir. Such a valve may be, for example, a ball valve, butterfly valve, pneumatic valve, gate valve, globe valve, diaphragm valve, plug valve, needle valve, angle valve, pinch valve, slide valve, flush bottom valve, solenoid valve, control valve, flow regulating valve, pressure regulating valve, y-type valve, piston valve, check valve, or any other useful valve. In some instances, the diluent station may comprise at least about 1, 2, 3, 4, 5, 6, 7, 8, 9, 10, 20, 30, 40, 50, 60, 70, 80, 90, 100, 200, 300, 400, 500, or more diluents, which may be of at least about 1, 2, 3, 4, 5, 6, 7, 8, 9, 10, 20, 30, 40, 50, 60, 70, 80, 90, 100, 200, 300, 400, 500 or more different types. Alternatively or additionally, the reagent station may comprise at most about 500, 400, 300, 200, 100, 90, 80, 70, 60, 50, 40, 30, 20, 10, 9, 8, 7, 6, 5, 4, 3, 2, or 1 diluents, which may be of at most about 500, 400, 300, 200, 100, 90, 80, 70, 60, 50, 40, 30, 20, 10, 9, 8, 7, 6, 5, 4, 3, 2, or 1 different types. In some instances, a diluent station may comprise at least about 1, 2, 3, 4, 5, 6, 7, 8, 9, 10, 20, 30, 40, 50, 60, 70, 80, 90, 100, 200, 300, 400, 500, or more reservoirs, which reservoirs may be for 1, 2, 3, 4, 5, 6, 7, 8, 9, 10, 20, 30, 40, 50, 60, 70, 80, 90, 100, 200, 300, 400, 500 or more different diluents (e.g., of the same or different types). Alternatively or additionally, a diluent station may comprise at most about 500, 400, 300, 200, 100, 90, 80, 70, 60, 50, 40, 30, 20, 10, 9, 8, 7, 6, 5, 4, 3, 2, or 1 reservoirs, which reservoirs may be for 1, 2, 3, 4, 5, 6, 7, 8, 9, 10, 20, 30, 40, 50, 60, 70, 80, 90, 100, 200, 300, 400, 500 or more different diluents (e.g., of the same or different types). In some instances, the diluent station may comprise a diluent reservoir for at least one reagent in the reagent station. In some instances, the diluent station may comprise a separate diluent reservoir for each reagent in the reagent station. In some instances, a first reagent may be diluted to a first concentration and a second reagent may be diluted to a second concentration different from the first concentration. In some instances, a first reagent may be diluted with a first diluent and a second reagent may be diluted with a second diluent different from the first diluent.

In some instances, the diluent station may be fluidically connected to a supply of water (e.g., a water storage or a substantially continuous supply of water, such as tap water) to generate filtered and/or deionized water at the system 1500 and/or apparatus. For example, the system may comprise a filtration and deionization system for treating water. The filtration and deionization system may comprise one or more filters and/or resins to generate filtered and/or deionized water from the supply of water (e.g., from tap water). Alternatively, the supply of water may not be further filtered or processed prior to mixing with a reagent. In some cases, the methods of the present disclosure may comprise receiving frozen concentrated reagent and performing thawing, dilution, and mixing on the instrument (sequencing system 1500). This may have several advantages including reducing the cost and burden of shipping and logistics; for example, because the shipped frozen concentrated reagent may include a decreased amount of water, and in some cases minimal to no water, which makes concentrated reagents easier to transport.

Some or all of the fluidics of system 1500 may be operated via one or more manifolds. A manifold may provide a fluidic interface for intra-station (e.g., sample station, reagent station, diluent station, etc.) and/or inter-station fluidic transfer. The manifold may comprise a fluidic tube, line, capillary, duct, channel, reservoir, cavity, conduit, canal, or any combination thereof which can receive or facilitate fluid movement. The manifold may comprise one or more valves, such as a ball valve, butterfly valve, pneumatic valve, gate valve, globe valve, diaphragm valve, plug valve, needle valve, angle valve, pinch valve, slide valve, flush bottom valve, solenoid valve, control valve, flow regulating valve, pressure regulating valve, y-type valve, piston valve, check valve, or any other useful valve. The manifold may comprise one or more pumps, such as any linear pump, rotary displacement pump, syringe pump, piston pump, and the like. The manifold may be configured to provide positive pressure and/or negative pressure to direct a fluid from one location to another location. The manifold may comprise any number of fluid inlet(s) and any number of fluid outlet(s). In some cases, the manifold may comprise at least as many fluid inlet(s) as unique fluid types. In one example, the manifold may be fluidically coupled to (e.g., to draw from or dispense through) one or more reagent reservoirs (for each type of reagent), one or more diluent reservoirs (e.g., for each type of reagent), one or more sample tubes, and one or more dispensing nozzles. The manifold may be operably connected to a computer system, such as one described elsewhere herein, which can direct fluid(s) from a fluid inlet(s) to a fluid outlet(s) in the manifold. In some instances, the computer system can direct dilution of one or more reagents (e.g., transfer of reagents from reagent reservoirs to diluent reservoirs and concurrent or subsequent dilution of said reagents). In some cases, the manifold may be mounted in a fixed position in the system 1500 to increase stability of the fluidics interface.

Beneficially, different operations within the system may be multiplexed with high flexibility and control. For example, as described herein, one or more processing stations may be operated in parallel with one or more detection stations on different substrates in different modular sample environment systems to reduce or eliminate lag between different sequences of operations (e.g., chemistry first, then detection). The modular sample environment systems may be translated between the different stations accordingly to optimize efficient equipment use (e.g., such that the detection station is in operation almost 100% of the time). In some examples, at least 1, 2, 3, 4, 5, 6, 7, 8, 9, or more modules or stations of the sequencing system may be multiplexed. For example, 2 or more of the modules may each perform their intended function simultaneously or according to the methods described elsewhere herein. An example of this may comprise two-station multiplexing of an optics station and a chemistry station as described herein. Another example may comprise multiplexing three or more stations and process phases. For example, the method may comprise using staggered chemistry phases sharing a scanning station. The scanning station may be a high-speed scanning station. The modules or stations may be multiplexed using various sequences and configurations.

The nucleic acid sequencing systems and optical systems described herein (or any elements thereof) may be combined in a variety of architectures.

Using the systems, methods, and devices provided herein, the sequencing system may be able to run, without user intervention (e.g., subsequent to an initiation), for at least about 1, 2, 3, 4, 5, 6, 7, 8, 9, 10, 11, 12, 13, 14, 15, 16, 17, 18, 19, 20, 21, 22, 23, 24, 36, 48, 60, 72 hours or more.

Provided herein is a system for processing an analyte comprising one or more stations described herein, and one or more processors, individually or collectively programmed to, within at most 40 hours of running time of the processing station, output at least about 1.5 giga reads per substrate. Alternatively or additionally, the output may be at least about 1.0, 2.0, 3.0, 4.0, 5.0, 6.0, 7.0, 8.0, 9.0, 10.0, 20.0, 30.0, 40.0, or 50.0 giga reads per substrate or more.

Alternatively or additionally, the one or more processors can, individually or collectively programmed to, within at most 40 hours of running time of the processing station, output sequence reads averaging at least 140 base pairs (bp) in length. Alternatively or additionally, the output may be at least about 100, 110, 120, 130, 140, 150, 200, 250, 300, 350, 400, 450, 500 bp read length or more.

Alternatively or additionally, the one or more processors can, individually or collectively programmed to, within at most 40 hours of running time of the processing station, output at least 0.2 terabase reads per run. Alternatively or additionally, the output may be at least about 0.3, 0.4, 0.5, 0.6, 0.7, 0.8, 0.9, 1.0, 1.5, 2.0, 2.5, 3.0, 3.5, 4.0, 4.5, 5.0, 5.5, 6.0, 6.5, 7.0 terabase reads per run or more.

Beneficially, the systems and methods of the present disclosure may facilitate automated sequencing with minimum user intervention, or in some cases, with lack of user intervention, after initiation of the automated process. The methods and systems of the present disclosure may increase automation efficiency by implementing one or more sensors with a control system. Control systems may be implemented as computer systems, such as comprising one or more processors or microprocessors, which are individually or collectively configured to perform certain operations, which are described elsewhere herein, such as with respect to FIG. 6. A control system may be in operable communication with mechanical controllers (e.g., actuator components, environmental units, movement units, etc.) as well as a sensor, or a combination of sensors, which provide measurements on a state or change in a component or process of the automated sequencing system. In non-limiting examples, the sensors may include temperature sensors, pressure sensors, humidity or moisture sensors, weight sensors (e.g., load cells), friction sensors, flow meters, motion sensors, optical sensors (e.g., cameras), pH sensors, audio sensors, voltage, current, and/or resistive sensors. The sensor may be any device or system capable of detecting a signal on a state or change in a component or process of the automated sequencing system. The sensor may automatically, and/or upon request, detect and transmit a signal to the control system, which may analyze the signal to determine a conclusion and based on the conclusion instruct one or more mechanical controllers to adjust, calibrate, or maintain a component or process of the automated sequencing system. The feedback may be open loop control feedback and/or a closed loop control feedback. In some instances, predetermined values (or ranges) or predetermined threshold values, as measured by one or more sensors, may be associated for a given component or process of the automated sequencing system, and the control system may be configured to instruct the appropriate mechanical controllers to adjust, calibrate, and/or maintain the given component or process when a predetermined threshold value is crossed. In some instances, the control system may be configured to instruct the appropriate mechanical controllers to adjust, calibrate, and/or maintain the given component or process at or near the predetermined value (or range). The control system may be in operable communication with a network of sensors to control one or more components or processes of the automated sequencing system, such as components or processes of the various stations described elsewhere herein.

In an example, to facilitate timely and precise hot-swapping of reagents, as described elsewhere herein, one or more sensors may be provided in the automated sequencing system to detect that a reagent reservoir needs replenishing or replacing. For example, a load cell may be used to determine a volume or mass of the reagent remaining in the reservoir from a weight of the reservoir, or a camera may be used to determine a volume level of the reservoir. The sensor(s) may continuously monitor the reagent reservoirs or collect and transmit values upon request. In some cases, a predetermined value can be set as a predetermined threshold for alerting the control system. Upon receipt of an alert and/or determining that the reservoir needs replenishing or replacing (or otherwise that reagent may no longer be drawn from the reservoir), the control system may instruct that the drawing machine draw from the next available reservoir such that the sequencing process is not interrupted. The control system may also inform the operator that the first reservoir needs replenishing or replacing by sending an alert. Alternatively or in addition, the first reservoir may be automatically replenished or replaced. In another example, to facilitate optimal sample processing conditions in a sample environment system (e.g., 705a, 705b in FIGS. 7A-7C), one or more temperatures sensors and/or humidity sensors may be configured to detect the temperature and humidity of a sample environment to ensure that optimal temperature and humidity ranges are maintained during chemical processing and/or detection. Based on signals collected and received from the sensors, the control system may instruct one or more environmental units to adjust, calibrate, or maintain an optimal or predetermined environmental range. For example, if a temperature measured by a sensor is lower than an optimal temperature range, the control system may activate or adjust an environmental unit (e.g., heating or cooling element) to increase the temperature. In another example, to facilitate optimal reagent dispensing, an interferometer, as described elsewhere herein, may be used to determine a fluid layer thickness. The control system may, based on such determination, adjust, calibrate, or maintain dispensing parameters (e.g., fluid flow rate, substrate rotation rate, etc.). In another example, to facilitate efficient detection, pressure, distance, and/or positional sensors may be coupled to or integrated to the objective enclosure and/or the detector to provide feedback on efficiency and alignment of the objective. Based on signals collected and received from the sensors, the control system may adjust, calibrate, or maintain detection parameters (e.g., immersion fluid provision rate, alignment, movement speed, etc.). In some cases, optical signals collected by the detector itself may be used to calibrate the detection parameters, by the control system, for more efficient, accurate, and/or precise output.

Provided herein is a system for processing an analyte comprising one or more stations described herein, and one or more processors, individually or collectively programmed to, within at most 25 hours of running time of the processing station, output at least about 1.5 giga reads per substrate. Alternatively or additionally, the output may be at least about 0.5, 1.0, 2.0, 3.0, 4.0, 5.0, 6.0, 7.0, 8.0, 9.0, 10.0, 20.0, 30.0, 40.0, 50.0, 100.0, 200, 500, or 1000 giga reads per substrate or more. Alternatively or additionally, the one or more processors can, individually or collectively programmed to, within at most 25 hours of running time of the processing station, output at least 140 base pairs (bp) read length. Alternatively or additionally, the output may be at least about 100, 110, 120, 130, 140, 150, 200, 250, 300, 350, 400, 450, 500 bp read length or more. In some embodiments, the one or more processors are configured to output sequence reads of an average length longer than 500 bp, such as up to 550 bp, 600 bp, 700 bp, 800 bp, 900 bp, or up to 1000 bp or longer.

Alternatively or additionally, the one or more processors can, individually or collectively programmed to, within at most 25 hours of running time of the processing station, output at least 0.2 terabase reads per run. Alternatively or additionally, the output may include at least about 0.3, 0.4, 0.5, 0.6, 0.7, 0.8, 0.9, 1.0, 1.5, 2.0, 2.5, 3.0, 3.5, 4.0, 4.5, 5.0, 5.5, 6.0, 6.5, 7.0, 10.0, 20.0, 50.0, 100, 200, 300, 400, 500, 600, 700, 800, 900, or 1000 tera bases of sequence read information per run or more.

Provided herein is a system for processing an analyte comprising one or more stations described herein, and one or more processors, individually or collectively programmed to, within at most 15 hours of running time of the processing station, output at least about 1.5 giga reads per substrate. Alternatively or additionally, the output may be at least about 1.0, 2.0, 3.0, 4.0, 5.0, 6.0, 7.0, 8.0, 9.0, 10.0, 20.0, 30.0, 40.0, 50.0, 100.0, 200, 500, or 1000 giga reads per substrate or more. Alternatively or additionally, the one or more processors can, individually or collectively programmed to, within at most 15 hours of running time of the processing station, output at least 140 base pairs (bp) read length. Alternatively or additionally, the output may be at least about 100, 110, 120, 130, 140, 150, 200, 250, 300, 350, 400, 450, 500 bp read length or more. In some embodiments, the one or more processors are configured to output sequence reads of an average length longer than 500 bp, such as up to 550 bp, 600 bp, 700 bp, 800 bp, 900 bp, or up to 1000 bp or longer. Alternatively or additionally, the one or more processors can, individually or collectively programmed to, within at most 15 hours of running time of the processing station, output at least 0.2 terabase reads per run. Alternatively or additionally, the output may be at least about 0.3, 0.4, 0.5, 0.6, 0.7, 0.8, 0.9, 1.0, 1.5, 2.0, 2.5, 3.0, 3.5, 4.0, 4.5, 5.0, 5.5, 6.0, 6.5, 7.0, 10.0, 20.0, 50.0, 100, 200, 300, 400, 500, 600, 700, 800, 900, or 1000 tera bases of sequence read information per run or more.

In some examples, the methods may comprise discharging the output. In some cases, a portion of the output, such as at least about 1%, 2%, 5%, 10%, 15%, 20%, 30%, 40%, 50%, 60%, 70%, 80%, 90%, 99%, or more of the output may flow to the drain. In some examples, the method may comprise recycling one or more compounds from the output. Recycling may be performed for a number of reasons. For example, if a compound present in the output is a reagent, the compound may be recycled to its value. For example, a valuable or expensive reagent may be recycled. In some cases, a compound which may be harmful to the environment or otherwise not suitable for draining or discharging may be separated from the output. In some examples, the waste generated from the methods and systems may be treated. Waste or output treatment may comprise PH neutralization, separation of given compounds from the output, or adjusting other parameters or characteristics of the waste. In some examples, components which may be inappropriate to drain, discharge, or otherwise discard and/or that are more economical to recycle off-site can be collected in a container. In some cases, the reagents may be shipped in a concentrated form to a facility or place for separation, storage, recycling, re-processing or other applications.

As will be appreciated, the systems, methods, and apparatus described herein may also have non-biological applications, such as for analyzing non-biological samples.

In some instances, the system may be configured to purify a reagent mixture comprising a reagent prior to delivery of the reagent to the processing station, wherein the reagent mixture comprises a plurality of nucleotides or nucleotide analogs (e.g., as described herein). In some instances, purification may comprise (A) directing the reagent mixture to a reaction space comprising a support having a first plurality of nucleic acid molecules immobilized adjacent thereto; (B) incorporating a subset of nucleotides or nucleotide analogs from the plurality of nucleotides or nucleotide analogs into the first plurality of nucleic acid molecules, thereby providing a remainder of the plurality of nucleotides or nucleotides analogs, wherein (B) is performed without detecting the subset of nucleotides incorporated into the plurality of nucleic acid molecules; and (C) delivering the remainder of the plurality of nucleotides or nucleotide analogs to the processing station. In some instances, the method can further comprise (D) incorporating at least a subset of the remainder of the plurality of nucleotides or nucleotides analogs into a growing stand associated with the nucleic acid molecule.

In some instances, the subset of nucleotides or nucleotide analogs comprises less than 10%, less than 5%, less than 1%, less than 0.1%, or less than 0.01% of the plurality of nucleotides or nucleotide analogs. In some instances, the remainder of the plurality of nucleotides or nucleotide analogs has a ratio of a number of nucleotides or nucleotide analogs of one or more but less than all canonical types to a number of nucleotides or nucleotide analogs of all other canonical types which is greater than 19:1. In some instances, the ratio is at least about 29:1, 99:1, or 999:1.

In some instances, purification may comprise (A) selecting from a set of canonical types of nucleotides or nucleotides analogs a subset of canonical types of nucleotides or nucleotide analogs; (B) directing the reagent mixture to a reaction space comprising a support having a plurality of nucleic acid molecules immobilized thereto, wherein a percentage of nucleotides or nucleotide analogs corresponding to the subset relative to all other nucleotides or nucleotide analogs in the mixture is greater than 50%; and (C) incorporating nucleotides or nucleotide analogs from the mixture that do not correspond to the subset into the plurality of nucleic acid molecules such that the percentage is increased following the incorporating, wherein (A)-(C) are performed in absence of sequencing or sequence identification of the plurality of nucleic acid molecules. In some instances, purification may comprise (A) directing the reagent mixture to a reaction space comprising a support having a plurality of nucleic acid molecules immobilized thereto; and (B) incorporating a subset of nucleotides or nucleotide analogs form the plurality of nucleotides or nucleotide analogs into the plurality of nucleic acid molecules, thereby providing a remainder of the plurality of nucleotides or nucleotides analogs, wherein (A)-(B) are performed in absence of sequencing or sequence identification of the plurality of nucleic acid molecules. In some instances, the method can further comprise (C) using the remainder of the plurality of nucleotides or nucleotide analogs to perform nucleic acid sequencing by synthesis.

### Spin Coating Deflector

In some instances, the modular sample environment may be a bowl 1602, as shown in FIG. 16. The bowl may comprise a circular or arbitrary polygonal shape with a lip or edge 1603 configured to prevent liquid from spilling over the edge of the bowl. In some cases, the bowl may comprise one or more drains 1604 in fluid communication with a fluidic transport sequencing system, described elsewhere herein, to evacuate or drain fluid dispensed by the processing stations described elsewhere herein. In some instances, the bowl may comprise a material with anti-corrosive properties. In some cases, the bowl may comprise cut-out feature 1605 such that a rotational motor positioned underneath the bowl 1602 may be in mechanical communication with a substrate. In some cases, the cut-out feature 1605 may be circular or an arbitrary polygonal shape. Bowl 1602 may be made of material that can withstand the constantly high humidity and highly corrosive environment. In some embodiments, one or more anti-corrosive coatings may be applied to bowl 1602.

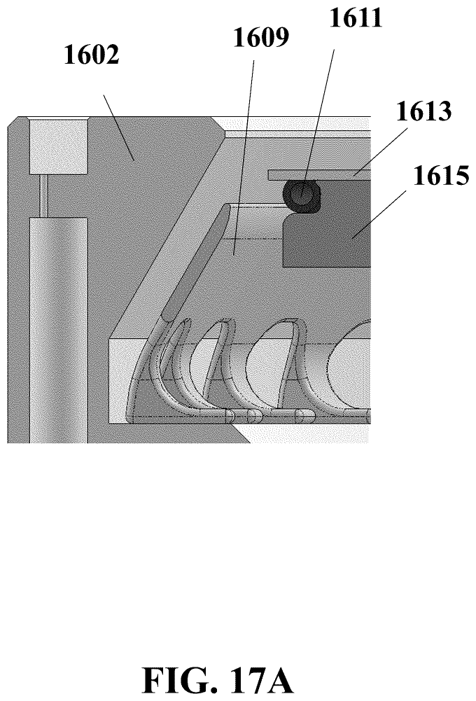

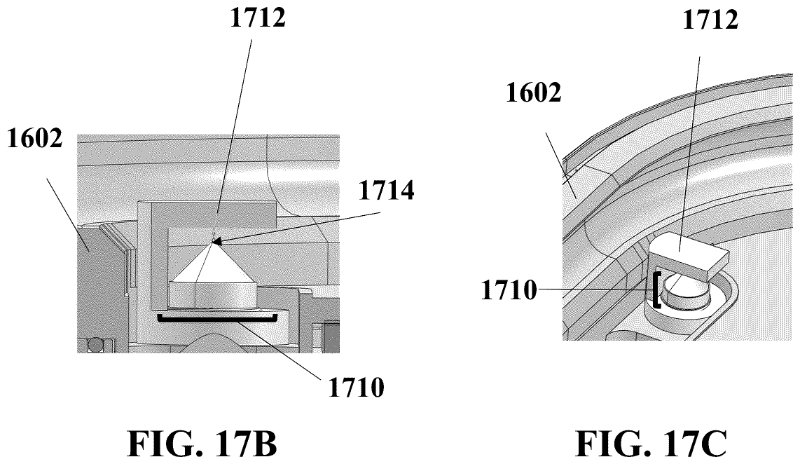

In some cases, the bowl 1602 may comprise a modular liquid-catching structure 1609 that may be deployed in an open or closed state, as seen in FIG. 17A. For example, in some cases, the modular liquid-catching structure 1609 may comprise a uniform or substantially uniform structure. Alternatively, in some cases, the modular liquid-catching structure 1609 may comprise one or more geometrical features (e.g., curved or not curved). In some instances, such a modular liquid-catching structure may be placed between the chuck 1615 and/or substrate 1613 and a wall of the bowl 1602. In some instances, a bowl 1602 comprising such a modular liquid-catching structure may also comprise internal contour. In some instances, a modular liquid-catching structure may be shaped so as to fit within bowl 1602 (e.g., to conform to any internal contours of the bowl). In some cases, the modular liquid-catching structure may be placed within the bowl 1602 and be configured to absorb liquid that might otherwise be deflected out of the bowl from the substrate 1613, structural enhancement feature 1611, chuck 1615, or any combination thereof. In some cases, the modular liquid-catching structure may be deployed in an open state with a clearance gap between the top plane of the modular liquid-catching structure and the objective enclosure. In some instances, the modular liquid-catching structure may be deployed in a closed state, where the modular liquid-catching structure is folded away from the chuck 1615, substrate 1613, and structural enhancement feature 1611 assembly. In some cases, the modular liquid-catching structure may be actuated between an open and/or closed state (e.g., switching between the open state and the closed state), which states are controlled by one or more servo motors that are in mechanical communication with the modular liquid-catching structure. In some cases, the one or more servo motors may be in electrical communication with the sequencing system processor, as described elsewhere herein.

In some cases, the modular liquid-catching structure may be used in a method of spin coating the substrate with reagents to reduce the splash of the reagent out of the bowl. In some case the method comprises: (a) providing a substrate on a substrate chuck, where the substrate comprises immobilized thereto one or more beads, where the one or more beads comprise one or more nucleic acid molecules coupled thereto, and where the substrate chuck comprises a deflector configured in an open state or a closed state; (b) at an open state of the deflector, rotating the substrate; (c) dispensing a reagent onto a surface of the substrate; and (d) actuating the deflector to the closed state.

### Overflow Prevention Sensor

In some cases, the modular sample environment may further comprise a sensor 1710 mounted in bowl 1602, as shown in FIGS. 17B-17C. In some instances, the sensor comprises an illumination source (e.g., an LED, and IR LED, a fluorescent light source, an incandescent light source, etc.) and a detector (e.g., a power meter, a photodetector, phototransistor, etc.). In some instances, the sensor comprises a prism through which illumination light passes. In some cases, the sensor is a liquid level sensor and the sensor is configured to initiate drainage of the bowl when a triggering condition (e.g., rising level of fluid in the bowl) occurs.

In some instances, the detector measures a first voltage (or first illumination amount) when the sensor is not triggered and a second voltage (or second illumination amount) when the sensor is triggered. In some instances, the detector detects the presence/absence of illumination. In some cases, the illumination that is detected is directed to the detector due to total internal reflection (TIR) (e.g., light emitted by the illumination source that is directed, due to reflection by the surrounding environment, to the detector). For instance, the sensor may comprise a prism that may reflect light emitted by the light source into a photodiode detector under certain environmental conditions (e.g., the presence or absence of liquid adjacent to the sensor). As one example, the prism may comprise a refractive index such that i) when the surrounding environment is air, light emitted by the sensor will be reflected by the prism and directed to the director, and ii) when the surrounding environment is a liquid (e.g., water), light emitted by the sensor will not be reflected (or refracted) by the prism and will not be directed to the detector.

In some cases, sensors can be triggered adventitiously (e.g., the sensor is not triggered even though the triggering condition is present, or the sensor is triggered even in the absence of the triggering condition). For example, with a TIR sensor liquid level that is triggered by rising water level, in some cases, light emitted by the sensor may not trigger even when the water level has risen to appropriate levels. This may be due to reflection of the emitted light from the air-water interface, leading to continuous TIR. To alleviate this issue, the sensor may further comprise a cap 1712. In some cases, the cap comprises an infrared (IR) black material. In such cases, the cap will enable accurate triggering of the sensor, even in adverse conditions. For example, the cap may be set at a distance above the tip of the sensor such that upon changes in the environmental surroundings (e.g., a rising water level) the sensor will be able to be triggered and will not be subject to false negatives from unintended TIR at the air/water interface.

In some instances, sensor 1710 is configured (e.g., with a cap 1712 placed appropriately) to be activated (e.g., to initiate drainage of the bowl 1602) when fluid level in the bowl reaches a predetermined distance from the top of the sensor 1714 (as seen in FIG. 17B). In some instances, the predetermined distance may be at least 0.5 millimeters (mm), 1 mm, 2 mm, 3 mm, 4 mm, 5 mm, 6 mm, 7 mm, 8 mm, 9 mm, 10 mm, 11 mm, 12 mm, 13 mm, 14 mm, 15 mm, 16 mm, 17 mm, 18 mm, 19 mm, 20 mm, 25 mm, or 50 mm form the top of the sensor 1714.

In some instances, sensor 1710 is configured (e.g., with a cap 1712 placed appropriately) to be activated (e.g., to initiate drainage of the bowl 1602) when fluid level in the bowl reaches a predetermined distance from the top of the bowl or a predetermined distance from a location along the side of the bowl. For instance, the predetermined distance may be at least 0.5 millimeters (mm), 1 mm, 2 mm, 3 mm, 4 mm, 5 mm, 6 mm, 7 mm, 8 mm, 9 mm, 10 mm, 11 mm, 12 mm, 13 mm, 14 mm, 15 mm, 16 mm, 17 mm, 18 mm, 19 mm, 20 mm, 25 mm, 50 mm, 100 mm, 150 mm, or 200 mm the top of the bowl or from a location along the side of the bowl.

In some instances, sensor 1710 is configured (e.g., with a cap 1712 placed appropriately) to be activated (e.g., to initiate drainage of the bowl 1602) when fluid level in the bowl reaches a predetermined height of the bowl. For example, the predetermined height of the bowl may be at least 50%, at least 60%, at least 70%, at least 75%, at least 80%, at least 85%, at least 90%, at least 95%, at least 99%, or at least 100% of the total height of the bowl.

In some instances, sensor 1710 is configured (e.g., with a cap 1712 placed appropriately) to be activated (e.g., to initiate drainage of the bowl 1602) when the liquid volume in the bowl reaches a predetermined amount. In some cases, the predetermined amount comprises at least 50%, at least 60%, at least 70%, at least 75%, at least 80%, at least 85%, at least 90%, at least 95%, at least 99%, or at least 100% of the total volume of the bowl. In some cases, the predetermined amount comprises at least 50 mL, 75 mL, 100 mL, 125 mL, 150 mL, 175 mL, 200 mL, 250 mL, or 300 mL.

Cap 1712 can vary in size. That is, if cap 1712 is placed further from the tip of sensor 1710 (e.g., further from the base of the bowl), the cap may be larger, and if cap 1712 is placed nearer to the tip of sensor 1710 (e.g., nearer to the base of the bowl), the cap may be smaller. For example, when the cap is located a first height above the sensor, the cap will have a first area, and when the cap is located a second height above the sensor, the cap will have a second area, where the second height is larger than the first height and the second area is larger than the first area. The cap area will be proportional to the potential angles at which light may exit from and reenter the prism (e.g., such that the cap will prevent false negative results from the sensor).

In some cases, the sensor may be mounted in the bowl 1602 vertically (e.g., as illustrated in FIGS. 17B-17C). Alternatively, the sensor may be mounted in the bowl 1602 at an angle less than perpendicular with respect to the base of the bowl (e.g., tilted with respect to the illustrations in FIGS. 17B-17C). In each case, a cap 1712 may be placed above the sensor (e.g., further from the base of the bowl) to reduce adventitious triggering of the sensor and improve accuracy.

In some cases, the liquid level sensor may be used in a method of spin coating the substrate with reagents to reduce the risk of the reagent flooding out of the bowl. In some cases the method comprises: (a) providing a substrate on a substrate chuck, where the substrate comprises immobilized thereto one or more beads, where the one or more beads comprise one or more nucleic acid molecules coupled thereto, and where the substrate chuck comprises a sensor configured in an active state or an inactive state; (b) at an inactive state of the sensor, rotating the substrate; (c) dispensing a reagent onto a surface of the substrate; and (d) stopping rotation of the substrate and/or reagent dispense upon activation of the sensor.

Alternatively or in addition, in some cases the method comprises: (a) providing a substrate on a substrate chuck in a modular sample environment, where the substrate comprises immobilized thereto one or more beads, where the one or more beads comprise one or more nucleic acid molecules coupled thereto, and where the substrate chuck comprises a sensor configured in an active state or an inactive state; (b) at an inactive state of the sensor, rotating the substrate; (c) dispensing a reagent onto a surface of the substrate; and (d) upon activation of the sensor, initiating draining the modular sample environment.

### Hot and Warm Swapping

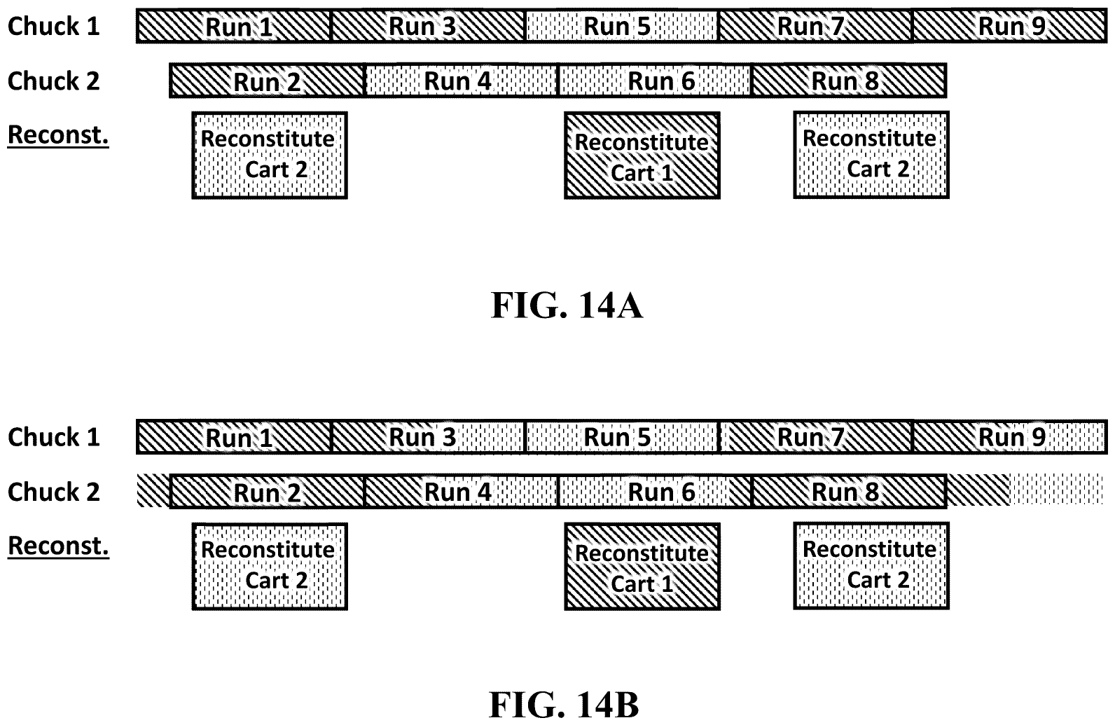

In some examples, a process of the system, described elsewhere herein, may comprise hot swapping and/or warm swapping of reagents, substrates (e.g., wafer) or flow cell, and/or samples in the system during operation of one or more stations, such as the processing station. FIGS. 14A-14B illustrate examples of warm swapping and hot swapping of reagents, respectively.

Hot-swapping (as shown in FIG. 14B with reagents) may comprise switching a part or component of the system such as reagent, substrate, or flow cell without stopping, shutting down, or rebooting the system. In some examples, the method may comprise hot swapping one or more of reagents, substrate (e.g., wafer), sample, and/or other components of the system. In some examples, the method may comprise hot-swapping all three of the reagents, substrates, and samples. Hot-swapping may offer various advantages such as facilitating 24/7 continuous runs of the systems of the present disclosure. The system may comprise a machine which is configured to draw from multiple system reservoirs. In some cases, hot-swapping may comprise using two or more reservoirs which may be identical. The machine (e.g., drawing machine) may draw the contents of the reservoir one at a time. For example, the machine may draw reagents or samples from the first reservoir until it is nearly empty and then begin to draw from the second reservoir by quickly switching between the two. This ability of the machine to smoothly switch from the first to the second reservoir allows the first reservoir to be replenished or replaced with a new reservoir while the machine continues to function. Alternatively, the machine may draw the contents from multiple reservoirs simultaneously. In some cases, where the system comprises more than two reservoirs, the method may comprise proceeding to draw from the following reservoirs subsequently and respectively. After the machine switches over to the next reservoir, for instance before the second reservoir also runs out, the operator may replenish or swap out the empty first reservoir for a full replacement, in some cases, while the machine is running (e.g., with minimal to no stopping or interruption to the procedure). When the second reservoir runs out, the machine may switch back to drawing from the newly replaced or replenished first reservoir. In some examples, hot-swapping may be performed for the wafers (flow cells) which may be inserted as cartridges and may be hot-swapped according to the methods provided herein to avoid interrupting the workflow of the process. In some examples, samples may be hot-swapped. In some cases, the method may comprise hot-swapping all reagents, wafers, and samples to facilitate un-interrupted extended runs of the sequencer (24 hours per day for several days, weeks, or months). Similarly, any number of additional reservoirs (e.g., third reservoir, fourth reservoir, etc.) may be added to the system for access by one or more machines of the system, while the system is running. Similarly, any number of reservoirs not in use may be removed from the system, while the system is running. FIG. 14B illustrates the operation of two different chucks (each with its own substrate) operating in two different sample processing environments (e.g., 715). At any point in time, both sample processing environments are drawing reagents from the same reagent cartridge (diagonally-dashed blocks: drawing from first reagent cartridge; dotted blocks: drawing from second reagent cartridge). When a first reagent cartridge runs out, the two sample processing environments begin drawing reagents from the same second reagent cartridge, and the first reagent cartridge is able to be reconstituted (e.g., replenished). When a second reagent cartridge runs out, the two sample processing environments begin drawing reagents from the same reconstituted first reagent cartridge, and the second reagent cartridge is able to be reconstituted (e.g., replenished). The switch between the first reagent cartridge and the second reagent cartridge may occur during the middle of a sequencing run (e.g., of both processing stations).

In some cases, provided herein is a method of warm-swapping of reagents, substrates (e.g., water) or flow cell, and/or samples in the system (as seen in FIG. 14A with reagents). In some cases, warm-swapping may be a specific type of hot-swapping, in which the switch between system reservoirs is timed to happen between distinct sequencing runs such that a switch does not happen during a sequencing run. For example, reconstitutions, replacements, or replenishments of a system reservoir may not begin midway through a sequencing run for methods using warm-swapping. In some cases, warm-swapping may comprise using two or more reservoirs which may be identical. The system may draw the contents of a system reservoir (e.g., reagent cartridge) one at a time. For example, the system may draw reagents or samples from the first reservoir through the course of a completed sequencing run until it is empty after which the system may then proceed to draw from a second reservoir during a subsequent sequencing run. Once the system begins drawing from the second reservoir during the subsequent sequencing run, the first reservoir may be replenished. In some cases, the method may comprise: (a) providing a first substrate to a first chemical processing station and a second substrate to a second chemical processing station; (b) initiating a plurality of first sequencing runs on the first chemical processing station and a plurality of second sequencing runs on the second chemical processing station, where at least a portion of the plurality of first sequencing runs and at least a portion of the plurality of second sequencing runs overlap in time, where the first chemical processing station is configured to dispense reagents from either a first reagent cartridge or a second reagent cartridge during a single run of the plurality of first sequencing runs, and where the second chemical processing station is configured to dispense reagent from either the first reagent cartridge or the second reagent cartridge during a single run of the plurality of second sequencing runs; and (c) replenishing the first reagent cartridge when both the first chemical processing station and the second processing station are processing first respective sequencing runs that dispenses reagents from the second reagent cartridge, and replenishing the second reagent cartridge when both the first chemical processing station and the second processing station are processing second respective sequencing runs that dispenses reagents from the first reagent cartridge. For example, FIG. 14A illustrates the operation of two different chucks (each with its own substrate) operating in two different sample processing environments (e.g., 715). During a single sequencing run for either chuck, a sample processing environment is drawing reagents from only one reagent cartridge (diagonally-dashed blocks: drawing from first reagent cartridge; dotted blocks: drawing from second reagent cartridge). However, during a single point in time, a first sample processing environment (chuck 1) may be drawing reagents from the first reagent cartridge during its current sequencing run, and a second sample processing environment (chuck 2) may be drawing reagents from the second reagent cartridge during its current sequencing run. A reagent cartridge may be reconstituted (e.g., replenished) during a time that corresponds to both sample processing environments running their respective sequencing runs not using that reagent cartridge. The switch between the first reagent cartridge and the second reagent cartridge for a single sample processing environment may occur between distinct sequencing runs, and not midway through a sequencing run.

### System Cleaning

Provided herein are systems and methods configured to clean and/or decontaminate the systems and related system stations, described elsewhere herein. Contamination of various fluidic aspects of the system may occur gradually over time with continued use of the systems and related system stations described herein, leading to degradation of performance of the bioprocesses of the system. By cleaning and decontaminating the system, system performance and up processing time (i.e., the time which the system is operable) may be increased. One or more methods of sterilization and/or cleaning to combat contamination are described. In some cases, bleach may be used to clean any fluidic components of the system, such as a nozzle, tubing, needle, or any other component. In some cases, antimicrobial agents may be introduced into one or more fluidic streams and/or reagent reservoirs described elsewhere herein. In some instances, the antimicrobial agents may comprise metal salts of hydrazoic acid, NH₃, e.g., sodium azide; metal salts of hydrofluoric acid e.g., sodium fluoride; various detergent-type compounds such as benzalkonium chloride, or any combination thereof. In some instances, antimicrobial agents may be provided as an independent reagent, such as provided in its own reagent reservoir or cartridge. In some instances, antimicrobial agents may be provided as an additive to other reagents, such as provided in the reagent reservoir or cartridge of the other reagents. In some cases, antimicrobial agents can be introduced continuously or intermittently into a flowing working fluid, e.g., deionized water, to enable the supply of either clean or modified working fluids. In some instances, the antimicrobial agents may be introduced as a component of a wash fluid with intermittent exposure to fluidic components. In some cases, the antimicrobial agent may be added to a buffer at the time of manufacturing the buffer solution. In some cases, the antimicrobial agents may be contained within a distinct cartridge or reservoir configured to dispense the antimicrobial agents on demand.

In some cases, the antimicrobial agents may be incorporated into standard workflows of the system methods, described elsewhere herein, to continuously maintain a hygienic state of the hardware and prevent occlusions of filters. In some cases, a syringe pump may deliver controlled amounts of antimicrobial agents into a fluid stream at precisely controlled rates to achieve desired concentrations.

In some instances, provided herein are algorithms configured to determine optimal dispensing concentrations and flows of antimicrobial agents. In some cases the measurement of antimicrobial concentration and/or measurement of microbial contamination may be used by the algorithms to modify the rates of antimicrobial agent introduction or the frequency of antimicrobial treatments. In some cases, the algorithm may comprise an artificial intelligence-based algorithm or a machine learning algorithm.

In some instances, residue (e.g., salt residues) may form and/or deposit on a ceiling of a processing chamber (defined by a bowl and a lid ceiling). In some instances, the sequencing systems described herein may comprise a method of cleaning and/or removing residue that has formed and/or deposited on a ceiling. The method of cleaning and/or removing residue deposited on ceiling may comprise dispensing washing solution by fluid dispensers in a space between the substrate and ceiling, rotating the substrate in mechanical communication with a chuck at a first velocity for a first period of time to cause the washing solution to clean and/or remove residue deposited on the ceiling, and draining a combination solution of liquid and residue removed from the ceiling. In some cases, the distance between the substrate and the ceiling may be adjusted. For example, the distance may be decreased by using a thicker substrate, and/or moving the substrate upwards to be closer to the ceiling, and/or moving the ceiling downwards to be closer to the substrate. In some cases, the ceiling and/or substrate may be moved such that they are in contact during cleaning. This method may further prevent leaks from the processing chamber.

### Data Communication

Systems described herein, such as the open substrate systems, may comprise a plurality of subassemblies. For example, a subassembly may comprise one or more of a controller, sensor, actuator, any module, any hardware component, any mechanical component, and any software component as described elsewhere herein. A subassembly may function within a single station. A subassembly may function within or across multiple stations. A station may comprise one or more subassemblies. A plurality of stations may comprise a plurality of subassemblies. The system may comprise subassemblies such as but not limited to a fluidics subassembly, a detection subassembly, an immersion optics subassembly, an autofocus subassembly, a sample chilling subassembly, a sample temperature control subassembly, a sample storage subassembly, a sample loading subassembly, a reagent storage subassembly, a reagent temperature control subassembly, a reagent dispensing subassembly, a washing subassembly, a system cleaning subassembly, a substrate storage subassembly, a substrate loading subassembly, a substrate rotation subassembly, any sensor subassembly, an image data processor subassembly, a data analysis subassembly, a graphic user interface (GUI) subassembly, a cloud computing subassembly, a data memory subassembly, a CPU and/or GPU subassembly, a power supply subassembly, an embedded real-time controls subassembly, etc. It will be appreciated that a subset of components within any of the above subassemblies may be its own subassembly. It will be appreciated that a subset of components selected from any of the above different subassemblies may be its own subassembly. It will be appreciated that a subassembly may comprise any combination of the above subassemblies.

Various combinations of two or more subassemblies, and/or all subassemblies, may be in communication with each other directly or indirectly via one or more controllers. In some cases, two or more subassemblies may be functioning simultaneously or substantially simultaneously based on data (e.g., sensor data) communicated between the two or more subassemblies and/or data communicated to one or more controllers. Recognized herein is a need for a system, method, and/or device with a compact form factor that can deliver fast data communication between different subassemblies, which compact form factor allows ready integration into a sequencing system. Provided herein are systems and methods that address at least the abovementioned needs. The systems and methods may comprise a dual-network cable that comprises both EtherCAT (Ethernet for Control Automation) and CAN (Controller Area Network) networks. The dual-network cable may enable the sequencing system to operate as a distributed system in which any module can communicate and broadcast its state, which can significantly improve debugging efficiencies.

The EtherCAT architecture is a master/slave protocol in which a single master device communicates with one or more slave devices (or nodes), and where data is flowed to and from a master and slave device but not between different slave devices. The CAN network does not require a master device, and different nodes may communicate with each other by subscribing to and publishing messages, but messages are assigned a priority via a priority algorithm based on the message identifier. Data transmission via the CAN network may be a relatively slow process (e.g., 1 MHz). Any data type may be communicated via either or both of the EtherCAT or CAN networks within the sequencing system. A network for transmission of a data type may be selected based on a variety of factors, such as the priority of the data, speed the data needs to be transmitted, or origin and destination module(s) for the data transfer. For example, the CAN network may allow the addition of firmware upgrades without changing system software.

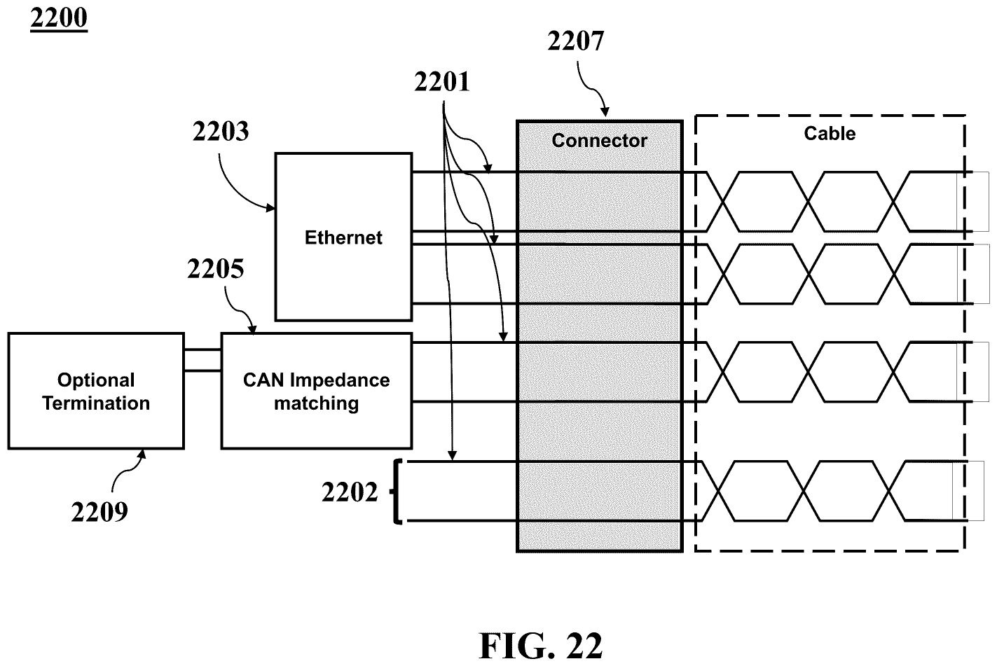

A single cable comprising a plurality of twisted pairs of conductors may be configured to route both Ethernet data and CAN bus data by assigning different pairs of twisted pairs to different networks, thus permitting a single cable to carry two types of communication, e.g., relatively high-speed EtherCAT and relatively low speed CAN bus telemetry. The cable comprising the plurality of twisted pairs of conductors may be a Category (CAT) cable, such as a CAT5 or other CATn cable. The high-speed EtherCAT may be communicated in a master-slave network and the low-speed CANbus telemetry may be communicated in a broadcast network. When implemented in a sequencing instrument, for example, low-priority and/or low-rigidity debug and vitals messages related to various subassemblies in the sequencing instrument may be communicated via the CAN channel and high-priority information related to individual subassemblies in the sequencing instrument may be communicated via the EtherCAT channel without impacting control-loop latencies. FIG. 22 illustrates a block diagram of an example dual network cable. In this example, a CAT cable 2200 comprises four twisted pairs of conductors 2201, of which two are assigned to route EtherCAT 2203 communication and one is assigned to route CAN 2205 communication. The cable comprises a connector 2207, such as a RJ45 connector. In some cases, additional network combinations are possible (e.g., where different network components are included). By way of example, in FIG. 22, the fourth pair of conductors 2202 (which were not required for EtherCAT or CAN communications) may be assigned to low voltage differential signaling (LVDS) communication. In some cases, as described below, the cable further comprises impedance matching. Here the impedance matching is shown with the CAN communication twisted pair of conductors, but it may alternatively be associated with another type of communication (e.g., the two twisted pairs of conductors routing EtherCAT 2203 communications). In some cases, optionally, one or more of the twisted pairs of conductors may be terminated 2209.

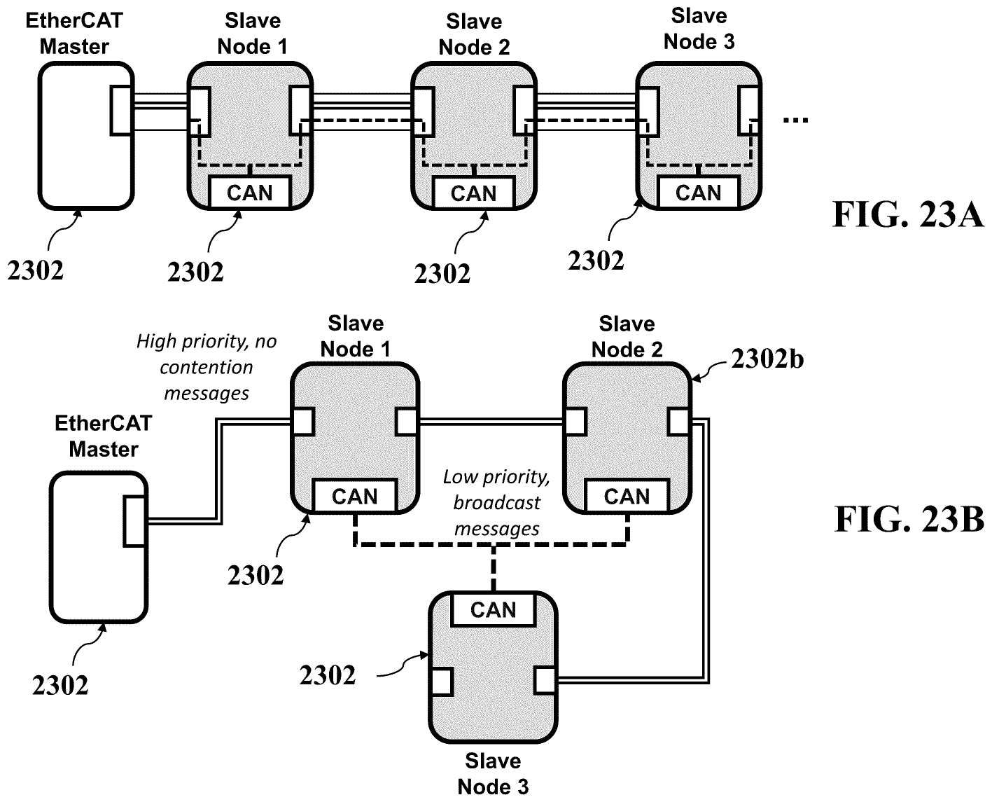

The dual network combination is possible due to similar impedance requirements of Ethernet and CAN. For example, in some cases CAN has only a 20% higher impedance requirement than EtherCAT. In some cases, Ethernet may have a higher impedance requirement than CAN. In some such cases (e.g., where there are impedance differences to be overcome), the system comprises an impedance-matching circuit, such as an impedance-matching circuit of at least and/or at most about 10, 20, 30, 40, 50, 60, 70, 80, 90, 100, 110, 120, 130, 140, 150, 160, 170, 180, 190, 200, 250, 300, 350, 400, 450, 500 ohms (Q). In some cases, the CAN data-link layer may be modified to reduce the impedance mismatch. In some cases, the CAN signals may be converted from a voltage-driven to a current-driven differential signal via analog electronics. FIGS. 23A and 23B illustrate an EtherCAT master 2302 and one or more CAN slave nodes 2304 in physical connectivity and logical connectivity, respectively. As shown in FIG. 23A, information in this exemplary EtherCAT/CAN system, information will pass from the master node 2302 (e.g., the controller) to the first slave node, the second slave node, the third slave node, etc. (e.g., one or more subassemblies), where information that is configured in a first communication mode (e.g., Ethernet) will be transferred on a first type of twisted pair(s) of conductors and information configured in a second communication mode (e.g., CAN) will be transferred on a second type of twisted pair(s) of conductors. FIG. 23B illustrates how the transfer of different types of information (e.g., information comprising a first communication mode vs. information comprising a second communication mode) may be performed in different networks (e.g., corresponding to the priority of the information). For example, high priority instructions (e.g., those without possible contention) may be transmitted from the controller 2302 to one or more subassemblies 2304 via a first connector (e.g., one or more twisted pairs of conductors assigned to route a first type of communication, while lower priority instructions (e.g., broadcast instructions) may be transmitted between subassemblies 2304 (and/or from the controller 2302 to the one or more subassemblies 2304) via a second connector (e.g., one or more twisted pairs of conductors) assigned to route a second type of communication, where the first and second connectors are in the same cable. In this way, high priority instructions may be segregated from lower priority instructions without adding additional cables to a system.

Accordingly, provided here is a data communication system, comprising: a cable comprising a plurality of twisted pairs of conductors, wherein a first subset of one or more twisted pairs of conductors is assigned to and configured for EtherCAT (Ethernet for Control Automation) communication, and wherein a second subset of one or more twisted pairs of conductors, different from the first subset of one or more twisted pairs of conductors, is assigned to and configured for CAN (Controller Area Network) communication. The respective twisted pairs in the first and second subsets may be mutually exclusive. In some cases, the first subset comprises two twisted pairs. In some cases, the second subset comprises one twisted pair. The cable can comprise any number of twisted pairs of conductors, such as 1, 2, 3, 4, 5, 6, 7, 8, 9, 10 or more pairs. The cable can be a Category (CAT) cable, such as a CAT5 cable. The cable can be configured to connect and/or be capable of connecting a first subassembly to a controller and/or to a second subassembly. The controller may be a master device. The first subassembly and/or the second subassembly may be slave node in the EtherCAT communication network. Accordingly, provided herein is a data communication method, comprising: connecting a cable between a first subassembly and (i) a controller or (ii) a second subassembly, wherein the cable comprises a plurality of twisted pairs of conductors, wherein a first subset of one or more twisted pairs of conductors is assigned to and configured for EtherCAT (Ethernet for Control Automation) communication, and wherein a second subset of one or more twisted pairs of conductors, different from the first subset of one or more twisted pairs of conductors, is assigned to and configured for CAN (Controller Area Network) communication. The method may further comprise, where the cable is connected between the first subassembly and the controller, communicating data between the first subassembly and the controller via the first subset of one or more twisted pairs. The method may further comprise, where the cable is connected between the first subassembly and the second subassembly, communicating data between the first subassembly and the second subassembly via the second subset of one or more twisted pairs.

Accordingly, provided herein is a data communication method, comprising: at a first node, dispatching first instructions to a second node, dispatching second instructions to a third node; and at the second node: dispatching third instructions to the third node and the fourth node; wherein: the first instructions comprise a first communication mode, and the second and third instructions comprise a second communication mode; and the first instructions are transmitted via a first connector configured for the first communication mode, and the second and third instructions are transmitted via a second connector configured for the second communication mode, where the first and second connectors comprise a cable. The method may further comprise, where the first connector and the second connector, respectively, comprises one or more twisted pairs of conductors. The method may further comprise, where the first node, the second node, the third node, and the fourth node are connected via the first cable and the second cable. The method may further comprise, where the first communication mode is Ethernet, and the second communication mode is CAN. The method may further comprise, where the first instructions have a first priority and the second instructions have a second priority, wherein the second priority is lower than the first priority. The method may further comprise, where the first node is a controller and the second, third, and fourth nodes are subassemblies. The method may further comprise, where the controller is a master device and the subassemblies are slave nodes.

### Computer Systems

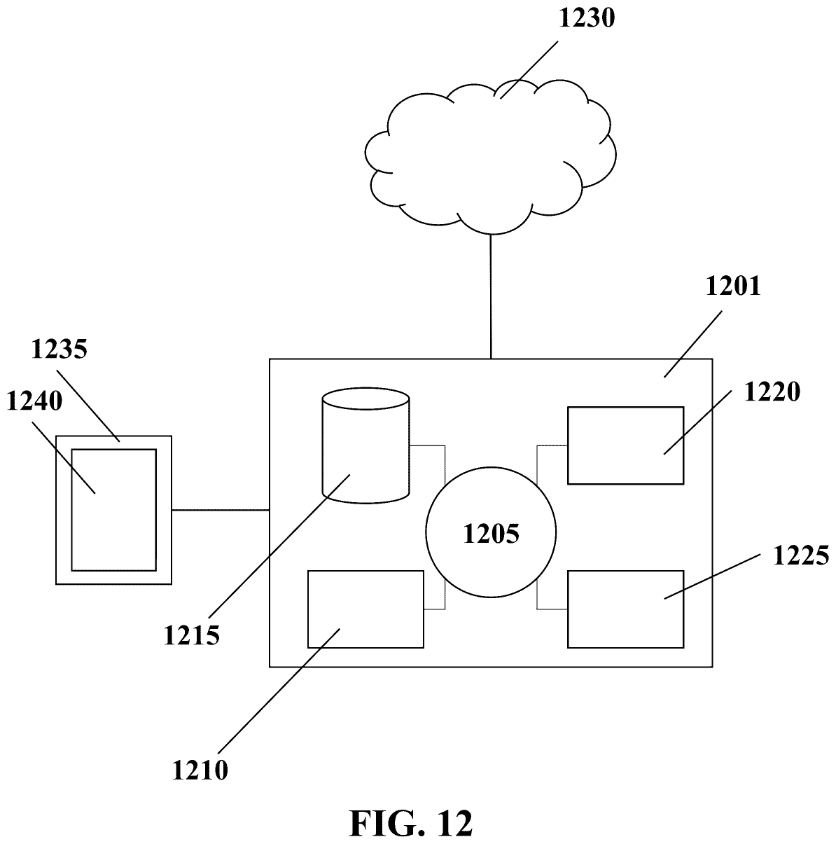

The present disclosure provides computer control systems that are programmed to implement methods of the disclosure. FIG. 12 shows a computer system 1201 that is programmed or otherwise configured to implement methods of the disclosure, such as to control the systems described herein (e.g., reagent dispensing, detecting, etc.) and collect, receive, and/or analyze sequencing information. The computer system 1201 can be an electronic device of a user or a computer system that is remotely located with respect to the electronic device. The electronic device can be a mobile electronic device.

The computer system 1201 includes a central processing unit (CPU, also “processor” and “computer processor” herein) 1205, which can be a single core or multi core processor, or a plurality of processors for parallel processing. The computer system 1201 also includes memory or memory location 1210 (e.g., random-access memory, read-only memory, flash memory), electronic storage unit 1215 (e.g., hard disk), communication interface 1220 (e.g., network adapter) for communicating with one or more other systems, and peripheral devices 1225, such as cache, other memory, data storage and/or electronic display adapters. The memory 1210, storage unit 1215, interface 1220 and peripheral devices 1225 are in communication with the CPU 1205 through a communication bus (solid lines), such as a motherboard. The storage unit 1215 can be a data storage unit (or data repository) for storing data. The computer system 1201 can be operatively coupled to a computer network (“network”) 1230 with the aid of the communication interface 1220. The network 1230 can be the Internet, an isolated or substantially isolated internet and/or extranet, or an intranet and/or extranet that is in communication with the Internet. The network 1230 in some cases is a telecommunication and/or data network. The network 1230 can include one or more computer servers, which can enable distributed computing, such as cloud computing. The network 1230, in some cases with the aid of the computer system 1201, can implement a peer-to-peer network, which may enable devices coupled to the computer system 1201 to behave as a client or a server.

The CPU 1205 can execute a sequence of machine-readable instructions, which can be embodied in a program or software. The instructions may be stored in a memory location, such as the memory 1210. The instructions can be directed to the CPU 1205, which can subsequently program or otherwise configure the CPU 1205 to implement methods of the present disclosure. Examples of operations performed by the CPU 1205 can include fetch, decode, execute, and writeback.

The CPU 1205 can be part of a circuit, such as an integrated circuit. One or more other components of the system 1201 can be included in the circuit. In some cases, the circuit is an application specific integrated circuit (ASIC).

The storage unit 1215 can store files, such as drivers, libraries and saved programs. The storage unit 1215 can store user data, e.g., user preferences and user programs. The computer system 1201 in some cases can include one or more additional data storage units that are external to the computer system 1201, such as located on a remote server that is in communication with the computer system 1201 through an intranet or the Internet.

The computer system 1201 can communicate with one or more remote computer systems through the network 1230. For instance, the computer system 1201 can communicate with a remote computer system of a user. Examples of remote computer systems include personal computers (e.g., portable PC), slate or tablet PC's (e.g., Apple® iPad, Samsung® Galaxy Tab), telephones, Smart phones (e.g., Apple® iPhone, Android-enabled device, Blackberry®), or personal digital assistants. The user can access the computer system 1201 via the network 1230.

Methods as described herein can be implemented by way of machine (e.g., computer processor) executable code stored on an electronic storage location of the computer system 1201, such as, for example, on the memory 1210 or electronic storage unit 1215. The machine executable or machine-readable code can be provided in the form of software. During use, the code can be executed by the processor 1205. In some cases, the code can be retrieved from the storage unit 1215 and stored on the memory 1210 for ready access by the processor 1205. In some situations, the electronic storage unit 1215 can be precluded, and machine-executable instructions are stored on memory 1210.

The code can be pre-compiled and configured for use with a machine having a processor adapted to execute the code or can be compiled during runtime. The code can be supplied in a programming language that can be selected to enable the code to execute in a pre-compiled or as-compiled fashion.

Aspects of the systems and methods provided herein, such as the computer system 1201, can be embodied in programming. Various aspects of the technology may be thought of as “products” or “articles of manufacture” typically in the form of machine (or processor) executable code and/or associated data that is carried on or embodied in a type of machine-readable medium. Machine-executable code can be stored on an electronic storage unit, such as memory (e.g., read-only memory, random-access memory, flash memory) or a hard disk. “Storage” type media can include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer into the computer platform of an application server. Thus, another type of media that may bear the software elements includes optical, electrical, and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to non-transitory, tangible “storage” media, terms such as computer or machine “readable medium” refer to any medium that participates in providing instructions to a processor for execution.

Hence, a machine readable medium, such as computer-executable code, may take many forms, including but not limited to, a tangible storage medium, a carrier wave medium or physical transmission medium. Non-volatile storage media include, for example, optical or magnetic disks, such as any of the storage devices in any computer(s) or the like, such as may be used to implement the databases, etc. shown in the drawings. Volatile storage media include dynamic memory, such as main memory of such a computer platform. Tangible transmission media include coaxial cables; copper wire and fiber optics, including the wires that comprise a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a ROM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a processor for execution.

The computer system 1201 can include or be in communication with an electronic display 1235 that comprises a user interface (UI) 1240 for providing, for example, results of a nucleic acid sequence (e.g., sequence reads), status of reagent supply, status of sample supply, status of substrate supply, or any combination thereof. Examples of UI's include, without limitation, a graphical user interface (GUI) and web-based user interface.

Methods and systems of the present disclosure can be implemented by way of one or more algorithms. An algorithm can be implemented by way of software upon execution by the central processing unit 1205. The algorithm can, for example, spatially resolve a plurality of analyte sequences using sequencing information.

### Kits

Aspects of the disclosure provided comprise cartridge sample and/or reagent pack kits that may be configured to interface with the system described elsewhere herein. In some cases, the kits may comprise: a cartridge configured to be inserted into a print head; and a sample pack configured to be inserted into said cartridge, where the sample pack comprises a nucleic acid sample coupled to one or more beads. In some cases, the kits may comprise a cartridge configured to be inserted into a print head; and a reagent pack configured to be inserted into a cartridge, where the reagent pack comprises a sequencing reagent of labeled or unlabeled nucleotides. In some cases, the kits may comprise user instructions for how to insert the cartridge and/or reagent pack into the respective receptacle on the system.

### Numbered Embodiments

The following embodiments recite non-limiting permutations of combinations of features disclosed herein. Other permutations of combinations of features are also contemplated. In particular, each of these numbered embodiments is contemplated as depending from or relating to every previous or subsequent numbered embodiment, independent of their order as listed.

1. A method for non-contact heating, comprising:
(a) providing a substrate surface and a non-contact heater, wherein the non-contact heater comprises a surface comprising a plurality of light-emitting diodes (LEDs) mounted thereto;
(b) positioning the non-contact heater above the substrate surface such that the plurality of LEDs are configured to direct light to the substrate surface; and
(c) activating at least a subset of the plurality of LEDs to direct light to the substrate surface.

2. The method of embodiment 1, wherein the positioning in (b) comprises lowering the non-contact heater from a non-heating position to a heating position.

3. The method of any one of embodiments 1-2, wherein one or more controllers, individually or in combination, activate the at least the subset of plurality of LEDs to direct light to the substrate surface.

4. The method of any one of embodiments 1-3, wherein the substrate surface comprises a plurality of analytes immobilized thereto.

5. The method of embodiment 4, wherein the plurality of analytes comprises single-stranded nucleic acid molecules.

6. The method of embodiment 4, wherein the plurality of analytes comprises double-stranded nucleic acid molecules.

7. The method of embodiment 6, wherein during or subsequent to the activating in (c), the double-stranded nucleic acid molecules are denatured to generate single-stranded nucleic acid molecules.

8. The method of embodiment 5 or embodiment 7, wherein during or subsequent to the activating in (c), the single-stranded nucleic acid molecules are hybridized to sequencing primers.

9. The method of embodiment 5, wherein the single-stranded nucleic acid molecules are hybridized to sequencing primers, and wherein the at least the subset of the plurality of LEDs are activated in the presence of sequencing reagents.

10. The method of embodiment 9, wherein the sequencing reagents comprises a plurality of labeled nucleotides.

11. The method of any one of embodiments 4-10, wherein the plurality of analytes are coupled to a plurality of beads, which beads are immobilized to the substrate surface.

12. The method of any one of embodiments 4-11, wherein the plurality of analytes are immobilized to a plurality of individually addressable locations on the substrate surface.

13. The method of any one of embodiments 1-12, wherein the substrate surface is stationary while the at least the subset of the plurality of LEDs are activated in (c).

14. The method of any one of embodiments 1-12, wherein the substrate surface is rotating with respect to the non-contact heater while the at least the subset of the plurality of LEDs are activated in (c).

15. The method of any one of embodiments 1-14, wherein the non-contact heater comprises at least 50 LEDs.

16. The method of any one of embodiments 1-15, wherein the plurality of LEDs are configured to emit red light.

17. A system for non-contact heating, comprising:
a substrate comprising a substrate surface;
a non-contact heater, wherein the non-contact heater comprises a surface comprising a plurality of light-emitting diodes (LEDs) mounted thereto; and
one or more controllers, individually or in combination, configured to activate at least a subset of the plurality of LEDs to direct light towards the substrate surface.

18. The system of embodiment 17, further comprising one or more actuators configured to move the non-contact heater from a non-heating position to a heating position, or vice versa.

19. The system of any one of embodiments 17-18, wherein the plurality of LEDs are mounted on the surface of a printed circuit board (PCB).

20. The system of any one of embodiments 17-19, wherein the substrate surface comprises a plurality of analytes.

21. A method for handling a substrate, comprising:
providing a chuck configured to contact the substrate, wherein the chuck comprising a plurality of supports and a plurality of suction cups, wherein the plurality of supports are coupled to the plurality of suction cups, wherein at least a subset of the plurality of supports comprises a fluidic pathway, and wherein the chuck comprises one or more channels that fluidically connects the fluidic pathway of the at least the subset of the plurality of supports to at least a subset of the plurality of suction cups that are coupled to the at least the subset of the plurality of supports.

22. The method of embodiment 21, further comprising: contacting the substrate to the plurality of suction cups of the chuck.

23. The method of embodiment 22, further comprising subjecting the fluidic pathway to a vacuum or negative pressure.

24. A system for handling a substrate, comprising:
a chuck configured to contact the substrate, wherein the chuck comprising a plurality of supports and a plurality of suction cups, wherein the plurality of supports are coupled to the plurality of suction cups, wherein at least a subset of the plurality of supports comprises a fluidic pathway, and wherein the chuck comprises one or more channels that fluidically connects the fluidic pathway of the at least the subset of the plurality of supports to at least a subset of the plurality of suction cups that are coupled to the at least the subset of the plurality of supports.

25. The system of embodiment 24, further comprising the substrate.

26. The system of embodiment 25, wherein the substrate is contacting the plurality of suction cups of the chuck.

27. The system of any one of embodiments 24-26, further comprising a device configured to apply a vacuum or subject the fluidic pathway to negative pressure.

28. The system of embodiment 27, wherein the device comprises a compressor.

29. A method for heating a substrate during sequencing, comprising:
(a) providing a substrate comprising a substrate surface, wherein the substrate surface comprises a plurality of nucleic acid molecules immobilized thereto;
(b) contacting a plurality of labeled nucleotides to the plurality of nucleic acid molecules; and
(c) prior to, during, or subsequent to (b), heating the substrate surface by one or more of:
(i) directing light from a non-contact heater comprising a plurality of light-emitting diodes (LEDs), wherein the non-contact heater is not in contact with the substrate surface;
(ii) using a fan to heat a processing chamber comprising the substrate, wherein the fan is not in contact with the substrate surface;
(iii) heating a solution comprising the plurality of labeled nucleotides to a temperature higher than a temperature of the substrate surface, and dispensing the solution in (b);
(iv) heating a washing solution, and dispensing the washing solution prior to (b); and
(v) heating a chuck, a sub-chuck, or a theta stage, wherein the substrate is coupled to the chuck, wherein the chuck is coupled to the theta stage via the sub-chuck, wherein the theta stage is configured to rotate the substrate.

30. The method of embodiment 29, wherein in (iii) and (iv), the solution or washing solution is heated by heating a dispense nozzle used to dispense the solution or washing solution.

31. The method of any one of embodiments 29-30, wherein in (iii) and (iv), the solution or washing solution is heated by heating a fluid tubing that the solution or washing solution is directed through for dispensing to the substrate surface.

32. The method of any one of embodiments 29-31, wherein in (v), rotating of the theta stage heats the theta stage.

33. The method of any one of embodiments 29-32, wherein in (b), the plurality of nucleic acid molecules are contacted with a mixture comprising the plurality of labeled nucleotides and a plurality of unlabeled nucleotides.

34. The method of any one of embodiments 29-33, wherein the plurality of nucleic acid molecules are hybridized to a plurality of sequencing primers.

35. The method of any one of embodiments 29-34, wherein the substrate surface is rotating during the contacting in (b).

36. The method of any one of embodiments 29-35, wherein the substrate surface is rotating during the heating in (c).

37. The method of any one of embodiments 29-36, wherein the plurality of nucleic acid molecules are hybridized to a plurality of sequencing primers, and prior to (b), a plurality of nucleotides are provided to the plurality of nucleic acid molecules to extend the plurality of sequencing primers through a known adapter sequence of the plurality of nucleic acid molecules, wherein a concentration of the plurality of nucleotides provided are adjusted based on the known adapter sequence.

38. A method for cooling a substrate during sequencing, comprising:
(a) providing a substrate comprising a substrate surface, wherein the substrate surface comprises a plurality of nucleic acid molecules immobilized thereto;
(b) detecting one or more signals from the plurality of nucleic acid molecules, indicative of incorporation of a nucleotide, using a detector comprising an objective; and
(c) prior to or during (b), cooling the substrate surface by one or more of:
(i) using a fan to cool a processing chamber comprising the substrate, wherein the fan is not in contact with the substrate surface;
(ii) dispensing a scan buffer to at least a region of the substrate surface in optical communication with the objective, wherein the scan buffer dispensed is at a lower temperature than a temperature of the substrate surface; and
(iii) cooling a chuck, a sub-chuck, or a theta stage, wherein the substrate is coupled to the chuck, wherein the chuck is coupled to the theta stage via the sub-chuck, wherein the theta stage is configured to rotate the substrate; and
(iv) dispensing a washing solution prior to (b), wherein the washing solution is at a temperature lower than the substrate surface at time of dispensing.

39. The method of embodiment 38, wherein the objective is an immersion objective, wherein the immersion objective is in contact with an immersion fluid, which immersion fluid is in contact with the region of the substrate surface in optical communication with the objective.

40. The method of any one of embodiments 37-38, wherein the washing solution in (iv) is at room temperature.

41. A data communication method, comprising:
at a first node:
dispatching first instructions to a second node; and dispatching second instructions to a third node; and
   at the second node:
   dispatching third instructions to the third node and a fourth node;
wherein:
the first instructions comprise a first communication mode, and the second and third instructions comprise a second communication mode; and the first instructions are transmitted via a first connector configured for the first communication mode, and the second and third instructions are transmitted via a second connector configured for the second communication mode, wherein the first and second connectors comprise a cable.

42. The data communication method of embodiment 41, wherein the first connector and the second connector, respectively, comprises one or more twisted pairs of conductors.

43. The data communication method of embodiment 41, wherein the first node, the second node, the third node, and the fourth node are connected via the first connector and the second connector.

44. The data communication method of embodiment 41, wherein the first communication mode comprises Ethernet.

45. The data communication method of embodiment 41, wherein the second communication mode comprises CAN.

46. The data communication method of embodiment 41, wherein the first instructions have a first priority and the second instructions comprise a second priority, wherein the second priority is lower than the first priority.

47. The data communication method of embodiment 41, wherein the first node is a controller and the second, third, and fourth nodes comprise subassemblies.

48. The data communication method of embodiment [0394], wherein the controller is a master device and the subassemblies are slave nodes.

49. A data communication system, comprising:
a cable comprising a plurality of twisted pairs of conductors, wherein a first subset of one or more twisted pairs of conductors is assigned to and configured for EtherCAT (Ethernet for Control Automation) communication, and wherein a second subset of one or more twisted pairs of conductors, different from the first subset of one or more twisted pairs of conductors, is assigned to and configured for CAN (Controller Area Network) communication.

50. The data communication system of embodiment 49, wherein respective twisted pairs in the first and second subsets are mutually exclusive.

51. The data communication system of embodiment 49, wherein the first subset comprises two twisted pairs.

52. The data communication system of embodiment 49, wherein the second subset comprises one twisted pair.

53. The data communication system of embodiment 49, wherein the cable comprises a Category (CAT) cable.

54. The data communication system of embodiment 49, wherein the cable is configured to connect a first subassembly to a controller and/or to a second subassembly.

55. The data communication system of embodiment 49, wherein the controller is a master device.

56. The data communication system of embodiment 49, wherein the first subassembly and/or the second subassembly are slave nodes.

57. A data communication method, comprising:
connecting a cable between a first subassembly and (i) a controller or (ii) a second subassembly, wherein the cable comprises a plurality of twisted pairs of conductors,
wherein a first subset of one or more twisted pairs of conductors is assigned to and configured for EtherCAT (Ethernet for Control Automation) communication, and
wherein a second subset of one or more twisted pairs of conductors, different from the first subset of one or more twisted pairs of conductors, is assigned to and configured for CAN (Controller Area Network) communication.

58. The data communication method of embodiment 57, wherein the cable is connected between the first subassembly and the controller, communicating data between the first subassembly and the controller via the first subset of one or more twisted pairs.

59. The data communication method of embodiment 57, wherein the cable is connected between the first subassembly and the second subassembly, communicating data between the first subassembly and the second subassembly via the second subset of one or more twisted pairs.

60. A method of spin coating a substrate, comprising:
(a) providing the substrate on a substrate chuck, wherein the substrate comprises immobilized thereto one or more beads, wherein the one or more beads comprise one or more nucleic acid molecules coupled thereto, and wherein the substrate chuck comprises a sensor configured in an active state or an inactive state;
(b) at an inactive state of the sensor, rotating the substrate;
(c) dispensing a reagent onto a surface of the substrate; and
(d) stopping rotation of the substrate and/or stopping reagent dispense upon activation of the sensor.

61. A method of spin coating a substrate, comprising:
(a) providing a substrate on a substrate chuck in a modular sample environment, wherein the substrate comprises immobilized thereto one or more beads, wherein the one or more beads comprise one or more nucleic acid molecules coupled thereto, and wherein the substrate chuck comprises a sensor configured in an active state or an inactive state;
(b) at an inactive state of the sensor, rotating the substrate;
(c) dispensing a reagent onto a surface of the substrate; and
(d) upon activation of the sensor, initiating draining the modular sample environment.

62. The method of embodiment 60 or embodiment 61, wherein the sensor comprises a light source, a prism, and a photodetector.

63. The method of embodiment 60, wherein the substrate chuck is in a modular sample environment.

64. The method of embodiment 61 or embodiment 63, wherein the sensor is activated when a volume of the reagent comprises at least 75% of a total volume of the modular sample environment.

65. The method of embodiment 61 or embodiment 63, wherein the sensor is activated when a level of the reagent in the modular sample environment is at least 75% of the height of the modular sample environment.

66. A method, comprising:
(a) dispensing a first droplet onto a surface of a substrate using a printer head, wherein the droplet comprises an analyte coupled to a bead; and
(b) subjecting the substrate comprising the droplet thereon to rotation, wherein (b) is performed during or subsequent to (a).

67. A method, comprising:
(a) dispensing (i) a first set of droplets onto a surface of a substrate in a first dispensing pattern using a printer head, wherein a first droplet of the first set of droplets comprises a first analyte coupled to a first bead, and (ii) a second set of droplets onto the surface of the substrate in a second dispensing pattern using the printer head that is different than the first dispensing pattern, wherein a second droplet of the second set of droplets comprises a second analyte coupled to a second bead; and
(b) subjecting the substrate comprising the first droplet and the second droplet thereon to rotation, wherein (b) is performed during or subsequent to (a).

68. The method of any one of embodiments 66-67, wherein the printer head comprises one or more print head nozzles.

69. The method of embodiment 68, wherein the one or more print head nozzles are configured to dispense the first droplet, the second droplet, or both.

70. The method of embodiment 69, wherein the one or more print head nozzles comprise an ink-jet print head nozzle.

71. The method of any one of embodiments 66-70, wherein the printer head moves radially toward or away from a rotational axis of the surface during the dispensing.

72. The method of any one of embodiments 67-71, wherein the first dispensing pattern is substantially the same as the second dispensing pattern.

73. The method of any one of embodiments 67-71, wherein the first dispensing pattern is a spiral, the second dispensing pattern is a spiral, or both.

74. The method of any one of embodiments 67-71, wherein the first dispensing pattern does not spatially overlap with the second dispensing pattern.

75. The method of any one of embodiments 67-71, wherein the first dispensing pattern is a sector of a circle, the second dispensing pattern is a sector of a circle, or both.

76. The method of any one of embodiments 67-71, wherein the first dispensing pattern and the second dispensing pattern comprise concentric rings.

77. The method of embodiment 69, wherein the one or more print head nozzles are configured to translate linearly or non-linearly in a plane parallel to the substrate when dispensing the first droplet.

78. The method of embodiment 69, wherein the substrate is configured to translate linearly or non-linearly in a plane orthogonal to the one or more print head nozzles of the printer head when dispensing the first droplet.

79. The method of any one of embodiments 67-78, wherein the printer head comprises one or more cartridges, wherein the one or more cartridges comprise one or more of a first droplet solution, a second droplet solution, a first reagent, and a second reagent.

80. The method of embodiment 79, wherein the one or more cartridges maintain a first temperature of the first droplet solution.

81. The method of any one of embodiments 79-80, wherein the one or more print head nozzles are configured to increase the first temperature of the first droplet solution to a second temperature prior to dispensing the first droplet.

82. The method of any one of embodiments 80-81, wherein an environment surrounding the one or more print head nozzles or the substrate increases the first temperature of the first droplet when the first droplet is dispensed.

83. The method of embodiment 79, wherein the one or more cartridges are replaceable, disposable, refillable, or any combination thereof.

84. The method of any one of embodiments 67-83, further comprising (c) rotating the substrate along a rotational axis of the substrate for a first duration of time and (d) stopping the rotating for a second duration of time.

85. The method of embodiment 84, wherein (c) and (d) are repeated at least two times, at least three times, or at least four times.

86. The method of any one of embodiments 67-83, further comprising translating the substrate in a plane parallel to the substrate for a first duration of time and (d) stopping the translating for a second duration of time.

87. The method of any one of embodiments 67-83, further comprising (c) vibrating the substrate for a first duration of time.

88. The method of any one of embodiments 67-83, further comprising (c) translating the substrate such that the translating comprises a non-zero derivative of an acceleration of the substrate.

89. The method of any one of embodiments 67-88, further comprising (c) exposing the first droplet and the second droplet dispensed onto the surface of the substrate to an environment for a period of time thereby reducing a thickness of a film formed by the dispensed first and second droplet.

90. The method of any one of embodiments 67-89, further comprising (c) covering the surface of the substrate with a cover.

91. The method of embodiment 90, wherein the cover is disposable, cleanable, reusable, or any combination thereof.

92. The method of embodiment 90 or embodiment 91, further comprising (d) rotating the substrate while holding the cover stationary.

93. The method of embodiment 79, wherein the one or more cartridges comprise a cleaning solution configured to clean the one or more print head nozzles.

94. The method of embodiment 93, wherein the cleaning solution comprises bleach.

95. The method of embodiment 79, wherein the one or more cartridges further comprise an antimicrobial agent.

96. The method of embodiment 95, wherein the antimicrobial agent comprises metal salts of hydrazoic acid sodium azide, metal salts of hydrofluoric acid, sodium fluoride, benzalkonium chloride, or any combination thereof.

97. A system for sequencing a plurality of nucleic acid samples, comprising:
a sample loading station configured to dispense a nucleic acid sample of the plurality of nucleic acid samples onto a surface of a substrate;
a processing station configured to bring a nucleic acid molecule of the nucleic acid sample immobilized on the surface of the substrate into contact with a reagent to sequence the nucleic acid molecule;
a sample station configured to supply the nucleic acid sample to the sample loading station;
a substrate station configured to supply the substrate to the sample loading station;
a reagent station configured to supply the reagent to the processing station, wherein the reagent is supplied from a first reservoir or a second reservoir; and
one or more processors, individually or collectively, programmed to execute (i) at least a portion of a first queuing instruction to introduce the nucleic acid sample of the plurality of nucleic acid samples from the sample station to the sample loading station according to a first order of introduction defined by the first queuing instruction, (ii) a substrate loading instruction to introduce the substrate from the substrate station to the sample loading station and dispense the nucleic acid sample onto the substrate, and (iii) a sequencing instruction to draw the reagent from the first reservoir, from the second reservoir, or alternately from the first reservoir and the second reservoir, and deliver the reagent to the processing station,
   wherein the processing station is capable of operating during performance of one or more actions selected from the group consisting of
(1) introducing an additional nucleic acid sample of the plurality of nucleic acid samples to the sample loading station,
(2) inputting a second queuing instruction and executing at least a portion of the second queuing instruction, wherein the second queuing instruction defines a second order of introduction that is different than the first order of introduction,
(3) introducing an additional substrate to the substrate station, and
(4) introducing an additional volume of the reagent to the reagent station by one or more of (i) replacing the first reservoir or the second reservoir with a third reservoir containing the reagent and (ii) replenishing the first reservoir or the second reservoir with the reagent.

98. The system of embodiment 97, wherein the sample loading station is configured to dispense a sample solution as one or more droplets onto the surface of the substrate.

99. The system of embodiment 98, wherein the one or more droplets comprise a plurality of nucleic acid samples coupled to one or more beads.

100. The system of any one of embodiments 97-99, wherein the substrate is configured to immobilize adjacent thereto the nucleic acid sample.

101. The system of any one of embodiments 97-100, wherein the sample loading station comprises one or more dispensing nozzles configured to dispense the nucleic acid sample to the substrate.

102. The system of embodiment 101, wherein the sample loading station comprises a lid, wherein the lid comprises a seal that is configured to seal a chamber enclosing the substrate and the one or more dispensing nozzles.

103. The system of embodiment 102, wherein the seal comprises a hermetic seal.

104. The system of embodiment 102, wherein the chamber comprises humidity and/or temperature control.

105. The system of any one of embodiments 101-104, wherein the sample loading station comprises a washing station configured to wash the one or more dispensing nozzles.

106. The system of embodiment 105, wherein the lid comprises a sealable slot configured to provide access of the one or more dispensing nozzles into the chamber to dispense the nucleic acid sample onto the substrate.

107. The system of any one of embodiments 97-106, wherein the reagent station comprises temperature controlled tubing in fluid communication between the first or second reservoir and the processing station.

108. The system of embodiment 107, wherein a temperature of the temperature-controlled tubing is controlled on demand.

109. The system of embodiment 108, wherein the temperature of the temperature-controlled tubing is controlled within about 0.1 degrees Kelvin (K), 0.2 degrees K, or 0.5 degrees K of a target temperature.

110. The system of any one of embodiments 97-109, wherein the processing station comprises a detecting station, wherein the detecting station comprises an objective lens in optical communication with the surface of the substrate.

111. The system of embodiment 110, further comprising deionized water, wherein the objective lens is configured for cleaning by submerging the objective lens in the deionized water prior to or after imaging the surface of the substrate.

112. The system of any one of embodiments 97-111, wherein the sample loading station comprises a print head configured to dispense the nucleic acid sample as one or more droplets onto the surface of the substrate.

113. The system of embodiment 112, wherein the print head comprises one or more print head nozzles.

114. The system of embodiment 113, wherein the one or more print head nozzles comprise an ink-jet printer nozzle.

115. The system of any one of embodiments 97-114, wherein the processing station is capable of operating for at least 24 hours without human intervention.

116. The system of any one of embodiments 97-114, wherein the system is capable of continuous operation for more than 10 days with human intervention at intervals of not less than 18 hours.

117. The system of any one of embodiments 97-116, wherein the processing station is capable of operating during performance of two or more actions selected from the group consisting of (1), (2), (3), and (4).

118. The system of any one of embodiments 97-116, wherein the processing station is capable of operating during performance of three or more actions selected from the group consisting of (1), (2), (3), and (4).

119. The system of any one of embodiments 97-116, wherein the processing station is capable of operating during performance of each of (1), (2), (3), and (4).

120. The system of any one of embodiments 97-119, wherein the sequencing instruction comprises instructions to draw the reagent from the first reservoir until the first reservoir is depleted below a predetermined threshold, then to draw the reagent from the second reservoir.

121. The system of any one of embodiments 97-120, wherein (4) comprises replacing or replenishing a reservoir from the first reservoir and the second reservoir that is depleted below a predetermined threshold.

122. The system of any one of embodiments 97-121, wherein the reagent comprises one or more members selected from the group consisting of a nucleotide solution, a cleavage solution, and a washing solution.

123. The system of embodiment 122, wherein the nucleotide solution comprises one or more members selected from the group consisting of adenine-containing nucleotides, cytosine-containing nucleotides, guanine-containing nucleotides, thymine-containing nucleotides, and uracil-containing nucleotides.

124. The system of embodiment 122, wherein the nucleotide solution comprises labeled nucleotides.

125. The system of any one of embodiments 97-124, wherein the substrate is a wafer.

126. The system of any one of embodiments 97-124, wherein the substrate comprises a substantially planar array.

127. The system of any one of embodiments 97-124, wherein the substrate comprises a plurality of independently addressable locations.

128. The system of any one of embodiments 97-127, wherein the substrate is configured to rotate about an axis in the processing station.

129. The system of any one of embodiments 97-127, wherein the substrate is configured to linearly translate in the processing station.

130. The system of any one of embodiments 97-129, wherein the plurality of nucleic acid samples is compatible with a common sequencing protocol.

131. The system of any one of embodiments 97-130, wherein the processing station is disposed in a first environment different from a second environment in which the sample station, substrate station, and/or reagent station is disposed.

132. The system of any one of embodiments 97-131, wherein the processing station comprises a thin film interferometer that is configured to measure a thickness of the reagent dispensed onto the surface of the substrate.

133. The system of embodiment 132, wherein the processing station is disposed in a first environment different from a second environment in which the sample station, substrate station, and/or reagent station is disposed, and wherein the one or more processors are in operable communication with the thin film interferometer, and individually or collectively programmed to use the thickness to calculate a humidity of the first environment.

134. The system of embodiment 133, wherein the humidity of the first environment is utilized by the one or more processors to adjust a dispense rate and/or temperature of the nucleic acid sample, the substrate, the reagent, or any combination thereof.

135. The system of embodiment 132, wherein the thickness of the reagent is used to determine a uniformity of a film of the reagent dispensed across the surface of the substrate.

136. The system of embodiment 131, wherein the first environment has a higher relative humidity than the second environment.

137. The system of embodiment 131, wherein the first environment comprises one or more regions of controlled average temperature different from a second average temperature of the second environment.

138. The system of any one of embodiments 97-137, wherein the processing station is disposed in an environment different from an ambient environment.

139. The system of embodiment 138, wherein the environment comprises a higher relative humidity than the ambient environment.

140. The system of embodiment 138, wherein the environment comprises one or more regions of controlled average temperature different from an ambient temperature.

141. The system of any one of embodiments 97-140, wherein the system comprises a dilution station configured to dilute the reagent from the reagent station prior to delivery of the reagent to the processing station.

142. The system of embodiment 141, wherein the reagent is diluted with deionized water.

143. The system of any one of embodiments 97-142, wherein the substrate station comprises a sealed environment.

144. The system of any one of embodiments 97-143, wherein the substrate station comprises a hermetically sealed environment.

145. The system of any one of embodiments 97-144, wherein the substrate station comprises a vacuum desiccator.

146. The system of any one of embodiments 97-145, wherein the one or more processors are configured to, individually or collectively, within at most 40 hours of running time of the processing station, output one or more selected from the group consisting of.
(i) at least 1.5 giga reads per substrate,
(ii) at least 140 base pairs (bp) read length, and
(iii) at least 0.2 terabase reads per run.

147. The system of any one of embodiments 97-145, wherein the one or more processors are configured to, within at most 40 hours of running time of the processing station, output at least 40.0 Giga reads per substrate.

148. The system of any one of embodiments 97-145, wherein the one or more processors are configured to, within at most 40 hours of running time of the processing station, output at least 500 bp read length.

149. The system of any one of embodiments 97-145, wherein the one or more processors are configured to, within at most 40 hours of running time of the processing station, output at least 6.5 terabase reads per run.

150. The system of any one of embodiments 97-145, wherein the one or more processors are configured to, within at most 25 hours of running time of the processing station, output one or more selected from the group consisting of:
(i) at least 1.5 giga reads per substrate,
(ii) at least 140 base pairs (bp) read length, and
(iii) at least 0.2 terabase reads per run.

151. The system of any one of embodiments 97-145, wherein the one or more processors are configured to, within at most 15 hours of running time of the processing station, output one or more selected from the group consisting of:
(i) at least 1.5 giga reads per substrate,
(ii) at least 140 base pairs (bp) read length, and
(iii) at least 0.2 terabase reads per run.

152. The system of any one of embodiments 97-151, wherein the system is further configured to (A) receive (1) the plurality of nucleic acid samples, including the nucleic acid sample, in the sample station and (2) a plurality of substrates, including the substrate, in the substrate station; and (B) receive, by the one or more processors, user instructions to start two or more sequencing cycles.

153. The system of any one of embodiments 97-152, wherein the system is further configured to (C) in a first sequencing cycle, process a first nucleic acid sample from the plurality of nucleic acid samples on a first substrate of the plurality of substrates; and (D) during or subsequent to the first sequencing cycle, in a second sequencing cycle, process a second nucleic acid sample from the plurality of nucleic acid samples on a second substrate of the plurality of substrates, wherein the second sequencing cycle is configured to be performed in absence of additional user intervention.

154. The system of embodiment 152, wherein the two or more sequencing cycles are at least 5 sequencing cycles.

155. The system of embodiment 152, wherein the two or more sequencing cycles are at least 10 sequencing cycles.

156. The system of embodiment 152, wherein the two or more sequencing cycles are at least 20 sequencing cycles.

157. The system of any one of embodiments 97-156, wherein the system is further configured to purify a reagent mixture comprising the reagent prior to delivery of the reagent to the processing station, wherein the reagent mixture comprises a plurality of nucleotides or nucleotide analogs.

158. A method of preparing a sample for processing, comprising:
(a) providing a substrate in a sample loading station;
(b) loading a nucleic acid sample onto a surface of the substrate in the sample loading station, wherein the nucleic acid sample comprises one or more nucleic acid molecules coupled to one or more beads;
(c) coating the surface of the substrate with a coating solution, to provide a coated surface; and
(d) transporting the substrate comprising the coated surface to a processing station.

159. The method of embodiment 158, wherein the coating solution is configured to prevent drying of the nucleic acid sample loaded onto the surface of the substrate.

160. The method of any one of embodiments 158-159, wherein the substrate is a wafer.

161. The method of any one of embodiments 158-160, wherein the substrate is provided to the sample loading station via a mechanical interface.

162. The method of any one of embodiments 158-161, wherein the substrate is transported from the sample loading station to the processing station via a mechanical interface.

163. The method of any one of embodiments 158-162, wherein the coating solution comprises a thickness of between about 90 micrometers (μm) and about 200 μm.

164. The method of any one of embodiments 158-163, wherein the substrate comprising the coated surface further comprises a dry surface wherein the dry surface does not comprise the nucleic acid sample or the coating solution.

165. The method of embodiment 162, wherein the mechanical interface comprises a mechanical arm.

166. The method of embodiment 165, wherein the mechanical interface is configured to mechanically contact the dry surface.

167. The method of embodiment 162, further comprising (e) sanitizing the mechanical interface.

168. The method of any one of embodiments 158-168, comprising (f) washing a tubing of the sample loading station in fluidic communication with the nucleic acid sample by introducing a cleaning solution through the tubing.

169. The method of any one of embodiments 158-168, wherein the processing station comprises a chemical station, a detection station, or any combination thereof.

170. A method for spin coating a substrate, comprising:
(a) providing a substrate on a substrate chuck, wherein the substrate comprises immobilized thereto one or more beads, wherein the one or more beads comprises one or more nucleic acid molecules coupled thereto, and wherein the substrate chuck comprises a deflector configured in an open state or a closed state;
(b) at an open state of the deflector, rotating the substrate;
(c) dispensing a reagent onto a surface of the substrate; and
(d) actuating the deflector to the closed state.

171. The method of embodiment 170, wherein the deflector is configured to prevent splash from the dispensing.

172. A method of replenishing a reagent of a chemical processing station in operation, comprising:
(a) providing a first substrate to a first chemical processing station and a second substrate to a second chemical processing station;
(b) initiating a plurality of first sequencing runs on the first chemical processing station and a plurality of second sequencing runs on the second chemical processing station, wherein at least a portion of the plurality of first sequencing runs and at least a portion of the plurality of second sequencing runs overlap in time, wherein the first chemical processing station is configured to dispense reagents from either a first reagent cartridge or a second reagent cartridge during a single run of the plurality of first sequencing runs, and wherein the second chemical processing station is configured to dispense reagents from either the first reagent cartridge or the second reagent cartridge during a single run of the plurality of second sequencing runs; and
(c) replenishing the first reagent cartridge when both the first chemical processing station and the second chemical processing station are processing first respective sequencing runs that dispenses reagents from the second reagent cartridge, and replenishing the second reagent cartridge when both the first chemical processing station and the second chemical processing station are processing second respective sequencing runs that dispenses reagents from the first reagent cartridge.

173. A method for mixing reagents, comprising:
(a) providing a first reservoir comprising a first sequencing reagent of labeled nucleotides and a second reservoir comprising a second sequencing reagent of unlabeled nucleotides, wherein the first reservoir is in fluidic communication with a first dispensing nozzle and the second reservoir is in fluidic communication with a second dispensing nozzle; and
(b) dispensing the first sequencing reagent and the second sequencing reagent using the first dispensing nozzle and the second dispensing nozzle, respectively, onto a surface of a substrate, wherein the first sequencing reagent is dispensed at a first flow rate and the second sequencing reagent is dispensed at a second flow rate, thereby mixing the first sequencing reagent and the second sequencing reagent.

174. The method of embodiment 173, wherein the first dispensing nozzle dispenses the first sequencing reagent at a time prior to or after the second dispensing nozzle dispenses the second sequencing reagent.

175. The method of any one of embodiments 173-174, wherein the first and second dispensing nozzles are disposed parallel to each other.

176. The method of any one of embodiments 173-174, wherein the first dispensing nozzle and the second dispensing nozzle are at an angle with respect to each other.

177. A method for mixing reagents, comprising:
(a) providing a first reservoir comprising a first sequencing reagent of labeled nucleotides and a second reservoir comprising a second sequencing reagent of unlabeled nucleotides, wherein the first reservoir and the second reservoir are in fluidic communication with a fluid line; and
(b) directing the first sequencing reagent and the second sequencing reagent from the first reservoir and the second reservoir, respectively, into the fluid line, wherein the first sequencing reagent is directed to flow at a first rate and the second sequencing reagent is directed to flow at a second rate, thereby mixing the first and second sequencing reagents in the fluid line.

178. A method for mixing reagents, comprising:
(a) providing a first reservoir comprising a first sequencing reagent of labeled nucleotides and a second reservoir comprising a second sequencing reagent of unlabeled nucleotides, wherein the first reservoir and the second reservoir are in fluidic communication with a valve; and
(b) directing the first sequencing reagent and the second sequencing reagent from the first reservoir and the second reservoir, respectively, into the valve, wherein the first sequencing reagent and the second sequencing reagent are mixed in the valve.

179. A method for mixing sequencing reagents, comprising:
(a) providing a first reservoir comprising a first sequencing reagent of labeled nucleotides fluidically coupled to a first syringe pump and a second reservoir comprising a second sequencing reagent of unlabeled nucleotides fluidically coupled to a second syringe pump; and
(b) aspirating the first sequencing reagent from the first reservoir with the first syringe pump and the second sequencing reagent from the second reservoir with the second syringe pump into a third syringe pump, thereby mixing the first sequencing reagent and the second sequencing reagent in the third syringe pump.

180. The method of embodiment 179, wherein the first syringe pump aspirates the first sequencing reagent at a first rate and the second syringe pump aspirates the second sequencing reagent at a second rate.

181. The method of embodiment 180, wherein the first rate and the second rate are different.

182. A kit, comprising:
a cartridge configured to be inserted into a print head; and
a sample pack configured to be inserted into the cartridge, wherein the sample pack comprises a nucleic acid sample coupled to one or more beads.

183. A kit, comprising:
a cartridge configured to be inserted into a print head; and a reagent pack configured to be inserted into a cartridge, wherein the reagent pack comprises a sequencing reagent of labeled or unlabeled nucleotides.

184. A method for sequencing, comprising:
(a) receiving, at a reagent station of a sequencer, a reagent cartridge comprising a reagent;
(b) transferring the reagent from the reagent cartridge to a reagent reservoir at the reagent station; and
(c) directing, via a manifold in the sequencer, the reagent from the reagent reservoir to a dispensing nozzle disposed at a processing station of the sequencer, wherein the manifold comprises a fluid inlet in fluid communication with the reagent reservoir and a fluid outlet in fluid communication with the dispensing nozzle.

185. The method of embodiment 184, further comprising, prior to dispensing the reagent from the dispensing nozzle at the processing station, diluting the reagent with a diluent.

186. The method of embodiment 185, wherein the reagent is diluted in the reagent reservoir.

187. The method of embodiment 185, wherein the reagent is diluted subsequent to exiting the reagent reservoir.

188. The method of embodiment 185, wherein the reagent is mixed with a diluent via the manifold, wherein the manifold comprises a second fluid inlet in fluid communication with a diluent reservoir comprising the diluent.

189. The method of any one of embodiments 184-188, further comprising removing the reagent cartridge from the reagent station or replacing the reagent cartridge with a second reagent cartridge while the processing station is in operation.

190. The method of embodiment 189, wherein the processing station is dispensing the reagent via the dispensing nozzle during operation.

191. The method of any one of embodiments 184-190, wherein the manifold is mounted in the sequencer.

192. The method of any one of embodiments 184-191, wherein the manifold comprises a plurality of fluid actuating devices configured to provide positive pressure or negative positive pressure or both to direct a fluid from a given fluid inlet of the manifold to a given fluid outlet of the manifold.

While preferred embodiments of the present invention have been shown and described herein, it will be obvious to those skilled in the art that such embodiments are provided by way of example only. It is not intended that the invention be limited by the specific examples provided within the specification. While the invention has been described with reference to the aforementioned specification, the descriptions and illustrations of the embodiments herein are not meant to be construed in a limiting sense. Numerous variations, changes, and substitutions will now occur to those skilled in the art without departing from the invention. Furthermore, it shall be understood that all aspects of the invention are not limited to the specific depictions, configurations or relative proportions set forth herein which depend upon a variety of conditions and variables. It should be understood that various alternatives to the embodiments of the invention described herein may be employed in practicing the invention. It is therefore contemplated that the invention shall also cover any such alternatives, modifications, variations or equivalents. It is intended that the following claims define the scope of the invention and that methods and structures within the scope of these claims and their equivalents be covered thereby.

1.-100. (canceled)

101. A method for non-contact heating, comprising:
(a) providing a substrate surface and a non-contact heater, wherein the non-contact heater comprises a surface comprising a plurality of light-emitting diodes (LEDs) mounted thereto, wherein the substrate surface comprises a plurality of analytes immobilized thereto;
(b) positioning the non-contact heater above the substrate surface such that the plurality of LEDs are configured to direct light to the substrate surface; and
(c) activating at least a subset of the plurality of LEDs to direct light to a subset of the plurality of analytes immobilized on the substrate surface.

102. The method of claim 101, wherein the positioning in (b) comprises lowering the non-contact heater from a non-heating position to a heating position.

103. The method of claim 101, wherein the plurality of analytes comprises nucleic acid molecules.

104. The method of claim 101, wherein the plurality of analytes comprises double-stranded nucleic acid molecules and wherein, during or subsequent to the activating in (c), the double-stranded nucleic acid molecules are denatured to generate single-stranded nucleic acid molecules.

105. The method of claim 103, wherein during or subsequent to the activating in (c), the nucleic acid molecules are hybridized to sequencing primers.

106. The method of claim 101, wherein the at least the subset of the plurality of LEDs are activated in the presence of sequencing reagents.

107. The method of claim 106, wherein the sequencing reagents comprises a plurality of labeled nucleotides.

108. The method of claim 101, wherein the plurality of analytes are coupled to a plurality of beads, which beads are immobilized to the substrate surface.

109. The method of claim 101, wherein the substrate surface is stationary while the at least the subset of the plurality of LEDs are activated in (c).

110. The method of claim 101, wherein the substrate surface is rotating with respect to the non-contact heater while the at least the subset of the plurality of LEDs are activated in (c).

111. A system for non-contact heating, comprising:
a substrate comprising a substrate surface, wherein the substrate surface comprises a plurality of analytes immobilized thereto;
a non-contact heater, wherein the non-contact heater comprises a surface comprising a plurality of light-emitting diodes (LEDs) mounted thereto; and
one or more controllers, individually or in combination, configured to activate at least a subset of the plurality of LEDs to direct light towards a subset of the plurality of analytes immobilized on the substrate surface.

112. The system of claim 111, further comprising one or more actuators configured to move the non-contact heater from a non-heating position to a heating position, or vice versa.

113. The system of claim 111, wherein the plurality of LEDs are mounted on the surface of a printed circuit board (PCB).

114. The system of claim 111, further comprising:
a chuck configured to contact the substrate, wherein the chuck comprises a plurality of supports and a plurality of suction cups, wherein the plurality of supports are coupled to the plurality of suction cups, wherein at least a subset of the plurality of supports comprises a fluidic pathway, and wherein the chuck comprises one or more channels that fluidically connects the fluidic pathway of the at least the subset of the plurality of supports to at least a subset of the plurality of suction cups that are coupled to the at least the subset of the plurality of supports.

115. The system of claim 114, wherein the substrate is contacting the plurality of suction cups of the chuck.

116. The system of claim 114, further comprising a device configured to apply a vacuum or subject the fluidic pathway to negative pressure.

117. A method for heating a substrate during sequencing, comprising:
(a) providing a substrate comprising a substrate surface, wherein the substrate surface comprises a plurality of nucleic acid molecules immobilized thereto;
(b) contacting a plurality of labeled nucleotides to the plurality of nucleic acid molecules; and
(c) prior to, during, or subsequent to (b), heating the substrate surface by one or more of:
(i) directing light from a non-contact heater comprising a plurality of light-emitting diodes (LEDs), wherein the non-contact heater is not in contact with the substrate surface;
(ii) using a fan to heat a processing chamber comprising the substrate, wherein the fan is not in contact with the substrate surface;
(iii) heating a solution comprising the plurality of labeled nucleotides to a temperature higher than a temperature of the substrate surface, and dispensing the solution in (b);
(iv) heating a washing solution, and dispensing the washing solution prior to (b); and
(v) heating a chuck, a sub-chuck, or a theta stage, wherein the substrate is coupled to the chuck, wherein the chuck is coupled to the theta stage via the sub-chuck, and wherein the theta stage is configured to rotate the substrate.

118. The method of claim 117, wherein in (v), rotating of the theta stage heats the theta stage.

119. The method of claim 117, wherein the substrate surface is rotating during the contacting in (b), rotating during the heating in (c), or both.

120. The method of claim 117, wherein the plurality of nucleic acid molecules are hybridized to a plurality of sequencing primers, and prior to (b), a plurality of nucleotides are provided to the plurality of nucleic acid molecules to extend the plurality of sequencing primers through a known adapter sequence of the plurality of nucleic acid molecules, wherein a concentration of the plurality of nucleotides provided are adjusted based on the known adapter sequence.
